(19) United States
(12) Patent Application Publication
(10) Pub. No.: US 2022/0080424 A1
(43) Pub. Date: Mar. 17, 2022

(54) DEVICES, SYSTEMS, AND METHODS FOR CONTROLLING LIQUID FLOW

(71) Applicant: 10X Genomics, Inc., Pleasanton, CA (US)

(72) Inventors: Ivan AKHREMICHEV, Pleasanton, CA (US); Rajiv BHARADWAJ, Pleasanton, CA (US); Lynna CHEN, Pleasanton, CA (US); Francis CUI, Oakland, CA (US); Rachel GERVER, Pleasanton, CA (US); Mohammad Rahimi LENJI, Livermore, CA (US); Bill Kengli LIN, Pleasanton, CA (US); Anthony MAKAREWICZ, Livermore, CA (US); Martin SAUZADE, Pleasanton, CA (US); Astha TANNA, Pleasanton, CA (US); Fernandino VALDECANAS, Pleasanton, CA (US); Tobias Daniel WHEELER, Alameda, CA (US); Yiran ZHANG, Castro Valley, CA (US); Alireza SALMANZADEH, San Ramon, CA (US)

(21) Appl. No.: 17/357,617

(22) Filed: Jun. 24, 2021

Related U.S. Application Data
(63) Continuation of application No. PCT/US2019/068374, filed on Dec. 23, 2019.
(60) Provisional application No. 62/868,624, filed on Jun. 28, 2019.
(60) Provisional application No. 62/853,698, filed on May 28, 2019.
(60) Provisional application No. 62/811,992, filed on Feb. 28, 2019.
(60) Provisional application No. 62/811,871, filed on Feb. 28, 2019.
(60) Provisional application No. 62/811,823, filed on Feb. 28, 2019.
(60) Provisional application No. 62/811,571, filed on Feb. 28, 2019.
(60) Provisional application No. 62/784,642, filed on Dec. 24, 2018.

(30) Foreign Application Priority Data
Dec. 11, 2019 (US) PCT/US2019/065735

(51) Int. Cl. B01L 3/00; B01L 7/00

(52) U.S. Cl. CPC B01L 3/502784; B01L 7/52; B01L 3/502715; B01L 3/502723; B01L 3/502738; B01L 2400/06; B01L 2300/0883; B01L 2300/0867; B01L 2400/0487; B01L 2200/0684; B01L 2300/0663

(57) ABSTRACT

Disclosed are devices, systems, kits, and methods for controlling liquid flow and, e.g., in particular, for forming droplet having substantially uniform droplet-to-droplet content. The devices, systems, and kits may include a first channel including a funnel or may include a first channel and a first-side channel, the first channel being in fluid communication with a droplet formation region. The devices, systems, and kits may further include a second channel fluidically connected to the first channel or the first side-channel. Funnels and/or side-channels may be used to enhance the control over particle spacing in the channels, thereby providing superior control over the number of particles of the same kind in formed droplets. The devices, systems, and kits of the invention may further include a mixer downstream of a channel intersection. Mixers can be used to reduce localized pockets of high concentration of dissolved ingredients.

### BACKGROUND OF THE INVENTION

Many biomedical applications rely on high-throughput assays of samples combined with one or more reagents in droplets. For example, in both research and clinical applications, high-throughput genetic tests using target-specific reagents are able to provide information about samples in drug discovery, biomarker discovery, and clinical diagnostics, among others.

Improved devices, systems, and methods for producing droplets would be beneficial.

### SUMMARY OF THE INVENTION

In general, the invention provides devices, systems, and methods for controlling liquid flow.

In one aspect, the invention provides a device for producing droplets. The device includes:
a) a first channel having a first depth, a first width, a first proximal end, and a first distal end;
b) a first side-channel having a first side-channel depth, a first side-channel width, a first side-channel proximal end, and a first side-channel distal end,
   where the first side-channel proximal end includes one or more first side-channel inlets, and the first side-channel distal end includes one or more first side-channel outlets,
   where the first side-channel proximal end is fluidically connected to the first channel at a first proximal intersection between the first proximal end and the first distal end, and the first side-channel distal end is fluidically connected to the first channel at a first distal intersection between the first proximal intersection and the first distal end, and
   where the first side-channel optionally includes a first side-channel reservoir configured for holding a liquid; and
c) a droplet formation region having at least one outlet and at least one inlet in fluid communication with the first channel;
   where the device is configured to produce droplets.

In some embodiments, each of the one or more first side-channel outlets has at least one dimension smaller than the smaller of the first depth and the first width. In certain embodiments, each of the one or more first side-channel inlets has at least one dimension smaller than the smaller of the first depth and the first width.

In particular embodiments, the device includes a second side-channel having a second side-channel depth, a second side-channel width, a second side-channel proximal end, and a second side-channel distal end,
where the second side-channel proximal end includes one or more second side-channel inlets, and the second side-channel distal end includes one or more second side-channel outlets,
where the second side-channel proximal end is fluidically connected to the first channel at a second proximal intersection between the first proximal end and the first distal end, and the second side-channel distal end is fluidically connected to the first channel at a second distal intersection between the second proximal intersection and the first distal end, and
where the second side-channel optionally includes a reservoir configured for holding a liquid.

In further embodiments, the first proximal intersection is substantially opposite the second proximal intersection. In yet further embodiments, the first distal intersection is substantially opposite the second distal intersection. In still further embodiments, the second side-channel includes the second side-channel reservoir. In other embodiments, the second side-channel reservoir is the same as the first side-channel reservoir. In yet other embodiments, the first side-channel includes a first side-channel reservoir. In still other embodiments, the device further includes a first reservoir configured for holding a liquid, where the first reservoir is in fluid communication with the first channel. In some embodiments, the first proximal end is fluidically connected to the first reservoir. In particular embodiments, the device further includes one or more funnels, each funnel having a funnel proximal end, a funnel distal end, a funnel width, and a funnel depth, and where each funnel proximal end includes a funnel inlet, and each funnel distal end includes a funnel outlet. In yet further embodiments, the first channel includes at least one funnel. In still further embodiments, at least one funnel is disposed between the first proximal end and the first proximal intersection. In other embodiments, at least one funnel is disposed between the first distal end and the first distal intersection. In yet other embodiments, at least one funnel is disposed between the first distal intersection and the first proximal intersection. In still other embodiments, for one funnel, the funnel proximal end is fluidically connected to the first reservoir. In some embodiments, the funnel width of the one funnel is substantially equal to the width of the first reservoir. In particular embodiments, at least one funnel has at least one dimension that decreases in the direction from the funnel proximal end to the funnel distal end. In certain embodiments, at least one funnel has at least one dimension that decreases in the direction from the funnel distal end to the funnel proximal end. In further embodiments, the funnel has a funnel length, the funnel outlet has a funnel outlet depth and a funnel outlet width, and the funnel inlet has a funnel inlet depth and a funnel inlet width, where the funnel length is at least 20 times greater than the smaller of the funnel outlet depth, the funnel outlet width, the funnel inlet depth, and the funnel inlet width. In further embodiments, at least one funnel includes one or more hurdles. In yet further embodiments, the one or more hurdles are pegs and/or barriers. In some embodiments, the one or more hurdles are pegs or a combination of a barrier and pegs. In certain embodiments, the pegs have a peg length and a peg width, and the peg length is greater than the peg width (e.g., the peg length is at least 10%, 25%, 50%, 75%, 100%, 150%, 200%, or 300% greater than the peg width; e.g., the peg length is 10% to 1000%, 10% to 900%, 10% to 800%, 10% to 700%, 10% to 600%, 50% to 1000%, 50% to 900%, 50% to 800%, 50% to 700%, 50% to 600%, 100% to 1000%, 100% to 900%, 100% to 800%, 100% to 700%, 100% to 600%, 200% to 1000%, 200% to 900%, 200% to 800%, 200% to 700%, or 200% to 600% greater than the peg width). In particular embodiments, at least one hurdle is disposed closer to the funnel outlet than to the funnel inlet. In further embodiments, at least one hurdle is disposed closer to the funnel inlet than to the funnel outlet. In still further embodiments, the first side-channel includes a mixer. In other embodiments, the mixer is a passive mixer. In yet other embodiments, the mixer is a chaotic advection mixer. In still other embodiments, the first side-channel depth is half of the first depth or less. In some embodiments, the first side-channel depth is a quarter of the first depth or less. In certain embodiments, the device further includes a second channel having a second depth, a second width, a second proximal end, and a second distal end, where the second channel is in fluid communication with the first channel. In particular embodiments, the second channel is fluidically connected to the first channel between the first distal end and the first distal intersection. In further embodiments, the first side-channel includes a mixer, and the second channel is fluidically connected to the first side-channel between the mixer and the first side-channel proximal end.

In yet further embodiments, the second channel includes a trap having a trap depth and configured to entrap air bubbles. In still further embodiments, the trap depth is greater than the second depth. In certain embodiments, the second channel further includes one or more funnels, each funnel having a funnel proximal end, a funnel distal end, a funnel width, and a funnel depth, and where each funnel proximal end includes a funnel inlet, and each funnel distal end includes a funnel outlet; where the one or more funnels are disposed between the second proximal end and the second distal end. In particular embodiments, at least one funnel has at least one dimension that decreases in the direction from the funnel proximal end to the funnel distal end. In some embodiments, at least one funnel has at least one dimension that decreases in the direction from the funnel distal end to the funnel proximal end. In further embodiments, the funnel has a funnel length, the funnel outlet has a funnel outlet depth and a funnel outlet width, and the funnel inlet has a funnel inlet depth and a funnel inlet width, where the funnel length is at least 20 times greater than the smaller of the funnel outlet depth, the funnel outlet width, the funnel inlet depth, and the funnel inlet width. In yet further embodiments, the funnel width is defined by two opposing, curved walls. In still further embodiments, at least one funnel includes one or more hurdles. In some embodiments, the one or more hurdles are pegs and/or barriers. In certain embodiments, the one or more hurdles are pegs or a combination of a barrier and pegs. In particular embodiments, the pegs have a peg length and a peg width, and the peg length is greater than the peg width. In further embodiments, the hurdles are disposed along a curve. In yet further embodiments, at least one hurdle is disposed closer to the funnel inlet than to the funnel outlet. In still further embodiments, at least one hurdle is disposed closer to the funnel outlet than to the funnel inlet. In some embodiments, at least one funnel includes a ramp configured to reduce the funnel depth from the funnel inlet to the funnel outlet.

In another aspect, the invention provides a device for producing droplets. The device includes:
a) a first channel having a first depth, a first width, a first proximal end, and a first distal end, where the first channel includes one or more funnels, each funnel having a funnel proximal end, a funnel distal end, a funnel width, and a funnel depth, and where each funnel proximal end includes a funnel inlet, and each funnel distal end includes a funnel outlet; and
b) a droplet formation region having at least one outlet and at least one inlet in fluid communication with the first channel, where the droplet formation region
   (i) is configured to allow a liquid to expand in at least one dimension, or
   (ii) includes a step region having a step depth;
      where the device is configured to produce droplets.

In some embodiments, the device further includes a first reservoir configured for holding a liquid, where the first reservoir is in fluid communication with the first channel. In certain embodiments, the first proximal end is fluidically connected to the first reservoir. In particular embodiments, for one funnel, the funnel proximal end is fluidically connected to the first reservoir. In further embodiments, the funnel width of the one funnel is substantially equal to the width of the first reservoir. In yet further embodiments, at least one funnel has at least one dimension that decreases in the direction from the funnel proximal end to the funnel distal end. In still further embodiments, at least one funnel has at least one dimension that decreases in the direction from the funnel distal end to the funnel proximal end. In other embodiments, at least one funnel includes one or more hurdles. In yet other embodiments, the one or more hurdles are pegs and/or barriers. In some embodiments, the one or more hurdles are pegs or a combination of a barrier and pegs. In certain embodiments, the pegs have a peg length and a peg width, and the peg length is greater than the peg width (e.g., the peg length is at least 10%, 25%, 50%, 75%, 100%, 150%, 200%, or 300% greater than the peg width; e.g., the peg length is 10% to 1000%, 10% to 900%, 10% to 800%, 10% to 700%, 10% to 600%, 50% to 1000%, 50% to 900%, 50% to 800%, 50% to 700%, 50% to 600%, 100% to 1000%, 100% to 900%, 100% to 800%, 100% to 700%, 100% to 600%, 200% to 1000%, 200% to 900%, 200% to 800%, 200% to 700%, or 200% to 600% greater than the peg width). In particular embodiments, at least one hurdle is disposed closer to the funnel outlet than to the funnel inlet. In further embodiments, at least one hurdle is disposed closer to the funnel inlet than to the funnel outlet. In still other embodiments, the funnel has a funnel length, the funnel outlet has a funnel outlet depth and a funnel outlet width, and the funnel inlet has a funnel inlet depth and a funnel inlet width, where the funnel length is at least 20 times greater than the smaller of the funnel outlet depth, the funnel outlet width, the funnel inlet depth, and the funnel inlet width. In some embodiments, the device further includes a second channel having a second depth, a second width, a second proximal end, and a second distal end, where the second channel is fluidically connected to the first channel at a channel intersection between the first proximal end and the first distal end. In certain embodiments, at least one funnel is disposed between the first proximal end and the channel intersection. In particular embodiments, at least one funnel is disposed between the first distal end and the channel intersection. In further embodiments, the second channel includes a mixer disposed between the second proximal end and the channel intersection.

In yet another aspect, the invention provides a device for producing droplets. The device includes:
a) a first channel having a first depth, a first width, a first proximal end, and a first distal end;
b) a second channel having a second depth, a second width, a second proximal end, and a second distal end, where the second channel is fluidically connected to the first channel at a channel intersection between the first proximal end and the first distal end, and the second channel includes a mixer disposed between the second proximal end and the channel intersection; and
c) a droplet formation region having at least one outlet and at least one inlet in fluid communication with the first channel;
   where the device is configured to produce droplets.

In some embodiments, the device further includes a first reservoir configured for holding a liquid, where the first reservoir is in fluid communication with the first channel. In certain embodiments, the first proximal end is fluidically connected to the first reservoir. In particular embodiments, the mixer is a passive mixer. In further embodiments, the mixer is a chaotic advection mixer. In yet further embodiments, including a second reservoir configured for holding a liquid, where the second reservoir is in fluid communication with the first channel. In still further embodiments, the second reservoir is fluidically connected to the second channel. In some embodiments, the device further includes a third reservoir configured for holding a liquid, where the third reservoir is in fluid communication with the first channel. In certain embodiments, the device further includes a third channel having a third depth, third width, third proximal end, and third distal end, where the third channel is fluidically connected to the second channel and the third reservoir.

In some embodiments, the third channel includes at least one trap. In certain embodiments, the trap depth is greater than the third depth. In particular embodiments, the first channel includes at least one trap. In further embodiments, the trap is disposed between the first proximal end and the channel intersection. In yet further embodiments, the trap depth is greater than the first depth.

In some embodiments, the second channel further includes one or more funnels, each funnel having a funnel proximal end, a funnel distal end, a funnel width, and a funnel depth, and where each funnel proximal end includes a funnel inlet, and each funnel distal end includes a funnel outlet; where the one or more funnels are disposed between the second proximal end and the second distal end.

In another aspect, the invention provides a device for producing droplets, the device including:
a) a first channel having a first depth, a first width, a first proximal end, and a first distal end;
b) a second channel having a second depth, a second width, a second proximal end, and a second distal end, where the second channel is fluidically connected to the first channel at a channel intersection between the first proximal end and the first distal end, and the second channel includes one or more funnels, each funnel having a funnel proximal end, a funnel distal end, a funnel width, and a funnel depth, and where each funnel proximal end includes a funnel inlet, and each funnel distal end includes a funnel outlet; and
c) a droplet formation region having at least one outlet and at least one inlet in fluid communication with the first channel;
   where the first channel, the second channel, and the droplet formation region are configured to produce droplets.

In some embodiments, at least one funnel has at least one dimension that decreases in the direction from the funnel proximal end to the funnel distal end. In certain embodiments, at least one funnel has at least one dimension that decreases in the direction from the funnel distal end to the funnel proximal end. In particular embodiments, the funnel has a funnel length, the funnel outlet has a funnel outlet depth and a funnel outlet width, and the funnel inlet has a funnel inlet depth and a funnel inlet width, where the funnel length is at least 20 times greater than the smaller of the funnel outlet depth, the funnel outlet width, the funnel inlet depth, and the funnel inlet width. In further embodiments, the funnel width is defined by two opposing, curved walls. In yet further embodiments, at least one funnel includes one or more hurdles. In still further embodiments, the one or more hurdles are pegs and/or barriers. In some embodiments, the one or more hurdles are pegs or a combination of a barrier and pegs. In certain embodiments, the pegs have a peg length and a peg width, and the peg length is greater than the peg width. In particular embodiments, the hurdles are disposed along a curve. In further embodiments, at least one hurdle is disposed closer to the funnel inlet than to the funnel outlet. In yet further embodiments, at least one hurdle is disposed closer to the funnel outlet than to the funnel inlet. In still further embodiments, at least one funnel includes a ramp configured to reduce the funnel depth from the funnel inlet to the funnel outlet. In some embodiments, the second channel includes a trap having a trap depth and configured to entrap air bubbles.

In another aspect, the invention provides a device for producing droplets, the device including:
a) a first channel having a first depth, a first width, a first proximal end, and a first distal end;
b) a second channel having a second depth, a second width, a second proximal end, and a second distal end, where the second channel is fluidically connected to the first channel at a channel intersection between the first proximal end and the first distal end;
c) a droplet formation region having at least one outlet and at least one inlet in fluid communication with the first channel; and
   where at least one of the first channel and the second channel includes at least one trap, each trap having a trap depth, where each trap is configured to entrap air bubbles, and where the device is configured to produce droplets;
   where the first channel, the second channel, and the droplet formation region are configured to produce droplets.

In some embodiments, the second channel includes at least one trap. In certain embodiments, the trap is disposed between the second proximal end and the channel intersection. In particular embodiments, the trap depth is greater than the second depth. In further embodiments, the second channel includes a mixer, and at least one trap is disposed between the second proximal end and the mixer. In yet further embodiments, the second channel includes a mixer, and at least one trap is disposed between the second distal end and the mixer.

In some embodiments, the droplet formation region is configured to allow a liquid to expand in at least one dimension. In certain embodiments, the droplet formation region includes a shelf region having a droplet formation region depth and a droplet formation region width. In particular embodiments, the droplet formation region includes a step region having a step depth. In further embodiments, the device further includes a collection region configured to collect droplets produced in the droplet formation region. In yet further embodiments, the device is configured to produce a population of droplets that are substantially stationary in the collection region. In still further embodiments, the droplets include particles. In other embodiments, the device is configured to produce droplets including a single particle.

In a further aspect, the invention provides a system for producing droplets. The system includes:

a) a device including:
i) a first channel having a first depth, a first width, a first proximal end, and a first distal end, the first channel including a first liquid and particles;
ii) a first side-channel having a first side-channel proximal end and a first side-channel distal end,
   where the first side-channel proximal end includes one or more first side-channel inlets, and the first side-channel distal end includes one or more first side-channel outlets,
   where the first side-channel proximal end is fluidically connected to the first channel at a first proximal intersection between the first proximal end and the first distal end, and the first side-channel distal end is fluidically connected to the first channel at a first distal intersection between the first proximal intersection and the first distal end, and
   where the first side-channel optionally includes a first side-channel reservoir configured for holding a liquid; and
iii) a droplet formation region having at least one outlet and at least one inlet in fluid communication with the first channel;
   b) a first liquid disposed in the first channel and the first side-channel;
   c) a second liquid disposed in the droplet formation region, where the first liquid and the second liquid are immiscible; and
   d) particles disposed in the first channel;
   where the system is configured to produce droplets of a first liquid in a second liquid, the droplets including the particles.

In certain embodiments, the first side-channel is substantially free of the particles. In particular embodiments, the second side-channel includes the first liquid. In further embodiments, the second side-channel is substantially free of the particles. In yet further embodiments, the device is as described herein. In still further embodiments, the first reservoir includes the first liquid and particles. In other embodiments, the second channel includes a third liquid, and where the droplets produced by the device further include the third liquid. In yet other embodiments, the first side-channel depth is half of the first depth or less. In still other embodiments, the first side-channel depth is a quarter of the first depth or less. In some embodiments, the first side-channel is sized to substantially prevent ingress of particles from the first channel

In a yet further aspect, the invention provides a system for producing droplets. The system includes:

a) a device including:
i) a first channel having a first depth, a first width, a first proximal end, a first distal end, where the first channel includes one or more funnels, each funnel having a funnel proximal end, a funnel distal end, a funnel width, and a funnel depth, and where each funnel proximal end includes a funnel inlet, and each funnel distal end includes a funnel outlet; and
ii) a droplet formation region having at least one outlet and at least one inlet in fluid communication with the first channel, where the droplet formation region
   (i) is configured to allow a liquid to expand in at least one dimension, or
   (ii) includes a step region having a step depth;
      b) a first liquid disposed in the first channel;
      c) a second liquid disposed in the droplet formation region, where the first liquid and the second liquid are immiscible; and
      d) particles disposed in the first channel;
      where the system is configured to produce droplets of a first liquid in a second liquid, the droplets including the particles.

In some embodiments, the device is as described herein. In certain embodiments, the first reservoir includes the first liquid and the particles. In particular embodiments, the system further includes a third liquid disposed in the second channel, and the droplets further include the third liquid. In further embodiments, the system is configured to produce droplets including a single particle.

In a still further aspect, the invention provides a system for producing droplets. The system includes:

a) a device including:
i) a first channel having a first depth, a first width, a first proximal end, and a first distal end;
ii) a second channel having a second depth, a second width, a second proximal end, and a second distal end, where the second channel is fluidically connected to the first channel at a channel intersection between the first proximal end and the first distal end, and the second channel includes a mixer disposed between the second proximal end and the channel intersection; and
iii) a droplet formation region having at least one outlet and at least one inlet in fluid communication with the first channel;
   b) a first liquid disposed in the first channel;
   c) a second liquid disposed in the droplet formation region, where the first liquid and the second liquid are immiscible;
   d) a third liquid disposed in the second channel;
   where the system is configured to produce droplets of the first and third liquids in the second liquid.

In some embodiments, the first reservoir includes the first liquid. In certain embodiments, the mixer is a passive mixer. In particular embodiments, the mixer is a chaotic advection mixer. In further embodiments, the device further includes particles, where the particles are disposed in the first channel and, when present, the first reservoir. In yet further embodiments, the device further includes a second reservoir configured for holding a liquid, where the second reservoir is in fluid communication with the first channel. In still further embodiments, the third liquid is disposed in the second reservoir. In other embodiments, the second reservoir is fluidically connected to the second channel. In yet other embodiments, the system further includes a fourth liquid, and the device further includes a third reservoir configured for holding a liquid, where the third reservoir is in fluid communication with the first channel, and the fourth liquid is disposed in the third reservoir. In still other embodiments, the device further includes a third channel having a third depth, third width, third proximal end, and third distal end, where the third channel is fluidically connected to the second channel and the third reservoir, and where the fourth liquid is disposed in the second and third channels. In some embodiments, the mixer is configured to mix the liquids.

In another aspect, the invention provides a system for producing droplets, the system including:

a) a device including:
i) a first channel having a first depth, a first width, a first proximal end, and a first distal end;
ii) a second channel having a second depth, a second width, a second proximal end, and a second distal end, where the second channel is fluidically connected to the first channel at a channel intersection between the first proximal end and the first distal end, and the second channel includes one or more funnels, each funnel having a funnel proximal end, a funnel distal end, a funnel width, and a funnel depth, and where each funnel proximal end includes a funnel inlet, and each funnel distal end includes a funnel outlet; and
iii) a droplet formation region having at least one outlet and at least one inlet in fluid communication with the first channel;
   b) a first liquid disposed in the first channel;
   c) a second liquid disposed in the droplet formation region, where the first liquid and the second liquid are immiscible;
   d) a third liquid disposed in the second channel;
   where the system is configured to produce droplets of the first and third liquids in the second liquid.

In another aspect, the invention provides system for producing droplets, the system including:

a) a device including:
i) a first channel having a first depth, a first width, a first proximal end, and a first distal end;
ii) a second channel having a second depth, a second width, a second proximal end, and a second distal end, where the second channel is fluidically connected to the first channel at a channel intersection between the first proximal end and the first distal end;
iii) a droplet formation region having at least one outlet and at least one inlet in fluid communication with the first channel; and
where at least one of the first channel and the second channel includes at least one trap, each trap having a trap depth, where each trap is configured to entrap air bubbles, and where the device is configured to produce droplets;
where the first channel, the second channel, and the droplet formation region are configured to produce droplets;
   b) a first liquid disposed in the first channel;
   c) a second liquid disposed in the droplet formation region, where the first liquid and the second liquid are immiscible; and
   d) a third liquid disposed in the second channel;
   where the system is configured to produce droplets of the first and third liquids in the second liquid.

In some embodiments, the system of the invention includes a device of the invention.

In particular embodiments, the droplet formation region is configured to allow a liquid to expand in at least one dimension. In certain embodiments, the droplet formation region includes a shelf region having a droplet formation region depth and a droplet formation region width. In further embodiments, the droplet formation region includes a step region having a step depth. In yet further embodiments, the device further includes a collection region configured to collect droplets produced in the droplet formation region. In still further embodiments, the device is configured to produce a population of droplets that are substantially stationary in the collection region. In some embodiments, the droplets include particles. In certain embodiments, the device is configured to produce droplets including a single particle.

In another aspect, the invention provides a method of producing droplets including a first liquid and a particle. The method includes providing a system described herein. The method further includes allowing the first liquid to flow from the first channel to the droplet formation region to produce droplets of the first liquid and a particle in the second liquid. Alternatively, the method further includes allowing the first liquid to flow from the first channel to the droplet formation region to produce droplets in the second liquid, the droplets including the first liquid and the third liquid premixed with another liquid.

In some embodiments, the another liquid is the first liquid. In certain embodiments, the another liquid is the fourth liquid.

In particular embodiments, the droplet formation region is configured to allow a liquid to expand in at least one dimension. In further embodiments, the droplet formation region includes a shelf region having a droplet formation region depth and a droplet formation region width. In yet further embodiments, the droplet formation region includes a step region having a step depth. In still further embodiments, the device further includes a collection region configured to collect droplets produced in the droplet formation region.

In general, the invention provides devices, systems, and methods for controlled formation of droplets, e.g., during high-throughput droplet generation.

In one aspect, the invention provides a device for producing droplets, the device including:
(i) one or more first channels, each first channel having independently a first depth, a first width, a first proximal end, and a first distal end, the first distal end including a first channel outlet;
(ii) one or more second channels, each second channel having independently a second depth, a second width, a second proximal end, and a second distal end, where each second channel intersects one of the first channels between the first proximal and first distal ends;
(iii) a droplet collection region; and
(iv) a droplet formation region including a shelf region, where the droplet formation region is in fluid communication with (e.g., fluidically connected to) the first channel outlets and the droplet collection region;
   where the first channels, the second channels, the droplet formation region, and the droplet collection region are configured to produce droplets.

In some embodiments, the width of the droplet formation region is at least five times greater (e.g., at least 6, 7, 8, 9, 10, 11, 12, 13, 14, 15, 16, 17, 18, 19, 20, 21, 22, 23, 24, 25, 26, 27, 28, 29, or 30 times greater; e.g., 5 to 30 times greater, 6 to 30 times greater, 7 to 30 times greater, 8 to 30 times greater, 9 to 30 times greater, 10 to 30 times greater, 11 to 30 times greater, 12 to 30 times greater, 13 to 30 times greater, 14 to 30 times greater, 15 to 30 times greater, 20 to 30 times greater, 25 to 30 times greater, 5 to 20 times greater, 6 to 20 times greater, 7 to 20 times greater, 8 to 20 times greater, 9 to 20 times greater, 10 to 20 times greater, 11 to 20 times greater, 12 to 20 times greater, 13 to 20 times greater, 14 to 20 times greater, 15 to 20 times greater, or 20 to 20 times greater) than the combined widths of the first channel outlets.

In certain embodiments, the droplet formation region includes a protrusion from the first channel outlet towards the droplet collection region.

In particular embodiments, at least one of the one or more first channels bifurcates into two downstream first channels after the intersection between the first channel and the second channel, and the downstream first channels are fluidically connected to the one or more droplet formation regions.

In some embodiments, the droplet formation region includes a row of pegs disposed along the width of the shelf region. In certain embodiments, the width of each peg is smaller than the width of a single first channel outlet by 50% or less. In particular embodiments, the width of each peg is greater than the width of a single first channel outlet by 100% or less. In further embodiments, the length of each peg is at least equal to the width of the peg. In yet further embodiments, the length of each peg is greater than the width of the peg by 200% or less. In still further embodiments, the row of pegs includes at least 10 pegs for each first channel outlet. In some embodiments, the row of pegs includes 30 or fewer pegs for each first channel outlet. In certain embodiments, the pegs are spaced at a distance that is smaller than the width of a single first channel outlet by 50% or less. In particular embodiments, the pegs are spaced at a distance that is equal to or smaller than the width of a single first channel outlet.

In further embodiments, the length of the shelf region is greater than the width of one first channel outlet by at least 100%. In yet further embodiments, the length of the shelf region is greater than the width of a single first channel outlet by 1000% or less. In still further embodiments, the depth of the shelf region increases in the direction from the funnel outlet to the droplet collection region.

In certain embodiments, the droplet formation region occupies at least 25% of the perimeter of the droplet collection region. In some embodiments, the droplet formation region includes a shelf region protruding from the first channel outlet towards the droplet collection region. In particular embodiments, the shelf region has a shelf region width that is less than twice the width of the first channel outlet. In further embodiments, the droplet formation region includes a step region, and the shelf region protrudes into the step region.

In some embodiments, the two downstream first channels are curved. In certain embodiments, at least one of the second channels includes a funnel. In certain embodiments, the funnel is disposed between the second proximal end and the intersection between the first channel and the second channel.

In particular further embodiments, the first channel includes a mixer. In further embodiments, the mixer is disposed between the first distal end and the intersection between the first channel and the second channel. In yet further embodiments, the mixer is a herringbone mixer.

In another aspect the invention provides a system for producing droplets, the system including:

(a) a device including:
(i) one or more first channels, each first channel having independently a first depth, a first width, a first proximal end, and a first distal end, the first distal end including a first channel outlet;
(ii) one or more second channels, each second channel having independently a second depth, a second width, a second proximal end, and a second distal end, where each second channel intersects one of the first channels between the first proximal and first distal ends;
(iii) a droplet collection region; and
(iv) a droplet formation region including a shelf region, where the droplet formation region is in fluid communication with (e.g., fluidically connected to) the first channel outlets and the droplet collection region, and
   (b) a first liquid disposed in the first channel;
   (c) a second liquid disposed in the droplet collection region; and
   (d) a third liquid disposed in the second channel;
   where the first liquid and the second liquid are immiscible;
   where the first liquid and the third liquid are miscible; and
   where the system is configured to produce droplets of the first and third liquids in the second liquid.

In some embodiments, the width of the droplet formation region is at least five times greater (e.g., at least 6, 7, 8, 9, 10, 11, 12, 13, 14, 15, 16, 17, 18, 19, 20, 21, 22, 23, 24, 25, 26, 27, 28, 29, or 30 times greater; e.g., 5 to 30 times greater, 6 to 30 times greater, 7 to 30 times greater, 8 to 30 times greater, 9 to 30 times greater, 10 to 30 times greater, 11 to 30 times greater, 12 to 30 times greater, 13 to 30 times greater, 14 to 30 times greater, 15 to 30 times greater, 20 to 30 times greater, 25 to 30 times greater, 5 to 20 times greater, 6 to 20 times greater, 7 to 20 times greater, 8 to 20 times greater, 9 to 20 times greater, 10 to 20 times greater, 11 to 20 times greater, 12 to 20 times greater, 13 to 20 times greater, 14 to 20 times greater, 15 to 20 times greater, or 20 to 20 times greater) than the combined widths of the first channel outlets.

In certain embodiments, the droplet formation region includes a protrusion from the first channel outlet towards the droplet collection region.

In particular embodiments, at least one of the one or more first channels bifurcates into two downstream first channels after the intersection between the first channel and the second channel, and the downstream first channels are fluidically connected to the one or more droplet formation regions.

In further embodiments, the system includes the device of the invention.

In yet further embodiments, the system further includes a plurality of particles disposed in the first channel.

In yet another aspect, the invention provides a method of producing droplets in a second liquid, the droplets including a first liquid and a third liquid, the method including:

(a) providing the system of the invention; and
(b) allowing the first liquid to flow from the first channel to the droplet formation region to produce droplets in the second liquid, the droplets including the first liquid and the third liquid.

We have developed a system for detecting the status, e.g., presence or absence, of a fluid, e.g., a liquid, in a portion of a device.

In one aspect, the system includes a device having a flow path including a first channel having a first proximal end and a first distal end; a first reservoir in fluid communication with the first proximal end; a collection reservoir in fluid communication with the first distal end; and one or more sensors configured to measure the status of the fluid as it flows in the system.

In some embodiments, the status is the presence or absence of the fluid in a portion of the device. In particular embodiments, the status is the depletion of the fluid in the portion of the device.

In certain embodiments, the one or more sensors are integrated into the device. In other embodiments, the one or more sensors are external to the device, e.g., operatively coupled to a manifold that provides displacing fluid to transport the fluid. In some embodiments, the one or more sensors are disposed at an interface of the first reservoir and the first distal end. In some embodiments, the one or more sensors are disposed between the first proximal end and the first distal end.

In further embodiments, the system includes a controller configured to collect, process, and/or transmit data collected by the one or more sensors. In some embodiments, the one or more sensors include a flow sensor, a pressure sensor, an optical sensor, or an electrical sensor.

In some embodiments, the flow sensor is a rotameter, a mass gas flow meter, a spring and piston flow meter, a positive displacement flow meter, a vortex meter, a differential pressure sensor, a magnetic flow meter, an ultrasonic flow meter, a turbine flow meter, a paddlewheel sensor, or an electromagnetic flow sensor. In certain embodiments, the pressure sensor is an inductive, resistive, piezoelectric, or capacitive transducer. In some embodiments, the optical sensor comprises a light source and a light detector.

In certain embodiments, the status of the fluid in the device of the system is determined by measuring the pressure, flow rate, viscosity, conductivity, or optical density of the fluid as it flows along the flow path. In other embodiments, the status of the fluid in the device is determined by measuring the pressure, flow rate, viscosity, conductivity, or optical density of a second fluid as it displaces the fluid, e.g., in a portion of the device.

In another aspect, the invention provides a method for detecting the status of a fluid. The method includes: providing a system as described herein; allowing a volume of a first fluid contained in the first reservoir to flow in the flow path; detecting the status of the first fluid as it flows using the one or more sensors; and stopping the flow of the first fluid or adding additional fluid to the first reservoir when the status of the first fluid flowing in the flow path meet a threshold condition.

In some embodiments, the status is the presence or absence of the first fluid in a portion of the device. In particular embodiments, the status is the depletion of the first fluid in the portion of the device.

In some embodiments, the detecting includes measuring the pressure, flow rate, viscosity, conductivity, optical density of the first fluid as it flows along the flow path. In some embodiments, the detecting includes comprises measuring the pressure, flow rate, viscosity, conductivity, or optical density of a second fluid as it displaces the first fluid, e.g., in a portion of the device.

In certain embodiments, the threshold condition results from displacement of the first fluid with a second fluid. In some embodiments, the first fluid is a liquid. In particular embodiments, the liquid is aqueous. In certain embodiments, the second fluid is a gas, e.g., air.

In certain embodiments, the flow of the first fluid in the flow path (or second fluid if the first fluid is completely depleted) is stopped within 0.0001 second to 1 second of when the status meets the threshold condition.

In certain embodiments, the method further includes allowing a volume of a second fluid, e.g., a liquid or gas, to flow in the flow path when the status meets the threshold condition. The method may further include detecting the status of the second fluid as it flows using the one or more sensors; and stopping the flow of the second fluid when the status of the second fluid flowing in the flow path meets a threshold condition. In certain embodiments, the method further includes allowing a second volume of the first fluid to flow in the flow path when the status of the second fluid flowing in the flow path meets its threshold condition. In certain embodiments, the method further includes allowing a volume of a third fluid to flow in the flow path when the status of the second fluid flowing in the flow path meets its threshold condition.

We have developed a microfluidic device that is capable of producing droplets of a first liquid in a second liquid that is immiscible with the first liquid.

In one aspect, the invention provides a device for producing droplets of a first liquid in a second liquid. The device includes a channel, a droplet formation region and a collection reservoir configured to collect droplets formed in the droplet formation region.

In one embodiment, the device includes a) a first channel having a first depth, a first width, a first proximal end, and a first distal end; b) a droplet formation region in fluid communication with the first channel; and c) a collection reservoir in fluid communication with the droplet formation region and configured to collect droplets formed in the droplet formation region. The first channel and droplet formation region are configured to produce droplets of the first liquid in the second liquid. The collection reservoir includes a first volume and a second volume. The first volume has at least one cross-sectional dimension (e.g., diameter, width, or length) that is smaller than a corresponding cross-sectional dimension of the second volume. The first volume has a volume that is 10% or less, e.g., less than 1%, of the volume of the second volume, and a droplet in the first volume does not contact the second volume.

In some embodiments, the first volume has a volume that is less than 0.9%, 0.8%, 0.7%, 0.6%, 0.5%, 0.4%, 0.3%, 0.2%, 0.1%, 0.01% or 0.001% of the volume of the second volume. In some embodiments, the first volume has a volume between 0.01 μL to 10 μL, and the second volume has a volume between 100 μL to 10,000 μL.

In some embodiments, the at least one cross-sectional dimension of the first volume is less than 50% of a corresponding cross-sectional dimension of the second volume. For example, the first volume may have a cross-sectional dimension, e.g., diameter, width, or length, that is less than 40%, 30%, 20%, 10%, 5%, 4%, 3%, 2%, 1%, 0.9%, 0.8%, 0.7%, 0.6%, 0.5%, 0.4%, 0.3%, 0.2%, 0.1%, or 0.01% of a corresponding cross-sectional dimension of the second volume.

In further embodiments, the device includes a second channel having a second depth, a second width, a second proximal end, and a second distal end, where the second channel intersects the first channel between the first proximal and first distal ends. In some embodiments, the droplet formation region includes a shelf region having a third depth, a third width, at least one inlet, and at least one outlet. The shelf region is configured to allow the first liquid to expand in at least one dimension. In further embodiments, the droplet formation region includes a step region having a fourth depth. In some cases, the step region and collection reservoir do not have an orthogonal feature that contacts the droplets when formed. In particular embodiments, the device is configured to produce a population of droplets that are substantially stationary in the collection reservoir.

In some embodiments, the first liquid contains particles. In certain embodiments, the first channel and the droplet formation region are configured to produce droplets including a single particle or a single particle of multiple types, e.g., one bead and one cell. In some embodiments, the third width increases from the inlet of the shelf region to the outlet of the shelf region.

In certain embodiments, the device includes a first reservoir and a second reservoir in fluid communication with the first proximal end and the second proximal end, respectively. In some embodiments, where the device is configured to produce a population of droplets that are substantially stationary in the collection reservoir. In some embodiments, the device includes a third channel having a third proximal end and a third distal end, where the third proximal end is in fluid communication with the shelf region and where the third distal end is in fluid communication with the step region.

In further embodiments, the device includes a plurality of first channels, second channels, and droplet formation regions, e.g., that are fluidically independent to produce an array.

In a related aspect, the invention includes a method of producing droplets of a first liquid in a second liquid, the method including the steps of a) providing a device including: i) a first channel having a first depth, a first width, a first proximal end, and a first distal end; ii) a droplet formation region in fluid communication with the first channel; and iii) a collection reservoir in fluid communication with the droplet formation region and configured to collect droplets formed in the droplet formation region. The first channel and droplet formation region are configured to produce droplets of the first liquid in the second liquid. The collection reservoir includes a first volume and a second volume. The first volume has at least one cross-sectional dimension (e.g., diameter, width, or length) that is smaller than a corresponding cross-sectional dimension of the second volume. The first volume has a volume that is less than 10%, e.g., less than 1%, of the volume of the second volume, and a droplet in the first volume does not contact the second volume; b) allowing the first liquid to flow from the first channel to the droplet formation region to produce droplets of the first liquid in the second liquid; c) collecting the droplets in the collection reservoir, where the droplets pass through the first volume into the second volume; and d) removing the droplets from the collection reservoir.

In particular embodiments, removal of droplets does not require pressurization of the collection reservoir.

In some embodiments, the first volume has a volume that is less than 0.9%, 0.8%, 0.7%, 0.6%, 0.5%, 0.4%, 0.3%, 0.2%, 0.1%, 0.01% or 0.001% of the volume of the second volume. In some embodiments, the first volume has a volume between 0.01 μL to 10 μL, and the second volume has a volume between 100 μL to 10,000 μL.

In some embodiments, the at least one cross-sectional dimension of the first volume is less than 5% of a corresponding cross-sectional dimension of the second volume. For example, the first volume may have a cross-sectional dimension, e.g., diameter, width, or length, that is less than 40%, 30%, 20%, 10%, 5%, 4%, 3%, 2%, 1%, 0.9%, 0.8%, 0.7%, 0.6%, 0.5%, 0.4%, 0.3%, 0.2%, 0.1%, or 0.01% of a corresponding cross-sectional dimension of the second volume.

In further embodiments, the device includes a second channel having a second depth, a second width, a second proximal end, and a second distal end, where the second channel intersects the first channel between the first proximal and first distal ends. In some embodiments, the droplet formation region includes a shelf region having a third depth, a third width, at least one inlet, and at least one outlet. The shelf region is configured to allow the first liquid to expand in at least one dimension. In further embodiments, the droplet formation region includes a step region having a fourth depth.

In particular embodiments, the device is configured to produce a population of droplets that are substantially stationary in the collection reservoir.

In some embodiments, the first liquid contains particles. In certain embodiments, the first channel and the droplet formation region are configured to produce droplets including a single particle or a single particle of multiple types, e.g., one bead and one cell. In some embodiments, the third width increases from the inlet of the shelf region to the outlet of the shelf region.

In certain embodiments, the device includes a first reservoir and a second reservoir in fluid communication with the first proximal end and the second proximal end, respectively. In some embodiments, where the device is configured to produce a population of droplets that are substantially stationary in the collection reservoir. In some embodiments, the device includes a third channel having a third proximal end and a third distal end, where the third proximal end is in fluid communication with the shelf region and where the third distal end is in fluid communication with the step region.

In further embodiments, the device includes a plurality of first channels, second channels, and droplet formation regions, e.g., that are fluidically independent to produce an array.

In one aspect, the invention provides a method of producing droplets by bringing a first liquid in contact with a second liquid immiscible with the first liquid at a specified droplet generation parameter to produce droplets in a device; monitoring a temperature of the device; and adjusting a pressure of the first liquid or the second liquid based on the temperature to substantially maintain the specified droplet generation parameter.

In some embodiments, the droplet generation parameter is selected from the group consisting of flow rate, droplet generation frequency, and ratio of droplets including a specified number of particles compared to droplets not including the specified number of particles.

The specified droplet generation parameter (e.g., flow rate, droplet generation frequency, and ratio of droplets including a specified number of particles compared to droplets not including the specified number of particles) may be substantially maintained at a constant or specified value (e.g., ±1%, 2%, 3%, 4%, 5%, 10%, 15%, 20%, 25%, or 30% of the value).

In some embodiments, the droplet includes a particle. The particle may include a biological particle, a bead, or a combination thereof. The biological particle may include a cell or one or more constituents of a cell. The biological particle may include a matrix.

In some embodiments, the method maintains a substantially constant ratio of droplets including a specified number of particles as compared to droplets not including the specified number of particles.

In some embodiments, the method maintains a substantially constant ratio of droplets including a particle as compared to droplets not including a particle.

In some embodiments, adjusting the pressure of the first liquid or the second liquid includes increasing the pressure.

In some embodiments, adjusting the pressure of the first liquid or the second liquid includes decreasing the pressure.

In some embodiments, the pressure of the first liquid or the second liquid is adjusted based on a viscosity calculated based on the temperature of the device.

In some embodiments, the device includes a first channel having a first depth, a first width, a first proximal end, and a first distal end; a second channel having a second depth, a second width, a second proximal end, and a second distal end; a droplet formation region, that includes a shelf region having a third depth and a third width, and a step region having a fourth depth; and a droplet collection region, in fluid communication with the droplet formation region. The second channel intersects the first channel between the first proximal and first distal ends. The shelf region is configured to allow the first liquid to expand in at least one dimension and has at least one inlet and at least one outlet and is disposed between the first distal end and the step region. The first channel and the droplet formation region are configured to produce droplets of the first liquid in the second liquid.

In some embodiments, the first liquid includes a plurality of particles. The particles may include an analyte detection moiety, and the second liquid may include an analyte.

In some embodiments, the first channel includes the first liquid and the second channel includes the second liquid.

In some embodiments, the method further includes allowing the particles in the first liquid to flow proximal-to-distal through the first channel, and allowing the second liquid to flow proximal-to-distal through the second channel. The second liquid combines with the first liquid to form an analyte detection liquid at the intersection, and the analyte detection liquid meets a partitioning liquid at the droplet formation region under droplet forming conditions, thereby forming a plurality of analyte detection droplets including one or more of the particles in the analyte detection liquid.

In some embodiments, the first channel is one of a plurality of first channels and the second channel is one of a plurality of second channels, and the device further includes a first reservoir connected proximally to the plurality of first channels and a second reservoir connected proximally to the plurality of second channels.

In some embodiments, the first liquid and the second liquid are aqueous liquids and the partitioning liquid is immiscible with the first liquid and the second liquid.

In some embodiments, the analyte is a bioanalyte. The bioanalyte may be selected from the group consisting of a nucleic acid, an intracellular protein, a glycan, and a surface protein.

In some embodiments, the analyte detection moiety includes a nucleic acid or an antigen-binding protein. In some embodiments, the second liquid includes a cell or fragment or product thereof.

In some embodiments, the plurality of analyte detection droplets accumulate as a population in the droplet collection region.

In another aspect, the invention provides a system for producing droplets including a device including a droplet formation region for producing droplets of a first liquid immiscible in a second liquid at a specified droplet generation parameter; a temperature sensor for monitoring a temperature of the device; a pressure sensor for monitoring a pressure of the device; and a controller configured to adjust a flow rate of the first liquid or the second liquid.

In some embodiments, the droplet generation parameter is selected from the group consisting of flow rate, droplet generation frequency, and ratio of droplets including a specified number of particles compared to droplets not including the specified number of particles

In some embodiments, the device includes a first channel having a first depth, a first width, a first proximal end, and a first distal end; a second channel having a second depth, a second width, a second proximal end, and a second distal end; the droplet formation region, which includes a shelf region having a third depth and a third width, and a step region having a fourth depth; and a droplet collection region, in fluid communication with the droplet formation region. The second channel intersects the first channel between the first proximal and first distal ends. The shelf region is configured to allow the first liquid to expand in at least one dimension and has at least one inlet and at least one outlet. The shelf region is disposed between the first distal end and the step region. The first channel and droplet formation region are configured to produce droplets of the first liquid in the second liquid.

In some embodiments, the first channel is one of a plurality of first channels and the second channel is one of a plurality of second channels. The device may further include a first reservoir connected proximally to the plurality of first channels and a second reservoir connected proximally to the plurality of second channels.

In some embodiments, the system further includes a holder configured to hold the device in operative connection with the pressure sensor, the temperature sensor, and the controller. The temperature sensor may be positioned between the holder and the device. The temperature sensor may be embedded within the holder.

In yet another aspect, the invention provides a device for producing droplets. The device includes:
(a) a first channel having a first channel depth, a first channel width, a first proximal end, and a first distal end;
(b) a shelf region having a shelf width and a shelf depth, wherein the shelf region is in fluid communication with the first distal end; and
and
(c) a droplet collection region having a droplet collection region width and a droplet collection region depth, the droplet collection region including a recess having a recess depth and a recess width, wherein the recess is fluidically connected to the shelf region, the recess depth is greater than the shelf depth, and the recess width is greater than or equal to the shelf width;
   wherein the first channel and the shelf region are configured to produce droplets.

In some embodiments, the recess width is 100% of the shelf region width to 1000% of the droplet collection region width. In some embodiments, the device further includes a step region having a step region depth and being in fluid communication with the shelf region, where the shelf region is disposed between the step region and the first distal end. In some embodiments, the shelf and step regions connect via a curved wall.

In some embodiments, the recess width increases distally from the shelf region. In some embodiments, the recess depth increases distally from the shelf region (e.g., from 100% of the shelf region depth (e.g., 150%, 200%, 250%, 300%, 350%, 400%, 450%, 500%, 550%, 600%, 650%, 700%, 750%, 800%, 850%, 900%, 950%, or 1000%) to 100% of the droplet collection region depth (e.g., 0.5% to 15% (e.g., about 1%, 2%, 3%, 4%, 5%, 6%, 7%, 8%, 9%, 10%, 11%, 12%, 13%, 14%, or 15%), 10% to 25% (e.g., about 10%, 11%, 12%, 13%, 14%, 15%, 16%, 17%, 18%, 19%, 20%, 21%, 22%, 23%, 24%, or 25%), 20% to 35% (e.g., about 20%, 21%, 22%, 23%, 24%, 25%, 26%, 27%, 28%, 29%, 30%, 31%, 32%, 33%, 34%, or 35%), 30% to 45% (e.g., about 30%, 31%, 32%, 33%, 34%, 35%, 36%, 37%, 38%, 39%, 40%, 41%, 42%, 43%, 44%, or 45%), 40% to 55% (e.g., about 40%, 41%, 42%, 43%, 44%, 45%, 46%, 47%, 48%, 49%, 50%, 51%, 52%, 53%, 54%, or 55%), 50% to 65% (e.g., about 50%, 51%, 52%, 53%, 54%, 55%, 56%, 57%, 58%, 59%, 60%, 61%, 62%, 63%, 64%, or 65%), 60% to 75% (e.g., about 60%, 61%, 62%, 63%, 64%, 65%, 66%, 67%, 68%, 69%, 70%, 71%, 72%, 73%, 74%, or 75%), 70% to 85% (e.g., about 70%, 71%, 72%, 73%, 74%, 75%, 76%, 77%, 78%, 79%, 80%, 81%, 82%, 83%, 84%, or 85%), 80% to 95% (e.g., about 80%, 81%, 82%, 83%, 84%, 85%, 86%, 87%, 88%, 89%, 90%, 91%, 92%, 93%, 94%, or 95%), 85% to 99.99% (e.g., about 85%, 86%, 87%, 88%, 89%, 90%, 91%, 92%, 93%, 94%, 95%, 96%, 97%, 98%, 99%, or 99.99%), 0.5% to 25%, 25% to 50%, 50% to 75%, or 75% to 99.99%). In some embodiments, the shelf region width is greater than the first channel width by at least 10%. In some embodiments, the shelf region width is greater than the first channel width by 100000% or less. In some embodiments, the shelf region width is greater than the first channel width by 10% to 100000% (e.g., 100% to 100000%, 200% to 100000%, 100% to 50000%, 200% to 50000%, 100% to 20000%, or 200% to 20000%). The recess length may range from 100% to 10000% of the length of the shelf region (e.g., 200% to 10000%, 500% to 10000%, 750% to 10000%, 1500% to 10000%, 2500% to 10000%, 4000% to 10000%, 6000% to 10000%, 8000% to 10000%, 9000% to 10000%, 200% to 7500%, 500% to 7500%, 750% to 7500%, 1500% to 7500%, 2500% to 7500%, 4000% to 7500%, 6000% to 7500%, 200% to 5000%, 500% to 5000%, 750% to 5000%, 1500% to 5000%, 2500% to 5000%, or 4000% to 5000%). In some embodiments, the droplet collection region includes one or more peripherally protruding volumes.

In still another aspect, the invention provides a device for producing droplets. The device includes:
(a) a first channel having a first channel depth, a first channel width, a first proximal end, and a first distal end;
(b) a shelf region having a shelf width and a shelf depth, wherein the shelf region is in fluid communication with the first distal end; and
and
(c) a droplet collection region having a droplet collection region width and a droplet collection region depth, the droplet collection region including one or more peripherally protruding volumes;
   wherein the first channel and the shelf region are configured to produce droplets.

In some embodiments, the one or more peripherally protruding volumes extend away from the periphery of the droplet collection region. In some embodiments, the one or more peripherally protruding volumes extend away from the periphery of the droplet collection region by at least 10% of the droplet collection region width. In some embodiments, the device further includes a step region having a step region depth and being in fluid communication with the shelf region, where the shelf region is disposed between the step region and the first distal end. In some embodiments, the shelf and step regions connect via a curved wall.

In another aspect, the invention provides a device for producing droplets. The device includes:
a) a first channel having a first channel depth, a first channel width, a first proximal end, and a first distal end;
(b) a shelf region and a step region, the shelf region having a shelf width and a shelf depth, and the step region having the step depth, wherein the shelf region is in fluid communication with the first distal end, and wherein the step and shelf regions connect via a curved wall,
   wherein the first channel and the droplet formation region are configured to produce droplets.

In some embodiments, the curved wall has a curvature length of 0.0001% to 10000% of the length of the shelf region. In some embodiments, the curved wall has a curvature length of 0.05% to 10000% (e.g., 1% to 10000%, 1% to 500%, 1% to 50%, 1% to 25%, 1% to 10%, 1% to 5%, 10% to 50%, 50% to 10000%, 200% to 10000%, 50% to 5000%, 200% to 5000%, 50% to 2000%, or 200% to 2000%) of the length of the shelf region.

In another aspect, the invention provides a device for producing droplets. The device includes:
a) a first channel having a first channel depth, a first channel width, a first proximal end, and a first distal end;
(b) a shelf region and a step region, the shelf region having a shelf width, the shelf region having a central portion aligned with the first distal end having a first shelf depth and two peripheral portions on either side of the central portion, each independently having a second shelf depth, wherein the first shelf depth is less than the second shelf depths, and the step region having the step depth, wherein the shelf region is in fluid communication with the first distal end and disposed between the first distal end and the step region,
   wherein the first channel and the shelf and step regions are configured to produce droplets.

In embodiments, the width of the central portion is less than five times the shelf depth. In embodiments, the width of the central portion is 0.01-99.99% of the shelf width (e.g., 0.5% to 15% (e.g., about 1%, 2%, 3%, 4%, 5%, 6%, 7%, 8%, 9%, 10%, 11%, 12%, 13%, 14%, or 15%), 10% to 25% (e.g., about 10%, 11%, 12%, 13%, 14%, 15%, 16%, 17%, 18%, 19%, 20%, 21%, 22%, 23%, 24%, or 25%), 20% to 35% (e.g., about 20%, 21%, 22%, 23%, 24%, 25%, 26%, 27%, 28%, 29%, 30%, 31%, 32%, 33%, 34%, or 35%), 30% to 45% (e.g., about 30%, 31%, 32%, 33%, 34%, 35%, 36%, 37%, 38%, 39%, 40%, 41%, 42%, 43%, 44%, or 45%), 40% to 55% (e.g., about 40%, 41%, 42%, 43%, 44%, 45%, 46%, 47%, 48%, 49%, 50%, 51%, 52%, 53%, 54%, or 55%), 50% to 65% (e.g., about 50%, 51%, 52%, 53%, 54%, 55%, 56%, 57%, 58%, 59%, 60%, 61%, 62%, 63%, 64%, or 65%), 60% to 75% (e.g., about 60%, 61%, 62%, 63%, 64%, 65%, 66%, 67%, 68%, 69%, 70%, 71%, 72%, 73%, 74%, or 75%), 70% to 85% (e.g., about 70%, 71%, 72%, 73%, 74%, 75%, 76%, 77%, 78%, 79%, 80%, 81%, 82%, 83%, 84%, or 85%), 80% to 95% (e.g., about 80%, 81%, 82%, 83%, 84%, 85%, 86%, 87%, 88%, 89%, 90%, 91%, 92%, 93%, 94%, or 95%), 85% to 99.99% (e.g., about 85%, 86%, 87%, 88%, 89%, 90%, 91%, 92%, 93%, 94%, 95%, 96%, 97%, 98%, 99%, or 99.99%), 0.5% to 25%, 25% to 50%, 50% to 75%, or 75% to 99.99%).

In another aspect, the invention provides a device for producing droplets. The device includes:
a) a first channel having a first channel depth, a first channel width, a first proximal end, and a first distal end;
(b) a shelf region and a step region, the shelf region having a shelf width and a shelf depth, and the step region having the step depth, wherein the shelf region is in fluid communication with the first distal end, and wherein the long axis of the shelf region is oriented perpendicular to the long axis of the first channel (i.e., the depth of the shelf region is greater than the width of the shelf region),
   wherein the first channel and the shelf region are configured to produce droplets.

In some embodiments, the step region depth is greater than the shelf region depth and the first channel depth. In some embodiments, the first channel further includes a funnel. In some embodiments, the device further includes a second channel having a second depth, a second width, a second proximal end, and a second distal end, the second channel intersecting the first channel between the first proximal and first distal ends. Alternatively, the second distal end is in fluid communication with the shelf region, and the second channel does not intersect the first channel. In some embodiments, the second channel includes a funnel. In some embodiments, the funnel is disposed between the second proximal end and the intersection between the first channel and the second channel. In some embodiments, the second channel includes a funnel fluidically connected to the second proximal end. In some embodiments, the first channel includes a funnel disposed between the first proximal end and the intersection between the first channel and the second channel. In some embodiments, the first channel includes a funnel disposed between the first distal end and the intersection between the first channel and the second channel. In some embodiments, the first channel includes a funnel fluidically connected to the first proximal end.

In some embodiments, the funnel includes a row of pegs comprising a first end and a second end disposed along the width of the funnel. In some embodiments, the row of pegs is disposed along a diagonal across the funnel width. In some embodiments, the first end is disposed nearer to the proximal end than the second end.

In some embodiments, the first channel includes a mixer. In some embodiments, the mixer is disposed between the first distal end and the intersection between the first channel and the second channel, when present. In some embodiments, the mixer is a herringbone mixer.

In another aspect, the invention provides a system for producing droplets, the system including:

(a) a device including:
(i) a first channel having a first channel depth, a first channel width, a first proximal end, and a first distal end;
(ii) a shelf region having a shelf width and a shelf depth, wherein the shelf region is in fluid communication with the first distal end;
(iii) a droplet collection region having a droplet collection region width and a droplet collection region depth, the droplet collection region having a recess having a recess depth and a recess width, wherein the recess is fluidically connected to the shelf region, the recess depth is greater than the shelf depth, and the recess width is greater than or equal to the shelf width;
   (b) a first liquid disposed in the first channel;
   (c) a second liquid disposed in the droplet collection region; and
   wherein the first liquid and the second liquid are immiscible;
   wherein the system is configured to produce droplets of the first liquid in the second liquid.

In another aspect, the invention provides a system for producing droplets, the system including:

(a) a device including:
(i) a first channel having a first channel depth, a first channel width, a first proximal end, and a first distal end;
(ii) a shelf region having a shelf width and a shelf depth, wherein the shelf region is in fluid communication with the first distal end; and
and
(iii) a droplet collection region having a droplet collection region width and a droplet collection region depth, the droplet correction region comprising one or more peripherally protruding volumes;
   (b) a first liquid disposed in the first channel;
   (c) a second liquid disposed in the droplet collection region; and
   wherein the first liquid and the second liquid are immiscible;
   wherein the system is configured to produce droplets of the first liquid in the second liquid.

In another aspect, the invention provides a system for producing droplets, the system including:

(a) a device including:
(i) a first channel having a first channel depth, a first channel width, a first proximal end, and a first distal end;
(ii) a shelf region and a step region, the shelf region having a shelf width and a shelf depth, and the step region having the step depth, wherein the shelf region is in fluid communication with the first distal end, and wherein the step region comprises a smooth curved wall extending away from the shelf region,
   (b) a first liquid disposed in the first channel;
   (c) a second liquid disposed in the droplet collection region; and
   wherein the first liquid and the second liquid are immiscible;
   wherein the system is configured to produce droplets of the first liquid in the second liquid.

In another aspect, the invention provides a system for producing droplets, the system including:

(a) a device including:
(i) a first channel having a first channel depth, a first channel width, a first proximal end, and a first distal end;
(ii) a shelf region and a step region, the shelf region having a shelf width, the shelf region having a central portion aligned with the first distal end having a first shelf depth and two peripheral portions on either side of the central portion, each independently having a second shelf depth, wherein the first shelf depth is less than the second shelf depths, and the step region having the step depth, wherein the shelf region is in fluid communication with the first distal end and disposed between the first distal end and the step region,
   (b) a first liquid disposed in the first channel;
   (c) a second liquid disposed in the droplet collection region; and
   wherein the first liquid and the second liquid are immiscible;
   wherein the system is configured to produce droplets of the first liquid in the second liquid.

In another aspect, the invention provides a system for producing droplets, the system including:

(a) a device including:
(i) a first channel having a first channel depth, a first channel width, a first proximal end, and a first distal end;
(ii) a shelf region and a step region, the shelf region having a shelf width and a shelf depth, and the step region having the step depth, wherein the shelf region is in fluid communication with the first distal end, and wherein the long axis of the shelf region is oriented perpendicular to the long axis of the first channel (i.e., the depth of the shelf region is greater than the width of the shelf region),
   wherein the first channel and the shelf region are configured to produce droplets.
   (b) a first liquid disposed in the first channel;
   (c) a second liquid disposed in the droplet collection region; and
   wherein the first liquid and the second liquid are immiscible;
   wherein the system is configured to produce droplets of the first liquid in the second liquid.

In some embodiments, the system includes a device as described herein. In some embodiments, the first channel further comprises a funnel. In some embodiments, the device further includes a second channel having a second depth, a second width, a second proximal end, and a second distal end, the second channel intersecting the first channels between the first proximal and first distal ends; wherein the second channel comprises a third liquid, and the system is configured to produce droplets of the first and third liquids in the second liquid. In some embodiments, the second channel comprises a funnel. In some embodiments, the funnel is disposed between the second proximal end and the intersection between the first channel and the second channel. In some embodiments, the second channel comprises a funnel fluidically connected to the second proximal end. In some embodiments, the first channel comprises a funnel disposed between the first proximal end and the intersection between the first channel and the second channel. In some embodiments, the first channel comprises a funnel disposed between the first distal end and the intersection between the first channel and the second channel. In some embodiments, the first channel comprises a funnel fluidically connected to the first proximal end. In some embodiments, the funnel comprises a row of pegs comprising a first end and a second end disposed along the width of the funnel. In some embodiments, the row of pegs is disposed along a diagonal across the funnel width. In some embodiments, the first end is disposed nearer to the proximal end than the second end.

In some embodiments, the first channel comprises a mixer. In some embodiments, the mixer is disposed between the first distal end and the intersection between the first channel and the second channel, when present. In some embodiments, the mixer is a herringbone mixer. In some embodiments, the system further includes a plurality of particles disposed in the first channel.

In another aspect, the invention provides a method of producing droplets in a second liquid, the method comprising:

(a) providing the system disclosed herein; and
(b) allowing the liquids to flow from the channel(s) (e.g., the first channel and/or the second channel) to the droplet formation region to produce droplets in the second liquid, the droplets comprising the liquids from the channel(s) (the first liquid; the third liquid, when present; and the particles, when present, e.g., a single particle).

In another aspect, the disclosure provides a device for producing droplets. The device includes:
a) a first channel having a first depth, a first width, a first proximal end, and a first distal end;
b) a second channel having a second depth, a second width, a second proximal end, and a second distal end; and
d) a step region having a wall having a fourth depth, wherein the fourth depth is greater than the first depth,
   wherein a first liquid flowing from the first distal end and a third liquid flowing from the second distal end combine and form droplets in a second, immiscible liquid at the step region and wherein the first and second channels do not intersect.

In some embodiments, the device further includes a shelf region being in fluid communication with the first distal end and the second distal end and having a third depth and a third width, wherein the third width is greater than the first width and wherein the shelf region is fluidically connected to the step region, and disposed between the first distal end and the step region. In certain embodiments, the third width increases from the first distal end to the step region. In embodiments, the third width is greater than the first and second widths, e.g., greater than the sum of the first and second widths. In embodiments, the third depth is less than the first, second, and/or fourth depths, e.g., less than the first and fourth depths or less than the first, second, and fourth depths.

In another embodiment, the device further includes a first reservoir in fluid communication with the first proximal end. In yet another embodiment, the device further includes a second reservoir in fluid communication with the second proximal end. In some embodiments, the device further includes a collection reservoir in fluid communication with the step region to collect droplets, e.g., the wall of the step region is part of the wall of the collection reservoir.

In another aspect, the disclosure provides a system for producing droplets. The system includes:
a) a device for producing droplets, the device including:
   i) a first channel having a first depth, a first width, a first proximal end, and a first distal end;
   ii) a second channel having a second depth, a second width, a second proximal end, and a second distal end;
   iii) a step region having a wall having a fourth depth, wherein the fourth depth is greater than the first depth;
   iv) a first reservoir in fluid communication with the first proximal end, wherein the first reservoir comprises a first liquid; and
   v) a second reservoir in fluid communication with the second proximal end, wherein the second reservoir comprises a third liquid, wherein the first and third liquids are miscible with each other and wherein the first and third liquids combine at the distal end of the first channel and second channel,
b) a second liquid contained in the step region, wherein the first liquid and the second liquid are immiscible with each other,
   wherein the combined first and third liquids, flowing from the first distal end to the step region, form droplets of the first and third liquids dispersed in the second liquid and wherein the first and second channels do not intersect.

In some embodiments, in the system for producing droplets the device further includes a shelf region being in fluid communication with the first distal end and the second distal end and having a third depth and a third width, wherein the third width is greater than the first width and wherein the shelf region is fluidically connected to the step region and disposed between the first distal end and the step region. In embodiments, the third width is greater than the first and second widths, e.g., greater than the sum of the first and second widths. In embodiments, the third depth is less than the first, second, and/or fourth depths, e.g., less than the first and fourth depths or less than the first, second, and fourth depths. In certain embodiments, the first liquid includes particles. In another embodiment, the third liquid includes an analyte.

In other embodiments, the third width increases from the first distal end to the step region.

In certain embodiments, the device further includes a collection reservoir in fluid communication with the step region to collect droplets, e.g., the wall of the step region is part of the wall of the collection reservoir.

In another embodiment, the device further includes a controller operatively coupled to the first channel and the second channel to transport the first liquid in the first reservoir, the third liquid in the second reservoir to the step region. The first and third liquids may combine at the step region or a shelf region if present.

In another aspect, the disclosure provides a method of producing droplets of a first liquid in a second liquid by:
a) providing a device or system of the invention; and
b) allowing the first liquid to flow from the first channel and the third liquid to flow from the second channel to the shelf region to produce droplets of the combination of the first and third liquids in the second liquid. In embodiments, the method further includes collecting the droplets in a collection reservoir in fluid communication with the step region; and optionally removing the droplets from the collection reservoir.

In some embodiments, the device further includes a shelf region being in fluid communication with the first distal end and the second distal end and having a third depth and a third width, wherein the third width is greater than the first width and wherein the shelf region is fluidically connected to the step region, and disposed between the first distal end and the step region. In certain embodiments, the third width increases from the first distal end to the step region. In embodiments, the third width is greater than the first and second widths, e.g., greater than the sum of the first and second widths. In embodiments, the third depth is less than the first, second, and/or fourth depths, e.g., less than the first and fourth depths or less than the first, second, and fourth depths.

In another embodiment, the device further includes a first reservoir in fluid communication with the first proximal end. In yet another embodiment, the device further includes a second reservoir in fluid communication with the second proximal end. In some embodiments, the device further includes a collection reservoir in fluid communication with the step region to collect droplets, e.g., the wall of the step region is part of the wall of the collection reservoir.

In another aspect, the disclosure provides a device for producing droplets, the device includes:
a) a first channel having a first depth, a first width, a first proximal end, and a first distal end;
b) a second channel having a second depth, a second width, a second proximal end, and a second distal end, wherein the second channel intersects the first channel between the first proximal and first distal ends and wherein the intersection has a depth greater than the first depth;
c) a shelf region in fluid communication with the first distal end and having a third depth and a third width, wherein the third width is greater than the first width; and
d) a step region having a wall having a fourth depth, wherein the fourth depth is greater than the third depth, wherein the shelf region is fluidically connected to the step region, and the shelf region is disposed between the first distal end and the step region,
wherein a first liquid flowing from the first distal end and a third liquid flowing from the second distal end combine and form droplets in a second, immiscible liquid at the step region.

In certain embodiments, the intersection depth is greater than the third depth. In other embodiments, the third width increases from the first distal end to the step region. In another embodiment, the device further includes a first reservoir in fluid communication with the first proximal end. In yet another embodiment, the device further includes a second reservoir in fluid communication with the second proximal end. In another embodiment, the device further includes a collection reservoir in fluid communication with the step region to collect droplets produced by the device.

In another aspect, the disclosure provides a system for producing droplets. The system includes:
a) a device for producing droplets, the device including:
   i) a first channel having a first depth, a first width, a first proximal end, and a first distal end;
   ii) a second channel having a second depth, a second width, a second proximal end, and a second distal end, wherein the second channel intersects the first channel between the first proximal and first distal ends and wherein the intersection has a depth greater than the first depth;
   iii) a shelf region in fluid communication with the first distal end and having a third depth and a third width, wherein the third width is greater than the first width; and
   iv) a step region having a wall having a fourth depth, wherein the fourth depth is greater than the third depth, wherein the shelf region is fluidically connected to the step region, and the shelf region is disposed between the first distal end and the step region,
   v) a first reservoir in fluid communication with the first proximal end, wherein the first reservoir comprises a first liquid; and
   vi) a second reservoir in fluid communication with the second proximal end, wherein the second reservoir comprises a third liquid, wherein the first and third liquids are miscible with each other and wherein the first and third liquids combine at the intersection of the first channel and second channel,
b) a second liquid contained in the droplet formation region, wherein the first liquid and the second liquid are immiscible with each other, and
   wherein the combined first and third liquids, flowing from the first distal end to the droplet formation region, form droplets of the first and third liquids dispersed in the second liquid, and wherein the fourth depth is sized for droplets produced in the droplet formation region to be transported therefrom by buoyancy.

In some embodiments, the first liquid comprises particles. In other embodiments, the third liquid comprises an analyte. In yet another embodiment, the intersection depth is greater than the third depth. In another embodiment, the third width increases from the first distal end to the step region. In other embodiments, the device further includes a collection reservoir in fluid communication with the step region to collect droplets formed by the device. In certain embodiments, the system further includes a controller operatively coupled to the first channel and the second channel to transport the first liquid in the first reservoir, the third liquid in the second reservoir to the intersection, and the combined first and third liquids from the intersection to the droplet formation region.

In another aspect, the disclosure provides a method of producing droplets of a first liquid in a second liquid comprising:
a) providing a device or a system of the invention;
b) allowing the first liquid to flow from the first channel the third liquid to flow from the second channel to the shelf region to produce droplets of the combination of the first and third liquids in the second liquid. In some embodiments, the method further includes:
c) collecting the droplets in a collection reservoir; and optionally
d) removing the droplets from the collection reservoir.

In another aspect, the disclosure provides a system for producing droplets. The system includes:
a) a device for producing droplets, the device includes:
   i) a first channel having a first depth, a first width, a first proximal end, and a first distal end; and
   ii) a reservoir including a step region including a wall having a fourth depth, wherein the fourth depth is greater than the first depth, wherein the first distal end is in fluid communication with the wall;
b) a ferrofluid contained in the reservoir, wherein the first liquid and the ferrofluid are immiscible with each other; and
c) a magnetic actuator in operative connection with the device;
   wherein the first liquid, flowing from the first distal end to the step region, forms droplets of the first liquid dispersed in the ferrofluid.

In some embodiments, the device further includes a shelf region being in fluid communication with the first distal end and having a third depth and a third width, wherein the third width is greater than the first width and wherein the shelf region is fluidically connected to the step region and disposed between the first distal end and the step region.

In another embodiment, the device further includes a second channel, having a second depth, a second width, a second proximal end, and a second distal end, where:
a) the second channel intersects the first channel between the first proximal and first distal end; or
b) the second distal end is in fluid communication with the step region, and the second channel does not intersect the first channel.

In certain embodiments, the first liquid comprises particles. In other embodiments, the third liquid comprises an analyte. In another embodiment, the third width increases from the first distal end to the step region.

In another aspect, the disclosure provides a method of producing droplets. The method includes:
a) providing the system of any device of the invention; and
b) producing droplets of the first liquid in the ferrofluid.

In another embodiment, the method further includes manipulating the droplets by actuating the magnetic actuator. In certain embodiments, the droplets are separated by altering the magnetic field. In another embodiment, the droplets are separated based on droplet size. In certain embodiments, the droplets are heated by altering the magnetic field. In another embodiment, the droplets are directed above or below the ferrofluid by the magnetic field.

In an aspect, the invention provides a device for producing droplets of a first liquid in a second liquid including:

a) a first channel having a first proximal end, a first distal end, a first width, and a first depth;
b) a droplet formation region having a width or depth greater than the first width or first depth and being in fluid communication with the first distal end, e.g., wherein the droplet formation region is contiguous with a reservoir; and
c) a reentrainment channel having a proximal end and a distal end, wherein the proximal end is in fluid communication with the droplet formation region.

In embodiments, the device further includes a second channel have a second proximal end, a second distal end, a second width, and a second depth, wherein either the second channel intersects the first channel between the first proximal and first distal ends or the second distal end is in fluid communication with the droplet formation region. In embodiments, the droplet formation region includes a shelf region having a third width and third depth, wherein the third width is greater than the first width. In embodiments, the droplet formation region further includes a step region comprising a wall having a fourth depth, wherein the step region is in fluid communication with the shelf region and the shelf region is disposed between the first distal end and the step region. In embodiments, the droplet formation region includes a step region including a wall having a fourth depth, wherein the step region is in fluid communication with the first distal end. In embodiments, the droplet formation region is contiguous with a reservoir, wherein the proximal end of the reentrainment channel is at the top or the bottom of the reservoir. In embodiments, the device further includes a magnetic actuator disposed to apply a magnetic force to direct droplets to the reentrainment channel. In embodiments, the device further includes a controller operably coupled to flow fluid in the reentrainment channel.

In an aspect the invention provides a system for producing droplets of a first liquid in a second liquid. The system includes:

a) a device including
i) a first channel having a first proximal end, a first distal end, a first width, and a first depth;
ii) a droplet formation region having a width or depth greater than the first width or first depth and being in fluid communication with the first distal end, e.g., wherein the droplet formation region is contiguous with a reservoir; and
iii) a reentrainment channel having a proximal end and a distal end, wherein the proximal end is in fluid communication with the droplet formation region; and
   b) a second liquid in the droplet formation region.

In embodiments, the droplet formation region is contiguous with a reservoir, wherein the proximal end of the reentrainment channel is at the top or the bottom of the reservoir. In embodiments, the second liquid includes a ferrofluid and the system further includes a magnetic actuator disposed to apply a magnetic force to direct droplets to the reentrainment channel. In embodiments, the reservoir comprises the second liquid and a spacing liquid, wherein the density of the droplets is between that of the second and spacing liquids. In embodiments, the device further includes a second channel have a second proximal end, a second distal end, a second width, and a second depth, wherein either the second channel intersects the first channel between the first proximal and first distal ends or the second distal end is in fluid communication with the droplet formation region. In embodiments, the droplet formation region includes a shelf region having a third width and third depth, wherein the third width is greater than the first width. In embodiments, the droplet formation region further includes a step region including a wall having a fourth depth, wherein the step region is in fluid communication with the shelf region and the shelf region is disposed between the first distal end and the step region. In embodiments, the droplet formation region includes a step region include a wall having a fourth depth, wherein the step region is in fluid communication with the first distal end. In embodiments, the system further includes a controller operably coupled to flow fluid in the reentrainment channel.

In an aspect, the invention provides a method of manipulating droplets of a first liquid in a second liquid by:

a) providing a device or system of the invention;
b) producing droplets in the droplet formation region;
c) directing the droplets into the reentrainment channel.

In embodiments, the second liquid includes a ferrofluid and the droplets are directed by application of a magnetic field to the ferrofluid. In embodiments, the droplet formation region is contiguous with a reservoir, wherein the proximal end of the reentrainment channel is at the top or the bottom of the reservoir. In embodiments, the reservoir comprises the second liquid and spacing liquid, wherein the density of the droplets is between that of the second and spacing liquids, and wherein the droplets are directed to the reentrainment channel by pressure. In embodiments, the method further includes flowing a liquid in the reentrainment channel.

### Definitions

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

The term “about,” as used herein, refers to ±10% of a recited value.

The terms “adaptor(s)”, “adapter(s)” and “tag(s)” may be used synonymously. An adaptor or tag can be coupled to a polynucleotide sequence to be “tagged” by any approach including ligation, hybridization, or other approaches.

The term “barcode,” as used herein, generally refers to a label, or identifier, that conveys or is capable of conveying information about an analyte. A barcode can be part of an analyte. A barcode can be a tag attached to an analyte (e.g., nucleic acid molecule) or a combination of the tag in addition to an endogenous characteristic of the analyte (e.g., size of the analyte or end sequence(s)). A barcode may be unique. Barcodes can have a variety of different formats. For example, barcodes can include: polynucleotide barcodes; random nucleic acid and/or amino acid sequences; and synthetic nucleic acid and/or amino acid sequences. A barcode can be attached to an analyte in a reversible or irreversible manner. A barcode can be added to, for example, a fragment of a deoxyribonucleic acid (DNA) or ribonucleic acid (RNA) sample before, during, and/or after sequencing of the sample. Barcodes can allow for identification and/or quantification of individual sequencing-reads in real time.

The term “bead,” as used herein, generally refers to a particle. The bead may be a solid or semi-solid particle. The bead may be a gel bead. The gel bead may include a polymer matrix (e.g., matrix formed by polymerization or cross-linking). The polymer matrix may include one or more polymers (e.g., polymers having different functional groups or repeat units). Polymers in the polymer matrix may be randomly arranged, such as in random copolymers, and/or have ordered structures, such as in block copolymers. Cross-linking can be via covalent, ionic, or inductive, interactions, or physical entanglement. The bead may be a macromolecule. The bead may be formed of nucleic acid molecules bound together. The bead may be formed via covalent or non-covalent assembly of molecules (e.g., macromolecules), such as monomers or polymers. Such polymers or monomers may be natural or synthetic. Such polymers or monomers may be or include, for example, nucleic acid molecules (e.g., DNA or RNA). The bead may be formed of a polymeric material. The bead may be magnetic or non-magnetic. The bead may be rigid. The bead may be flexible and/or compressible. The bead may be disruptable or dissolvable. The bead may be a solid particle (e.g., a metal-based particle including but not limited to iron oxide, gold or silver) covered with a coating comprising one or more polymers. Such coating may be disruptable or dissolvable.

The term “biological particle,” as used herein, generally refers to a discrete biological system derived from a biological sample. The biological particle may be a macromolecule. The biological particle may be a small molecule. The biological particle may be a virus. The biological particle may be a cell or derivative of a cell. The biological particle may be an organelle. The biological particle may be a rare cell from a population of cells. The biological particle may be any type of cell, including without limitation prokaryotic cells, eukaryotic cells, bacterial, fungal, plant, mammalian, or other animal cell type, mycoplasmas, normal tissue cells, tumor cells, or any other cell type, whether derived from single cell or multicellular organisms. The biological particle may be a constituent of a cell. The biological particle may be or may include DNA, RNA, organelles, proteins, or any combination thereof. The biological particle may be or may include a matrix (e.g., a gel or polymer matrix) comprising a cell or one or more constituents from a cell (e.g., cell bead), such as DNA, RNA, organelles, proteins, or any combination thereof, from the cell. The biological particle may be obtained from a tissue of a subject. The biological particle may be a hardened cell. Such hardened cell may or may not include a cell wall or cell membrane. The biological particle may include one or more constituents of a cell, but may not include other constituents of the cell. An example of such constituents is a nucleus or an organelle. A cell may be a live cell. The live cell may be capable of being cultured, for example, being cultured when enclosed in a gel or polymer matrix, or cultured when comprising a gel or polymer matrix.

The term “fluidically connected”, as used herein, refers to a direct connection between at least two device elements, e.g., a channel, reservoir, etc., that allows for fluid to move between such device elements without passing through an intervening element.

The term “funnel,” as used herein, refers to a channel portion having an inlet and an outlet in fluid communication with the inlet, and at least one cross-sectional dimension (e.g., width) between the inlet and outlet that is greater than the corresponding cross-sectional dimension (e.g., width) of the outlet. Funnels of the invention may be conical or pear-shaped (e.g., having an in-plane longitudinal cross-section of an isosceles trapezoid or hexagon). Funnels of the invention may have, e.g., an in-plane longitudinal cross-section of a trapezoid (e.g., an isosceles trapezoid), in which the smaller of the two bases corresponds to the funnel outlet. Alternatively, funnels of the invention may have, e.g., an in-plane longitudinal cross-section of a hexagon (e.g., a hexagon corresponding to two trapezoids fused at the greater of their bases, where the smaller of their bases correspond to the funnel inlet and outlet). For example, the leg of one trapezoid may be longer (e.g., at least 50% longer, at least 100% longer, at least 200% longer, at least 300% longer, at least 400% longer, or at least 500% longer; e.g., 1000% longer or less) than the leg of the other trapezoid in a funnel having an in-plane longitudinal cross-section of a hexagon. The sides in the trapezoid(s) may be straight or curved. The vertices of the trapezoid(s) may be sharp or rounded. Preferably, a funnel has two cross-sectional dimensions (e.g., width and depth) between the inlet and outlet that are greater than each of the corresponding cross-sectional dimensions (e.g., width and depth) of the outlet. Preferably, within a funnel, the maximum funnel width and the maximum funnel depth are located at the same distance from the inlet. Preferably, the depth and/or width maxima are closer to the funnel inlet than to the funnel outlet. A funnel may be a rectifier or mini-rectifier. Rectifiers are funnels having a length (i.e., the distance from the inlet to the outlet) of at least 10 times (e.g., at least 20 times, or at least 25 times) the smaller of the funnel outlet width, funnel outlet depth, funnel inlet width, and funnel inlet depth. Typically, a rectifier has a length that is 1,500% to 4,000% (e.g., 1,500% to 3,000%, 2,000% to 3,000%, or 2,500% to 3,000%) of the smaller of the funnel outlet width, funnel outlet depth, funnel inlet width, and funnel inlet depth. Mini-rectifiers are funnels having a length (i.e., the distance from the inlet to the outlet) of 10 times or less of the smaller of the funnel outlet width, funnel outlet depth, funnel inlet width, and funnel inlet depth. Typically, a mini-rectifier has a length that is 500% to 1,000% of the smaller of the funnel outlet width, funnel outlet depth, funnel inlet width, and funnel inlet depth.

The term “genome,” as used herein, generally refers to genomic information from a subject, which may be, for example, at least a portion or an entirety of a subject's hereditary information. A genome can be encoded either in DNA or in RNA. A genome can comprise coding regions (e.g., that code for proteins) that code for proteins as well as non-coding regions. A genome can include the sequence of all chromosomes together in an organism. For example, the human genome has a total of 46 chromosomes. The sequence of all of these together may constitute a human genome.

The term “hurdle,” as used herein, refers to a partial blockage of a channel or funnel that maintains the fluid communication between sides of the channel or funnel surrounding the blockage. Non-limiting examples of hurdles are pegs, barriers, and their combinations. A peg, or a row of pegs, is a hurdle having a height, width, and length, where the height is the greatest of the dimensions. A peg may be, for example, cylindrical. A barrier is a hurdle having a height, width, and length, where the width or length is the greatest of the dimensions. A barrier may be, for example, trapezoidal. In some embodiments, a peg has the same height as the channel or funnel, in which the peg is disposed. In certain embodiments, a barrier has the same width as the channel or funnel, in which the barrier is disposed. In particular embodiments, a barrier has the same length as the funnel, in which the barrier is disposed.

The term “in fluid communication with”, as used herein, refers to a connection between at least two device elements, e.g., a channel, reservoir, etc., that allows for fluid to move between such device elements with or without passing through one or more intervening device elements. When two compartments in fluid communication are directly connected, i.e., connected in a manner allowing fluid exchange without necessity for the fluid to pass through any other intervening compartment, the two compartments are deemed to be fluidically connected.

The term “macromolecular constituent,” as used herein, generally refers to a macromolecule contained within or from a biological particle. The macromolecular constituent may comprise a nucleic acid. In some cases, the biological particle may be a macromolecule. The macromolecular constituent may comprise DNA or a DNA molecule. The macromolecular constituent may comprise RNA or an RNA molecule. The RNA may be coding or non-coding. The RNA may be messenger RNA (mRNA), ribosomal RNA (rRNA) or transfer RNA (tRNA), for example. The RNA may be a transcript. The RNA molecule may be (i) a clustered regularly interspaced short palindromic (CRISPR) RNA molecule (crRNA) or (ii) a single guide RNA (sgRNA) molecule. The RNA may be small RNA that are less than 200 nucleic acid bases in length, or large RNA that are greater than 200 nucleic acid bases in length. Small RNAs may include 5.8S ribosomal RNA (rRNA), 5S rRNA, transfer RNA (tRNA), microRNA (miRNA), small interfering RNA (siRNA), small nucleolar RNA (snoRNAs), Piwi-interacting RNA (piRNA), tRNA-derived small RNA (tsRNA) and small rDNA-derived RNA (srRNA). The RNA may be double-stranded RNA or single-stranded RNA. The RNA may be circular RNA. The macromolecular constituent may comprise a protein. The macromolecular constituent may comprise a peptide. The macromolecular constituent may comprise a polypeptide or a protein. The polypeptide or protein may be an extracellular or an intracellular polypeptide or protein. The macromolecular constituent may also comprise a metabolite. These and other suitable macromolecular constituents (also referred to as analytes) will be appreciated by those skilled in the art (see U.S. Pat. Nos. 10,011,872 and 10,323,278, and WO/2019/157529 each of which is incorporated herein by reference in its entirety).

The term “molecular tag,” as used herein, generally refers to a molecule capable of binding to a macromolecular constituent. The molecular tag may bind to the macromolecular constituent with high affinity. The molecular tag may bind to the macromolecular constituent with high specificity. The molecular tag may comprise a nucleotide sequence. The molecular tag may comprise a nucleic acid sequence. The nucleic acid sequence may be at least a portion or an entirety of the molecular tag. The molecular tag may be a nucleic acid molecule or may be part of a nucleic acid molecule. The molecular tag may be an oligonucleotide or a polypeptide. The molecular tag may comprise a DNA aptamer. The molecular tag may be or comprise a primer. The molecular tag may be, or comprise, a protein. The molecular tag may comprise a polypeptide. The molecular tag may be a barcode.

The term “oil,” as used herein, generally refers to a liquid that is not miscible with water. An oil may have a density higher or lower than water and/or a viscosity higher or lower than water.

The term “partition,” as used herein, generally, refers to a space or volume that may be suitable to contain one or more species or conduct one or more reactions. A partition may be a physical compartment, such as a droplet or well. The partition may isolate space or volume from another space or volume. The droplet may be a first phase (e.g., aqueous phase) in a second phase (e.g., oil) immiscible with the first phase. The droplet may be a first phase in a second phase that does not phase separate from the first phase, such as, for example, a capsule or liposome in an aqueous phase. A partition may comprise one or more other (inner) partitions. In some cases, a partition may be a virtual compartment that can be defined and identified by an index (e.g., indexed libraries) across multiple and/or remote physical compartments. For example, a physical compartment may comprise a plurality of virtual compartments.

The term “real time,” as used herein, can refer to a response time of less than about 1 second, a tenth of a second, a hundredth of a second, a millisecond, or less. The response time may be greater than 1 second. In some instances, real time can refer to simultaneous or substantially simultaneous processing, detection or identification.

The term “sample,” as used herein, generally refers to a biological sample of a subject. The biological sample may be a nucleic acid sample or protein sample. The biological sample may be derived from another sample. The sample may be a tissue sample, such as a biopsy, core biopsy, needle aspirate, or fine needle aspirate. The sample may be a liquid sample, such as a blood sample, urine sample, or saliva sample. The sample may be a skin sample. The sample may be a cheek swap. The sample may be a plasma or serum sample. The sample may include a biological particle, e.g., a cell or virus, or a population thereof, or it may alternatively be free of biological particles. A cell-free sample may include polynucleotides. Polynucleotides may be isolated from a bodily sample that may be selected from the group consisting of blood, plasma, serum, urine, saliva, mucosal excretions, sputum, stool and tears.

The term “sequencing,” as used herein, generally refers to methods and technologies for determining the sequence of nucleotide bases in one or more polynucleotides. The polynucleotides can be, for example, nucleic acid molecules such as deoxyribonucleic acid (DNA) or ribonucleic acid (RNA), including variants or derivatives thereof (e.g., single stranded DNA). Sequencing can be performed by various systems currently available, such as, without limitation, a sequencing system by ILLUMINA®, Pacific Biosciences (PACBIO®), Oxford NANOPORE®, or Life Technologies (ION TORRENT®). Alternatively or in addition, sequencing may be performed using nucleic acid amplification, polymerase chain reaction (PCR) (e.g., digital PCR, quantitative PCR, or real time PCR), or isothermal amplification. Such systems may provide a plurality of raw genetic data corresponding to the genetic information of a subject (e.g., human), as generated by the systems from a sample provided by the subject. In some examples, such systems provide sequencing reads (also “reads” herein). A read may include a string of nucleic acid bases corresponding to a sequence of a nucleic acid molecule that has been sequenced. In some situations, systems and methods provided herein may be used with proteomic information.

The term “side-channel,” as used herein, refers to a channel in fluid communication with, but not fluidically connected to, a droplet formation region.

The term “subject,” as used herein, generally refers to an animal, such as a mammal (e.g., human) or avian (e.g., bird), or other organism, such as a plant. The subject can be a vertebrate, a mammal, a mouse, a primate, a simian or a human. Animals may include, but are not limited to, farm animals, sport animals, and pets. A subject can be a healthy or asymptomatic individual, an individual that has or is suspected of having a disease (e.g., cancer) or a pre-disposition to the disease, or an individual that is in need of therapy or suspected of needing therapy. A subject can be a patient.

The term “substantially stationary”, as used herein with respect to droplet formation, generally refers to a state when motion of formed droplets in the continuous phase is passive, e.g., resulting from the difference in density between the dispersed phase and the continuous phase.

### BRIEF DESCRIPTION OF THE DRAWINGS

FIG. 1 illustrates the function of a combination of first channel 100, first side-channel 110, and second side-channel 120. In this figure, particles 130 propagate through channel 100 in the direction of an arrow labeled “Mixed flow.” Prior to proximal intersections 111 and 121, spacing between consecutive particles is non-uniform. At the proximal intersections, excess first liquid L1 escapes into side-channels 110 and 120. The inlets of side-channels 110 and 120 are sized to substantially prevent ingress of particles from first channel 100. The liquid that escapes into side-channels 110 and 120 rejoins first channel 100 at distal intersections 112 and 122.

FIG. 2A illustrates the direction of the excess liquid flow from first channel 100 into the side-channels at proximal intersections 111 and 121. In this figure, the side-channels have a depth sized to substantially prevent particle ingress from first channel 100.

FIG. 2B illustrates the direction of the excess liquid flow from first channel 100 into the side-channel at proximal intersection 111. In this figure, the side-channel includes filter 113 to substantially prevent particle ingress from first channel 100.

FIG. 3A is an image showing the top view of an exemplary device of the invention. The device includes first channel 300 having two funnels 301, first reservoir 302, first side-channel 310 including first side-channel reservoir 314, two second channels 340 fluidically connected to second reservoir 342, droplet formation region 350, and droplet collection region 360. This device is adapted to control pressure in first channel 300 through the use of first side-channel 310. The inset shows an isometric view of the distal intersection 312 with first-side channel 310 having a first side-channel depth that is smaller than the first depth and a first side-channel width that is greater than the first width. Droplet collection region 360 is in fluid communication with first reservoir 302, first side-channel reservoir 314, and second reservoir 342. First channel 300 has a depth of 60 μm, and first side-channel 310 has a depth of 14 μm. This configuration may be used, e.g., with beads having a mean diameter of about 54 μm. In operation, beads flow with the first liquid L1 along first channel 300, and excess first liquid L1 is removed through first side-channel 310, and beads are sized to reduce or even substantially eliminate their ingress into first side-channel 310.

FIG. 3B is an image showing a top view of an intersection between a first channel and a first side-channel in use. In this figure, the first liquid and beads flow along a first channel at a pressure of 0.8 psi, the first liquid pressure applied in the first side-channel is 0.5 psi. Accordingly, excess first liquid is removed from the space between consecutive beads, and these beads are then tightly packed in the first channel.

FIG. 3C is an image showing a top view of an intersection between a first channel and a first side-channel in use in a device having only one intersection between channel 300 and side-channel 310. In this figure, the first liquid and beads flow along a first channel. The pressure applied to reservoir 302 is 0.8 psi, and the pressure applied to reservoir 314 is 0.6 psi. The beads are tightly packed in the first channel upstream of the channel intersection. The first liquid added to the first channel from the first side-channel is evenly distributed between consecutive beads, thereby providing a stream of evenly spaced beads.

FIG. 3D is a chart showing the frequency at which beads flow through a fixed region in the chip (Bead Injection Frequency, or BIF) as a function of time, during normal chip operation. The measurement was carried out by video analysis of a fixed region of the first channel, after the intersection between the first channel and first side-channel.

FIG. 4A is an image showing the top view of an exemplary device of the invention. The device includes first channel 400 having two funnels 401 and two mini-rectifiers 404, first reservoir 402, second channel 440 fluidically connected to second reservoir 442, droplet formation region 450, and droplet collection region 460. The proximal funnel width is substantially equal to the width of first reservoir 402. Funnels 401 and mini-rectifiers 404 include pegs 403 as hurdles. There are two rows of pegs 403 in proximal funnel 401 as hurdles. Droplet collection region 460 is in fluid communication with first reservoir 402 and second reservoir 442. The spacing between pegs 403 is 100 μm.

FIG. 4B is an image focused on the combination of proximal funnel 401 and first reservoir 402 in the device of FIG. 4A. Proximal funnel 401 is fluidically connected to first reservoir 402 and includes two rows of pegs 403 as hurdles.

FIG. 4C is an image illustrating the depth changes in distal funnel 401. Distal funnel 401 has a depth and width increasing until a maximum width and depth are reached (i.e., the maximum depth is at the same location as the maximum width). In this drawing, the depth and width maxima are closer to the funnel inlet than to the funnel outlet.

FIG. 5A is an image showing the top view of an exemplary device of the invention. The device includes two first channels 500, each first channel having two funnels 501 and two mini-rectifiers 504; first reservoir 502; two second channels 540 fluidically connected to the same second reservoir 542; two droplet formation regions 550; and one droplet collection region 560. The proximal funnel 501 on the left includes one barrier 505 as a hurdle. The proximal funnel 501 on the right includes three rows of pegs 503 as hurdles. Droplet collection region 560 is in fluid communication with first reservoir 502 and second reservoir 542. Barrier 505 has a height of 30 μm, and pegs 503 are spaced at 100 μm intervals.

FIG. 5B is an image focused on the combination of two proximal funnels 501 and first reservoir 502. Proximal funnel 501 on the left is fluidically connected to first reservoir 502 and includes one barrier 505 as a hurdle. Proximal funnel 501 on the right is fluidically connected to first reservoir 502 includes three rows of pegs 503 as hurdles.

FIG. 6A is an image showing the top view of an exemplary device of the invention. The device includes two first channels 600, each first channel having two funnels 601 and two mini-rectifiers 604; first reservoir 602; two second channels 640 fluidically connected to the same second reservoir 642; two droplet formation regions 650; and one droplet collection region 660. Proximal funnel 601 on the left includes two rows of pegs 603 as hurdles. Proximal funnel 601 on the right includes three rows of pegs 603 as hurdles. Droplet collection region 660 is in fluid communication with first reservoir 602 and second reservoir 642. The spacing between pegs 603 is 65 μm.

FIG. 6B is an image focused on the combination of proximal funnels 601 and first reservoir 602. Proximal funnel 601 on the left is fluidically connected to first reservoir 602 and includes two rows of pegs 603 as hurdles. Proximal funnel 601 on the right is fluidically connected to first reservoir 602 and includes three rows of pegs 603 as hurdles.

FIG. 7A is an image showing the top view of an exemplary device of the invention. The device includes two first channels 700, each first channel having two funnels 701 and two mini-rectifiers 704; first reservoir 702; two second channels 740 fluidically connected to the same second reservoir 742; two droplet formation regions 750; and one droplet collection region 760. Proximal funnel 701 on the left includes a barrier with two rows of pegs disposed on top of the barrier as hurdle 706. Proximal funnel 701 on the right includes a barrier with three rows of pegs disposed on top of the barrier as hurdle 706. Droplet collection region 760 is in fluid communication with first reservoir 702 and second reservoir 742. Each hurdle 706 is a 30 μm-tall barrier with pegs spaced at 100 μm.

FIG. 7B is an image focused on the combination of proximal funnels 701 and first reservoir 702. Proximal funnel 701 on the left is fluidically connected to first reservoir 702 and includes a barrier with two rows of pegs disposed on top of the barrier as hurdle 706. Proximal funnel 701 on the right is fluidically connected to first reservoir 702 includes a barrier with three rows of pegs disposed on top of the barrier as hurdle 706.

FIG. 8A is an image showing the top view of an exemplary device of the invention. The device includes two first channels 800, each first channel having two funnels 801; first reservoir 802; two second channels 840 fluidically connected to the same second reservoir 842; two droplet formation regions 850; and one droplet collection region 860. Proximal funnel 801 on the left includes two rows of pegs 803 as hurdles. Pegs 803 are spaced at 100 μm. Proximal funnel 801 on the right includes a barrier with two rows of pegs disposed on top of the barrier as hurdle 806. Hurdle 806 is a 60 μm-tall barrier with pegs spaced at 65 μm. Distal funnel 801 on the left is elongated having the length of 2 mm and an inlet sized 60 μm×60 μm. Droplet collection region 860 is in fluid communication with first reservoir 802 and second reservoir 842.

FIG. 8B is an image focused on the combination of proximal funnels 801 and first reservoir 802. Proximal funnel 801 on the left is fluidically connected to first reservoir 802 and includes two rows of pegs 803 as hurdles. Proximal funnel 801 on the right is fluidically connected to first reservoir 802 includes a barrier with two rows of pegs disposed on top of the barrier as hurdle 806.

FIG. 9A is an image showing the top view of an exemplary device of the invention. The device includes two first channels 900, each first channel having two funnels 901, where first channel 900 on the left includes two mini-rectifiers 904, and first channel 900 on the right does not; first reservoir 902; two second channels 940 fluidically connected to the same second reservoir 942; two droplet formation regions 950; and one droplet collection region 960. First channel 900 on the left has dimensions of 65×60 μm, and first channel 900 on the right has dimensions of 70×65 μm. Each proximal funnel 901 includes a barrier with two rows of pegs 903 as hurdles. Droplet collection region 960 is in fluid communication with first reservoir 902 and second reservoir 942.

FIG. 9B is an image focused on the combination of proximal funnels 901 and first reservoir 902. Each proximal funnel 901 on the left is fluidically connected to first reservoir 902 and includes two rows of pegs 903 as hurdles.

FIG. 10 illustrates an exemplary device of the invention. The device includes two first channels 1000, each first channel having two funnels 1001; first reservoir 1002; two second channels 1040 fluidically connected to the same second reservoir 1042; two droplet formation regions 1050; and one droplet collection region 1060. First channel 1000 on the left has dimensions of 65×110 μm, and first channel 1000 on the right has dimensions of 60×55 μm. Each proximal funnel 1001 includes two rows of pegs 1003 as hurdles. Droplet collection region 1060 is in fluid communication with first reservoir 1002 and second reservoir 1042.

FIG. 11A is an image showing the top view of an exemplary device of the invention. The device includes first channel 1100 having two funnels 1101, first reservoir 1102, second channel 1140 fluidically connected to second reservoir 1142, droplet formation region 1150, and droplet collection region 1160. First channel 1100 on the left has dimensions of 55×50 μm, and first channel 1100 on the right has dimensions of 50×50 μm. Proximal funnel 1101 includes two rows of pegs 1103 as hurdles. Droplet collection region 1160 is in fluid communication with first reservoir 1102 and second reservoir 1142.

FIG. 11B, FIG. 11C, FIG. 11D, and FIG. 11E focus on droplet formation region 1150 and intersection between first channel 1100 and second channel 1140. In these figures, first channel 1100 includes channel portion 1107 where first depth is reduced in proximal-to-distal direction, second channel 1140 includes a channel portion 1147 where second depth is reduced in proximal-to-distal direction.

FIGS. 11F and 11G are images showing perspective views of exemplary devices of the invention focusing on droplet formation regions 1150. In FIGS. 11F and 11G, R is a radius defining cylindrically curved walls of the shelf region, h is a shelf region depth, w is a first channel width, d is a shelf region length, W is a shelf region width, and H is a step region depth. In some embodiments, h is from 5 μm to 200 μm (e.g., 10 to 200 μm, 20 to 200 μm, 30 to 200 μm, 40 to 200 μm, 50 to 200 μm, 75 to 200 μm, 100 to 200 μm, 10 to 150 μm, 20 to 150 μm, 30 to 150 μm, 40 to 150 μm, 50 to 150 μm, 75 to 150 μm, 100 to 150 μm, 10 to 100 μm, 20 to 100 μm, 30 to 100 μm, 40 to 100 μm, 50 to 100 μm, 75 to 100 μm, 10 to 75 μm, 20 to 75 μm, 30 to 75 μm, 40 to 75 μm, 50 to 75 μm, 10 to 50 μm, 20 to 50 μm, 30 to 50 μm, or 40 to 50 μm). In some embodiments, d is 5 to 1000 μm (e.g., 20 to 1000 μm, 100 to 1000 μm, 300 to 1000 μm, 500 to 1000 μm, 700 to 1000 μm, 900 to 1000 μm, 20 to 500 μm, 100 to 500 μm, 300 to 500 μm, 20 to 100 μm, 50 to 100 μm, 75 to 100 μm, or 90 to 100 μm). In some embodiments, R is 100 μm or less (e.g., 1 to 100 μm, 10 to 100 μm, 20 to 100 μm, 30 to 100 μm, 40 to 100 μm, 50 to 100 μm, 60 to 100 μm, 70 to 100 μm, 80 to 100 μm, 90 to 100 μm, 1 to 75 μm, 10 to 75 μm, 20 to 75 μm, 30 to 75 μm, 40 to 75 μm, 50 to 75 μm, 60 to 75 μm, 70 to 75 μm, 1 to 50 μm, 10 to 50 μm, 20 to 50 μm, 30 to 50 μm, or 40 to 50 μm). In some embodiments, W is 0.1 μm to 1000 μm (e.g., 5 to 1000 μm, 100 to 750 μm, 150 to 700 μm, or 200 to 700 μm). In some embodiments, w is 10 μm to 100 μm (e.g., 20 μm to 100 μm, 30 μm to 100 μm, 40 μm to 100 μm, 50 μm to 100 μm, 20 μm to 75 μm, 30 μm to 75 μm, 40 μm to 75 μm, or 50 μm to 75 μm). In some embodiments, D is from 5 μm to 200 μm (e.g., 10 to 200 μm, 20 to 200 μm, 30 to 200 μm, 40 to 200 μm, 50 to 200 μm, 75 to 200 μm, 100 to 200 μm, 10 to 150 μm, 20 to 150 μm, 30 to 150 μm, 40 to 150 μm, 50 to 150 μm, 75 to 150 μm, 100 to 150 μm, 10 to 100 μm, 20 to 100 μm, 30 to 100 μm, 40 to 100 μm, 50 to 100 μm, 75 to 100 μm, 10 to 75 μm, 20 to 75 μm, 30 to 75 μm, 40 to 75 μm, 50 to 75 μm, 10 to 50 μm, 20 to 50 μm, 30 to 50 μm, or 40 to 50 μm).

FIG. 12A is a brightfield image showing droplet generation in a device lacking a mixer. The brightfield image shows a portion of the device in use, the device including an intersection between first channel 1200 and second channel 1240; droplet formation region 1250; first, second, and third liquids; beads 1230; and forming droplet 1251 including bead 1230 and a combination of the first and third liquids. Interface 1209 is between the first and third liquids, and interface 1252 is between the second liquid and the combination of first and third liquids. In this device, first and third liquids are combined at an intersection of first channel 1200 and second channel 1240. The first liquid carries beads 1230. Forming droplet 1251 is surrounded by the second liquid. The first and third liquids are miscible, and the second liquid is not miscible with the first and third liquids.

FIG. 12B is a fluorescent image showing droplet generation in the same device as that which is shown in FIG. 12A. The fluorescent image shows a portion of the device in use with a focus on the combination of first and third liquid at an intersection between first channel 1200 and second channel 1240. Interface 1209 between the first liquid (dark) and second liquid (light) extends from the channel intersection through droplet formation region 1250 into forming droplet 1251. The presence of interface 1209 in forming droplet 1251 indicates that the first liquid (dark) and the third liquid (light) are not homogeneously mixed at the channel intersection.

FIG. 13 is an image showing the top view of an exemplary device of the invention. The device includes first channel 1300 fluidically connected to first reservoir 1302, second channel 1340 including mixer 1380 and fluidically connected to second reservoir 1342, third channel 1370 fluidically connected to third reservoir 1372, droplet formation region 1350, and droplet collection region 1360. Third channel 1370 intersects second channel 1340, the distal end of which is fluidically connected to first channel 1300. Droplet collection region 1360 is in fluid communication with first reservoir 1302, second reservoir 1342, and third reservoir 1372.

FIG. 14A is an image showing the top view of an exemplary device of the invention. The device includes first channel 1400 fluidically connected to first reservoir 1402, first side channel 1410 including mixer 1480, second channel 1440 fluidically connected to second reservoir 1442 and to first side-channel 1410, droplet formation region 1450, and droplet collection region 1460. Droplet collection region 1460 is in fluid communication with first reservoir 1402 and second reservoir 1442.

FIG. 14B focuses on a portion of the device of FIG. 14A in use. A mixture of first liquid L1 and beads 1430 is carried through first channel 1400 in the proximal-to-distal direction. Excess first liquid L1 is diverted from first channel 1400 at intersection 1411 into first side-channel 1410. Excess L1 is then combined with L3 at the intersection of first side-channel 1410 and second channel 1440. The combination of first liquid L1 and third liquid L3 then enters mixer 1480 and, after mixing, is combined with beads 1430/first liquid L1 at intersection 1412. As shown in FIG. 14B, beads 1430 are unevenly spaced in the proximal portion of first channel 1400 before intersection 1411. Between intersections 1411 and 1412 beads 1430 are tightly packed in first channel 1400. After intersection 1412, beads 1430 are substantially evenly spaced.

FIG. 15 is an image showing a top view of an exemplary device of the invention. The device includes first channel 1500 fluidically connected to first reservoir 1502. First channel 1500 includes funnel 1501 disposed at its proximal end. Funnel 1501 at the proximal end of first channel 1500 includes pegs 1503. The device includes droplet collection region 1560 fluidically connected to droplet formation region 1550. The device also includes second reservoir 1542 fluidically connected to second channel 1540 that includes funnel 1543 at its proximal end. Second channel 1540 intersect channel 1500 between the first distal end and funnel 1508.

FIG. 16A is a top view of an exemplary funnel that may be included, e.g., at the proximal end of a first channel. The funnel includes two rows of pegs as hurdles closer to the funnel inlet and a single row of pegs (in this instance, a single peg) closer to the funnel outlet.

FIG. 16B is a perspective view of an exemplary funnel shown in FIG. 16A.

FIG. 16C is a top view of an exemplary funnel that may be included, e.g., at the proximal end of a first channel. The funnel includes a barrier with one row of pegs disposed on top of the barrier as hurdle.

FIG. 16D is a perspective view of an exemplary funnel shown in FIG. 16C.

FIG. 17A is a top view of an exemplary funnel that may be included, e.g., at the proximal end of a first channel. The funnel includes a barrier with one row of pegs disposed on top of the barrier as hurdle. The pegs have a peg length that is greater than the peg width.

FIG. 17B is a perspective view of an exemplary funnel shown in FIG. 17A.

FIG. 17C is a top view of an exemplary funnel that may be included, e.g., at the proximal end of a first channel. The funnel includes a barrier with one row of pegs disposed on top of the barrier as hurdle. The pegs have a peg length that is greater than the peg width.

FIG. 17D is a perspective view of an exemplary funnel shown in FIG. 17C.

FIG. 17E is a perspective view of an exemplary funnel that may be included, e.g., at the proximal end of a first channel.

FIG. 18A is a top view of an exemplary funnel that may be included, e.g., at the proximal end of a second channel. The funnel includes a barrier with one row of pegs disposed along a curve on top of the barrier as hurdle.

FIG. 18B is a perspective view of an exemplary funnel shown in FIG. 18A.

FIG. 18C is a top view of an exemplary funnel that may be included, e.g., at the proximal end of a first channel. The funnel includes a barrier with one row of pegs disposed on top of the barrier as hurdle. The pegs have a peg length that is greater than the peg width.

FIG. 18D is a perspective view of an exemplary funnel shown in FIG. 18C.

FIG. 18E is a top view of an exemplary funnel that may be included, e.g., at the proximal end of a first channel. The funnel includes a barrier with one row of pegs disposed along a curve. The pegs have a peg length that is greater than the peg width. The funnel also includes a ramp.

FIG. 18F is a perspective view of an exemplary funnel shown in FIG. 18E.

FIG. 19A is a top view of an exemplary series of traps. In this figure, channel 1900 includes two traps 1907. The solid-fill arrow indicates the liquid flow direction through the channel including a series of traps.

FIG. 19B is a side view cross section of a channel including a trap. The trap has a length (L) and depth (h). In operation, air bubbles that might be carried with a liquid can be lifted by the air buoyancy and thus removed from the liquid flow.

FIG. 19C is a side view cross section of a channel including a trap. The trap has a length (L) and depth (h+50). In operation, air bubbles that might be carried with a liquid can be lifted by the air buoyancy and thus removed from the liquid flow.

FIG. 20A is a top view of an exemplary herringbone mixer. This herringbone mixer may be used to provide a single mix cycle in a channel. The herringbone mixer includes and grooves extending transversely across the channel. In this drawing, um stands for microns.

FIG. 20B is a side view cross section of an exemplary herringbone mixer portion shown in FIG. 20A. In this drawing, um stands for microns.

FIG. 20C is a top view of an exemplary herringbone mixer including twenty mix cycles assembled from herringbone mixers shown in FIG. 20A.

FIG. 21 is an image showing the top view of an exemplary device of the invention. The device includes two first channels 2100, each first channel having funnel 2108 and being in fluid communication with proximal funnel 2101 and first reservoir 2102; two second channels 2140 in fluid communication with the second reservoir 2142 via separate funnels 2143; droplet formation region 2150; and droplet collection region 2160. The proximal funnel 2101 includes two rows of pegs 2103 as a hurdle. Droplet collection region 2160 is in fluid communication with first reservoir 2102 and second reservoir 2142.

FIG. 22 is an image showing the top view of a portion of an exemplary device of the invention. The portion shown includes an intersection between a first channel and a second channel, a bifurcation in the first channel into two curved downstream first channels, each of which is fluidically connected to a droplet formation region (shown in light grey). The distal end of each downstream first channel includes a ramp (shown in dark grey) that decreases the depth of the downstream first channel.

FIG. 23A is an image showing the top view of a portion of an exemplary device of the invention. The portion shown includes an intersection between a first channel and a second channel and a droplet formation region. The droplet formation region includes a shelf region protruding from the first channel outlet towards the droplet collection region, which is not shown.

FIG. 23B is an image showing a perspective view of the portion of an exemplary device of the invention shown in FIG. 23A.

FIG. 24 is an image showing the top view of a schematic representation of an exemplary device of the invention. The device includes first channel 2400 having funnel 2401; first reservoir 2402; two second channels 2440 in fluid communication with second reservoir 2442 and each having a funnel 2443; droplet formation region 2450; and droplet collection region 2460. Droplet collection region 2460 is in fluid communication with first reservoir 2402 and second reservoir 2442.

FIG. 25 is an image showing the top view of a schematic representation of an exemplary device of the invention. The device includes first channel 2500 having funnel 2501 and mixer 2580; first reservoir 2502; two second channels 2540 in fluid communication with the second reservoir 2542; droplet formation region 2550; and droplet collection region 2560. Droplet collection region 2560 is in fluid communication with first reservoir 2502 and second reservoir 2542.

FIG. 26A is an image showing the top view of a schematic representation of an exemplary droplet formation region including a row of pegs disposed along the width of the shelf region. The droplet formation region occupies one third of the droplet collection region perimeter.

FIG. 26B is an image showing a portion of the droplet formation region shown in FIG. 26A. In this figure, um stands for microns.

FIG. 26C is an image showing the top view of a schematic representation of an exemplary droplet formation region including a row of pegs disposed along the width of the shelf region. The droplet formation region is fluidically connected to three first channel outlets and occupies one third of the droplet collection region perimeter.

FIG. 27 is an image showing the perspective view of a funnel including a plurality of pegs. This funnel may be used as a filter in a second channel.

FIGS. 28A-28B show an example of system for detecting the status of a fluid. FIG. 28A shows the system before the detection of the absence of a fluid in a portion of the device. FIG. 28B shows the system of FIG. 28A after the detection of the absence of the fluid in a portion of the device.

FIG. 29 shows an example measurement of the flow rate as a fluid is transported in the system. As shown, when the fluid is depleted, the flow sensor indicates a transient increase, which crosses a threshold and indicates the depletion of the fluid.

FIG. 30 shows the run duration for a fixed volume of input fluid to be depleted from a reservoir at three different operating temperatures.

FIG. 31 is a schematic drawing showing an example of a microfluidic device for the introduction of particles, e.g., beads, into discrete droplets.

FIG. 32 is a schematic drawing showing an example of a microfluidic device for increased droplet formation throughput.

FIG. 33 is a schematic drawing showing another example of a microfluidic device for increased droplet formation throughput.

FIG. 34 is a schematic drawing showing another example of a microfluidic device for the introduction of particles, e.g., beads, into discrete droplets.

FIGS. 35A-35B are schematic drawings showing cross-section (FIG. 36A) and perspective (FIG. 36B) views an embodiment according to the invention of a microfluidic device with a geometric feature for droplet formation.

FIGS. 36A-36B are schematic drawings showing a cross-section view and a top view, respectively, of another example of a microfluidic device with a geometric feature for droplet formation.

FIGS. 37A-37B are schematic drawings showing a cross-section view and a top view, respectively, of another example of a microfluidic device with a geometric feature for droplet formation.

FIGS. 38A-38B are schematic drawings showing a cross-section view and a top view, respectively, of another example of a microfluidic device with a geometric feature for droplet formation.

FIGS. 39A-39B are schematic drawings showing views of another device of the invention. FIG. 39A is top view of a device of the invention with reservoirs. FIG. 39B is a micrograph of a first channel intersected by a second channel adjacent a droplet formation region.

FIGS. 40A-40E are schematic drawings showing views of droplet formation regions including shelf regions.

FIGS. 41A-41D are schematic drawings showing views of droplet formation regions including shelf regions including additional channels to deliver continuous phase.

FIG. 42 is a schematic drawing showing another device according to the invention having a pair of intersecting channels that lead to a droplet formation region and collection reservoir.

FIGS. 43A-43B are schematic drawings showing views of a device of the invention. FIG. 43A is an overview of a device with four droplet formation regions. FIG. 43B is a zoomed in view of an exemplary droplet formation region within the dotted line box in FIG. 43A.

FIGS. 44A-44B are schematic drawings showing views of devices according to the invention. FIG. 44A shows a device with three reservoirs employed in droplet formation. FIG. 44B is a device of the invention with four reservoirs employed in the droplet formation.

FIG. 45 is a schematic drawing showing a view of a device according to the invention with four reservoirs.

FIGS. 46A-46B are schematic drawings showing views of an embodiment according to the invention. FIG. 46A is a top view of a device having two liquid channels that meet adjacent to a droplet formation region. FIG. 46B is a zoomed in view of the droplet formation region showing the individual droplet formations regions.

FIGS. 47A-47B are schematic drawings showing schematic representations of a method according to the invention for applying a differential coating to a surface of a device of the invention. FIG. 47A is an overview of the method, and FIG. 47B is a micrograph showing the use of a blocking fluid to protect a channel from a coating agent.

FIGS. 48A-48B are schematic drawings showing cross-sectional views of a microfluidic device including a piezoelectric element for droplet formation. FIG. 48A shows the piezoelectric element in a first state. FIG. 48B shows the piezoelectric element in a second state.

FIG. 49 is a schematic drawing showing a microfluidic device including a piezoelectric element for droplet formation.

FIG. 50 is a schematic drawing showing a microfluidic device including a piezoelectric element for droplet formation. The droplets are collected in a circulating bath after formation.

FIG. 51 is a schematic drawing showing a microfluidic device including a piezoelectric element for droplet formation including a particle. The droplets contain a particle and are collected in a bath after formation.

FIG. 52 is a schematic drawing showing a microfluidic device including a piezoelectric element for droplet formation. The droplets contain a particle and are collected in a bath after formation.

FIGS. 53A-53B are vertical cross-sections of collection reservoirs with the collection reservoir partitioned into a lower first volume and an upper second volume. FIG. 53A shows a vertical cross-section of a collection reservoir where the first volume is approximately 1% that of the second volume. FIG. 53B shows a vertical cross-section of an embodiment of a collection reservoir of the present invention where the first volume is substantially smaller than the second volume.

FIGS. 54A-54B are zoomed-in vertical cross-sections of the collection reservoir shown in FIG. 53A filled with the second liquid (gray) and droplets (black diamonds). FIG. 54A shows droplets collected up to the interface between the first and second volumes of the collection reservoir, with the vertical level of remaining second liquid denoted as z_{liquid}. FIG. 54B shows droplets collected past the second volume and into the first volume of the collection reservoir with the vertical level of remaining second liquid denoted as z_{liquid}.

FIGS. 55A-55B are vertical cross-sections of the collection reservoirs shown in FIGS. 53A-53B filled with the second liquid (gray) and droplets (black diamonds). FIG. 55A shows droplets collected past the second volume and into the first volume of the collection reservoir of FIG. 53A with the vertical level of remaining second liquid denoted as z_{liquid} with its associated volume V_{liquid}. FIG. 55B shows droplets collected up to the interface of the first and second volume of the collection reservoir of FIG. 53B, with the vertical level of remaining second liquid denoted as z_{liquid} with its associated volume V_{liquid} being greater than the critical vertical level of second liquid needed for unimpeded droplet formation denoted (z_{liquid})^{crit}.

FIGS. 56A-56B are vertical cross-sections of the collection reservoirs shown in FIGS. 53A-53B filled with the second liquid (gray) and droplets (black diamonds) after the collection reservoir has been pressurized to remove excess second liquid. FIG. 56A shows droplets collected past the second volume and into the first volume of the collection reservoir of FIG. 53A with the vertical level of remaining second liquid after pressurization of the collection reservoir denoted as (z_{liquid})ₘᵢₙ with its associated volume V_{liquid}. FIG. 56B shows droplets collected past the second volume and into the first volume of the collection reservoir of FIG. 53B with the vertical level of remaining second liquid after pressurization of the collection reservoir denoted as (z_{liquid})ₘᵢₙ with its associated volume V_{liquid}.

FIGS. 57A-57B are schemes of a microfluidic device including a temperature sensor and a pressure sensor. FIG. 57A shows a device with a single temperature sensor and pressure sensor. FIG. 57B shows a device with multiple pressure sensors and a flow controller for each channel.

FIGS. 58A-58B are graphs showing the impact of temperature changes upon droplet occupancy rate (FIG. 58A) and gel bead in emulsion (GEM) generation frequency (FIG. 58B).

FIGS. 59A-59B are schematic drawings showing locations of a temperature sensor (e.g., thermocouple) in the body of a device holder. FIG. 59A shows a location of a temperature sensor that may be in thermal contact with the device holder. FIG. 59B shows a location of a temperature sensor that is embedded within the body of a device holder.

FIG. 60 is an image of a mold including the space for a droplet collection reservoir having a recess fluidically connected to a droplet formation region.

FIG. 61A is an image of a mold including the space for a droplet collection reservoir having peripherally protruding volumes extending therefrom.

FIG. 61B is an image of a mold including the space for a droplet collection reservoir having a circumferential peripherally protruding volume extending therefrom.

FIG. 62 is a cross-sectional image of a device having a channel, a shelf, and a step, where the shelf and step connect via having a curved wall.

FIG. 63A is an isometric view of a droplet formation region having a shelf region with a central portion aligned with the first distal end and two peripheral portions on either side. The depth of the central portion is less than that of the peripheral portions.

FIG. 63B is a photograph of the droplet formation region shown in FIG. 63A in operation. FIG. 63B shows the droplet formation region as producing droplets in a zig-zag pattern.

FIG. 64 is a schematic drawing showing droplets produced at a generation point and moving into a single channel. The droplets in the channel then reach a droplet sorter which deflects one type of droplet into one partition and another type of droplet into a different partition.

FIGS. 65A-65C are schematic drawings of a device having non-intersecting first and second channels.

FIGS. 66A-66B are schematic drawings of a device using ferrohydrodynamic droplet manipulation to manipulate droplets.

FIGS. 67A-67B are schematic drawings of a device using ferrohydrodynamic manipulation to move an emulsion layer below the surface of a ferrofluidic oil.

FIG. 68 is a schematic drawing of a device using electromagnetic heating.

FIGS. 69A-69B are schematic drawings of a recess of the invention.

FIG. 70 is a schematic drawing of an embodiment of a device of the disclosure for reentrainment of droplets or particles. Droplets or particles within the collection reservoir (7001) can be reentrained into a reentrainment channel (7007).

FIGS. 71A-71D are schematic drawings of an embodiment of a device of the disclosure for reentrainment of buoyant droplets or particles. FIG. 71A shows an emulsion layer (7101) at the top of a partitioning oil (7102) within a droplet collection reservoir. FIG. 71B shows a drawing of a spacing liquid (e.g., mineral oil) added to the top of the collection reservoir. FIG. 71C shows the emulsion layer reentrainment into a reentrainment channel. FIG. 71D is a close up view of droplets in a reentrainment channel including an oil flow to meter droplets and dilute concentrated droplets prior to detection.

FIGS. 72A-72C are schematic drawings of an embodiment of a device of the disclosure for unit operations or inline detection of droplets or particles.

FIG. 73 is a schematic drawing of an embodiment of a device of the disclosure for unit operations or inline detection of droplets or particles having a pressure control (7207).

### DETAILED DESCRIPTION

The invention provides devices, kits, systems, and methods for controlling liquid flow, e.g., for forming droplets with reduced droplet-to-droplet content variation or droplet content uniformity. For examples, devices, kits, systems, and methods of the invention may be used to generate droplets with high degree of control over the droplet-to-droplet content variation, individual droplet content uniformity, and/or droplet size.

The devices, kits, systems, and methods of the invention may provide droplets with reduced droplet-to-droplet content variation and/or with improved droplet content uniformity. For example, the devices, systems, and methods of the invention may provide droplets having a single particle per droplet. This effect may be achieved through the use of one or more side-channels. Without wishing to be bound by theory, a side-channel may be used to take away excess liquid separating consecutive particles, thereby reducing the number of droplets lacking particles. Alternatively, a side-channel may be used to add liquid between consecutive particles to reduce the “bunching” effect, thereby reducing the number of droplets containing multiple particles of the same kind per droplet. The devices, kits, systems, and methods of the invention may provide a plurality of droplets, in which majority of droplets are occupied by no more than one particle of the same type. In some cases, fewer than 25% of the occupied droplets contain more than one particle of the same type, and in many cases, fewer than 20% of the occupied droplets have more than one particle of the same type. In some cases, fewer than 10% or even fewer than 5% of the occupied droplets include more than one particle of the same type. In some cases, the devices, kits, systems, and methods of the invention may provide a plurality of droplets, in which majority of droplets are occupied by no more than one particle of one type (e.g., a bead) and one particle of another type (e.g., a biological particle).

It may also be desirable to avoid the creation of excessive numbers of empty droplets, for example, from a cost perspective and/or efficiency perspective. However, while this may be accomplished by providing sufficient numbers of beads into the droplet formation region, the Poissonian distribution may expectedly increase the number of droplets that may include multiple particles of the same type. As such, at most about 95%, 90%, 85%, 80%, 75%, 70%, 65%, 60%, 55%, 50%, 45%, 40%, 35%, 30%, 25%, 20%, 15%, 10%, 5% or less of the generated droplets can be unoccupied. In some cases, the flow of one or more of the particles and/or liquids directed into the droplet formation region can be conducted such that, in many cases, no more than about 50% of the generated droplets, no more than about 25% of the generated droplets, or no more than about 10% of the generated droplets are unoccupied. These flows can be controlled, as described herein, so as to present non-Poissonian distribution of singly occupied droplets while providing lower levels of unoccupied droplets. The above noted ranges of unoccupied droplets can be achieved while still providing any of the single occupancy rates described above. For example, in many cases, the devices, kits, systems, and methods of the invention produce droplets that have multiple occupancy rates of the same type of less than about 25%, less than about 20%, less than about 15%, less than about 10%, and, in many cases, less than about 5%, while having unoccupied droplets of less than about 50%, less than about 40%, less than about 30%, less than about 20%, less than about 10%, less than about 5%, or less.

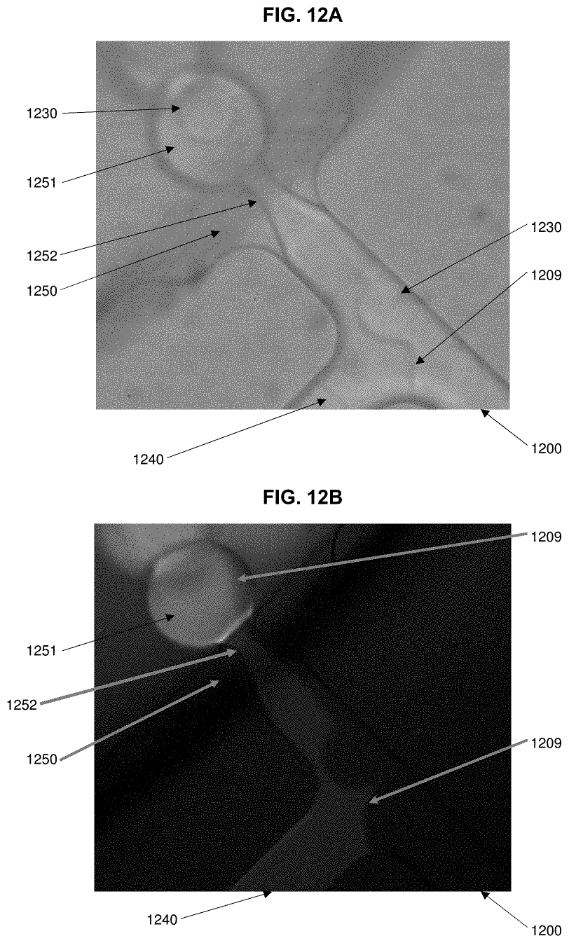

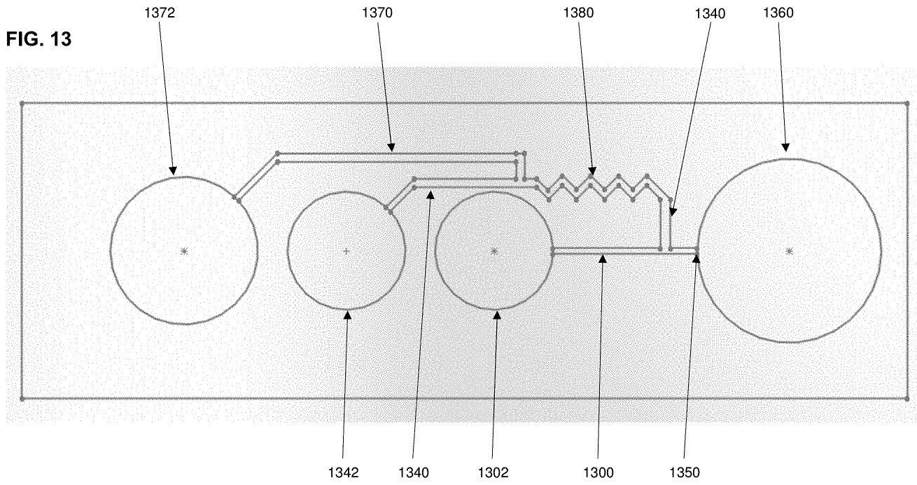

The devices, kits, systems, and methods of the invention may provide droplets having substantially uniform distribution of dissolved ingredients (e.g., lysing reagents). In applications requiring controlled cell lysis, the devices, systems, and methods of the invention may also be used to reduce premature cell lysis (e.g., to reduce the extent of cell lysis in channels). For example, non-uniform distribution of dissolved ingredients is illustrated in FIGS. 12A and 12B. In these figures, a combined stream of two partially unmixed liquids is formed by combining two liquids at a channel intersection. Without wishing to be bound by theory, the devices, kits, systems, and methods of the invention that include a mixer (e.g., a passive mixer) may pre-mix liquids (e.g., a third liquid and a fourth liquid or a third liquid and a first liquid) prior to droplet formation, thereby reducing localized high concentrations of dissolved ingredients (e.g., lysing reagents), which may cause premature cell lysis.

Additionally or alternatively, inclusion of funnels in sample channels (e.g., second channels) may improve distribution uniformity by reducing the amount of debris entering the sample channel from the sample. In particular, this reduction in the amount of debris may reduce pressure fluctuations at a channel intersection, thereby improving the consistency in the mix ratio between liquids at the channel intersection. Thus, inclusion of funnels in sample channels may reduce the droplet-to-droplet content variation.

Additionally or alternatively, inclusion of traps in channels (e.g., a first channel, second channel, or third channel) may improve uniformity by reducing the pressure fluctuations at a channel intersection by removing air bubbles from the liquid flow. Further, particle spacing uniformity may also be improved by removing air bubbles from the liquid flow. Thus, inclusion of traps in channels may reduce the droplet-to-droplet content variation.

Additionally or alternatively, droplet content uniformity may be improved by using a device including a channel in fluid communication with a shelf region having a shelf depth, the channel having a channel depth (e.g., at the channel intersection, e.g., most distal channel intersection) that is greater than the shelf depth. In some embodiments, the first channel (e.g., at the channel intersection, e.g., most distal channel intersection) is sized not to squeeze particles (e.g., a channel having a channel depth and channel width, where each of channel depth and channel width is greater than the particle diameter).

Additionally, or alternatively, devices, kits, systems, and methods of the invention may produce droplets (e.g., droplets having a diameter of about 53.5 micron) at a rate of at least 1 droplet per second (e.g., at least 5 droplets per second, at least 10 droplets per second, at least 20 droplets per second, at least 30 droplets per second, at least 40 droplets per second, at least 50 droplets per second, at least 100 droplets per second, at least 200 droplets per second, at least 300 droplets per second, at least 400 droplets per second, at least 500 droplets per second, at least 600 droplets per second, at least 700 droplets per second, at least 800 droplets per second, at least 900 droplets per second, or at least 1000 droplets per second; e.g., 5 to 10000 droplets per second, 10 to 10000 droplets per second, 20 to 10000 droplets per second, 30 to 10000 droplets per second, 40 to 10000 droplets per second, 50 to 10000 droplets per second, 100 to 10000 droplets per second, 200 to 10000 droplets per second, 300 to 10000 droplets per second, 400 to 10000 droplets per second, 500 to 10000 droplets per second, 1000 to 10000 droplets per second, 2000 to 10000 droplets per second, 3000 to 10000 droplets per second, 4000 to 10000 droplets per second, 5000 to 10000 droplets per second, 6000 to 10000 droplets per second, 7000 to 10000 droplets per second, 8000 to 10000 droplets per second, 9000 to 10000 droplets per second, 5 to 9000 droplets per second, 10 to 9000 droplets per second, 20 to 9000 droplets per second, 30 to 9000 droplets per second, 40 to 9000 droplets per second, 50 to 9000 droplets per second, 100 to 9000 droplets per second, 200 to 9000 droplets per second, 300 to 9000 droplets per second, 400 to 9000 droplets per second, 500 to 9000 droplets per second, 1000 to 9000 droplets per second, 2000 to 9000 droplets per second, 3000 to 9000 droplets per second, 4000 to 9000 droplets per second, 5000 to 9000 droplets per second, 6000 to 9000 droplets per second, 7000 to 9000 droplets per second, 8000 to 9000 droplets per second, 5 to 8000 droplets per second, 10 to 8000 droplets per second, 20 to 8000 droplets per second, 30 to 8000 droplets per second, 40 to 8000 droplets per second, 50 to 8000 droplets per second, 100 to 8000 droplets per second, 200 to 8000 droplets per second, 300 to 8000 droplets per second, 400 to 8000 droplets per second, 500 to 8000 droplets per second, 1000 to 8000 droplets per second, 2000 to 8000 droplets per second, 3000 to 8000 droplets per second, 4000 to 8000 droplets per second, 5000 to 8000 droplets per second, 6000 to 8000 droplets per second, 7000 to 8000 droplets per second, 5 to 7000 droplets per second, 10 to 7000 droplets per second, 20 to 7000 droplets per second, 30 to 7000 droplets per second, 40 to 7000 droplets per second, 50 to 7000 droplets per second, 100 to 7000 droplets per second, 200 to 7000 droplets per second, 300 to 7000 droplets per second, 400 to 7000 droplets per second, 500 to 7000 droplets per second, 1000 to 7000 droplets per second, 2000 to 7000 droplets per second, 3000 to 7000 droplets per second, 4000 to 7000 droplets per second, 5000 to 7000 droplets per second, 6000 to 7000 droplets per second, 5 to 6000 droplets per second, 10 to 6000 droplets per second, 20 to 6000 droplets per second, 30 to 6000 droplets per second, 40 to 6000 droplets per second, 50 to 6000 droplets per second, 100 to 6000 droplets per second, 200 to 6000 droplets per second, 300 to 6000 droplets per second, 400 to 6000 droplets per second, 500 to 6000 droplets per second, 1000 to 6000 droplets per second, 2000 to 6000 droplets per second, 3000 to 6000 droplets per second, 4000 to 6000 droplets per second, 5000 to 6000 droplets per second, 5 to 5000 droplets per second, 10 to 5000 droplets per second, 20 to 5000 droplets per second, 30 to 5000 droplets per second, 40 to 5000 droplets per second, 50 to 5000 droplets per second, 100 to 5000 droplets per second, 200 to 5000 droplets per second, 300 to 5000 droplets per second, 400 to 5000 droplets per second, 500 to 5000 droplets per second, 1000 to 5000 droplets per second, 2000 to 5000 droplets per second, 3000 to 5000 droplets per second, 4000 to 5000 droplets per second, 5 to 4000 droplets per second, 10 to 4000 droplets per second, 20 to 4000 droplets per second, 30 to 4000 droplets per second, 40 to 4000 droplets per second, 50 to 4000 droplets per second, 100 to 4000 droplets per second, 200 to 4000 droplets per second, 300 to 4000 droplets per second, 400 to 4000 droplets per second, 500 to 4000 droplets per second, 1000 to 4000 droplets per second, 2000 to 4000 droplets per second, 3000 to 4000 droplets per second, 5 to 3000 droplets per second, 10 to 3000 droplets per second, 20 to 3000 droplets per second, 30 to 3000 droplets per second, 40 to 3000 droplets per second, 50 to 3000 droplets per second, 100 to 3000 droplets per second, 200 to 3000 droplets per second, 300 to 3000 droplets per second, 400 to 3000 droplets per second, 500 to 3000 droplets per second, 1000 to 3000 droplets per second, 2000 to 3000 droplets per second, 5 to 2000 droplets per second, 10 to 2000 droplets per second, 20 to 2000 droplets per second, 30 to 2000 droplets per second, 40 to 2000 droplets per second, 50 to 2000 droplets per second, 100 to 2000 droplets per second, 200 to 2000 droplets per second, 300 to 2000 droplets per second, 400 to 2000 droplets per second, 500 to 2000 droplets per second, 1000 to 2000 droplets per second, 5 to 1000 droplets per second, 10 to 1000 droplets per second, 20 to 1000 droplets per second, 30 to 1000 droplets per second, 40 to 1000 droplets per second, 50 to 1000 droplets per second, 100 to 1000 droplets per second, 200 to 1000 droplets per second, 300 to 1000 droplets per second, 400 to 1000 droplets per second, 500 to 1000 droplets per second, 5 to 900 droplets per second, 10 to 900 droplets per second, 20 to 900 droplets per second, 30 to 900 droplets per second, 40 to 900 droplets per second, 50 to 900 droplets per second, 100 to 900 droplets per second, 200 to 900 droplets per second, 300 to 900 droplets per second, 400 to 900 droplets per second, 500 to 900 droplets per second, 5 to 800 droplets per second, 10 to 800 droplets per second, 20 to 800 droplets per second, 30 to 800 droplets per second, 40 to 800 droplets per second, 50 to 800 droplets per second, 100 to 800 droplets per second, 200 to 800 droplets per second, 300 to 800 droplets per second, 400 to 800 droplets per second, 500 to 800 droplets per second, 5 to 700 droplets per second, 10 to 700 droplets per second, 20 to 700 droplets per second, 30 to 700 droplets per second, 40 to 700 droplets per second, 50 to 700 droplets per second, 100 to 700 droplets per second, 200 to 700 droplets per second, 300 to 700 droplets per second, 400 to 700 droplets per second, 500 to 700 droplets per second, 5 to 600 droplets per second, 10 to 600 droplets per second, 20 to 600 droplets per second, 30 to 600 droplets per second, 40 to 600 droplets per second, 50 to 600 droplets per second, 100 to 600 droplets per second, 200 to 600 droplets per second, 300 to 600 droplets per second, 400 to 600 droplets per second, or 500 to 600 droplets per second). In some embodiments, the droplet formation region includes a row of pegs, the spaces between the pegs defining nozzles. In certain embodiments, the droplet formation region includes 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 nozzles. In particular embodiments, the droplet formation region produces droplets (e.g., droplets having a diameter of about 53.5 micron) at a rate of at least 1 droplet per second (e.g., at least 5 droplets per second, at least 10 droplets per second, at least 20 droplets per second, at least 30 droplets per second, at least 40 droplets per second, at least 50 droplets per second, or at least 100 droplets per second; e.g., 5 to 200 droplets per second, 10 to 200 droplets per second, 20 to 200 droplets per second, 30 to 200 droplets per second, 40 to 200 droplets per second, 50 to 200 droplets per second, 100 to 200 droplets per second, 5 to 150 droplets per second, 10 to 150 droplets per second, 20 to 150 droplets per second, 30 to 150 droplets per second, 40 to 150 droplets per second, 50 to 150 droplets per second, 100 to 150 droplets per second, 5 to 140 droplets per second, 10 to 140 droplets per second, 20 to 140 droplets per second, 30 to 140 droplets per second, 40 to 140 droplets per second, 50 to 140 droplets per second, 100 to 140 droplets per second, 5 to 130 droplets per second, 10 to 130 droplets per second, 20 to 130 droplets per second, 30 to 130 droplets per second, 40 to 130 droplets per second, 50 to 130 droplets per second, 100 to 130 droplets per second, 5 to 120 droplets per second, 10 to 120 droplets per second, 20 to 120 droplets per second, 30 to 120 droplets per second, 40 to 120 droplets per second, 50 to 120 droplets per second, 100 to 120 droplets per second, 5 to 110 droplets per second, 10 to 110 droplets per second, 20 to 110 droplets per second, 30 to 110 droplets per second, 40 to 110 droplets per second, 50 to 110 droplets per second, or 100 to 110 droplets per second) per nozzle.

Droplet formation regions may suffer from a pinned droplet failure. In this type of a failure, a previously generated droplet remains pinned on one side or both sides of a droplet formation region, thereby interfering with further droplet formation. In contrast, droplet formation regions of the present invention improve robustness of the devices, kits, systems, and methods of the invention by reducing or eliminating the incidence of the pinned droplet failures.

In certain aspects, devices of the invention feature a collection reservoir for collecting droplets formed in the droplet formation region. The collection reservoir is configured to allow for unimpeded droplet formation in a low volume of a continuous phase while enhancing the efficiency of collecting formed droplets by having a first volume that is smaller than the second volume. The smaller first volume of the collection reservoir of devices of the invention minimizes the remaining volume of the continuous phase that remains after droplets are formed, thus increasing device efficiency and minimizing device downtime.

In certain aspects, a device of the invention includes a first channel having a depth, a width, a proximal end, and a distal end. The proximal end is or is configured to be in fluid communication with a source of liquid, e.g., a reservoir integral to the device or coupled to the device, e.g., by tubing. The distal end is in fluid communication with, e.g., fluidically connected to, a droplet formation region. A droplet formation region allows liquid from the first channel to expand in at least one dimension, leading to droplet formation under appropriate conditions as described herein. A droplet formation region can be of any suitable geometry. In one embodiment, the droplet formation region includes a shelf region that allows liquid to expand substantially in one dimension, e.g., perpendicular to the direction of flow. The width of the shelf region is greater than the width of the first channel at its distal end. In certain embodiments, the first channel is a channel distinct from a shelf region, e.g., the shelf region widens or widens at a steeper slope or curvature than the distal end of the first channel. In other embodiments, the first channel and shelf region are merged into a continuous flow path, e.g., one that widens linearly or non-linearly from its proximal end to its distal end; in these embodiments, the distal end of the first channel can be considered to be an arbitrary point along the merged first channel and shelf region. In another embodiment, the droplet formation region includes a step region, which provides a spatial displacement and allows the liquid to expand in more than one dimension. The spatial displacement may be upward or downward or both relative to the channel. The choice of direction may be made based on the relative density of the dispersed and continuous phases, with an upward step employed when the dispersed phase is less dense than the continuous phase and a downward step employed when the dispersed phase is denser than the continuous phase. Droplet formation regions may also include combinations of a shelf and a step region, e.g., with the shelf region disposed between the channel and the step region.

Droplets or particles may be first formed in a larger volume, such as in a reservoir, and then reentrained into a channel, e.g., for unit operations, such as trapping, holding, incubation, reaction, emulsion breaking, sorting, and/or detection. A device may include a first region in fluid communication with (e.g., fluidically connected to) a second region, e.g., with at least one (e.g., each) cross-sectional dimension smaller than the corresponding cross-sectional dimension of the first region. For example, the droplets or particles may be formed or provided in a region in which each cross-sectional dimension of the sorting region may have a length of at least 1 mm (e.g., 2 mm, 3 mm, 4 mm, 5 mm, 6 mm, 7 mm, 8 mm, 9 mm, 10 mm, or more). Following formation or provision, the droplets or particles may be reentrained into a second region (e.g., a channel) in which each cross-section dimension is less than about 1 mm (e.g., less than about 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 5 nm, 1 nm, 900 μm, 800 μm, 700 μm, 600 μm, 500 μm, 400 μm, 300 μm, 200 μm, 100 μm, 50 μm, 10 μm, 5 μm, 2 μm, 1 μm, or less). Manipulations may be employed in the first region and/or the second region or a subsequent region downstream. This method may include detecting the droplets, e.g., as they are formed or provided in the first region, reentrained in the second region, or while traversing a subsequent region downstream. The device may further include additional regions, e.g., reservoirs, for manipulation, e.g., holding, incubation, reaction, or deemulsification. Any suitable mechanism for reentraining droplets may be employed. Examples include the use of magnetic, electric, dielectrophoretic, or optical energy, differences in density, advection, and pressure. In one example, droplets are produced in a ferrofluid, the magnetic actuation of which can be used to direct droplets to a reentrainment channel. Devices may include features in a reservoir to aid direction of droplets to a reentrainment channel. For example, a reservoir in which droplets are produced or held may have a funnel feature connecting to a reentrainment channel, e.g., sized to allow droplets to pass one by one into the reentrainment channel. In embodiments, droplets are produced in a channel in which they can be transported. In embodiments, the reentrainment channel is in fluid communication with one or more additional reservoirs, e.g., for any of the unit operations described herein.

Droplets or particles may be formed in a larger volume, such as a reservoir (e.g., a reservoir containing a ferrofluid (e.g., a colloidal suspension of small magnetic particles (e.g., iron oxide, nickel, cobalt, etc.) in a liquid (e.g., an aqueous liquid or an oil)), and then manipulated using a magnetic actuator. Droplets or particles in a ferrofluid may be reentrained into a channel using a magnetic actuator, e.g., for unit operations, such as trapping, holding, incubation, reaction, emulsion, breaking, sorting, and/or detection. A device may include a first region in fluid communication with (e.g., fluidically connected to) a second region, e.g., with at least one (e.g., each) cross-sectional dimension smaller than the corresponding cross-sectional dimension of the first region. For example, the droplets or particles may be formed or provided in a region containing a ferrofluid, and a magnetic actuator may alter the magnetic field, manipulating the droplets (e.g., the droplets may be separated based on size or the droplets may be directed above or below the ferrofluid). Following formation or provision, the droplets or particles may be reentrained into a second region (e.g., a channel) by activating the magnetic actuator. Manipulations may be employed in the first region and/or the second region or a subsequent region downstream. This method may include detecting the droplets, e.g., as they are formed or provided in the first region, reentrained in the second region, or while traversing a subsequent region downstream. The device may further include additional regions, e.g., reservoirs, for manipulation, e.g., holding, incubation, reaction, or deemulsification. The magnetic actuator can also be used to heat the ferrofluid and the droplets or particles by altering the magnetic field.

The invention provides systems and methods for detecting the status, e.g., the presence or absence, of a fluid, e.g., a liquid, in a portion of a device, such as a microfluidic device, e.g., in a reservoir, channel, or manifold. The invention may be employed in detecting the depletion of a fluid from a portion of a device, e.g., a reservoir, channel, or droplet formation region. In response to such detection, the systems and methods may stop the flow of fluid in the device, e.g., by closing a valve or stopping a pump. Alternatively, upon detection of the status of a fluid, additional fluid may be added to the device, e.g., in a reservoir, to maintain a continuous flow. Added fluid may or may not be same the as the fluid that was detected. One or more sensors operatively coupled to the system along the fluid flow path may be used to detect the status of the fluid. Beneficially, the systems and methods of the invention allow for operation without loading excess reagents, thereby reducing or eliminating waste or incomplete analysis of sample. Furthermore, the systems and methods allow for controlling the concentration of the final product of the device without excess or insufficient dilution, and the systems and methods may reduce or eliminate contamination caused by introduction of air after depletion. Thus, efficiency may greatly increase, both in terms of sample and reagent consumption and recovery.

In certain assays and syntheses, fluids, e.g., liquids, are provided in a fixed volume and are transported in a device, such as a microfluidic device, for a fixed period of time. The period of time is based on the initial volume and the flow rate, which may vary depending on the temperature. Thus, a single time may not be used for a given volume in all circumstances, as changes in ambient conditions will affect the flow rate of the fluid in the device. In methods of using fluidic devices, it is typically advantageous to process as much of a fluid, e.g., a sample, as possible, with the method optimally processing all of the fluid for its intended purpose. However, once the fixed volume of fluid is depleted, a second, displacing fluid, commonly air or another liquid, may enter the device or other part of the system, resulting in contamination (e.g., by drying liquids in the system and leaving residues) or otherwise affect operation or output of the device. Thus, an excess of fluid is typically employed (or, alternatively, a device is operated for less than maximal time) to prevent the adverse effects of depletion. The use of excess reagents may, however, lead to excess dilution of the end product, and the early termination of operation of the device may result in incomplete processing. The present invention solves these problems by detecting the status of a fluid and either stopping the flow or adding additional fluid. The detecting can occur upstream of any location where contamination or other adverse effects result from the desired fluid being displaced, e.g., by air, such as in a channel, in a reservoir, or at the interface of a channel and reservoir.

The invention provides devices, kits, and systems for forming droplets and methods of their use. The devices, kits, systems, and methods of the invention may be used to form droplets of a size suitable for utilization as microscale chemical reactors, e.g., for genetic sequencing. In general, droplets are formed in a device by flowing a first liquid through a channel and into a droplet formation region including a second liquid, i.e., the continuous phase, which may or may not be externally driven. Thus, droplets can be formed without the need for externally driving the second liquid.

Additionally, devices, kits, systems, and methods of the invention may allow for control over the size of the droplets with lower sensitivity to changes in liquid properties. For example, the size of the generated droplets is less sensitive to the dispersed phase flow rate. Adding multiple formation regions is also significantly easier from a layout and manufacturing standpoint. The addition of further formation regions allows for formation of droplets even in the event that one droplet formation region becomes blocked. Droplet formation can be controlled by adjusting one or more geometric features of fluidic channel architecture, such as a width, depth, and/or expansion angle of one or more fluidic channels. For example, droplet size and speed of droplet formation may be controlled. In some instances, the number of regions of formation at a driven pressure can be increased to increase the throughput of droplet formation.

In addition to the features described herein, any of the devices, systems, methods and kits described in U.S. 2019/0060890, U.S. 2019/0060905, U.S. 2019/0060904, U.S. 2019/0060906, U.S. 2019/0064173, and WO 2019/040637, the disclosures of which are hereby incorporated by reference in their entirety, are contemplated for adaptation in the present systems and methods. Exemplary fluidic configurations for use with various aspects of the invention are also described in Examples 26-47 and 58.

### Devices and Systems

A device or system of the invention includes a first channel having a depth, a width, a proximal end, and a distal end. The proximal end is or is configured to be in fluid communication with a source of liquid, e.g., a reservoir integral to the device or coupled to the device, e.g., by tubing. The distal end is in fluid communication with, e.g., fluidically connected to, a droplet formation region.

In general, the components of a device or system, e.g., channels, may have certain geometric features that at least partly determine the sizes and/or content of the droplets. For example, any of the channels described herein have a depth (a height), h₀, and width, w. The droplet formation region may have an expansion angle, α. Droplet size may decrease with increasing expansion angle. The resulting droplet radius, R_{d}, may be predicted by the following equation for the aforementioned geometric parameters of h₀, w, and α:

$${R}_{d} \approx 0.44 ( 1 + 2.2 \sqrt{tan α} \frac{w}{{h}_{0}} ) \frac{{h}_{0}}{\sqrt{tan α}}$$

As a non-limiting example, for a channel with w=21 μm, h=21 μm, and α=3°, the predicted droplet size is 121 μm. In another example, for a channel with w=25 μm, h=25 μm, and α=5°, the predicted droplet size is 123 μm. In yet another example, for a channel with w=28 μm, h=28 μm, and α=7°, the predicted droplet size is 124 μm. In some instances, the expansion angle may be between a range of from about 0.5° to about 4°, from about 0.1° to about 10°, or from about 0° to about 90°. For example, the expansion angle can be at least about 0.01°, 0.1°, 0.2°, 0.3°, 0.4°, 0.5°, 0.6°, 0.7°, 0.8°, 0.9°, 1°, 2°, 3°, 4°, 5°, 6°, 7°, 8°, 9°, 10°, 15°, 20°, 25°, 30°, 35°, 40°, 45°, 50°, 55°, 60°, 65°, 70°, 75°, 80°, 85°, or higher. In some instances, the expansion angle can be at most about 89°, 88°, 87°, 86°, 85°, 84°, 83°, 82°, 81°, 80°, 75°, 70°, 65°, 60°, 55°, 50°, 45°, 40°, 35°, 30°, 25°, 20°, 15°, 10°, 9°, 8°, 7°, 6°, 5°, 4°, 3°, 2°, 1°, 0.1°, 0.01°, or less.

The depth and width of the channel may be the same, or one may be larger than the other, e.g., the width is larger than the depth, or depth is larger than the width. In some embodiments, the depth and/or width is between about 0.1 μm and 1000 μm. In some embodiments, the depth and/or width of the channel is from 1 to 750 μm, 1 to 500 μm, 1 to 250 μm, 1 to 100 μm, 1 to 50 μm, or 3 to 40 μm. In certain embodiments, the depth and/or width of the channel is 10 μm to 100 μm (e.g., 20 μm to 100 μm, 30 μm to 100 μm, 40 μm to 100 μm, 50 μm to 100 μm, 20 μm to 75 μm, 30 μm to 75 μm, 40 μm to 75 μm, or 50 μm to 75 μm). In some cases, when the width and length differ, the ratio of the width to depth is, e.g., from 0.1 to 10, e.g., 0.5 to 2 or greater than 3, such as 3 to 10, 3 to 7, or 3 to 5. The width and depths of the first channel may or may not be constant over its length. In particular, the width may increase or decrease adjacent the distal end. In general, channels may be of any suitable cross section, such as a rectangular, triangular, or circular, or a combination thereof. In particular embodiments, a channel may include a groove along the bottom surface. The width or depth of the channel may also increase or decrease, e.g., in discrete portions, to alter the rate of flow of liquid or particles or the alignment of particles.

Devices and systems of the invention may include additional channels that intersect the first channel between its proximal and distal ends, e.g., one or more side-channels (e.g., a first side-channel and optionally a second side-channel) and/or one or more additional channel (e.g., a second channel).

Funnels and/or side-channels may be used to control particle (e.g., bead) flow, e.g., to provide evenly spaced particles (e.g., beads).

In some cases, a particle channel (e.g., the first channel) may include one or more funnels, each funnel having a funnel proximal end, a funnel distal end, a funnel width, and a funnel depth, and each funnel proximal end has a funnel inlet, and each funnel distal end has a funnel outlet. In some cases, the particle channel (e.g., the first channel) includes 1 to 5 (e.g., 1 to 4, 1 to 3, 1 to 2, or 1) funnel(s). For example, the particle channel (e.g., the first channel) may include 1, 2, 3, 4, or 5 funnel(s). In some cases, at least one funnel is a mini-rectifier. In some cases, at least one funnel is a rectifier. For example, the particle channel (e.g., the first channel) may include 1, 2, or 3 rectifiers and 1, 2, or 3 mini-rectifiers. In some cases, the first channel may include a funnel (e.g., a rectifier) between the first reservoir and the proximal channel intersection (e.g., a proximal intersection of the first channel and the first side-channel, or an intersection of the first channel and the second channel). In some cases, the first channel may include a funnel (e.g., a rectifier) in its proximal portion, e.g., the funnel (e.g., the rectifier) inlet may be fluidically connected to the first reservoir. In some cases, the first channel may include a funnel (e.g., a rectifier) in its distal portion, e.g., the funnel (e.g., the rectifier) outlet may be fluidically connected to the distal channel intersection (e.g., a distal intersection of the first channel and the first side-channel, or an intersection of the first channel and the second channel). In some cases, the first channel may include one or more (e.g., 1, 2, or 3) funnels (e.g., mini-rectifiers) in its middle portion, e.g., between a distal funnel inlet and a proximal funnel outlet or a proximal intersection of the first channel and the first side-channel.

In some cases, a sample channel (e.g., the second channel) may include one or more funnels, each funnel having a funnel proximal end, a funnel distal end, a funnel width, and a funnel depth, and each funnel proximal end has a funnel inlet, and each funnel distal end has a funnel outlet. In some cases, the sample channel (e.g., the second channel) includes 1 to 5 (e.g., 1 to 4, 1 to 3, 1 to 2, or 1) funnel(s). For example, the sample channel (e.g., the second channel) may include 1, 2, 3, 4, or 5 funnel(s). In some cases, at least one funnel is a mini-rectifier. In some cases, at least one funnel is a rectifier. For example, the sample channel (e.g., the second channel) may include 1, 2, or 3 rectifiers and 1, 2, or 3 mini-rectifiers. In some cases, the second channel may include a funnel (e.g., a rectifier) between the second reservoir and a channel intersection (e.g., an intersection of the first channel and the second channel, an intersection of the second channel and the first side-channel, or an intersection of the second channel and the third channel). In some cases, the second channel may include a funnel (e.g., a rectifier) in its proximal portion, e.g., the funnel (e.g., the rectifier) inlet may be fluidically connected to the second reservoir. In some cases, the second channel may include a funnel (e.g., a rectifier) in its distal portion, e.g., the funnel (e.g., the rectifier) outlet may be fluidically connected to the channel intersection (e.g., an intersection of the first channel and the second channel, an intersection of the second channel and the first side-channel, or an intersection of the second channel and the third channel). In some cases, the second channel may include one or more (e.g., 1, 2, or 3) funnels (e.g., mini-rectifiers) in its middle portion, e.g., between a distal funnel inlet and a proximal funnel outlet or a channel intersection (e.g., an intersection of the first channel and the second channel, an intersection of the second channel and the first side-channel, or an intersection of the second channel and the third channel). In some cases, the funnel (e.g., a funnel including a plurality of pegs) in the second channel may be used as a filter, e.g., to remove debris from the liquid flow.

One or more funnels may include hurdle(s) (e.g., 1, 2, or 3 hurdles in one funnel). The hurdle may be a row of pegs, a barrier, or a combination thereof. The hurdles may be disposed anywhere within the funnel, e.g., closer to the funnel inlet, closer to the funnel outlet, or in the middle. Typically, when rows of pegs are included in the funnel, at least two rows of pegs are included. Pegs may have a diameter of 40 μm to 100 μm (e.g., 50 μm to 100 μm, 60 μm to 100 μm, 70 μm to 100 μm, 80 μm to 100 μm, 90 μm to 100 μm, 40 μm to 90 μm, 50 μm to 90 μm, 60 μm to 90 μm, 70 μm to 90 μm, 80 μm to 90 μm, 40 μm to 80 μm, 50 μm to 80 μm, 60 μm to 80 μm, 70 μm to 80 μm, 40 μm to 70 μm, 50 μm to 70 μm, or 60 μm to 70 μm). Pegs may have a width of 40 μm to 100 μm (e.g., 50 μm to 100 μm, 60 μm to 100 μm, 70 μm to 100 μm, 80 μm to 100 μm, 90 μm to 100 μm, 40 μm to 90 μm, 50 μm to 90 μm, 60 μm to 90 μm, 70 μm to 90 μm, 80 μm to 90 μm, 40 μm to 80 μm, 50 μm to 80 μm, 60 μm to 80 μm, 70 μm to 80 μm, 40 μm to 70 μm, 50 μm to 70 μm, or 60 μm to 70 μm). Pegs may have a peg length and a peg width, and the peg length may be greater than the peg width (e.g., the peg length may be at least 10%, 25%, 50%, 75%, 100%, 150%, 200%, or 300% greater than the peg width; e.g., the peg length may be 10% to 1000%, 10% to 900%, 10% to 800%, 10% to 700%, 10% to 600%, 50% to 1000%, 50% to 900%, 50% to 800%, 50% to 700%, 50% to 600%, 100% to 1000%, 100% to 900%, 100% to 800%, 100% to 700%, 100% to 600%, 200% to 1000%, 200% to 900%, 200% to 800%, 200% to 700%, or 200% to 600% greater than the peg width). Individual pegs may be spaced at a distance sized to allow at least one particle through the row of pegs (e.g., the distance between individual pegs may be 100% to 500% of the particle diameter). For example, the distance between individual pegs may be at least same as the diameter of a particle (e.g., 100% to 1000% of the particle diameter, 100% to 900% of the particle diameter, 100% to 800% of the particle diameter, 100% to 700% of the particle diameter, 100% to 600% of the particle diameter, or 100% to 500% of the particle diameter), for which the funnel is configured. For example, individual pegs may be spaced at 50 μm to 100 μm (e.g., 60 μm to 100 μm, 70 μm to 100 μm, 80 μm to 100 μm, 90 μm to 100 μm, 50 μm to 90 μm, 60 μm to 90 μm, 70 μm to 90 μm, 80 μm to 90 μm, 50 μm to 80 μm, 60 μm to 80 μm, 70 μm to 80 μm, 50 μm to 70 μm, 60 μm to 70 μm, or 50 μm to 60 μm) from each other. A barrier may have a height that leaves space between the barrier and the opposite funnel wall sized to permit a particle through the space (e.g., the height between the barrier and the funnel wall may be 50% to 400% of the particle diameter). For example, the height between the barrier and the funnel wall may be at least 50% of the particle diameter, for which the funnel is configured (e.g., at least 60%, at least 70%, at least 80%, at least 90%, at least 100% of the particle diameter; e.g., 400% or less, 300% or less, 200% or less of the particle diameter). The barrier may have a height that is at least 100% of the particle diameter, for which the funnel is configured (e.g., at least 200%, at least 300%, at least 400%, at least 500%, at least 600%, or at least 700% of the particle diameter; 800% or less, 700% or less, 600% or less, 500% or less, 400% or less, 300% or less, 200% or less of the particle diameter). A barrier may have a height of at least 20 μm (e.g., at least 30 μm, at least 40 μm, at least 50 μm, or at least 60 μm). For example, a barrier may have a height of 20 μm to 70 μm (e.g., 30 μm to 70 μm, 40 μm to 70 μm, 50 μm to 70 μm, 60 μm to 70 μm, 20 μm to 60 μm, 30 μm to 60 μm, 40 μm to 60 μm, 50 μm to 60 μm, 20 μm to 50 μm, 30 μm to 50 μm, 40 μm to 50 μm, 20 μm to 40 μm, 30 μm to 40 μm, or 20 μm to 30 μm).

In some cases, a particle channel (e.g., the first channel) may intersect one or more side-channels (e.g., a first side-channel and optionally a second side-channel). In the devices and systems of the invention including a first side-channel, the first side-channel has a first side-channel depth, a first side-channel width, a first side-channel proximal end, and a first side-channel distal end. The first side-channel proximal end is fluidically connected to the first channel at a first proximal intersection between the first proximal end and the first distal end, and the first side-channel distal end is fluidically connected to the first channel at a first distal intersection between the first proximal intersection and the first distal end. The first side-channel includes a proximal end including one or more first side-channel inlets, and the first side-channel distal end includes one or more first side-channel outlets. The first side-channel may further include a first side-channel reservoir configured for holding a liquid. The first side-channel may be sized at its inlet to substantially prevent ingress of particles from the first channel. Accordingly, each of the one or more first side-channel inlets may have at least one dimension smaller than the smaller of the first depth and the first width. Each of the one or more first side-channel outlets may have at least one dimension smaller than the smaller of the first depth and the first width. For example, the first side-channel depth may be at least 25% (e.g., at least 50%) smaller than the first depth. Alternatively, the first side-channel may include a filter at its inlet and optionally at its outlet. The filter may be a row of spaced pegs disposed across the first side-channel inlet.

Additionally, in the devices and systems of the invention including a second side-channel, the second side-channel has a second side-channel depth, a second side-channel width, a second side-channel proximal end, and a second side-channel distal end. When the device or system of the invention includes the second side-channel, the second side-channel proximal end is fluidically connected to the first channel at a second proximal intersection between the first proximal end and the first distal end, and the second side-channel distal end is fluidically connected to the first channel at a second distal intersection between the second proximal intersection and the first distal end. The second side-channel optionally includes a reservoir configured for holding a liquid. Preferably, the first proximal intersection is substantially opposite the second proximal intersection. Also preferably, the first distal intersection is substantially opposite the second distal intersection. The arrangement of first and second (e.g., proximal and/or distal) intersections being substantially opposite each other may be particularly advantageous for reducing the amount of excess liquid between consecutive particles or for reducing the bunching of consecutive particles. The second side-channel at its inlet may further include a second side-channel reservoir configured for holding a liquid. The second side-channel may be sized to substantially prevent ingress of particles from the first channel. Accordingly, each of the one or more second side-channel inlets may have at least one dimension smaller than the smaller of the first depth and the first width. Each of the one or more second side-channel outlets may have at least one dimension smaller than the smaller of the first depth and the first width. For example, the second side-channel depth may be at least 25% (e.g., at least 50%) smaller than the first depth. Alternatively, the second side-channel may include a filter at its inlet and optionally at its outlet. The filter may be a row of spaced pegs disposed across the second side-channel inlet.

The side-channel reservoirs (e.g., the first side-channel reservoir and/or the second side-channel reservoir), when present, may be configured for controlling pressure in the side-channels to improve control over spacing between particles, thereby further enhancing droplet-to-droplet content uniformity (e.g., uniformity in the number of particles from the same source (e.g., of the same kind)). For example, a third liquid may be included in the side-channel reservoir, and the amount of the third liquid may control the pressure in the side-channels. Alternatively, the pressure control in the side-channel may be active or passive. Pressure control may be achieved using channel reservoirs. For example, the channel pressure may be passively controlled by controlling the amount of liquid in a reservoir, as the height level of the liquid may control the hydrostatic pressure exerted on the channel. Alternatively, the channel pressure may be actively controlled using a pump connected to the reservoir such that the pump applies a predetermined pressure to the liquid in the reservoir.

Additionally or alternatively, devices and systems of the invention may include one or more second channels having a second depth, a second width, a second proximal end, and a second distal end. Each of the first proximal end and second proximal ends are or are configured to be in fluid communication with, e.g., fluidically connected to, a source of liquid, e.g., a reservoir integral to the device or coupled to the device, e.g., by tubing. A second channel may or may not intersect the first channel. Liquids flowing in the first and second channels may combine in the device, e.g., at an intersection of the channels, or at a shelf region or step region connected to the distal ends of the channels. In non-intersecting embodiments, the distal ends of the first and second channels may be disposed adjacent one another so that liquid exiting the channels can contact and combine.

Devices of the invention may also include delay lines, e.g., channels or portions of channels that allow for different channels on the device to have about the same fluidic resistance. For example, planarity of a channel system may make it difficult to ensure that channels desired to have the same fluidic resistance are the same length. Accordingly, a channel that would otherwise be shorter may include turns or bends to increase the length of the channel.

The inclusion of one or more intersection channels allows for splitting liquid from the first channel or introduction of liquids into the first channel, e.g., that combine with the liquid in the first channel or do not combine with the liquid in the first channel, e.g., to form a sheath flow. Channels can intersect the first channel at any suitable angle, e.g., between 5° and 135° relative to the centerline of the first channel, such as between 75° and 115° or 85° and 95°. Additional channels may similarly be present to allow introduction of further liquids or additional flows of the same liquid. Multiple channels can intersect the first channel on the same side or different sides of the first channel. When multiple channels intersect on different sides, the channels may intersect along the length of the first channel to allow liquid introduction at the same point. Alternatively, channels may intersect at different points along the length of the first channel. In some instances, a channel configured to direct a liquid comprising a plurality of particles may comprise one or more grooves in one or more surface of the channel to direct the plurality of particles towards the droplet formation fluidic connection. For example, such guidance may increase single occupancy rates of the generated droplets. These additional channels may have any of the structural features discussed above for the first channel.

The first channel (e.g., particle channel) in the devices, kits, systems, and methods of the invention may be bifurcated into two downstream first channels. The two downstream first channels may be in fluid communication with, e.g., fluidically connected to, one or more droplet formation regions. The downstream first channels may be curved. The bifurcation of the first channel may improve the droplet formation robustness by reducing the number of consecutive particles entering the same downstream first channel. Without wishing to be bound by theory, it is believed that a particle entering one downstream first channel at the first channel bifurcation will cause fluid resistance behind it, thereby directing the subsequent particle to enter the other one of the two downstream first channels. Accordingly, a particle stream propagating through the first channel is expected to divide into two streams with particles entering the two downstream first channels in an alternating manner.

Devices may include multiple first channels, e.g., to increase the rate of droplet formation. In general, throughput may significantly increase by increasing the number of droplet formation regions of a device. For example, a device having five droplet formation regions may generate five times as many droplets simultaneously relative to a device having one droplet formation region, provided that the liquid flow rate is substantially the same. A device may have as many droplet formation regions as is practical and allowed for the size of the source of liquid, e.g., reservoir. For example, the device may have at least about 2, 3, 4, 5, 6, 7, 8, 9, 10, 20, 30, 40, 50, 60, 70, 80, 90, 100, 150, 200, 250, 300, 350, 400, 450, 500, 600, 700, 800, 900, 1000, 1500, 2000 or more droplet formation regions. Inclusion of multiple droplet formation regions may require the inclusion of channels that traverse but do not intersect, e.g., the flow path is in a different plane. Multiple first channel may be in fluid communication with, e.g., fluidically connected to, a separate source reservoir and/or a separate droplet formation region. In other embodiments, two or more first channels are in fluid communication with, e.g., fluidically connected to, the same fluid source, e.g., where the multiple first channels branch from a single, upstream channel. The droplet formation region may include a plurality of inlets in fluid communication with the first proximal end and a plurality of outlets (e.g., plurality of outlets in fluid communication with a collection region) (e.g., fluidically connected to the first proximal end and in fluid communication with a plurality of outlets). The number of inlets and the number of outlets in the droplet formation region may be the same (e.g., there may be 3-10 inlets and/or 3-10 outlets). Alternatively or in addition, the throughput of droplet formation can be increased by increasing the flow rate of the first liquid, third liquid (when present), and/or fourth liquid (when present). In some cases, the throughput of droplet formation can be increased by having a plurality of single droplet forming devices, e.g., devices with a first channel and a droplet formation region, in a single device, e.g., parallel droplet formation.

In certain preferred embodiments, the droplet formation region is a multiplexed droplet formation region having a width that is at least five times greater (e.g., at least 6 times greater, at least 7 times greater, at least 8 times greater, at least 9 times greater, at least 10 times greater, at least 15 times greater, at least 20 times greater, at least 25 times greater, at least 30 times greater, or at least 40 time greater; e.g., 5 to 50 times greater, 10 to 50 times greater, or 15 to 50 times greater) than the combined widths of the channel outlets fluidically connected to the droplet formation region. The length of the shelf region may be greater than the width of a single first channel outlet by at least 100% (e.g., at least 200%, at least 300%, at least 400%, at least 500%, at least 600%, at least 700%, at least 800%, at least 900%, at least 1000%, at least 1400%, at least 1500%, at least 1900%, or at least 2000%). The length of the shelf region may be greater than the width of a single first channel outlet by 2000% or less (e.g., by 1500% or less, 1000% or less, 900% or less, 800% or less, 700% or less, or 600% or less). For example, the shelf region length may be 100% to 2000% (e.g., 100% to 200%, 100% to 300%, 100% to 400%, 100% to 500%, 100% to 600%, 100% to 700%, 100% to 800%, 100% to 900%, 100% to 1000%, 100% to 1500%, 100% to 2000%, 200% to 300%, 200% to 400%, 200% to 500%, 200% to 600%, 200% to 700%, 200% to 800%, 200% to 900%, 200% to 1000%, 200% to 1500%, 200% to 2000%, 300% to 400%, 300% to 500%, 300% to 600%, 300% to 700%, 300% to 800%, 300% to 900%, 300% to 1000%, 300% to 1500%, 300% to 2000%, 400% to 500%, 400% to 600%, 400% to 700%, 400% to 800%, 400% to 900%, 400% to 1000%, 400% to 1500%, 400% to 2000%, 500% to 600%, 500% to 700%, 500% to 800%, 500% to 900%, 500% to 1000%, 500% to 1500%, 500% to 2000%, 600% to 700%, 600% to 800%, 600% to 900%, 600% to 1000%, 600% to 1500%, 600% to 2000%, 700% to 500%, 700% to 600%, 700% to 700%, 700% to 800%, 700% to 900%, 700% to 1000%, 700% to 1500%, or 700% to 2000%) of the width of a single first channel outlet. The droplet formation region may occupy at least 5% (e.g., at least 10%, at least 15%, at least 20%, at least 25%, or at least 30%) of the perimeter of the droplet collection region. The droplet formation region may occupy 75% or less (e.g., 70% or less, 60% or less, 50% or less, or 40% or less) of the perimeter of the droplet collection region. For example, the droplet formation region may occupy 5% to 75% (e.g., 5% to 70%, 5% to 60%, 5% to 50%, 5% to 40%, 10% to 70%, 10% to 60%, 10% to 50%, 10% to 40%, 15% to 70%, 15% to 60%, 15% to 50%, 15% to 40%, 20% to 70%, 20% to 60%, 20% to 50%, 20% to 40%, 25% to 70%, 25% to 60%, 25% to 50%, 25% to 40%, 30% to 70%, 30% to 60%, 30% to 50%, or 30% to 40%) of the perimeter of the droplet collection region.

In some preferred embodiments, the droplet formation region includes a shelf region protruding from the first channel outlet towards the droplet collection region. For example, the shelf region may be protruding into the step region. In these embodiments, the shelf region width may be twice the width of the first channel outlet or less.

The droplet formation region may include a shelf region and a row of pegs disposed along the width of the shelf region. The row of pegs may include at least 3 pegs (e.g., at least 4 pegs, at least 5 pegs, at least 6 pegs, at least 7 pegs, at least 8 pegs, at least 9 pegs, at least 10 pegs, at least 15 pegs, or at least 20 pegs; e.g., 3 to 50 pegs, 4 to 50 pegs, 5 to 50 pegs, 6 to 50 pegs, 7 to 50 pegs, 8 to 50 pegs, 9 to 50 pegs, 10 to 50 pegs, 15 to 50 pegs, 20 to 50 pegs, 3 to 40 pegs, 4 to 40 pegs, 5 to 40 pegs, 6 to 40 pegs, 7 to 40 pegs, 8 to 40 pegs, 9 to 40 pegs, 10 to 40 pegs, 15 to 40 pegs, 20 to 40 pegs, 3 to 30 pegs, 4 to 30 pegs, 5 to 30 pegs, 6 to 30 pegs, 7 to 30 pegs, 8 to 30 pegs, 9 to 30 pegs, 10 to 30 pegs, 15 to 30 pegs, or 20 to 30 pegs) for each channel outlet fluidically connected to the droplet formation region. The peg may have a width that is smaller than the width of a single first channel outlet by 75% or less (e.g., by 50% or less, by 40% or less, by 30% or less, by 20% or less, or by 10% or less). Alternatively, the peg may have a width that is greater than the width of a single first channel outlet by 500% or less (e.g., by 400% or less, by 300% or less, or by 200% or less). For example, the peg width may be 25% to 600% (e.g., 25% to 500%, 25% to 400%, 25% to 300%, 25% to 200%, 30% to 500%, 30% to 400%, 30% to 300%, 30% to 200%, 40% to 500%, 40% to 400%, 40% to 300%, 40% to 200%, 50% to 500%, 50% to 400%, 50% to 300%, or 50% to 200%) of a single first channel outlet. The peg may have a length that is at least equal to the width of the peg. Alternatively, the peg may have a length that is greater than the peg width by 500% or less (e.g., by 400% or less, by 300% or less, or by 200% or less). For example, the peg length may be 100% to 600% (e.g., 100% to 500%, 100% to 400%, 100% to 300%, or 100% to 200%) of the peg width. The pegs may be spaced in the row of pegs at a distance that is smaller than the width of a single first channel outlet by 75% or less (e.g., by 50% or less, by 40% or less, by 30% or less, by 20% or less, or by 10% or less). The pegs may be spaced in the row of pegs at a distance that is equal to the width of a single first channel outlet. For example, the spacing between pegs may be 25% to 100% (e.g., 30% to 100%, 40% to 100%, 50% to 100%, 60% to 100%, 70% to 100%, 80% to 100%, 90% to 100%, 30% to 90%, 40% to 90%, 50% to 90%, 60% to 90%, 70% to 90%, 80% to 90%, 30% to 80%, 40% to 80%, 50% to 80%, 60% to 80%, 70% to 80%, 30% to 70%, 40% to 70%, 50% to 70%, 60% to 70%, 30% to 60%, 40% to 60%, or 50% to 60%) of the width of a single first channel outlet.

The devices, kits, systems, and methods of the invention may include a mixer. The mixer may be included downstream of an intersection where two different liquids from two intersecting channels are combined.

A second channel may include a mixer, e.g., a passive mixer (e.g., a chaotic advection mixer). The mixer may be included downstream of an intersection between the second and third channels. In this configuration, a third liquid may be combined with a fourth liquid at the intersection. The combined second and third liquids may be mixed in the second channel mixer. The mixed second and third liquids may then be combined with a first liquid at an intersection between the first and second channels downstream from the mixer.

Alternatively, the first side-channel may include a mixer, e.g., a passive mixer (e.g., a chaotic advection mixer). For example, a mixer may be included in the first side-channel between an intersection of the first side-channel with the second channel and an intersection of the first side-channel with the first channel. In this configuration, a first liquid flowing through the first side-channel may be first combined with the third liquid at the intersection of the first side-channel with the second channel. The combined first and third liquids may be mixed in the first side-channel mixer and are then combined with the liquid in the first channel.

Mixers that may be included in the devices and systems of the invention are known in the art. Non-limiting examples of mixers include a herringbone mixer, connected-groove mixer, modified staggered herringbone mixer, wavy-wall channel mixer, chessboard mixer, alternate-injection mixer with an increased cross-section chamber, serpentine laminating micromixer, two-layer microchannel mixer, connected-groove micromixer, and SAR mixer. Non-limiting examples of mixers are described in Suh and Kang, Micromachines, 1:82-111, 2010; Lee et al., Int. J. Mol. Sci., 12:3263-3287, 2011; and Lee et al., Chem. Eng. J., 288:146-160, 2016. Typically, the mixer may be sized to accommodate particles passing through (e.g., biological particles, such as cells). The mixer may have a length of 2-15 mm (e.g., 2, 3, 4, 5, 6, 7, 8, 9, 10, 11, 12, 13, 14, or 15 mm).

Alternatively or additionally, the device may include one or more traps in channels. The traps may be included in channels in a configuration that permits air buoyancy to raise any bubbles away from the liquid flow. Thus, a trap typically has a trap depth that is greater than the depth of the channel, in which the trap is disposed. One of skill in the art will recognize that the terms depth and height may be used interchangeably to indicate the same dimension.

In some embodiments, the disclosure provides devices, systems, and methods for forming droplets by controlling one or more specified droplet generation parameters to provide droplets or populations of droplets with desirable properties. The invention provides a simplified process to control these parameters as described herein. The devices and systems are configured to monitor variables, such as temperature and pressure, and adjust the pressure of the liquid during droplet formation based on a temperature of the device. By adjusting pressure as a function of temperature, the methods provide populations of droplets with consistent features, such as the number of droplets produced, droplet fill ratio (e.g., number of droplets including a specified number of particles versus number of droplets not including a specified number of particles), and flow rate.

Droplets may be formed of a single liquid (e.g., aqueous phase) or multiple (e.g., 2, 3, 4, 5, or more) liquids (e.g., aqueous phases). When forming droplets with more than one liquid, e.g., to form droplets containing particles (e.g., gel beads) and/or separate reagents, the chemical composition of the liquids may be different and thus have different viscosities potentially requiring different flow rates to obtain consistent droplet formation (e.g., in rate, size, or composition). When forming droplets with particles, the number of droplets containing particles (e.g., gel beads) as compared a number that of droplets not containing particles is known as a fill ratio. The fill ratio of a droplet is dependent on variables such as flow rate and viscosity. Viscosity and flow rate are dependent on variables, such as the chemical composition of the liquid and the temperature. Thus, when producing droplets, especially from two or more liquids, it is desirable to maintain the liquids so that droplet formation is uniform. As temperature fluctuates, it can affect droplet formation, e.g., altering the viscosity of the liquids; however, it is possible to compensate for changes in the temperature by controlling the pressure of the liquids. It is desirable to control the pressure so that droplets can be produced with the same characteristics at different temperatures.

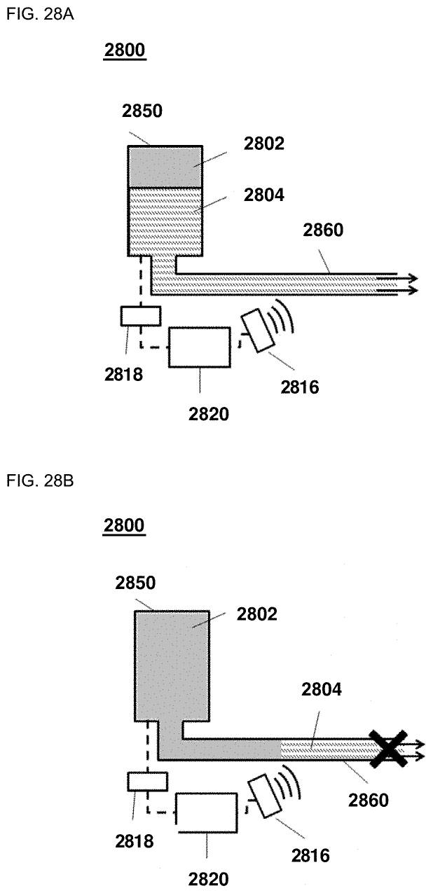

A device of the disclosure may include a first channel having a depth, a width, a proximal end, and a distal end. The proximal end is or is configured to be in fluid communication with a source of liquid, e.g., a reservoir integral to the device or coupled to the device, e.g., by tubing. The distal end is in fluid communication with, e.g., fluidically connected to, a droplet source (e.g., a droplet formation region). A droplet formation region may allow liquid from the first channel to expand in at least one dimension, leading to droplet formation under appropriate conditions as described herein. A droplet formation region can be of any suitable geometry. The device may optionally include a sorting region in fluid communication with, e.g., fluidically connected to, the droplet source (e.g., droplet formation region). The sorting region allows the droplets from the droplet source, e.g., the droplets that are formed in the droplet formation region, to be sorted according to a particular property or characteristic. The device may optionally include a detection region that may be configured to provide feedback to the sorting region, e.g., by actuating an electrode. The detection region may include a detector (e.g., a sensor) that provides a stimulus to the electrode, thereby directing the electrode to generate a force and thus sort the droplets in a particular manner. Exemplary devices configured for providing and/or forming droplets are shown in FIGS. 28-49.

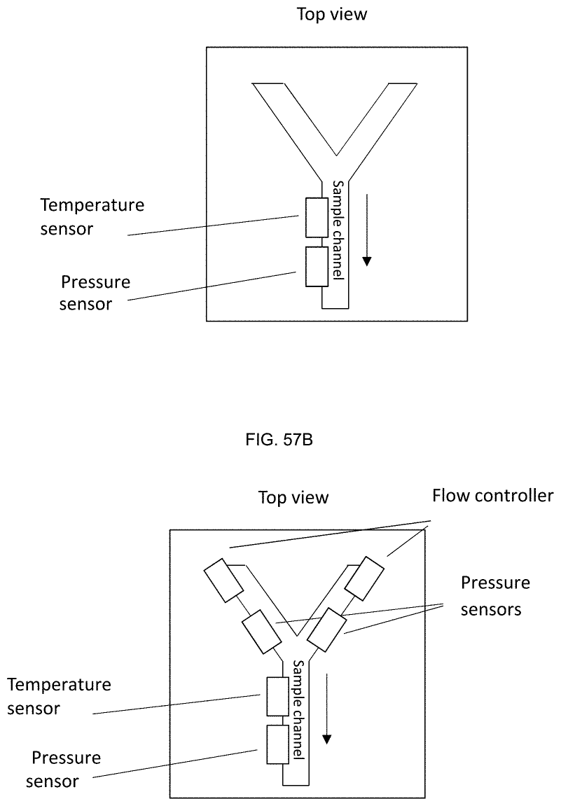

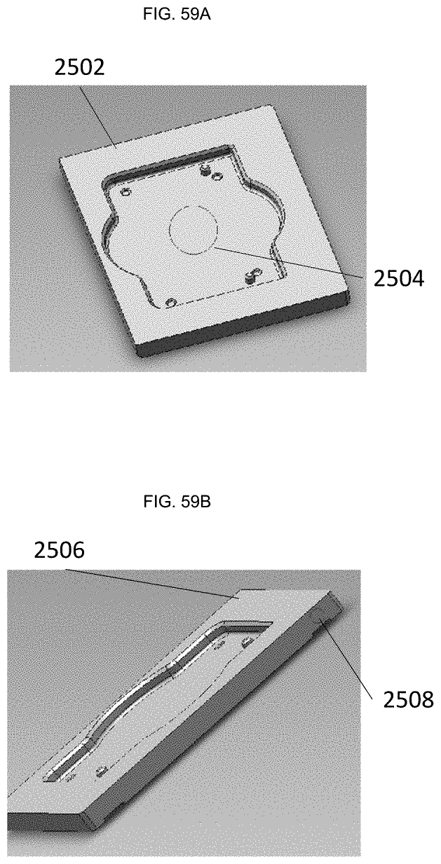

The devices described herein may include one or more (e.g., 2, 3, 4, 5, 6, 7, 8, 9, 10, or more) temperature sensors. The devices may also include one or more (e.g., 2, 3, 4, 5, 6, 7, 8, 9, 10, or more) pressure sensors. The devices may further include one or more controllers configured to adjust the flow rate (e.g., the flow rate of the first liquid or the second liquid). The devices (or systems) may also include a holder configured to hold the device in operative connection, e.g., with a pressure sensor, temperature sensor, and/or controller. The one or more temperature sensors may be a resistance temperature detector (RTD), an infrared sensor, or a thermocouple sensor. Thermocouples may be fine-wired or sheathed thermocouples. Thermocouples may include thermocouples of types B, E, J, K, N, R, S, or T. Thermocouples may have an accuracy of about 0.01K, about 0.02K, about 0.03K, about 0.04K, about 0.05K, about 0.06K, about 0.07K, about 0.08K, about 0.09K, about 0.1K, about 0.2K, about 0.3K, about 0.4K, about 0.5K, about 0.6K, about 0.7K, about 0.8K, about 0.9K, or about 1.0K. Thermocouples may be capable of a sampling rate of about 0.1 Hz, about 0.2 Hz, about 0.3 Hz, about 0.4 Hz, about 0.5 Hz, about 1.0 Hz, about 2.0 Hz, about 3.0 Hz, about 4.0 Hz, about 5.0 Hz, about 6.0 Hz, about 7.0 Hz, about 8.0 Hz, about 9.0 Hz, about 10.0 Hz, about 15 Hz, about 20 Hz, about 30 Hz, about 40 Hz, about 50 Hz, about 60 Hz, about 70 Hz, about 80 Hz, about 90 Hz, about 100 Hz, about 200 Hz, about 300 Hz, about 400 Hz, about 500 Hz, about 600 Hz, about 700 Hz, about 800 Hz, about 900 Hz, or about 1000 Hz. The one or more temperature sensors may be positioned at any location suitable to provide an accurate temperature measurement. The temperature sensor may be positioned within the device, on the surface of the device, or adjacent to the device (FIGS. 57A-57B and 59A-59B). For example, the temperature sensor may be positioned between the holder and the device. The one or more pressure sensors may also be positioned at any location suitable to provide an accurate pressure measurement. The pressure sensor may be located within the device or adjacent to the device. The pressure sensor may be located within or near the channel or reservoir of the liquid for which the pressure measurement is being obtained.

Temperature sensors (e.g., thermocouples) may be located as appropriate to obtain accurate temperature information for droplet formation. In one particular embodiment, depicted in FIG. 59A, a thermocouple may pass through the body of a device holder and be located at the surface (e.g., at 2504) of a device support structure 2502. In another embodiment, shown in FIG. 59B, a thermocouple may be embedded within the body (e.g., at 2508) of a device support structure 2506. In some embodiments, the system may include multiple thermocouples. Such a configuration may be useful for non-isothermal systems.

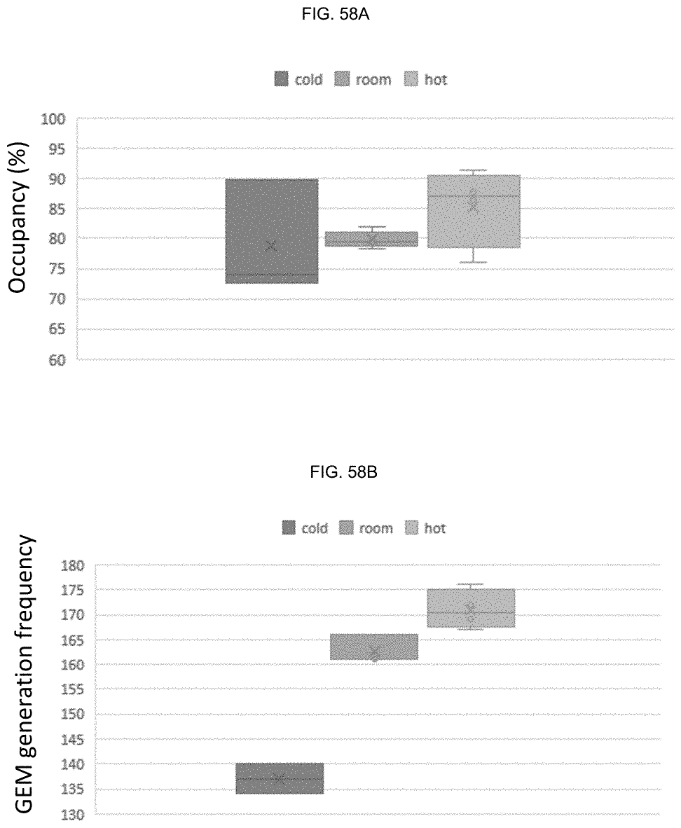

A device or system described herein may exist in different thermal regimes. In some embodiments, the device or system may be isothermal over the course of a run. In other embodiments, the device or system may be non-isothermal over the course of the run. An understanding of the temperature of the device is important for maintaining conditions for droplet formation. FIGS. 58A-58B show the effects that a relatively minor change in temperature can have on the overall rate of droplet occupancy and droplet formation frequency, as well as the data variability. For example, FIG. 58A shows the respective ranges of single occupancy rates of droplet formation at cold temperature (relative to room, at 18° C.), room temperature, and at hot temperature (relative to room, at 28° C.). FIG. 58B shows the respective ranges of droplet formation frequency (e.g., of singly occupied droplets, such as with a bead) at cold temperature (relative to room, at 18° C.), room temperature, and at hot temperature (relative to room, at 28° C.). Temperature changes may be produced by the operation of the device or by changes in the ambient environment of the instrument. In some aspects, the device or system may have a temperature of about 5° C. to about 100° C. (e.g., about 5° C. to about 90° C., about 10 to about 80° C., about 10° C. to about 50° C., about 10° C. to about 25° C., about 12° C. to about 22° C., about 15° C. to about 22° C., about 18° C. to about 22° C., e.g., about 10° C., 15° C., 20° C., 25° C., 30° C., 35° C., 40° C., 45° C., 50° C., 55° C., 60° C., 65° C., 70° C., 75° C., 80° C., 85° C., 90° C., 95° C., or 100° C.).

Droplets may be formed in a device by flowing a first liquid through a channel and into a droplet formation region including a second liquid, i.e., the continuous phase, which may or may not be externally driven. Thus, droplets can be formed without the need for externally driving the second liquid. The size of the generated droplets is significantly less sensitive to changes in liquid properties. For example, the size of the generated droplets is less sensitive to the dispersed phase flow rate. Adding multiple formation regions is also significantly easier from a layout and manufacturing standpoint. The addition of further formation regions allows for formation of droplets even in the event that one droplet formation region becomes blocked. Droplet formation can be controlled by adjusting one or more geometric features of fluidic channel architecture, such as a width, depth, and/or expansion angle of one or more fluidic channels. For example, droplet size and speed of droplet formation may be controlled. In some instances, the number of regions of formation at a driven pressure can be increased to increase the throughput of droplet formation.

Droplets may be formed by any suitable method known in the art. In general, droplet formation includes two liquid phases. The two phases may be, for example, an aqueous phase and an oil phase. During droplet formation, a plurality of discrete volume droplets are formed.

The droplets may be formed by shaking or stirring a liquid to form individual droplets, creating a suspension or an emulsion containing individual droplets, or forming the droplets through pipetting techniques, e.g., with needles, or the like. The droplets may be formed made using a micro-, or nanofluidic droplet maker. Examples of such droplet makers include, e.g., a T-junction droplet maker, a Y-junction droplet maker, a channel-within-a-channel junction droplet maker, a cross (or “X”) junction droplet maker, a flow-focusing junction droplet maker, a micro-capillary droplet maker (e.g., co-flow or flow-focus), and a three-dimensional droplet maker. The droplets may be produced using a flow-focusing device, or with emulsification systems, such as homogenization, membrane emulsification, shear cell emulsification, and fluidic emulsification.

Discrete liquid droplets may be encapsulated by a carrier fluid that wets the microchannel. These droplets, sometimes known as plugs, form the dispersed phase in which the reactions occur. Systems that use plugs differ from segmented-flow injection analysis in that reagents in plugs do not come into contact with the microchannel. In T junctions, the disperse phase and the continuous phase are injected from two branches of the “T”. Droplets of the disperse phase are produced as a result of the shear force and interfacial tension at the fluid-fluid interface. The phase that has lower interfacial tension with the channel wall is the continuous phase. To generate droplets in a flow-focusing configuration, the continuous phase is injected through two outside channels and the disperse phase is injected through a central channel into a narrow orifice. Other geometric designs to create droplets would be known to one of skill in the art. Methods of producing droplets are disclosed in Song et al. Angew. Chem. 45: 7336-7356, 2006, Mazutis et al. Nat. Protoc. 8(5):870-891, 2013, U.S. Pat. No. 9,839,911; U.S. Pub. Nos. 2005/0172476, 2006/0163385, and 2007/0003442, PCT Pub. Nos. WO 2009/005680 and WO 2018/009766. In some cases, electric fields or acoustic waves may be used to produce droplets, e.g., as described in PCT Pub. No. WO 2018/009766.

In some cases, a droplet formation region may allow liquid from the first channel to expand in at least one dimension, leading to droplet formation under appropriate conditions as described herein. A droplet formation region can be of any suitable geometry. In one embodiment, the droplet formation region includes a shelf region that allows liquid to expand substantially in one dimension, e.g., perpendicular to the direction of flow. The width of the shelf region is greater than the width of the first channel at its distal end. In certain embodiments, the first channel is a channel distinct from a shelf region, e.g., the shelf region widens or widens at a steeper slope or curvature than the distal end of the first channel. In other embodiments, the first channel and shelf region are merged into a continuous flow path, e.g., one that widens linearly or non-linearly from its proximal end to its distal end; in these embodiments, the distal end of the first channel can be considered to be an arbitrary point along the merged first channel and shelf region. In another embodiment, the droplet formation region includes a step region, which provides a spatial displacement and allows the liquid to expand in more than one dimension. The spatial displacement may be upward or downward or both relative to the channel. The choice of direction may be made based on the relative density of the dispersed and continuous phases, with an upward step employed when the dispersed phase is less dense than the continuous phase and a downward step employed when the dispersed phase is denser than the continuous phase. Droplet formation regions may also include combinations of a shelf and a step region, e.g., with the shelf region disposed between the channel and the step region.

Without wishing to be bound by theory, droplets of a first liquid can be formed in a second liquid in the devices of the invention by flow of the first liquid from the distal end into the droplet formation region. In embodiments with a shelf region and a step region, the stream of first liquid expands laterally into a disk-like shape in the shelf region. As the stream of first liquid continues to flow across the shelf region, the stream passes into the step region wherein the droplet assumes a more spherical shape and eventually detaches from the liquid stream. As the droplet is forming, passive flow of the continuous phase around the nascent droplet occurs, e.g., into the shelf region, where it reforms the continuous phase as the droplet separates from its liquid stream. Droplet formation by this mechanism can occur without externally driving the continuous phase, unlike in other systems. It will be understood that the continuous phase may be externally driven during droplet formation, e.g., by gently stirring or vibration but such motion is not necessary for droplet formation.

Passive flow of the continuous phase may occur simply around the nascent droplet. The droplet formation region may also include one or more channels that allow for flow of the continuous phase to a location between the distal end of the first channel and the bulk of the nascent droplet. These channels allow for the continuous phase to flow behind a nascent droplet, which modifies (e.g., increase or decreases) the rate of droplet formation. Such channels may be fluidically connected to a reservoir of the droplet formation region or to different reservoirs of the continuous phase. Although externally driving the continuous phase is not necessary, external driving may be employed, e.g., to pump continuous phase into the droplet formation region via additional channels. Such additional channels may be to one or both lateral sides of the nascent droplet or above or below the plane of the nascent droplet.

The width of a shelf region may be from 0.1 μm to 1000 μm (e.g., 5 to 1000 μm). In particular embodiments, the width of the shelf is from 1 to 750 μm, 10 to 500 μm, 10 to 250 μm, or 10 to 150 μm. In certain embodiments, the width of the shelf region is from 100 to 750 μm, 150 to 700 μm, or 200 to 700 μm. The shelf region width may be greater than the first channel width by, e.g., at least 10%. The shelf region width may be greater than the first channel width by, e.g., 100000% or less. For example, the shelf region width may be greater than the first channel width by 10% to 100000% (e.g., 100% to 100000%, 200% to 100000%, 100% to 50000%, 200% to 50000%, 100% to 20000%, or 200% to 20000%). The width of the shelf region may be constant along its length, e.g., forming a rectangular shape. Alternatively, the width of the shelf region may increase along its length away from the distal end of the first channel. For example, the width of the shelf region inlet may be fluidically connected to the distal end of the first channel, and the shelf region inlet width may be equal to the first channel width. This increase may be linear, nonlinear, or a combination thereof. In certain embodiments, the shelf widens 5% to 10,000%, e.g., at least 300%, (e.g., 10% to 500%, 100% to 750%, 300% to 1000%, or 500% to 1000%) relative to the width of the distal end of the first channel. The depth of the shelf can be the same as or different from the first channel. For example, the bottom of the first channel at its distal end and the bottom of the shelf region may be coplanar. Alternatively, a step or ramp may be present where the distal end meets the shelf region. The depth of the distal end may also be greater than the shelf region, such that the first channel forms a notch in the shelf region. The depth of the shelf may be from 0.1 to 1000 μm, e.g., 1 to 750 μm, 1 to 500 μm, 1 to 250 μm, 1 to 100 μm, 1 to 50 μm, or 3 to 40 μm. The depth of a shelf may be, e.g., from 5 μm to 200 μm (e.g., 10 to 200 μm, 20 to 200 μm, 30 to 200 μm, 40 to 200 μm, 50 to 200 μm, 75 to 200 μm, 100 to 200 μm, 10 to 150 μm, 20 to 150 μm, 30 to 150 μm, 40 to 150 μm, 50 to 150 μm, 75 to 150 μm, 100 to 150 μm, 10 to 100 μm, 20 to 100 μm, 30 to 100 μm, 40 to 100 μm, 50 to 100 μm, 75 to 100 μm, 10 to 75 μm, 20 to 75 μm, 30 to 75 μm, 40 to 75 μm, 50 to 75 μm, 10 to 50 μm, 20 to 50 μm, 30 to 50 μm, or 40 to 50 μm). In certain preferred embodiments, the depth of the shelf may be 5 to 200 μm (e.g., 10 to 50 μm). In some embodiments, the depth is substantially constant along the length of the shelf. Alternatively, the depth of the shelf slopes, e.g., downward or upward, from the distal end of the liquid channel to the step region. The final depth of the sloped shelf may be, for example, from 5% to 1000% greater than the shortest depth, e.g., 10 to 750%, 10 to 500%, 50 to 500%, 60 to 250%, 70 to 200%, or 100 to 150%. The overall length of the shelf region may be from at least about 0.1 μm to about 1000 μm, e.g., 0.1 to 750 μm, 0.1 to 500 μm, 0.1 to 250 μm, 0.1 to 150 μm, 1 to 150 μm, 10 to 150 μm, 50 to 150 μm, 100 to 150 μm, 10 to 80 μm, or 10 to 50 μm.

In certain embodiments, the length of the shelf may be 5 to 1000 μm (e.g., 20 to 1000 μm, 100 to 1000 μm, 300 to 1000 μm, 500 to 1000 μm, 700 to 1000 μm, 900 to 1000 μm, 20 to 500 μm, 100 to 500 μm, 300 to 500 μm, 20 to 100 μm, 50 to 100 μm, 75 to 100 μm, or 90 to 100 μm). In certain embodiments, the lateral walls of the shelf region, i.e., those defining the width, may be not parallel to one another. In other embodiments, the walls of the shelf region may narrower from the distal end of the first channel towards the step region. For example, the width of the shelf region adjacent the distal end of the first channel may be sufficiently large to support droplet formation. In other embodiments, the shelf region is not substantially rectangular, e.g., not rectangular or not rectangular with rounded or chamfered corners. In some embodiments, the shelf region has rounded corners. In some embodiments, the shelf region has rounded corners at the shelf region outlet (e.g., at the interface between the shelf region and the step region). In some embodiments, the shelf region has rounded corners at the shelf region inlet (e.g., at the interface between the shelf region and the first channel). The rounded corners may have a radius of 100 μm or less (e.g., 1 to 100 μm, 10 to 100 μm, 20 to 100 μm, 30 to 100 μm, 40 to 100 μm, 50 to 100 μm, 60 to 100 μm, 70 to 100 μm, 80 to 100 μm, 90 to 100 μm, 1 to 75 μm, 10 to 75 μm, 20 to 75 μm, 30 to 75 μm, 40 to 75 μm, 50 to 75 μm, 60 to 75 μm, 70 to 75 μm, 1 to 50 μm, 10 to 50 μm, 20 to 50 μm, 30 to 50 μm, or 40 to 50 μm). The shelf may be oriented so that the width of the shelf is greater than the width of the distal end of the first channel, or it may be oriented so the depth of the shelf is greater that the width and greater than the width of the distal end of the first channel. A shelf may also include a central portion and two peripheral portions on either side, with the depth of the central portion being less than the depths of the peripheral portions. In some embodiments, the central portion width may be from 0.0001% to 100% of the width of the shelf (e.g., 0.5% to 15% (e.g., about 1%, 2%, 3%, 4%, 5%, 6%, 7%, 8%, 9%, 10%, 11%, 12%, 13%, 14%, or 15%), 10% to 25% (e.g., about 10%, 11%, 12%, 13%, 14%, 15%, 16%, 17%, 18%, 19%, 20%, 21%, 22%, 23%, 24%, or 25%), 20% to 35% (e.g., about 20%, 21%, 22%, 23%, 24%, 25%, 26%, 27%, 28%, 29%, 30%, 31%, 32%, 33%, 34%, or 35%), 30% to 45% (e.g., about 30%, 31%, 32%, 33%, 34%, 35%, 36%, 37%, 38%, 39%, 40%, 41%, 42%, 43%, 44%, or 45%), 40% to 55% (e.g., about 40%, 41%, 42%, 43%, 44%, 45%, 46%, 47%, 48%, 49%, 50%, 51%, 52%, 53%, 54%, or 55%), 50% to 65% (e.g., about 50%, 51%, 52%, 53%, 54%, 55%, 56%, 57%, 58%, 59%, 60%, 61%, 62%, 63%, 64%, or 65%), 60% to 75% (e.g., about 60%, 61%, 62%, 63%, 64%, 65%, 66%, 67%, 68%, 69%, 70%, 71%, 72%, 73%, 74%, or 75%), 70% to 85% (e.g., about 70%, 71%, 72%, 73%, 74%, 75%, 76%, 77%, 78%, 79%, 80%, 81%, 82%, 83%, 84%, or 85%), 80% to 95% (e.g., about 80%, 81%, 82%, 83%, 84%, 85%, 86%, 87%, 88%, 89%, 90%, 91%, 92%, 93%, 94%, or 95%), 85% to 99.99% (e.g., about 85%, 86%, 87%, 88%, 89%, 90%, 91%, 92%, 93%, 94%, 95%, 96%, 97%, 98%, 99%, or 99.99%), 0.5% to 25%, 25% to 50%, 50% to 75%, or 75% to 99.99%).

A step region includes a spatial displacement (e.g., depth). The displacement may be formed by a wall. Typically, this displacement occurs at an angle of approximately 90°, e.g., between 85° and 95°. Other angles are possible, e.g., 10-90°, e.g., 20 to 90°, 45 to 90°, or 70 to 90°. The spatial displacement of the step region may be any suitable size to be accommodated on a device, as the ultimate extent of displacement does not affect performance of the device. Preferably the displacement is several times the diameter of the droplet being formed. In certain embodiments, the displacement is from about 1 μm to about 10 cm, e.g., 20 to 1000 μm or 20 to 500 μm or at least 10 μm, at least 40 μm, at least 100 μm, or at least 500 μm, e.g., 40 μm to 600 μm. In some embodiments, the displacement is at least 40 μm, at least 45 μm, at least 50 μm, at least 55 μm, at least 60 μm, at least 65 μm, at least 70 μm, at least 75 μm, at least 80 μm, at least 85 μm, at least 90 μm, at least 95 μm, at least 100 μm, at least 110 μm, at least 120 μm, at least 130 μm, at least 140 μm, at least 150 μm, at least 160 μm, at least 170 μm, at least 180 μm, at least 190 μm, at least 200 μm, at least 220 μm, at least 240 μm, at least 260 μm, at least 280 μm, at least 300 μm, at least 320 μm, at least 340 μm, at least 360 μm, at least 380 μm, at least 400 μm, at least 420 μm, at least 440 μm, at least 460 μm, at least 480 μm, at least 500 μm, at least 520 μm, at least 540 μm, at least 560 μm, at least 580 μm, at least 600 μm, at least 700 μm, at least 800 μm, at least 900 μm, or at least 1000 μm. In some cases, the depth of the step region is substantially constant. Alternatively, the depth of the step region may increase away from the shelf region, e.g., to allow droplets that sink or float to roll away from the spatial displacement as they are formed. The step region may also increase in depth in two dimensions relative to the shelf region, e.g., both above and below the plane of the shelf region. The reservoir may have an inlet and/or an outlet for the addition of continuous phase, flow of continuous phase, or removal of the continuous phase and/or droplets. The step may be part of a wall of a reservoir, e.g., collection reservoir. The depth of the step may be greater than that of the channel and the shelf. The step may form an edge at the connection with the shelf. Alternatively, the step and shelf may connect via a curved wall. The depth of the first channel may be greater than the depth of the shelf but less than the depth of the step. In one embodiment, the depth of the first channel increases at the intersection with a second channel (e.g., by about 5-500%, e.g., about 10-100%, about 50 to 200%, about 100 to 300%, or about 250-500%) and optionally then decreases at the distal end (e.g., by about 95-5%, about 90-10%, about 90 to 50%, or about 50 to 10%). In these embodiments, the depth of the shelf may be less that the diameter of a particle transported to the droplet formation region. In embodiments, the depth of the first channel is greater that the depth of the shelf and less than the depth of the step.

While dimension of the devices may be described as width or depths, the channels, shelf regions, and step regions may be disposed in any plane. For example, the width of the shelf may be in the x-y plane, the x-z plane, the y-z plane or any plane therebetween. In addition, a droplet formation region, e.g., including a shelf region, may be laterally spaced in the x-y plane relative to the first channel or located above or below the first channel. Similarly, a droplet formation region, e.g., including a step region, may be laterally spaced in the x-y plane, e.g., relative to a shelf region or located above or below a shelf region. The spatial displacement in a step region may be oriented in any plane suitable to allow the nascent droplet to form a spherical shape. The fluidic components may also be in different planes so long as connectivity and other dimensional requirements are met.

The device may also include a reservoir for collecting droplets formed in the droplet formation region. The collection reservoir includes two volumes, e.g., a first volume and a second volume. The first volume is sufficient to allow a droplet to form without contacting the second volume. Droplets then pass from the droplet formation region to the first volume and into the second volume after formation.

The droplets being formed and collected begin to fill the second volume. As the number of droplets increases, the second volume eventually completely fills with droplets, and droplets begin to collect in the first volume. So long as a certain vertical distance ((z_{liquid})^{crit}) exists between the closest droplet and the droplets being formed, additional droplets can be formed without affecting the quality of the droplets. Once the collected droplets are within (z_{liquid})^{crit}, droplets being formed contact collected droplets (which is undesirable), and generally droplet production ceases prior to this stage. Once droplet formation ceases, a residual volume of continuous phase is present in the first volume. In the present invention, this residual volume is low because the first volume is only a fraction of the second volume. Thus, when droplets are removed from devices of the present invention, there is less excess continuous phase present.

In some cases, the first volume of the collection reservoir is less than 10% of the volume of the second volume, e.g., less than about 10% to about 1%, less than about 1% to about 0.1%, less than about 0.5% to about 0.05%, less than about 0.1% to about 0.01%, less than about 0.05% to about 0.005%, or less than about 0.01% to about 0.001%, e.g., less than 10%, less than 9%, less than 8%, less than 7%, less than 6%, less than 5%, less than 4%, less than 3%, less than 2%, less than 1%, less than 0.95%, less than 0.90%, less than 0.85%, less than 0.80%, less than 0.75%, less than 0.70%, less than 0.65%, less than 0.60%, less than 0.55%, less than 0.50%, less than 0.45%, less than 0.40%, less than 0.35%, less than 0.30%, less than 0.25%, less than 0.20%, less than 0.15%, less than 0.10%, less than 0.09%, less than 0.08%, less than 0.07%, less than 0.06%, less than 0.05%, less than 0.04%, less than 0.03%, less than 0.02%, less than 0.01%, less than 0.009%, less than 0.008%, less than 0.007%, less than 0.006%, less than 0.005%, less than 0.004%, less than 0.003%, less than 0.002%, or less than 0.001%.

In certain instances, the first volume of the collection reservoir has a volume of between 0.01 μL to 10 μL, e.g., about 0.01 μL to about 10 μL, e.g., about 0.1 μL to about 0.5 μL, about 0.3 μL to about 1 μL, about 0.7 μL to about 2 μL, about 1 μL to about 4 μL, about 2 μL to about 6 μL, about 4 μL to about 8 μL, or about 5 μL to about 10 μL, e.g., about 0.1 μL, about 0.2 μL, about 0.3 μL, about 0.4 μLout 0.5 μL, about 0.6 μL, about 0.7 μL, about 0.8 μL, about 0.9 μL, about 1 μL, about 1.5 μL, about 2 μL, about 2.5 μL, about 3 μL, about 3.5 μL, about 4 μL, about 4.5 μL, about 5 μL, about 5.5 μL, about 6 μL, about 6.5 μL, about 7 μL, about 7.5 μL, about 8 μL, about 8.5 μL, about 9 μL, about 9.5 μL, or about 10 μL.

In certain instances, the second volume of the collection reservoir has a volume of between 100 μL and 10,000 μL, e.g., about 100 μL to about 10,000 μL, e.g., about 100 μL to about 500 μL, about 250 μL to about 800 μL, about 500 μL to about 1000 μL, about 750 μL to about 1500 μL, about 1000 μL to about 2000 μL, about 1500 μL to about 3000 μL, about 2000 μL to about 4000 μL, about 3000 μL to about 5000 μL, about 4000 μL to about 7000 μL, about 5000 μL to about 8000 μL, about 6000 μL to about 9000 μL, or about 7000 μL to about 10,000 μL, e.g., about 100 μL, about 150 μL, about 200 μL, about 250 μL, about 300 μL, about 350 μL, about 400 μL, about 450 μL, about 500 μL, about 550 μL, about 600 μL, about 650 μL, about 700 μL, about 750 μL, about 800 μL, about 850 μL, about 900 μL, about 950 μL, about 1000 μL, about 1500 μL, about 2000 μL, about 2500 μL, about 3000 μL, about 3500 μL, about 4000 μL, about 4500 μL, about 5000 μL, about 5500 μL, about 6000 μL, about 6500 μL, about 7000 μL, about 7500 μL, about 8000 μL, about 8500 μL, about 9000 μL, about 9500 μL, or about 10,000 μL.

The first and second volumes of a collection reservoir may be characterized by a cross-sectional dimension, e.g., diameter, width, or length. In some embodiments, at least one cross-sectional dimension of the first volume is less than 50% of a corresponding cross-sectional dimension of the second volume. For example, the first volume may have a cross-sectional dimension, e.g., diameter, width, or length, that is less than 40%, 30%, 20%, 10%, 5%, 4%, 3%, 2%, 1%, 0.9%, 0.8%, 0.7%, 0.6%, 0.5%, 0.4%, 0.3%, 0.2%, 0.1%, or 0.01% of a corresponding cross-sectional dimension of the second volume. For example, the first volume has a cross-sectional dimension, e.g., diameter, width, or length, of 1 mm or less, e.g., between 1 μm and 5 mm, such as 1 μm to 1 mm, 1 μm to 750 μm, 1 μm to 500 μm, 1 μm to 400 μm, 1 μm to 300 μm, 1 μm to 200 μm, 1 μm to 100 μm, 1 μm to 75 μm, or 1 μm to 50 μm. The second volume may have a cross-sectional dimension that is between 5 mm and 20 mm.

In certain embodiments, the first volume may have a height that is between 0.02 mm to 20 mm, e.g., about 0.02 mm to about 20 mm, e.g., about 0.02 mm to about 0.1 mm, about 0.05 mm to about 0.5 mm, about 0.1 mm to about 1 mm, about 0.5 mm to about 5 mm, about 2 mm to about 10 mm, or about 7 mm to about 20 mm, e.g., about 0.02 mm, about 0.03 mm, about 0.04 mm, about 0.05 mm, about 0.06 mm, about 0.07 mm, about 0.08 mm, about 0.09 mm, about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 1.5 mm, about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, about 10 mm, about 10.5 mm, about 11 mm, about 11.5 mm, about 12 mm, about 12.5 mm, about 13 mm, about 13.5 mm, about 14 mm, about 14.5 mm, about 15 mm, about 15.5 mm, about 16 mm, about 16.5 mm, about 17 mm, about 17.5 mm, about 18 mm, about 18.5 mm, about 19 mm, about 19.5 mm, or about 20 mm.

The second volume may have a height that is between 0.1 mm to 100 mm, e.g., about 0.1 mm to about 100 mm, e.g., about 0.1 mm to about 10 mm, about 1 mm to about 20 mm, about 10 mm to about 50 mm, or about 25 mm to about 100 mm, e.g., about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 10 mm, about 15 mm, about 20 mm, about 25 mm, about 30 mm, about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, or about 100 mm.

The device may also include reservoirs for liquid reagents (e.g., a first or second liquid). For example, the device may include a reservoir for the liquid to flow in a channel, e.g., the first channel, and/or a reservoir for the liquid into which droplets are formed. In some cases, devices of the invention include a collection region, e.g., a volume for collecting formed droplets. A droplet collection region may be a reservoir that houses continuous phase or can be any other suitable structure, e.g., a channel, a shelf, a chamber, or a cavity, on or in the device. For reservoirs or other elements used in collection, the walls may be smooth and not include an orthogonal element that would impede droplet movement. For example, the walls may not include any feature that at least in part protrudes or recedes from the surface. It will be understood, however, that such elements may have a ceiling or floor. The droplets that are formed may be moved out of the path of the next droplet being formed by gravity (either upward or downward depending on the relative density of the droplet and continuous phase). Alternatively or in addition, formed droplets may be moved out of the path of the next droplet being formed by an external force applied to the liquid in the collection region, e.g., gentle stirring, flowing continuous phase, or vibration. Similarly, a reservoir for liquids to flow in additional channels, such as those intersecting the first channel may be present. A single reservoir may also be connected to multiple channels in a device, e.g., when the same liquid is to be introduced at two or more different locations in the device. Waste reservoirs or overflow reservoirs may also be included to collect waste or overflow when droplets are formed. Alternatively, the device may be configured to mate with sources of the liquids, which may be external reservoirs such as vials, tubes, or pouches. Similarly, the device may be configured to mate with a separate component that houses the reservoirs. Reservoirs may be of any appropriate size, e.g., to hold 10 μL to 500 mL, e.g., 10 μL to 300 mL, 25 μL to 10 mL, 100 μL to 1 mL, 40 μL to 300 μL, 1 mL to 10 mL, or 10 mL to 50 mL. When multiple reservoirs are present, each reservoir may have the same or a different size.

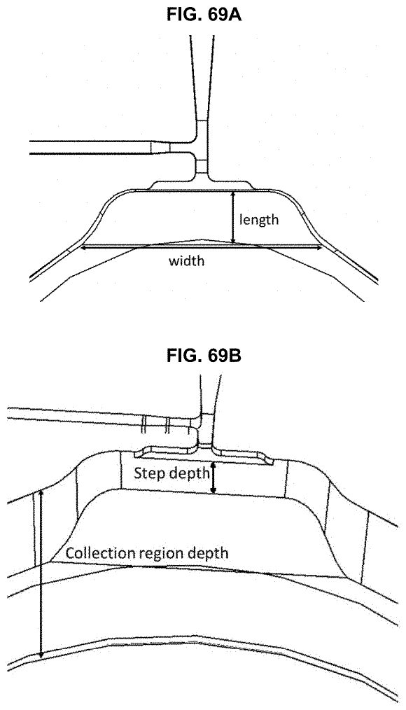

The droplet collection region may include a recess, e.g., fluidically connected to the droplet formation region (e.g., to the shelf region). The recess may have a width from 100% of the droplet formation region width to 1000% of the droplet collection region width (FIG. 69A). The recess may have recess depth, and the recess depth may be from 100% of the shelf region depth to 100% of the droplet collection region depth (FIG. 69B). In some embodiments, the recess may have a recess length. The recess length may range from 100% to 10000% of the length of the shelf region (e.g., 200% to 10000%, 500% to 10000%, 750% to 10000%, 1500% to 10000%, 2500% to 10000%, 4000% to 10000%, 6000% to 10000%, 8000% to 10000%, 9000% to 10000%, 200% to 7500%, 500% to 7500%, 750% to 7500%, 1500% to 7500%, 2500% to 7500%, 4000% to 7500%, 6000% to 7500%, 200% to 5000%, 500% to 5000%, 750% to 5000%, 1500% to 5000%, 2500% to 5000%, or 4000% to 5000%).

The droplet collection region may include one or more peripherally protruding volumes (e.g., extending therefrom). The one or more peripherally protruding volumes may have a length from 0% to 100% of the cross-sectional dimension, e.g., diameter, of the droplet collection region (e.g., 0.5% to 15% (e.g., 1%, 2%, 3%, 4%, 5%, 6%, 7%, 8%, 9%, 10%, 11%, 12%, 13%, 14%, or 15%), 10% to 25% (e.g., 10%, 11%, 12%, 13%, 14%, 15%, 16%, 17%, 18%, 19%, 20%, 21%, 22%, 23%, 24%, or 25%), 20% to 35% (20%, 21%, 22%, 23%, 24%, 25%, 26%, 27%, 28%, 29%, 30%, 31%, 32%, 33%, 34%, or 35%), 30% to 45% (e.g., 30%, 31%, 32%, 33%, 34%, 35%, 36%, 37%, 38%, 39%, 40%, 41%, 42%, 43%, 44%, or 45%), 40% to 55% (e.g., 40%, 41%, 42%, 43%, 44%, 45%, 46%, 47%, 48%, 49%, 50%, 51%, 52%, 53%, 54%, or 55%), 50% to 65% (e.g., 50%, 51%, 52%, 53%, 54%, 55%, 56%, 57%, 58%, 59%, 60%, 61%, 62%, 63%, 64%, or 65%), 60% to 75% (e.g., 60%, 61%, 62%, 63%, 64%, 65%, 66%, 67%, 68%, 69%, 70%, 71%, 72%, 73%, 74%, or 75%), 70% to 85% (e.g., 70%, 71%, 72%, 73%, 74%, 75%, 76%, 77%, 78%, 79%, 80%, 81%, 82%, 83%, 84%, or 85%), 80% to 95% (e.g., 80%, 81%, 82%, 83%, 84%, 85%, 86%, 87%, 88%, 89%, 90%, 91%, 92%, 93%, 94%, or 95%), 85% to 100% (e.g., 85%, 86%, 87%, 88%, 89%, 90%, 91%, 92%, 93%, 94%, 95%, 96%, 97%, 98%, 99%, or 100%), 0.5% to 25%, 25% to 50%, 50% to 75%, or 75% to 100%. Multiple peripherally protruding volumes may be arranged around the periphery of the droplet collection region or a single peripherally protruding volume may be arranged around the periphery.

In addition to the components discussed above, devices of the invention can include additional components. For example, channels may include filters to prevent introduction of debris into the device. In some cases, the microfluidic systems described herein may comprise one or more liquid flow units to direct the flow of one or more liquids, such as the aqueous liquid and/or the second liquid immiscible with the aqueous liquid. In some instances, the liquid flow unit may comprise a compressor to provide positive pressure at an upstream location to direct the liquid from the upstream location to flow to a downstream location. In some instances, the liquid flow unit may comprise a pump to provide negative pressure at a downstream location to direct the liquid from an upstream location to flow to the downstream location. In some instances, the liquid flow unit may comprise both a compressor and a pump, each at different locations. In some instances, the liquid flow unit may comprise different devices at different locations. The liquid flow unit may comprise an actuator. In some instances, where the second liquid is substantially stationary, the reservoir may maintain a constant pressure field at or near each droplet formation region. Devices may also include various valves to control the flow of liquids along a channel or to allow introduction or removal of liquids or droplets from the device. Suitable valves are known in the art. Valves useful for a device of the present invention include diaphragm valves, solenoid valves, pinch valves, or a combination thereof. Valves can be controlled manually, electrically, magnetically, hydraulically, pneumatically, or by a combination thereof. The device may also include integral liquid pumps or be connectable to a pump to allow for pumping in the first channels and any other channels requiring flow. Examples of pressure pumps include syringe, peristaltic, diaphragm pumps, and sources of vacuum. Other pumps can employ centrifugal or electrokinetic forces. Alternatively, liquid movement may be controlled by gravity, capillarity, or surface treatments. Multiple pumps and mechanisms for liquid movement may be employed in a single device. The device may also include one or more vents to allow pressure equalization, and one or more filters to remove particulates or other undesirable components from a liquid. The device may also include one or more inlets and or outlets, e.g., to introduce liquids and/or remove droplets. Such additional components may be actuated or monitored by one or more controllers or computers operatively coupled to the device, e.g., by being integrated with, physically connected to (mechanically or electrically), or by wired or wireless connection.

Alternatively or in addition to controlling droplet formation via microfluidic channel geometry, droplet formation may be controlled using one or more piezoelectric elements. Piezoelectric elements may be positioned inside a channel (i.e., in contact with a fluid in the channel), outside the channel (i.e., isolated from the fluid), or a combination thereof. In some cases, the piezoelectric element may be at the exit of a channel, e.g., where the channel connects to a reservoir or other channel, that serves as a droplet generation point. For example, the piezoelectric element may be integrated with the channel or coupled or otherwise fastened to the channel. Examples of fastenings include, but are not limited to, complementary threading, form-fitting pairs, hooks and loops, latches, threads, screws, staples, clips, clamps, prongs, rings, brads, rubber bands, rivets, grommets, pins, ties, snaps, adhesives (e.g., glue), tapes, vacuum, seals, magnets, or a combination thereof. In some instances, the piezoelectric element can be built into the channel. Alternatively or in addition, the piezoelectric element may be connected to a reservoir or channel or may be a component of a reservoir or channel, such as a wall. In some cases, the piezoelectric element may further include an aperture therethrough such that liquids can pass upon actuation of the piezoelectric element, or the device may include an aperture operatively coupled to the piezoelectric element.

The piezoelectric element can have various shapes and sizes. The piezoelectric element may have a shape or cross-section that is circular, triangular, square, rectangular, or partial shapes or combination of shapes thereof. The piezoelectric element can have a thickness from about 100 micrometers (μm) to about 100 millimeters (mm). The piezoelectric element can have a dimension (e.g., cross-section) of at least about 1 mm. The piezoelectric element can be formed of, for example, lead zirconate titanate, zinc oxide, barium titanate, potassium niobate, sodium tungstate, Ba₂NaNb₅O₅, and Pb₂KNb₅O₁₅. The piezoelectric element, for example, can be a piezo crystal. The piezoelectric element may contract when a voltage is applied and return to its original state when the voltage is unapplied. Alternatively, the piezoelectric element may expand when a voltage is applied and return to its original state when the voltage is unapplied. Alternatively or in addition, application of a voltage to the piezoelectric element can cause mechanical stress, vibration, bending, deformation, compression, decompression, expansion, and/or a combination thereof in its structure, and vice versa (e.g., applying some form of mechanical stress or pressure on the piezoelectric element may produce a voltage). In some instances, the piezoelectric element may include a composite of both piezoelectric material and non-piezoelectric material.

In some instances, the piezoelectric element may be in a first state when no electrical charge is applied, e.g., an equilibrium state. When an electrical charge is applied to the piezoelectric element, the piezoelectric element may bend backwards, pulling a part of the first channel outwards, and drawing in more of the first fluid into the first channel via negative pressure, such as from a reservoir of the first fluid. When the electrical charge is altered, the piezoelectric element may bend in another direction (e.g., inwards towards the contents of the channel), pushing a part of the first channel inwards, and propelling (e.g., at least partly via displacement) a volume of the first fluid, thereby generating a droplet of the first fluid in a second fluid. After the droplet is propelled, the piezoelectric element may return to the first state. The cycle can be repeated to generate more droplets. In some instances, each cycle may generate a plurality of droplets (e.g., a volume of the first fluid propelled breaks off as it enters the second fluid to form a plurality of discrete droplets). A plurality of droplets can be collected in a second channel for continued transportation to a different location (e.g., reservoir), direct harvesting, and/or storage. While the above non-limiting example describes bending of the piezoelectric element in response to application of an electrical charge, the piezoelectric may undergo or experience vibration, bending, deformation, compression, decompression, expansion, other mechanical stress and/or a combination thereof upon application of an electrical charge, which movement may be translated to the first channel. In some cases, a channel may include a plurality of piezoelectric elements working independently or cooperatively to achieve the desired formation (e.g., propelling) of droplets. For example, a first channel of a device can be coupled to at least 1, 2, 3, 4, 5, 6, 7, 8, 9, 10, 20, 30, 40, 50, 60, 70, 80, 90, 100, 200, 300, 400, or 500 piezoelectric elements. In an example, a separate piezoelectric element may be operatively coupled to (or be integrally part of) each side wall of a channel. In another example, multiple piezoelectric elements may be positioned adjacent to one another along an axis parallel to the direction of flow in the first channel. Alternatively or in addition, multiple piezoelectric elements may circumscribe the first channel. For example, a plurality of piezoelectric elements may each be in electrical communication with the same controller or one or more different controllers. The throughput of droplet generation can be increased by increasing the points of generation, such as increasing the number of junctions between first fluid channels and the second fluid channel. For example, each of the first fluid channels may comprise a piezoelectric element for controlled droplet generation at each point of generation. The piezoelectric element may be actuated to facilitate droplet formation and/or flow of the droplets.

The frequency of application of electrical charge to the piezoelectric element may be adjusted to control the speed of droplet generation. For example, the frequency of droplet generation may increase with the frequency of alternating electrical charge. Additionally, the material of the piezoelectric element, number of piezoelectric elements in the channel, the location of the piezoelectric elements, strength of the electrical charge applied, hydrodynamic forces of the respective fluids, and other factors may be adjusted to control droplet generation and/or size of the droplets generated. For example, without wishing to be bound by a particular theory, if the strength of the electrical charge applied is increased, the mechanical stress experienced by the piezoelectric element may be increased, which can increase the impact on the structural deformation of the first channel, increasing the volume of the first fluid propelled, resulting in an increased droplet size.

In a non-limiting example, the first channel can carry a first fluid (e.g., aqueous) and the second channel can carry a second fluid (e.g., oil) that is immiscible with the first fluid. The two fluids can communicate at a junction. In some instances, the first fluid in the first channel may include suspended particles. The particles may be beads, biological particles, cells, cell beads, or any combination thereof (e.g., a combination of beads and cells or a combination of beads and cell beads, etc.). A discrete droplet generated may include a particle, such as when one or more particles are suspended in the volume of the first fluid that is propelled into the second fluid. Alternatively, a discrete droplet generated may include more than one particle. Alternatively, a discrete droplet generated may not include any particles. For example, in some instances, a discrete droplet generated may contain one or more biological particles where the first fluid in the first channel includes a plurality of biological particles.

Alternatively or in addition, one or more piezoelectric elements may be used to control droplet formation acoustically.

The piezoelectric element may be operatively coupled to a first end of a buffer substrate (e.g., glass). A second end of the buffer substrate, opposite the first end, may include an acoustic lens. In some instances, the acoustic lens can have a spherical, e.g., hemispherical, cavity. In other instances, the acoustic lens can be a different shape and/or include one or more other objects for focusing acoustic waves. The second end of the buffer substrate and/or the acoustic lens can be in contact with the first fluid in the first channel. Alternatively, the piezoelectric element may be operatively coupled to a part (e.g., wall) of the first channel without an intermediary substrate. The piezoelectric element can be in electrical communication with a controller. The piezoelectric element can be responsive to (e.g., excited by) an electric voltage driven at RF frequency. In some embodiments, the piezoelectric element can be made from zinc oxide (ZnO).

The frequency that drives the electric voltage applied to the piezoelectric element may be from about 5 to about 300 megahertz (MHz). e.g., about 5 MHz, about 6 MHz, about 7 MHz, about MHz, about 9 MHz, about 10 MHz, about 20 MHz, about 30 MHz, about 40 MHz, about 50 MHz, about 60 MHz, about 70 MHz, about 80 MHz, about 90 MHz, about 100 MHz, about 110 MHz, about 120 MHz, about 130 MHz, about 140 MHz, about 150 MHz, about 160 MHz, about 170 MHz, about 180 MHz, about 190 MHz, about 200 MHz, about 210 MHz, about 220 MHz, about 230 MHz, about 240 MHz, about 250 MHz, about 260 MHz, about 270 MHz, about 280 MHz, about 290 MHz, or about 300 MHz. Alternatively, the RF energy may have a frequency range of less than about 5 MHz or greater than about 300 MHz. As will be appreciated, the necessary voltage and/or the RF frequency driving the electric voltage may change with the properties of the piezoelectric element (e.g., efficiency).

Before an electric voltage is applied to a piezoelectric element, the first fluid and the second fluid may remain separated at or near the junction via an immiscible barrier. When the electric voltage is applied to the piezoelectric element, it can generate sound waves (e.g., acoustic waves) that propagate in the buffer substrate. The buffer substrate, such as glass, can be any material that can transfer sound waves. The acoustic lens of the buffer substrate can focus the sound waves towards the immiscible interface between the two immiscible fluids. The acoustic lens may be located such that the interface is located at the focal plane of the converging beam of the sound waves. Upon impact of the sound burst on the barrier, the pressure of the sound waves may cause a volume of the first fluid to be propelled into the second fluid, thereby generating a droplet of the volume of the first fluid in the second fluid. In some instances, each propelling may generate a plurality of droplets (e.g., a volume of the first fluid propelled breaks off as it enters the second fluid to form a plurality of discrete droplets). After ejection of the droplet, the immiscible interface can return to its original state. Subsequent applications of electric voltage to the piezoelectric element can be repeated to subsequently generate more droplets. A plurality of droplets can be collected in the second channel for continued transportation to a different location (e.g., reservoir), direct harvesting, and/or storage. Beneficially, the droplets generated can have substantially uniform size, velocity (when ejected), and/or directionality.

In some cases, a device may include a plurality of piezoelectric elements working independently or cooperatively to achieve the desired formation (e.g., propelling) of droplets. For example, the first channel can be coupled to at least 1, 2, 3, 4, 5, 6, 7, 8, 9, 10, 20, 30, 40, 50, 60, 70, 80, 90, 100, 200, 300, 400, or 500 piezoelectric elements. In an example, multiple piezoelectric elements may be positioned adjacent to one another along an axis parallel of the first channel. Alternatively or in addition, multiple piezoelectric elements may circumscribe the first channel. In some instances, the plurality of piezoelectric elements may each be in electrical communication with the same controller or one or more different controllers. The plurality of piezoelectric elements may each transmit acoustic waves from the same buffer substrate or one or more different buffer substrates. In some instances, a single buffer substrate may comprise a plurality of acoustic lenses at different locations.

In some instances, the first channel may be in communication with a third channel. The third channel may carry the first fluid to the first channel such as from a reservoir of the first fluid. The third channel may include one or more piezoelectric elements, for example, as described herein in the described devices. As described elsewhere herein, the third channel may carry first fluid with one or more particles (e.g., beads, biological particles, etc.) and/or one or more reagents suspended in the fluid. Alternatively or in addition, the device may include one or more other channels communicating with the first channel and/or the second channel.

The number and duration of electric voltage pulses applied to the piezoelectric element may be adjusted to control the speed of droplet generation. For example, the frequency of droplet generation may increase with the number of electric voltage pulses. Additionally, the material and size of the piezoelectric element, material and size of the buffer substrate, material, size, and shape of the acoustic lens, number of piezoelectric elements, number of buffer substrates, number of acoustic lenses, respective locations of the one or more piezoelectric elements, respective locations of the one or more buffer substrates, respective locations of the one or more acoustic lenses, dimensions (e.g., length, width, depth, height, expansion angle) of the respective channels, level of electric voltage applied to the piezoelectric element, hydrodynamic forces of the respective fluids, and other factors may be adjusted to control droplet generation speed and/or size of the droplets generated.

A discrete droplet generated may include a particle, such as when one or more beads are suspended in the volume of the first fluid that is propelled into the second fluid. Alternatively, a discrete droplet generated may include more than one particle. Alternatively, a discrete droplet generated may not include any particles. For example, in some instances, a discrete droplet generated may contain one or more biological particles where the first fluid in the first channel further includes a suspension of a plurality of biological particles.

In some cases, the droplets formed using a piezoelectric element may be collected in a collection reservoir that is disposed below the droplet generation point. The collection reservoir may be configured to hold a source of fluid to keep the formed droplets isolated from one another. The collection reservoir used after piezoelectric or acoustic element-assisted droplet formation may contain an oil that is continuously circulated, e.g., using a paddle mixer, conveyor system, or a magnetic stir bar. Alternatively, the collection reservoir may contain one or more reagents for chemical reactions that can provide a coating on the droplets to ensure isolation, e.g., polymerization, e.g., thermal- or photo-initiated polymerization.

Sorting Region

The invention features devices that may optionally include a droplet sorting region. A droplet sorting region may be configured to sort one or more of the droplets into one or more partitions. The sorting region can be of any suitable geometry and may be, for example, a well, a channel, a reservoir, a portion thereof, or the like. The sorting region may be enclosed or not enclosed (e.g., open ended). The sorting region may be configured to sort droplets based on a particular characteristic or parameter (e.g., size, charge, composition, mass, material properties (e.g. magnetic properties, dielectric properties, acoustic properties, electrical properties), or presence/absence of a particle). The sorting mechanism may employ a force to sort the droplets to a partition in the collection region, e.g., by generating a force from the electrode to move the sorted droplet into a collection region. The sorting mechanism can employ two-way sorting (e.g., sorting the droplets into one of two different partitions) or multi-way sorting (e.g., sorting the droplets into one or three or more (e.g., 4, 5, 6, 7, 8, 9, 10, or more) partitions). A sorting region can be of any suitable geometry and may be or include, for example, a well, channel, reservoir, or portion thereof, or the like. The sorting region can be open-ended (e.g., connected to subsequent partitions, e.g., channels or reservoirs) or enclosed. The sorting region can have any length, width, and height suitable for sorting one or more droplets. For example, the length, width, and height may be at least, independently, e.g., 1 μm-10 mm (e.g., 1 μm, 2 μm, 3 μm, 4 μm, 5 μm, 6 μm, 7 μm, 8 μm, 9 μm, 10 μm, e.g., 10-100 μm, e.g., 20 μm, 30 μm, 40 μm, 50 μm, 60 μm, 70 μm, 80 μm, 90 μm, 100 μm, e.g., 100 μm-1000 μm, e.g., 200 μm, 300 μm, 400 μm, 500 μm, 600 μm, 700 μm, 800 μm, 900 μm, 1000 μm, e.g., 1 mm-10 mm, e.g., 2 mm, 3 mm, 4 mm, 5 mm, 6 mm, 7 mm, 8 mm, 9 mm, 10 mm). The sorting region may have a volume of at least, e.g., 1 nL-10 mL (e.g., 1 nL, 2 nL, 3 nL, 4 nL, 5 nL, 6 nL, 7 nL, 8 nL, 9 nL, 10 nL, e.g., 10 nL-100 nL, e.g., 20 nL, 30 nL, 40 nL, 50 nL, 60 nL, 70 nL, 80 nL, 90 nL, 100 nL, e.g., 100 nL-1 μL, e.g., 200 nL, 300 nL, 400 nL, 500 nL, 600 nL, 700 nL, 800 nL, 900 nL, 1 μL, e.g., 1 μL-10 μL, e.g., 2 μL, 3 μL, 4 μL, 5 μL, 6 μL, 7 μL, 8 μL, 9 μL, 10 μL, e.g., 10 μL-100 μL, e.g., 20 μL, 30 μL, 40 μL, 50 μL, 60 μL, 70 μL, 80 μL, 90 μL, 100 μL, e.g., 100 μL-1 mL, e.g., 200 μL, 300 μL, 400 μL, 500 μL, 600 μL, 700 μL, 800 μL, 900 μL, 1 mL, e.g., 1 mL-10 mL, e.g., 2 mL, 3 mL, 4 mL, 5 mL, 6 mL, 7 mL, 8 mL, 9 mL, 10 mL). In some embodiments, the sorting region has no cross-sectional dimension of less than 1 mm. For example, each cross-sectional dimension of the sorting region may have a length of at least 1 mm (e.g., 2 mm, 3 mm, 4 mm, 5 mm, 6 mm, 7 mm, 8 mm, 9 mm, 10 mm, or more). The mechanisms and electrodes that may be used for sorting droplets are described in more detail above.

### Collection Region

The invention provides devices that may include a collection region. A collection region includes one or more partitions to receive droplets from the sorting region and may be in fluid communication with, e.g., fluidically connected to, the sorting region. A collection region or the one or more partitions within a collection region can be of any suitable geometry and may be or include, for example, a well, channel, reservoir, or portion thereof, or the like. The collection region can be open-ended (e.g., connected to subsequent partitions, e.g., channels or reservoirs) or enclosed. The collection region may include one or more (e.g., 2, 3, 4, 5, 6, 7, 8, 9, 10, 20, 30, 40, 50, 60, 70, 80, 90, 100, 200, 300, 400, 500, 600, 700, 800, 900, 1000, or more) partitions (e.g., channels or reservoirs) configured to receive the droplets after sorting. The one or more partitions in the collection region can have any length, width, and height suitable for receiving one or more droplets. For example, the length, width, and height may be independently, e.g., 1 μm-10 mm (e.g., 1 μm, 2 μm, 3 μm, 4 μm, 5 μm, 6 μm, 7 μm, 8 μm, 9 μm, 10 μm, e.g., 10-100 μm, e.g., 20 μm, 30 μm, 40 μm, 50 μm, 60 μm, 70 μm, 80 μm, 90 μm, 100 μm, e.g., 100 μm-1 nm, e.g., 200 μm, 300 μm, 400 μm, 500 μm, 600 μm, 700 μm, 800 μm, 900 μm, 1 nm, e.g., 1 nm-10 nm, e.g., 2 nm, 3 nm, 4 nm, 5 nm, 6 nm, 7 nm, 8 nm, 9 nm, 10 nm, e.g., 10 nm-100 nm, e.g., 20 nm, 30 nm, 40 nm, 50 nm, 60 nm, 70 nm, 80 nm, 90 nm, 100 nm, e.g., 100 nm-1000 nm, e.g., 200 nm, 300 nm, 400 nm, 500 nm, 600 nm, 700 nm, 800 nm, 900 nm, 1000 nm, e.g., 1 μm-10 μm, e.g., 2 μm, 3 μm, 4 μm, 5 μm, 6 μm, 7 μm, 8 μm, 9 μm, 10 μm, e.g., 10-100 μm, e.g., 20 μm, 30 μm, 40 μm, 50 μm, 60 μm, 70 μm, 80 μm, 90 μm, 100 μm, e.g., 100 μm-1000 μm, e.g., 200 μm, 300 μm, 400 μm, 500 μm, 600 μm, 700 μm, 800 μm, 900 μm, 1000 μm, e.g., 1 mm-10 mm, e.g., 2 mm, 3 mm, 4 mm, 5 mm, 6 mm, 7 mm, 8 mm, 9 mm, 10 mm). In some embodiments, the collection region has no cross-sectional dimension of less than 1 mm. For example, each cross-sectional dimension of the collection region has a length of at least 1 mm (e.g., 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, or more). The one or more partitions may have one or more dividers between them to physically separate the sorted droplets. A divider may be any feature that can obstruct or prevent the droplets from moving into a different partition, thereby unsorting the sorted droplets. A divider may be an insert in or between partitions or may be, e.g., a hollow cylindrical or partially cylindrical insert configured to fit within a cylindrical well. For example a collection region may include multiple adjacent partitions, with each partition separated from its neighboring partition by a divider. This provides separation between the partitions so that the droplets within each partition cannot mix with the droplets in the neighboring partition, and the sorted populations of droplets are maintained as separate populations.

### Detection Region

The invention may optionally include a detection region. A detection region may be used to detect one or more droplets, for example, prior to, or following sorting. The detection region may optionally include one or more sensors that are used to detect one or more features or characteristics of a droplet. Upon sensing the presence or absence of the feature or characteristic, the one or more sensors may provide feedback to the electrode, thereby initiating a particular mode of sorting.

Upon emerging from the droplet source (e.g., a droplet formation region), a droplet tends to float or sink, depending on whether its density is less than or greater than the continuous phase. A surface (i.e., deflecting surface) in fluid communication with the droplet source deflects the droplet laterally, e.g., in the same lateral direction of egress from the droplet source. For example, as a droplet having a lower density than the continuous phase flows from the droplet source into an open volume, it rises, until the top of the droplet contacts the deflecting surface. The droplet then flows laterally along the surface until reaching the end of the surface.

The deflecting surface can position the droplets for detection by deflecting a stream of droplets to allow detection of individual droplets. For example, a detector (e.g., a microscope objective) may be substantially beneath a stream of droplets as they emerge from the droplet source. In the absence of a deflecting surface, the droplets align with the detector and overlap in the detection region, thereby obstructing a view of any single droplet. In the presence of a deflecting surface, the droplets are deflected such that individual droplets are unobstructed by the adjacent droplets. In some embodiments, the droplets flow through the detection region one-by-one.

The deflecting surface can be at any suitable angle to achieve particle detection described herein. In embodiments in which the droplets float in the continuous phase, the surface can be at an angle from 10° to 80° above a horizontal plane (e.g., from 10° to 70°, from 122° to 60°, from 20° to 50°, from 25° to 45°, or from 30° to 40° above a horizontal plane, e.g., from 10° to 15°, from 15° to 20°, from 20° to 25°, from 25° to 30°, from 30° to 35°, from 35° to 40°, from 40° to 45°, from 45° to 50°, from 50° to 55°, from 55° to 60°, from 60° to 65°, from 65° to 70°, from 70° to 75°, or from 75° to 80° above a horizontal plane, e.g., about 10°, about 11°, about 12°, about 13°, about 14°, about 15°, about 16°, about 17°, about 18°, about 19°, about 20°, about 21°, about 22°, about 23°, about 24°, about 25°, about 26°, about 27°, about 28°, about 29°, about 30°, about 31°, about 32°, about 33°, about 34°, about 35°, about 36°, about 37°, about 38°, about 39°, about 40°, about 41°, about 42°, about 43°, about 44°, about 45°, about 46°, about 47°, about 48°, about 49°, about 50°, about 51°, about 52°, about 53°, about 54°, about 55°, about 56°, about 57°, about 58°, about 59°, about 60°, about 61°, about 62°, about 63°, about 64°, about 65°, about 66°, about 67°, about 68°, about 69°, about 70°, about 71°, about 72°, about 73°, about 74°, about 75°, about 76°, about 77°, about 78°, about 79°, or about 80° above a horizontal plane). In embodiments in which the droplets sink in the continuous phase, the deflecting surface can be at an angle from 10° to 80° below a horizontal plane (e.g., from 10° to 70°, from 122° to 60°, from 20° to 50°, from 25° to 45°, or from 30° to 40° below a horizontal plane, e.g., from 10° to 15°, from 15° to 20°, from 20° to 25°, from 25° to 30°, from 30° to 35°, from 35° to 40°, from 40° to 45°, from 45° to 50°, from 50° to 55°, from 55° to 60°, from 60° to 65°, from 65° to 70°, from 70° to 75°, or from 75° to 80° below a horizontal plane, e.g., about 10°, about 11°, about 12°, about 13°, about 14°, about 15°, about 16°, about 17°, about 18°, about 19°, about 20°, about 21°, about 22°, about 23°, about 24°, about 25°, about 26°, about 27°, about 28°, about 29°, about 30°, about 31°, about 32°, about 33°, about 34°, about 35°, about 36°, about 37°, about 38°, about 39°, about 40°, about 41°, about 42°, about 43°, about 44°, about 45°, about 46°, about 47°, about 48°, about 49°, about 50°, about 51°, about 52°, about 53°, about 54°, about 55°, about 56°, about 57°, about 58°, about 59°, about 60°, about 61°, about 62°, about 63°, about 64°, about 65°, about 66°, about 67°, about 68°, about 69°, about 70°, about 71°, about 72°, about 73°, about 74°, about 75°, about 76°, about 77°, about 78°, about 79°, or about 80° below a horizontal plane).

Additionally or alternatively, the deflecting surface can have more than one angle or a variable angle (e.g., a curve, e.g., a concave or convex surface). The angle or curvature of the deflecting surface can be selected to provide a suitable speed of a floating or sinking droplet, e.g., at the detection region, which can be adapted for a particular means of detection (e.g., based on frame-rate of image acquisition or video).

To facilitate detection (e.g., optical detection), the deflecting surface can be made, wholly or partially, from a transparent material, e.g., to allow light to pass through the surface (e.g., to a reflective surface thereabove, e.g., at the top of the well). Such a transparent material can have a refractive index that substantially matches the refractive index of the continuous phase. For example, the refractive index can be within 10%, within 9%, within 8%, within 7%, within 6%, within 5%, within 4%, within 3%, within 2%, within 1%, within 0.5%, within 0.1%, within 0.05%, or within 0.01% of the refractive index of the continuous phase.

The refractive index of the deflecting surface can be from 1.3 to 1.6 (e.g., from 1.4 to 1.55 or from 1.45 to 1.50, e.g., from 1.3 to 1.35, from 1.35 to 1.40, from 1.40 to 1.45, from 1.45 to 1.50, from 1.50 to 1.55, or from 1.55 to 1.60, e.g., about 1.30, about 1.31, about 1.32, about 1.33, about 1.333, about 1.34, about 1.35, about 1.36, about 1.37, about 1.38, about 1.39, about 1.40, about 1.41, about 1.42, about 1.43, about 1.44, about 1.45, about 1.46, about 1.47, about 1.48, about 1.49, about 1.50, about 1.51, about 1.52, about 1.53, about 1.54, about 1.55, about 1.56, about 1.57, about 1.58, about 1.59, or about 1.60). In some instances, the refractive indexes of the deflecting surface and the continuous phase are both from 1.3 to 1.6 (e.g., from 1.4 to 1.55 or from 1.45 to 1.50, e.g., from 1.3 to 1.35, from 1.35 to 1.40, from 1.40 to 1.45, from 1.45 to 1.50, from 1.50 to 1.55, or from 1.55 to 1.60, e.g., about 1.30, about 1.31, about 1.32, about 1.33, about 1.333, about 1.34, about 1.35, about 1.36, about 1.37, about 1.38, about 1.39, about 1.40, about 1.41, about 1.42, about 1.43, about 1.44, about 1.45, about 1.46, about 1.47, about 1.48, about 1.49, about 1.50, about 1.51, about 1.52, about 1.53, about 1.54, about 1.55, about 1.56, about 1.57, about 1.58, about 1.59, or about 1.60).

The deflecting surface can be made of any suitable materials, such as polymers include acrylics, nylons, silicones, spandex, viscose rayon, polycarboxylic acids, polyvinyl acetate, polyacrylamide, polyacrylate, polyethylene glycol, polyurethanes, polylactic acid, silica, polystyrene, polyacrylonitrile, polybutadiene, polycarbonate, polyethylene, polyethylene terephthalate, poly(chlorotrifluoroethylene), poly(ethylene oxide), poly(ethylene terephthalate), polyethylene, polyisobutylene, poly(methyl methacrylate), poly(oxymethylene), polyformaldehyde, polypropylene, polystyrene, poly(tetrafluoroethylene), poly(vinyl acetate), poly(vinyl alcohol), poly(vinyl chloride), poly(vinylidene dichloride), poly(vinylidene difluoride), poly(vinyl fluoride) and/or combinations (e.g., co-polymers) thereof.

A droplet enters the sorting region or collection region upon traversing the deflecting surface. In some embodiments, the collection region is defined by a volume in a reservoir (e.g., a well) that is unoccupied by the surface and its supporting structures. For example, in a device configured to detect floating droplets in a well, a deflecting surface may be disposed on a downward-facing surface of a structure that can be inserted into the well (i.e., an insert), occupying a portion of its volume. After emerging from a droplet source at or near the bottom of the well, droplets are deflected by the downward facing surface and, after passing the edge of the deflecting surface, continue to rise into a collection region to the side of the insert.

Thus, an insert can define one or more boundaries of the collection region. In some instances, an insert can define all lateral boundaries of the collection region, e.g., as a hollow cylindrical or partially cylindrical insert configured to fit within a cylindrical well.

The insert can have a size and shape suitable to occupy a low volume of the reservoir in order to provide a suitable collection region volume. For example, the collection region can occupy from 10% to 99% of the lateral area of the reservoir (e.g., from 15% to 98%, from 20% to 97%, from 25% to 96%, from 30% to 95%, from 35% to 90%, from 40% to 85% from 45% to 80%, or from 50% to 75% of the lateral area of the reservoir, e.g., from 10% to 15%, from 15% to 20%, from 20% to 25%, from 25% to 30%, from 30% to 35%, from 35% to 40%, from 45% to 50%, from 50% to 55%, from 55% to 60%, from 60% to 65%, from 65% to 70%, from 70% to 75%, from 75% to 80%, from 80% to 85%, from 85% to 90%, from 90% to 95%, or from 95% to 99% of the lateral area of the reservoir, e.g., about 40%, about 45%, about 50%, about 55%, about 60%, about 65%, about 70%, about 75%, about 80%, about 85%, about 90%, or about 95% of the lateral area of the reservoir). Alternatively, the device can be made so that the deflecting surface and collection region are not separate.

The invention further provides elements that enhance the capacity of the collection region to collect droplets. For example, the device can be configured to shunt the continuous phase from the collection region to a separate reservoir (i.e., a continuous phase reservoir) as droplets accumulate in the collection region. A structure, such as that on which the deflecting surface is disposed (e.g., an insert), can feature one or more openings (e.g., one, two, three, four, or more openings) that render the detection region and the collection region in fluid communication with a continuous phase reservoir. The one or more openings can be positioned to prevent droplets from flowing into the continuous phase reservoir while allowing the continuous phase to freely pass in and out. For example, the one or more openings can be disposed near the bottom of a device configured for detecting floating droplets. Additionally or alternatively, the one or more openings can be positioned to either side of the stream of droplets as they emerge from the droplet source.

The continuous phase reservoir can occupy from 5% to 50% of the lateral area of the reservoir (e.g., from 10% to 45%, from 15%, to 40%, or from 20% to 30% of the lateral area of the reservoir, e.g., from 5% to 10%, from 10% to 15%, from 15% to 20%, from 20% to 25%, from 25% to 30%, from 30% to 35%, from 35% to 40%, or from 45% to 50% of the lateral area of the reservoir, e.g., about 5%, about 10%, about 15%, about 20%, about 25%, about 30%, about 35%, about 40%, about 45%, or about 50% of the lateral area of the reservoir).

Various means for detecting a droplet are contemplated for use with the devices of the present invention. In general, droplets are detected as they pass through the detection region prior to entering the collection region.

In some instances, the detection region includes a reflector. For example, the deflecting surface can feature a reflective portion across which droplets can flow. Such a reflector can be used in devices configured for optical detection, e.g., by bright-field imaging, e.g., bright-field microscopy. In some instances, a reflector can be within a portion on the deflecting surface, e.g., as a flat surface in an angled deflecting surface. Such a configuration can provide a perpendicular surface to align reflected light toward the detector, while providing a suitably angled surface for lateral deflection of droplets. All or a portion of the deflecting surface can be adapted as a reflector by coating the surface with a reflective material, such as a reflective paint or tape (e.g., chrome paint or aluminum tape, etc.).

Alternatively, a reflector can be disposed beyond the deflective surface (e.g., at or near the top of a device having a low droplet source for floating droplets, or vice-versa). For example, in some instances, a reflector (e.g., a mirror), is at the top of the well to reflect light downward toward a detector positioned below the detection region.

Droplets can be optically detectable, e.g., using a conventional optical microscope or with bright-field microscopy, as described herein. In some embodiments, droplets are detectable by light absorbance, scatter, and/or transmission. Additionally or alternatively, optical detection can include fluorescent detection, e.g., by fluorescence microscopy. In still further embodiments, devices can be configured for detection of droplets having electrical or magnetic labels.

### Surface Properties

A surface of the device may include a material, coating, or surface texture that determines the physical properties of the device. In particular, the flow of liquids through a device of the invention may be controlled by the device surface properties (e.g., wettability of a liquid-contacting surface). In some cases, a device portion (e.g., a region, channel, or sorter) may have a surface having a wettability suitable for facilitating liquid flow (e.g., in a channel) or assisting droplet formation of a first liquid in a second liquid (e.g., in a channel), e.g., if droplet formation is performed.

Wetting, which is the ability of a liquid to maintain contact with a solid surface, may be measured as a function of a water contact angle. A water contact angle of a material can be measured by any suitable method known in the art, such as the static sessile drop method, pendant drop method, dynamic sessile drop method, dynamic Wilhelmy method, single-fiber Wilhelmy method, single-fiber meniscus method, and Washburn's equation capillary rise method. The wettability of each surface may be suited to sorting cells or particulate components thereof or, if coupled to a droplet formation device, producing droplets of a first liquid in a second liquid.

For example, portions of the device carrying aqueous phases (e.g., a channel) may have a surface material or coating that is hydrophilic or more hydrophilic than other portions of the device, e.g., include a material or coating having a water contact angle of less than or equal to about 90°, and/or the other portion of the device (e.g., droplet formation region, shelf, or step) may have a surface material or coating that is hydrophobic or more hydrophobic than the channel, e.g., include a material or coating having a water contact angle of greater than 70° (e.g., greater than 90°, greater than 95°, greater than 100° (e.g., 95°-120° or 100°-10°)). In certain embodiments, the droplet formation region, shelf, or step of a device may include a material or surface coating that reduces or prevents wetting by aqueous phases. The device can be designed to have a single type of material or coating throughout. Alternatively, the device may have separate regions having different materials or coatings.

In addition or in the alternative, portions of the device carrying or contacting oil phases (e.g., a channel or exterior) may have a surface material or coating that is hydrophobic, fluorophilic, or more hydrophobic or fluorophilic than the portions of the device that contact aqueous phases, e.g., include a material or coating having a water contact angle of greater than or equal to about 90°. The device can be designed to have a single type of material or coating throughout. Alternatively, the device may have separate regions having different materials or coatings. Surface textures may also be employed to control fluid flow.

The device surface properties may be those of a native surface (i.e., the surface properties of the bulk material used for the device fabrication) or of a surface treatment. Non-limiting examples of surface treatments include, e.g., surface coatings and surface textures. In one approach, the device surface properties are attributable to one or more surface coatings present in a device portion. Hydrophobic coatings may include fluoropolymers (e.g., AQUAPEL® glass treatment), silanes, siloxanes, silicones, or other coatings known in the art. Other coatings include those vapor deposited from a precursor such as henicosyl-1,1,2,2-tetrahydrododecyldimethyltris(dimethylaminosilane); henicosyl-1,1,2,2-tetrahydrododecyltrichlorosilane (C12); heptadecafluoro-1,1,2,2-tetrahydrodecyltrichlorosilane (C10); nonafluoro-1,1,2,2-tetrahydrohexyltris(dimethylamino)silane; 3,3,3,4,4,5,5,6,6-nonafluorohexyltrichlorosilane; tridecafluoro-1,1,2,2-tetrahydrooctyltrichlorosilane (C8); bis(tridecafluoro-1,1,2,2-tetrahydrooctyl)dimethylsiloxymethylchlorosilane; nonafluorohexyltriethoxysilane (C6); dodecyltrichlorosilane (DTS); dimethyldichlorosilane (DDMS); or 10-undecenyltrichlorosilane (V11); pentafluorophenylpropyltrichlorosilane (C5). Hydrophilic coatings include polymers such as polysaccharides, polyethylene glycol, polyamines, and polycarboxylic acids. Hydrophilic surfaces may also be created by oxygen plasma treatment of certain materials.

A coated surface may be formed by depositing a metal oxide onto a surface of the device. Example metal oxides useful for coating surfaces include, but are not limited to, Al₂O₃, TiO₂, SiO₂, or a combination thereof. Other metal oxides useful for surface modifications are known in the art. The metal oxide can be deposited onto a surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al₂O₃ can be deposited on a surface by contacting it with trimethylaluminum (TMA) and water.

In another approach, the device surface properties may be attributable to surface texture. For example, a surface may have a nanotexture, e.g., have a surface with nanometer surface features, such as cones or columns, that alters the wettability of the surface. Nanotextured surface may be hydrophilic, hydrophobic, or superhydrophobic, e.g., have a water contact angle greater than 150°. Exemplary superhydrophobic materials include Manganese Oxide Polystyrene (MnO₂/PS) nano-composite, Zinc Oxide Polystyrene (ZnO/PS) nano-composite, Precipitated Calcium Carbonate, Carbon nano-tube structures, and a silica nano-coating. Superhydrophobic coatings may also include a low surface energy material (e.g., an inherently hydrophobic material) and a surface roughness (e.g., using laser ablation techniques, plasma etching techniques, or lithographic techniques in which a material is etched through apertures in a patterned mask). Examples of low surface energy materials include fluorocarbon materials, e.g., polytetrafluoroethylene (PTFE), fluorinated ethylene propylene (FEP), ethylene tetrafluoroethylene (ETFE), ethylene chloro-trifluoroethylene (ECTFE), perfluoro-alkoxyalkane (PFA), poly(chloro-trifluoroethylene) (CTFE), perfluoro-alkoxyalkane (PFA), and poly(vinylidene fluoride) (PVDF). Other superhydrophobic surfaces are known in the art.

In some cases, the water contact angle of a hydrophilic or more hydrophilic material or coating is less than or equal to about 90°, e.g., less than 80°, 70°, 60°, 50°, 40°, 30°, 20°, or 10°, e.g., 90°, 85°, 80°, 75°, 70°, 65°, 60°, 55°, 50°, 45°, 40°, 35°, 30°, 25°, 20°, 15°, 10°, 9°, 8°, 7°, 6°, 5°, 4°, 3°, 2°, 1°, or 0°. In some cases, the water contact angle of a hydrophobic or more hydrophobic material or coating is at least 70°, e.g., at least 80°, at least 85°, at least 90°, at least 95°, or at least 100° (e.g., about 100°, 101°, 102°, 103°, 104°, 105°, 106°, 107°, 108°, 109°, 110°, 115°, 120°, 125°, 130°, 135°, 140°, 145°, or about) 150°).

The difference in water contact angles between that of a hydrophilic or more hydrophilic material or coating and a hydrophobic or more hydrophobic material or coating may be 5° to 100°, e.g., 5° to 80°, 5° to 60°, 5° to 50°, 5° to 40°, 5° to 30°, 5° to 20°, 10° to 75°, 15° to 70°, 20° to 65°, 25° to 60°, 30 to 50°, 35° to 45°, e.g., 5°, 6°, 7°, 8°, 9°, 10°, 15°, 20°, 25°, 30°, 35°, 40°, 45°, 50°, 55°, 60, 65°, 70°, 75°, 80°, 85°, 90°, 95°, or 100°.

The above discussion centers on the water contact angle. It will be understood that liquids employed in the devices and methods of the invention may not be water, or even aqueous. Accordingly, the actual contact angle of a liquid on a surface of the device may differ from the water contact angle. Furthermore, the determination of a water contact angle of a material or coating can be made on that material or coating when not incorporated into a device of the invention.

### Particles

The invention includes devices, systems, and kits having particles, e.g., for use in analyte detection. For example, particles configured with analyte detection moieties (e.g., barcodes, nucleic acids, binding molecules (e.g., proteins, peptides, aptamers, antibodies, or antibody fragments), enzymes, substrates, etc.) can be included in a droplet containing an analyte to modify the analyte and/or detect the presence or concentration of the analyte. In some embodiments, particles are synthetic particles (e.g., beads, e.g., gel beads).

For example, a droplet may include one or more analyte-detection moieties, e.g., unique identifiers, such as barcodes. Analyte-detection moieties, e.g., barcodes, may be introduced into droplets previous to, subsequent to, or concurrently with droplet formation. The delivery of the analyte-detection moieties, e.g., barcodes, to a particular droplet allows for the later attribution of the characteristics of an individual sample (e.g., biological particle) to the particular droplet. Analyte-detection moieties, e.g., barcodes, may be delivered, for example on a nucleic acid (e.g., an oligonucleotide), to a droplet via any suitable mechanism. Analyte-detection moieties, e.g., barcoded nucleic acids (e.g., oligonucleotides), can be introduced into a droplet via a particle, such as a microcapsule. In some cases, analyte-detection moieties, e.g., barcoded nucleic acids (e.g., oligonucleotides), can be initially associated with the particle (e.g., microcapsule) and then released upon application of a stimulus which allows the analyte-detection moieties, e.g., nucleic acids (e.g., oligonucleotides), to dissociate or to be released from the particle. A particle, e.g., a bead, may be porous, non-porous, hollow (e.g., a microcapsule), solid, semi-solid, semi-fluidic, fluidic, and/or a combination thereof. In some instances, a particle, e.g., a bead, may be dissolvable, disruptable, and/or degradable. In some cases, a particle, e.g., a bead, may not be degradable. In some cases, the particle, e.g., a bead, may be a gel bead. A gel bead may be a hydrogel bead. A gel bead may be formed from molecular precursors, such as a polymeric or monomeric species. A semi-solid particle, e.g., a bead, may be a liposomal bead. Solid particles, e.g., beads, may comprise metals including iron oxide, gold, and silver. In some cases, the particle, e.g., the bead, may be a silica bead. In some cases, the particle, e.g., a bead, can be rigid. In other cases, the particle, e.g., a bead, may be flexible and/or compressible.

A particle, e.g., a bead, may comprise natural and/or synthetic materials. For example, a particle, e.g., a bead, can comprise a natural polymer, a synthetic polymer or both natural and synthetic polymers. Examples of natural polymers include proteins and sugars such as deoxyribonucleic acid, rubber, cellulose, starch (e.g., amylose, amylopectin), proteins, enzymes, polysaccharides, silks, polyhydroxyalkanoates, chitosan, dextran, collagen, carrageenan, ispaghula, acacia, agar, gelatin, shellac, sterculia gum, xanthan gum, corn sugar gum, guar gum, gum karaya, agarose, alginic acid, alginate, or natural polymers thereof. Examples of synthetic polymers include acrylics, nylons, silicones, spandex, viscose rayon, polycarboxylic acids, polyvinyl acetate, polyacrylamide, polyacrylate, polyethylene glycol, polyurethanes, polylactic acid, silica, polystyrene, polyacrylonitrile, polybutadiene, polycarbonate, polyethylene, polyethylene terephthalate, poly(chlorotrifluoroethylene), poly(ethylene oxide), poly(ethylene terephthalate), polyethylene, polyisobutylene, poly(methyl methacrylate), poly(oxymethylene), polyformaldehyde, polypropylene, polystyrene, poly(tetrafluoroethylene), poly(vinyl acetate), poly(vinyl alcohol), poly(vinyl chloride), poly(vinylidene dichloride), poly(vinylidene difluoride), poly(vinyl fluoride) and/or combinations (e.g., co-polymers) thereof. Beads may also be formed from materials other than polymers, including lipids, micelles, ceramics, glass-ceramics, material composites, metals, other inorganic materials, and others.

In some instances, the particle, e.g., the bead, may contain molecular precursors (e.g., monomers or polymers), which may form a polymer network via polymerization of the molecular precursors. In some cases, a precursor may be an already polymerized species capable of undergoing further polymerization via, for example, a chemical cross-linkage. In some cases, a precursor can comprise one or more of an acrylamide or a methacrylamide monomer, oligomer, or polymer. In some cases, the particle, e.g., the bead, may comprise prepolymers, which are oligomers capable of further polymerization. For example, polyurethane beads may be prepared using prepolymers. In some cases, the particle, e.g., the bead, may contain individual polymers that may be further polymerized together. In some cases, particles, e.g., beads, may be generated via polymerization of different precursors, such that they comprise mixed polymers, co-polymers, and/or block co-polymers. In some cases, the particle, e.g., the bead, may comprise covalent or ionic bonds between polymeric precursors (e.g., monomers, oligomers, linear polymers), oligonucleotides, primers, and other entities. In some cases, the covalent bonds can be carbon-carbon bonds or thioether bonds.

Cross-linking may be permanent or reversible, depending upon the particular cross-linker used. Reversible cross-linking may allow for the polymer to linearize or dissociate under appropriate conditions. In some cases, reversible cross-linking may also allow for reversible attachment of a material bound to the surface of a bead. In some cases, a cross-linker may form disulfide linkages. In some cases, the chemical cross-linker forming disulfide linkages may be cystamine or a modified cystamine.

Particles, e.g., beads, may be of uniform size or heterogeneous size. In some cases, the diameter of a particle, e.g., a bead, may be at least about 1 micrometer (μm), 5 μm, 10 μm, 20 μm, 30 μm, 40 μm, 50 μm, 60 μm, 70 μm, 80 μm, 90 μm, 100 μm, 250 μm, 500 μm, 1 mm, or greater. In some cases, a particle, e.g., a bead, may have a diameter of less than about 1 μm, 5 μm, 10 μm, 20 μm, 30 μm, 40 μm, 50 μm, 60 μm, 70 μm, 80 μm, 90 μm, 100 μm, 250 μm, 500 μm, 1 mm, or less. In some cases, a particle, e.g., a bead, may have a diameter in the range of about 40-75 μm, 30-75 μm, 20-75 μm, 40-85 μm, 40-95 μm, 20-100 μm, 10-100 μm, 1-100 μm, 20-250 μm, or 20-500 μm. The size of a particle, e.g., a bead, e.g., a gel bead, used to produce droplets is typically on the order of a cross section of the first channel (width or depth). In some cases, the gel beads are larger than the width and/or depth of the first channel and/or shelf, e.g., at least 1.5×, 2×, 3×, or 4× larger than the width and/or depth of the first channel and/or shelf. In certain embodiments, particles, e.g., beads, can be provided as a population or plurality of particles, e.g., beads, having a relatively monodisperse size distribution. Where it may be desirable to provide relatively consistent amounts of reagents within droplets, maintaining relatively consistent particle, e.g., bead, characteristics, such as size, can contribute to the overall consistency. In particular, the particles, e.g., beads, described herein may have size distributions that have a coefficient of variation in their cross-sectional dimensions of less than 50%, less than 40%, less than 30%, less than 20%, and in some cases less than 15%, less than 10%, less than 5%, or less.

Particles may be of any suitable shape. Examples of particles, e.g., beads, shapes include, but are not limited to, spherical, non-spherical, oval, oblong, amorphous, circular, cylindrical, and variations thereof. A particle, e.g., bead, injected or otherwise introduced into a droplet may comprise releasably, cleavably, or reversibly attached analyte detection moieties (e.g., barcodes). A particle, e.g., bead, injected or otherwise introduced into a droplet may comprise activatable analyte detection moieties (e.g., barcodes). A particle, e.g., bead, injected or otherwise introduced into a droplet may be a degradable, disruptable, or dissolvable particle, e.g., dissolvable bead.

Particles, e.g., beads, within a channel may flow at a substantially regular flow profile (e.g., at a regular flow rate). Such regular flow profiles can permit a droplet, when formed, to include a single particle (e.g., bead) and a single cell or other biological particle. Such regular flow profiles may permit the droplets to have an dual occupancy (e.g., droplets having at least one bead and at least one cell or other biological particle) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99% of the population. In some embodiments, the droplets have a 1:1 dual occupancy (i.e., droplets having exactly one particle (e.g., bead) and exactly one cell or other biological particle) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99% of the population. Such regular flow profiles and devices that may be used to provide such regular flow profiles are provided, for example, in U.S. Patent Publication No. 2015/0292988, which is entirely incorporated herein by reference.

As discussed above, analyte-detection moieties (e.g., barcodes) can be releasably, cleavably or reversibly attached to the particles, e.g., beads, such that analyte detection moieties (e.g., barcodes) can be released or be releasable through cleavage of a linkage between the barcode molecule and the particle, e.g., bead, or released through degradation of the particle (e.g., bead) itself, allowing the barcodes to be accessed or be accessible by other reagents, or both. Releasable analyte-detection moieties (e.g., barcodes) may sometimes be referred to as activatable analyte-detection moieties (e.g., activatable barcodes), in that they are available for reaction once released. Thus, for example, an activatable analyte detection-moiety (e.g., activatable barcode) may be activated by releasing the analyte detection moiety (e.g., barcode) from a particle, e.g., bead (or other suitable type of droplet described herein). Other activatable configurations are also envisioned in the context of the described methods and systems.

In addition to, or as an alternative to the cleavable linkages between the particles, e.g., beads, and the associated antigen detection moieties, such as barcode containing nucleic acids (e.g., oligonucleotides), the particles, e.g., beads may be degradable, disruptable, or dissolvable spontaneously or upon exposure to one or more stimuli (e.g., temperature changes, pH changes, exposure to particular chemical species or phase, exposure to light, reducing agent, etc.). In some cases, a particle, e.g., bead, may be dissolvable, such that material components of the particle, e.g., bead, are degraded or solubilized when exposed to a particular chemical species or an environmental change, such as a change temperature or a change in pH. In some cases, a gel bead can be degraded or dissolved at elevated temperature and/or in basic conditions. In some cases, a particle, e.g., bead, may be thermally degradable such that when the particle, e.g., bead, is exposed to an appropriate change in temperature (e.g., heat), the particle, e.g., bead, degrades. Degradation or dissolution of a particle (e.g., bead) bound to a species (e.g., a nucleic acid, e.g., an oligonucleotide, e.g., barcoded oligonucleotide) may result in release of the species from the particle, e.g., bead. As will be appreciated from the above disclosure, the degradation of a particle, e.g., bead, may refer to the disassociation of a bound or entrained species from a particle, e.g., bead, both with and without structurally degrading the physical particle, e.g., bead, itself. For example, entrained species may be released from particles, e.g., beads, through osmotic pressure differences due to, for example, changing chemical environments. By way of example, alteration of particle, e.g., bead, pore sizes due to osmotic pressure differences can generally occur without structural degradation of the particle, e.g., bead, itself. In some cases, an increase in pore size due to osmotic swelling of a particle, e.g., bead or microcapsule (e.g., liposome), can permit the release of entrained species within the particle. In other cases, osmotic shrinking of a particle may cause the particle, e.g., bead, to better retain an entrained species due to pore size contraction.

A degradable particle, e.g., bead, may be introduced into a droplet, such as a droplet of an emulsion or a well, such that the particle, e.g., bead, degrades within the droplet and any associated species (e.g., nucleic acids, oligonucleotides, or fragments thereof) are released within the droplet when the appropriate stimulus is applied. The free species (e.g., nucleic acid, oligonucleotide, or fragment thereof) may interact with other reagents contained in the droplet. For example, a polyacrylamide bead comprising cystamine and linked, via a disulfide bond, to a barcode sequence, may be combined with a reducing agent within a droplet of a water-in-oil emulsion. Within the droplet, the reducing agent can break the various disulfide bonds, resulting in particle, e.g., bead, degradation and release of the barcode sequence into the aqueous, inner environment of the droplet. In another example, heating of a droplet comprising a particle-, e.g., bead-, bound analyte-detection moiety (e.g., barcode) in basic solution may also result in particle, e.g., bead, degradation and release of the attached barcode sequence into the aqueous, inner environment of the droplet.

Any suitable number of analyte-detection moieties (e.g., molecular tag molecules (e.g., primer, barcoded oligonucleotide, etc.)) can be associated with a particle, e.g., bead, such that, upon release from the particle, the analyte detection moieties (e.g., molecular tag molecules (e.g., primer, e.g., barcoded oligonucleotide, etc.)) are present in the droplet at a pre-defined concentration. Such pre-defined concentration may be selected to facilitate certain reactions for generating a sequencing library, e.g., amplification, within the droplet. In some cases, the pre-defined concentration of a primer can be limited by the process of producing oligonucleotide-bearing particles, e.g., beads.

Additional reagents may be included as part of the particles (e.g., analyte-detection moieties) and/or in solution or dispersed in the droplet, for example, to activate, mediate, or otherwise participate in a reaction, e.g., between the analyte and analyte-detection moiety.

### Biological Samples

A droplet of the present disclosure may include biological particles (e.g., cells) and/or macromolecular constituents thereof (e.g., components of cells (e.g., intracellular or extracellular proteins, nucleic acids, glycans, or lipids) or products of cells (e.g., secretion products)). An analyte from a biological particle, e.g., component or product thereof, may be considered to be a bioanalyte. In some embodiments, a biological particle, e.g., cell, or product thereof is included in a droplet, e.g., with one or more particles (e.g., beads) having an analyte detection moiety. A biological particle, e.g., cell, and/or components or products thereof can, in some embodiments, be encased inside a gel, such as via polymerization of a droplet containing the biological particle and precursors capable of being polymerized or gelled.

In the case of encapsulated biological particles (e.g., cells), a biological particle may be included in a droplet that contains lysis reagents in order to release the contents (e.g., contents containing one or more analytes (e.g., bioanalytes)) of the biological particles within the droplet. In such cases, the lysis agents can be contacted with the biological particle suspension concurrently with, or immediately prior to the introduction of the biological particles into the droplet formation region, for example, through an additional channel or channels upstream or proximal to a second channel or a third channel that is upstream or proximal to a second droplet formation region. Examples of lysis agents include bioactive reagents, such as lysis enzymes that are used for lysis of different cell types, e.g., gram positive or negative bacteria, plants, yeast, mammalian, etc., such as lysozymes, achromopeptidase, lysostaphin, labiase, kitalase, lyticase, and a variety of other lysis enzymes available from, e.g., Sigma-Aldrich, Inc. (St Louis, Mo.), as well as other commercially available lysis enzymes. Other lysis agents may additionally or alternatively be contained in a droplet with the biological particles (e.g., cells) to cause the release of the biological particles' contents into the droplets. For example, in some cases, surfactant based lysis solutions may be used to lyse cells, although these may be less desirable for emulsion based systems where the surfactants can interfere with stable emulsions. In some cases, lysis solutions may include non-ionic surfactants such as, for example, TRITONX-100 and TWEEN 20. In some cases, lysis solutions may include ionic surfactants such as, for example, sarcosyl and sodium dodecyl sulfate (SDS). In some embodiments, lysis solutions are hypotonic, thereby lysing cells by osmotic shock. Electroporation, thermal, acoustic or mechanical cellular disruption may also be used in certain cases, e.g., non-emulsion based droplet formation such as encapsulation of biological particles that may be in addition to or in place of droplet formation, where any pore size of the encapsulate is sufficiently small to retain nucleic acid fragments of a desired size, following cellular disruption.

In addition to the lysis agents, other reagents can also be included in droplets with the biological particles, including, for example, DNase and RNase inactivating agents or inhibitors, such as proteinase K, chelating agents, such as EDTA, and other reagents employed in removing or otherwise reducing negative activity or impact of different cell lysate components on subsequent processing of nucleic acids.

In addition, in the case of encapsulated biological particles (e.g., cells), the biological particles may be exposed to an appropriate stimulus to release the biological particles or their contents from a microcapsule within a droplet. For example, in some cases, a chemical stimulus may be included in a droplet along with an encapsulated biological particle to allow for degradation of the encapsulating matrix and release of the cell or its contents into the larger droplet. In some cases, this stimulus may be the same as the stimulus described elsewhere herein for release of analyte detection moieties (e.g., oligonucleotides) from their respective particle (e.g., bead). In alternative aspects, this may be a different and non-overlapping stimulus, in order to allow an encapsulated biological particle to be released into a droplet at a different time from the release of analyte detection moieties (e.g., oligonucleotides) into the same droplet.

Additional reagents may also be included in droplets with the biological particles, such as endonucleases to fragment a biological particle's DNA, DNA polymerase enzymes and dNTPs used to amplify the biological particle's nucleic acid fragments and to attach the barcode molecular tags to the amplified fragments. Other reagents may also include reverse transcriptase enzymes, including enzymes with terminal transferase activity, primers and oligonucleotides, and switch oligonucleotides (also referred to herein as “switch oligos” or “template switching oligonucleotides”) which can be used for template switching. In some cases, template switching can be used to increase the length of a cDNA. In some cases, template switching can be used to append a predefined nucleic acid sequence to the cDNA. In an example of template switching, cDNA can be generated from reverse transcription of a template, e.g., cellular mRNA, where a reverse transcriptase with terminal transferase activity can add additional nucleotides, e.g., polyC, to the cDNA in a template independent manner. Switch oligos can include sequences complementary to the additional nucleotides, e.g., polyG. The additional nucleotides (e.g., polyC) on the cDNA can hybridize to the additional nucleotides (e.g., polyG) on the switch oligo, whereby the switch oligo can be used by the reverse transcriptase as template to further extend the cDNA.

Template switching oligonucleotides may comprise a hybridization region and a template region. The hybridization region can comprise any sequence capable of hybridizing to the target. In some cases, as previously described, the hybridization region comprises a series of G bases to complement the overhanging C bases at the 3′ end of a cDNA molecule. The series of G bases may comprise 1 G base, 2 G bases, 3 G bases, 4 G bases, 5 G bases or more than 5 G bases. The template sequence can comprise any sequence to be incorporated into the cDNA. In some cases, the template region comprises at least 1 (e.g., at least 2, 3, 4, 5 or more) tag sequences and/or functional sequences. Switch oligos may comprise deoxyribonucleic acids; ribonucleic acids; modified nucleic acids including 2-Aminopurine, 2,6-Diaminopurine (2-Amino-dA), inverted dT, 5-Methyl dC, 2′-deoxyinosine, Super T (5-hydroxybutynl-2′-deoxyuridine), Super G (8-aza-7-deazaguanosine), locked nucleic acids (LNAs), unlocked nucleic acids (UNAs, e.g., UNA-A, UNA-U, UNA-C, UNA-G), Iso-dG, Iso-dC, 2′ Fluoro bases (e.g., Fluoro C, Fluoro U, Fluoro A, and Fluoro G), or any combination.

In some cases, the length of a switch oligo may be 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250 nucleotides or longer.

In some cases, the length of a switch oligo may be at least 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249 or 250 nucleotides or longer.

In some cases, the length of a switch oligo may be at most 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249 or 250 nucleotides.

Once the contents of the cells are released into their respective droplets, the macromolecular components (e.g., macromolecular constituents of biological particles, such as RNA, DNA, or proteins) contained therein may be further processed within the droplets.

As described above, the macromolecular components (e.g., bioanalytes) of individual biological particles (e.g., cells) can be provided with unique identifiers (e.g., barcodes) such that upon characterization of those macromolecular components, at which point components from a heterogeneous population of cells may have been mixed and are interspersed or solubilized in a common liquid, any given component (e.g., bioanalyte) may be traced to the biological particle (e.g., cell) from which it was obtained. The ability to attribute characteristics to individual biological particles or groups of biological particles is provided by the assignment of unique identifiers specifically to an individual biological particle or groups of biological particles. Unique identifiers, for example, in the form of nucleic acid barcodes, can be assigned or associated with individual biological particles (e.g., cells) or populations of biological particles (e.g., cells), in order to tag or label the biological particle's macromolecular components (and as a result, its characteristics) with the unique identifiers. These unique identifiers can then be used to attribute the biological particle's components and characteristics to an individual biological particle or group of biological particles. This can be performed by forming droplets including the individual biological particle or groups of biological particles with the unique identifiers (via particles, e.g., beads), as described in the systems and methods herein.

The present invention provides for the use of molecular labels with biological particles (e.g., cells or organelles of cells). The molecular labels may comprise barcodes (e.g., nucleic acid barcodes). The molecular labels can be provided to the biological particles based on a number of different methods including, without limitation, microinjection, electroporation, liposome-based methods, nanoparticle-based methods, and lipophilic moiety-barcode conjugate methods. For instance, a lipophilic moiety conjugated to a nucleic acid barcode may be contacted with a biological particle. In the case of a cell, the lipophilic moiety may insert into the plasma membrane of a cell thereby labeling the cell with the barcode. The methods of the present invention may result in molecular labels being present on (i) the interior of a cell or organelle of a cell and/or (ii) the exterior of a cell or organelle of a cell (e.g., on or within the cell membrane). These and other suitable methods will be appreciated by those skilled in the art (see U.S. Published Patent App. Nos. 2019-0177800, 2019-0323088 and 2019-0338353 and U.S. patent application Ser. No. 16/439,675, each of which is incorporated herein by reference in its entirety).

In some aspects, the unique identifiers are provided in the form of oligonucleotides that comprise nucleic acid barcode sequences that may be attached to or otherwise associated with the nucleic acid contents of individual biological particle, or to other components of the biological particle, and particularly to fragments of those nucleic acids. The oligonucleotides are partitioned such that as between oligonucleotides in a given droplet, the nucleic acid barcode sequences contained therein are the same, but as between different droplets, the oligonucleotides can, and do have differing barcode sequences, or at least represent a large number of different barcode sequences across all of the droplets in a given analysis. In some aspects, only one nucleic acid barcode sequence can be associated with a given droplet, although in some cases, two or more different barcode sequences may be present.

The nucleic acid barcode sequences can include from 6 to about 20 or more nucleotides within the sequence of the oligonucleotides. In some cases, the length of a barcode sequence may be 6, 7, 8, 9, 10, 11, 12, 13, 14, 15, 16, 17, 18, 19, 20 nucleotides or longer. In some cases, the length of a barcode sequence may be at least 6, 7, 8, 9, 10, 11, 12, 13, 14, 15, 16, 17, 18, 19, 20 nucleotides or longer. In some cases, the length of a barcode sequence may be at most 6, 7, 8, 9, 10, 11, 12, 13, 14, 15, 16, 17, 18, 19, 20 nucleotides or shorter. These nucleotides may be completely contiguous, i.e., in a single stretch of adjacent nucleotides, or they may be separated into two or more separate subsequences that are separated by 1 or more nucleotides. In some cases, separated barcode subsequences can be from about 4 to about 16 nucleotides in length. In some cases, the barcode subsequence may be 4, 5, 6, 7, 8, 9, 10, 11, 12, 13, 14, 15, 16 nucleotides or longer. In some cases, the barcode subsequence may be at least 4, 5, 6, 7, 8, 9, 10, 11, 12, 13, 14, 15, 16 nucleotides or longer. In some cases, the barcode subsequence may be at most 4, 5, 6, 7, 8, 9, 10, 11, 12, 13, 14, 15, 16 nucleotides or shorter.

Analyte-detection moieties (e.g., oligonucleotides) in droplets can also include other functional sequences useful in processing of nucleic acids from biological particles contained in the droplet. These sequences include, for example, targeted or random/universal amplification primer sequences for amplifying the genomic DNA from the individual biological particles within the droplets while attaching the associated barcode sequences, sequencing primers or primer recognition sites, hybridization or probing sequences, e.g., for identification of presence of the sequences or for pulling down barcoded nucleic acids, or any of a number of other potential functional sequences.

Other mechanisms of forming droplets containing oligonucleotides may also be employed, including, e.g., coalescence of two or more droplets, where one droplet contains oligonucleotides, or microdispensing of oligonucleotides into droplets, e.g., droplets within microfluidic systems.

In an example, particles (e.g., beads) are provided that each include large numbers of the above described barcoded oligonucleotides releasably attached to the beads, where all of the oligonucleotides attached to a particular bead will include the same nucleic acid barcode sequence, but where a large number of diverse barcode sequences are represented across the population of beads used. In some embodiments, hydrogel beads, e.g., beads having polyacrylamide polymer matrices, are used as a solid support and delivery vehicle for the oligonucleotides into the droplets, as they are capable of carrying large numbers of oligonucleotide molecules, and may be configured to release those oligonucleotides upon exposure to a particular stimulus, as described elsewhere herein. In some cases, the population of beads will provide a diverse barcode sequence library that includes at least about 1,000 different barcode sequences, at least about 5,000 different barcode sequences, at least about 10,000 different barcode sequences, at least about 50,000 different barcode sequences, at least about 100,000 different barcode sequences, at least about 1,000,000 different barcode sequences, at least about 5,000,000 different barcode sequences, or at least about 10,000,000 different barcode sequences, or more. Additionally, each bead can be provided with large numbers of oligonucleotide molecules attached. In particular, the number of molecules of oligonucleotides including the barcode sequence on an individual bead can be at least about 1,000 oligonucleotide molecules, at least about 5,000 oligonucleotide molecules, at least about 10,000 oligonucleotide molecules, at least about 50,000 oligonucleotide molecules, at least about 100,000 oligonucleotide molecules, at least about 500,000 oligonucleotides, at least about 1,000,000 oligonucleotide molecules, at least about 5,000,000 oligonucleotide molecules, at least about 10,000,000 oligonucleotide molecules, at least about 50,000,000 oligonucleotide molecules, at least about 100,000,000 oligonucleotide molecules, and in some cases at least about 1 billion oligonucleotide molecules, or more.

Moreover, when the population of beads are included in droplets, the resulting population of droplets can also include a diverse barcode library that includes at least about 1,000 different barcode sequences, at least about 5,000 different barcode sequences, at least about 10,000 different barcode sequences, at least at least about 50,000 different barcode sequences, at least about 100,000 different barcode sequences, at least about 1,000,000 different barcode sequences, at least about 5,000,000 different barcode sequences, or at least about 10,000,000 different barcode sequences. Additionally, each droplet of the population can include at least about 1,000 oligonucleotide molecules, at least about 5,000 oligonucleotide molecules, at least about 10,000 oligonucleotide molecules, at least about 50,000 oligonucleotide molecules, at least about 100,000 oligonucleotide molecules, at least about 500,000 oligonucleotides, at least about 1,000,000 oligonucleotide molecules, at least about 5,000,000 oligonucleotide molecules, at least about 10,000,000 oligonucleotide molecules, at least about 50,000,000 oligonucleotide molecules, at least about 100,000,000 oligonucleotide molecules, and in some cases at least about 1 billion oligonucleotide molecules.

In some cases, it may be desirable to incorporate multiple different barcodes within a given droplet, either attached to a single or multiple particles, e.g., beads, within the droplet. For example, in some cases, mixed, but known barcode sequences set may provide greater assurance of identification in the subsequent processing, for example, by providing a stronger address or attribution of the barcodes to a given droplet, as a duplicate or independent confirmation of the output from a given droplet. Oligonucleotides may be releasable from the particles (e.g., beads) upon the application of a particular stimulus. In some cases, the stimulus may be a photo-stimulus, e.g., through cleavage of a photo-labile linkage that releases the oligonucleotides. In other cases, a thermal stimulus may be used, where increase in temperature of the particle, e.g., bead, environment will result in cleavage of a linkage or other release of the oligonucleotides form the particles, e.g., beads. In still other cases, a chemical stimulus is used that cleaves a linkage of the oligonucleotides to the beads, or otherwise results in release of the oligonucleotides from the particles, e.g., beads. In one case, such compositions include the polyacrylamide matrices described above for encapsulation of biological particles, and may be degraded for release of the attached oligonucleotides through exposure to a reducing agent, such as dithiothreitol (DTT).

The droplets described herein may contain either one or more biological particles (e.g., cells), either one or more barcode carrying particles, e.g., beads, or both at least a biological particle and at least a barcode carrying particle, e.g., bead. In some instances, a droplet may be unoccupied and contain neither biological particles nor barcode-carrying particles, e.g., beads. As noted previously, by controlling the flow characteristics of each of the liquids combining at the droplet formation region(s), as well as controlling the geometry of the droplet formation region(s), droplet formation can be optimized to achieve a desired occupancy level of particles, e.g., beads, biological particles, or both, within the droplets that are generated.

### Kits and Systems

Devices of the invention may be combined with various external components, e.g., pumps, reservoirs, sensors (e.g., temperature sensors and/or pressure sensors), or controllers (e.g., flow rate controllers), reagents, e.g., analyte detection moieties, liquids, particles (e.g., beads), and/or samples in the form of kits and systems.

The systems described herein may include a device as described herein and one or more (e.g., 2, 3, 4, 5, 6, 7, 8, 9, 10, or more) temperature sensors. The devices and systems may include one or more (e.g., 2, 3, 4, 5, 6, 7, 8, 9, 10, or more) pressure sensors (FIGS. 57A-57B). The devices and systems may further include one or more controllers configured to adjust the flow rate (e.g., the flow rate of a liquid, e.g., the first liquid or the second liquid). The devices and systems may also include a holder configured to hold the device in operative connection with, e.g., the pressure sensor, temperature sensor, and/or the controller. The one or more temperature sensors may be a resistance temperature detector (RTD) or a thermocouple sensor. The one or more temperature sensors may be positioned at any location suitable to provide an accurate temperature measurement. The temperature sensors may be positioned within the device or adjacent to the device. The temperature sensor may be positioned between the holder and the device. The one or more pressure sensors may also be positioned at any location suitable to provide an accurate pressure measurement. The pressure sensor may be located within the device or adjacent to the device. The pressure sensor may be located within or near the channel or reservoir of the liquid for which the pressure measurement is being obtained.

A system may include pressure control units for maintaining fluid pressures. The pressure controllers may include one or more pressure gauges for measuring the fluid pressure. In some embodiments, at least two fluid pressure gauges are used to measure a pressure drop within a single fluid flow channel. In some embodiments, each fluid flow channel within the system includes one or more pressure gauges. Pressure gauges may be operatively connected to one or more processors that collect, analyze, and control the fluid pressure environments throughout the droplet-generating device. One or more pressure control devices may be operatively connected to the processors. The pressure control devices may include pumps, compressors, or any other device that can move fluid or alter the fluid pressure. In some embodiments, pressure control devices may impart a positive pressure on one more fluid flow channels. In other embodiments, pressure control devices may impart a negative pressure on one or more fluid flow channels.

### Methods

The methods described herein to generate droplets, e.g., of uniform and predictable content, and with high throughput, may be used to greatly increase the efficiency of single cell applications and/or other applications receiving droplet-based input. Such single cell applications and other applications may often be capable of processing a certain range of droplet sizes. The methods may be employed to generate droplets for use as microscale chemical reactors, where the volumes of the chemical reactants are small (˜pLs).

Methods of the invention include the step of allowing one or more liquids to flow from the channels (e.g., the first, second, and optional third channel) to the droplet formation region.

The methods disclosed herein may produce emulsions, generally, i.e., droplet of a dispersed phases in a continuous phase. For example, droplets may include a first liquid (and optionally a third liquid, and, further, optionally a fourth liquid), and the other liquid may be a second liquid. The first liquid may be substantially immiscible with the second liquid. In some instances, the first liquid may be an aqueous liquid or may be substantially miscible with water. Droplets produced according to the methods disclosed herein may combine multiple liquids. For example, a droplet may combine a first and third liquids. The first liquid may be substantially miscible with the third liquid. The second liquid may be an oil, as described herein.

The methods described herein may include monitoring a temperature of the device while generating droplets and adjusting a pressure of a liquid (e.g., the first liquid or the second liquid) based on the temperature of the device. By adjusting (e.g., increasing or decreasing) the pressure (e.g., with a controller), a specified droplet generation parameter (e.g., flow rate, droplet generation frequency, and ratio of droplets including a specified number of particles compared to droplets not including the specified number of particles) is substantially maintained at a constant or specified value (e.g., ±1%, 2%, 3%, 4%, 5%, 10%, 15%, 20%, 25%, or 30% of the value) independent of the temperature. The pressure may be adjusted based on a viscosity calculated based on the temperature of the device.

The pressure of the liquid in the device may be adjusted based on empirical parameters. For example, a set of temperature and pressure calibration parameters can be measured empirically and formulated into a table (e.g., a function) that relates temperature to pressure, e.g., by using a computer algorithm or computer chip (e.g., software or firmware). This table (e.g., function) may be stored on the device or system or an instrument running the device or system. The pressure and/or flow rate can be calculated and adjusted based on the temperature in order to produce droplets of a uniform generation parameter (e.g., flow rate, droplet generation frequency, and ratio of droplets including a specified number of particles compared to droplets not including the specified number of particles). This control allows droplets to be formed of a uniform droplet generation parameter in different temperature settings. This process may also be automated by the device or system or an instrument running the device or system. This process may also be automated by the device or system.

The computer algorithm may use a formula, such as an exponential model for temperature dependence of viscosity

μ_{T}=μ₀ exp(−bT)

where μ_{T} is expected viscosity at temperature T and μ₀ and b are empirically derived constants unique to a particular liquid. These constants may be measured by conducting viscosity testing at multiple temperature points for each liquid being used. For example, n liquids may have viscosities that are a function of Z1 . . . Zn. A liquid that is immiscible with the aqueous liquid(s), such as a partitioning oil, may also have a viscosity, Zoil. In a scenario in which two miscible aqueous liquids are used to generate droplets, the viscosities may be defined as a function of Z1 and Z2. The flow rate is inversely proportional to liquid viscosity
Q≈1/μ

Thus, the system or the device can measure the temperature and calculate a ratio

R=(μ_{T}(Z2)/μ_{T}(Z1))/(μ₀(Z2)/μ₀(Z1))

This ratio can then be applied to the pressure. If it is desired to not exceed initial pressures, the pressure (e.g. of a liquid containing a bead) can be divided by this ratio if the value is greater than 1. Alternatively, this ratio can be used to control run times and/or applied pressures from the table (e.g., function) based on empirical data.

A variety of applications require the evaluation of the presence and quantification of different biological particle or organism types within a population of biological particles, including, for example, microbiome analysis and characterization, environmental testing, food safety testing, epidemiological analysis, e.g., in tracing contamination or the like.

The methods described herein may allow for the production of one or more droplets containing a single particle, e.g., bead, and/or single biological particle (e.g., cell) with uniform and predictable droplet content. The methods described herein may allow for the production of one or more droplets containing a single particle, e.g., bead, and/or single biological particle (e.g., cell) with uniform and predictable droplet size. The methods may also allow for the production of one or more droplets comprising a single biological particle (e.g., cell) and more than one particle, e.g., bead, one or more droplets comprising more than one biological particle (e.g., cell) and a single particle, e.g., bead, and/or one or more droplets comprising more than one biological particle (e.g., cell) and more than one particle, e.g., beads. The methods may also allow for increased throughput of droplet formation.

Droplets are in general formed by allowing a first liquid, or a combination of a first liquid with a third liquid and optionally fourth liquid, to flow into a second liquid in a droplet formation region, where droplets spontaneously form as described herein. The droplet content uniformity may be controlled using, e.g., funnels (e.g., funnels including hurdles), side channels, and/or mixers.

Mixers can be used to mix two liquid streams, e.g., before the droplet formation. Mixing two liquids is advantageous for controlling content uniformity of liquid streams and of droplets formed from such liquid streams. For example, one liquid (e.g., a third or fourth liquid) and another liquid (e.g., a first, third, or fourth liquid) may be combined at an intersection of two channels (e.g., an intersection of a first side-channel and a second channel, or an intersection of a second channel and a third channel). The one liquid may contain a biological particle (e.g., a cell), and the other liquid may contain reagents. By using a mixer, the two liquids can be rapidly mixed, thereby reducing localized high concentrations of lysing reagents. Thus, biological particle lysis may be reduced or eliminated until the droplet formation.

The mixer may be included downstream of an intersection between the second and third channels. In this configuration, a third liquid may be combined with a fourth liquid at the intersection. The combined third and fourth liquids may be mixed in the second channel mixer. The mixed third and fourth liquids may then be combined with a first liquid at an intersection between the first and second channels downstream from the mixer.

Alternatively, the mixer may be included downstream of an intersection between a first side-channel and a second channel. For example, a mixer may be included in the first side-channel between an intersection of the first side-channel with the second channel and an intersection of the first side-channel with the first channel. In this configuration, a first liquid flowing through the first side-channel may be combined with the third liquid at the intersection of the first side-channel with the second channel. The combined first and third liquids may be mixed in the first side-channel mixer and are then combined with the liquid in the first channel.

In methods described herein, funnels and/or side-channels may be used to control particle (e.g., bead) flow, e.g., to provide evenly spaced particles (e.g., beads). The evenly spaced particles may be used for forming droplets containing a single particle. Methods described herein including a step of allowing a liquid (e.g., a first liquid) to flow from the first channel to the droplet formation region may include allowing the liquid to flow through the first side-channel and optionally through the second side-channel.

The droplets may comprise an aqueous liquid dispersed phase within a non-aqueous continuous phase, such as an oil phase. In some cases, droplet formation may occur in the absence of externally driven movement of the continuous phase, e.g., a second liquid, e.g., an oil. As discussed above, the continuous phase may nonetheless be externally driven, even though it is not required for droplet formation. Emulsion systems for creating stable droplets in non-aqueous (e.g., oil) continuous phases are described in detail in, for example, U.S. Pat. No. 9,012,390, which is entirely incorporated herein by reference for all purposes. Alternatively or in addition, the droplets may comprise, for example, micro-vesicles that have an outer barrier surrounding an inner liquid center or core. In some cases, the droplets may comprise a porous matrix that is capable of entraining and/or retaining materials within its matrix. A variety of different vessels are described in, for example, U.S. Patent Application Publication No. 2014/0155295, which is entirely incorporated herein by reference for all purposes. The droplets can be collected in a substantially stationary volume of liquid, e.g., with the buoyancy of the formed droplets moving them out of the path of nascent droplets (up or down depending on the relative density of the droplets and continuous phase). Alternatively or in addition, the formed droplets can be moved out of the path of nascent droplets actively, e.g., using a gentle flow of the continuous phase, e.g., a liquid stream or gently stirred liquid, or any other active force, e.g., magnetic, electrical (e.g., charge), dielectrophoretic, or optical.

Allocating particles, e.g., beads (e.g., microcapsules carrying barcoded oligonucleotides) or biological particles (e.g., cells) to discrete droplets may generally be accomplished by introducing a flowing stream of particles, e.g., beads, in an aqueous liquid into a flowing stream or non-flowing reservoir of a non-aqueous liquid, such that droplets are generated. In some instances, the occupancy of the resulting droplets (e.g., number of particles, e.g., beads, per droplet) can be controlled by providing the aqueous stream at a certain concentration or frequency of particles, e.g., beads. In some instances, the occupancy of the resulting droplets can also be controlled by adjusting one or more geometric features at the point of droplet formation, such as a width of a fluidic channel carrying the particles, e.g., beads, relative to a diameter of a given particles, e.g., beads.

Where single particle-, e.g., bead-, containing droplets are desired, the relative flow rates of the liquids can be selected such that, on average, the droplets contain fewer than one particle, e.g., bead, per droplet in order to ensure that those droplets that are occupied are primarily singly occupied. In some embodiments, the relative flow rates of the liquids can be selected such that a majority of droplets are occupied, for example, allowing for only a small percentage of unoccupied droplets. The flows and channel architectures can be controlled as to ensure a desired number of singly occupied droplets, less than a certain level of unoccupied droplets and/or less than a certain level of multiply occupied droplets. The methods described herein can be operated such that a majority of occupied droplets include no more than one biological particle per occupied droplet. In some cases, the droplet formation process is conducted such that fewer than 25% of the occupied droplets contain more than one biological particle (e.g., multiply occupied droplets), and in many cases, fewer than 20% of the occupied droplets have more than one biological particle. In some cases, fewer than 10% or even fewer than 5% of the occupied droplets include more than one biological particle per droplet.

It may be desirable to avoid the creation of excessive numbers of empty droplets, for example, from a cost perspective and/or efficiency perspective. However, while this may be accomplished by providing sufficient numbers of particles, e.g., beads, into the droplet formation region, the Poisson distribution may expectedly increase the number of droplets that may include multiple biological particles. As such, at most about 95%, 90%, 85%, 80%, 75%, 70%, 65%, 60%, 55%, 50%, 45%, 40%, 35%, 30%, 25%, 20%, 15%, 10%, 5% or less of the generated droplets can be unoccupied. In some cases, the flow of one or more of the particles, or liquids directed into the droplet formation region can be conducted using devices and systems of the invention (e.g., those including one or more side-channels and/or funnels) such that, in many cases, no more than about 50% of the generated droplets, no more than about 25% of the generated droplets, or no more than about 10% of the generated droplets are unoccupied. These flows can be controlled so as to present non-Poisson distribution of singly occupied droplets while providing lower levels of unoccupied droplets. The above noted ranges of unoccupied droplets can be achieved while still providing any of the single occupancy rates described above. For example, in many cases, the use of the systems and methods described herein creates resulting droplets that have multiple occupancy rates of less than about 25%, less than about 20%, less than about 15%, less than about 10%, and in many cases, less than about 5%, while having unoccupied droplets of less than about 50%, less than about 40%, less than about 30%, less than about 20%, less than about 10%, less than about 5%, or less.

The flow of the first fluid may be such that the droplets contain a single particle, e.g., bead. In certain embodiments, the yield of droplets containing a single particle is at least 80%, e.g., at least 85%, at least 86%, at least 87%, at least 88%, at least 89%, at least 90%, at least 91%, at least 92%, at least 93%, at least 94%, at least 95%, at least 96%, at least 97%, at least 98%, or at least 99%.

As will be appreciated, the above-described occupancy rates are also applicable to droplets that include both biological particles (e.g., cells) and beads. The occupied droplets (e.g., at least about 10%, 20%, 30%, 40%, 50%, 60%, 70%, 80%, 90%, 95%, or 99% of the occupied droplets) can include both a bead and a biological particle. Particles, e.g., beads, within a channel (e.g., a particle channel) may flow at a substantially regular flow profile (e.g., at a regular flow rate; e.g., the flow profile being controlled by one or more side-channels and/or one or more funnels) to provide a droplet, when formed, with a single particle (e.g., bead) and a single cell or other biological particle. Such regular flow profiles may permit the droplets to have a dual occupancy (e.g., droplets having at least one bead and at least one cell or biological particle) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99%. In some embodiments, the droplets have a 1:1 dual occupancy (i.e., droplets having exactly one particle (e.g., bead) and exactly one cell or biological particle) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99%. Such regular flow profiles and devices that may be used to provide such regular flow profiles are provided, for example, in U.S. Patent Publication No. 2015/0292988, which is entirely incorporated herein by reference.

In some cases, additional particles may be used to deliver additional reagents to a droplet. In such cases, it may be advantageous to introduce different particles (e.g., beads) into a common channel (e.g., proximal to or upstream from a droplet formation region) or droplet formation intersection from different bead sources (e.g., containing different associated reagents) through different channel inlets into such common channel or droplet formation region. In such cases, the flow and/or frequency of each of the different particle, e.g., bead, sources into the channel or fluidic connections may be controlled to provide for the desired ratio of particles, e.g., beads, from each source, while optionally ensuring the desired pairing or combination of such particles, e.g., beads, are formed into a droplet with the desired number of biological particles.

The droplets described herein may comprise small volumes, for example, less than about 10 microliters (μL), 5 μL, 1 μL, 900 picoliters (pL), 800 pL, 700 pL, 600 pL, 500 pL, 400 pL, 300 pL, 200 pL, 100 pL, 50 pL, 20 pL, 10 pL, 1 pL, 500 nanoliters (nL), 100 nL, 50 nL, or less. For example, the droplets may have overall volumes that are less than about 1000 pL, 900 pL, 800 pL, 700 pL, 600 pL, 500 pL, 400 pL, 300 pL, 200 pL, 100 pL, 50 pL, 20 pL, 10 pL, 1 pL, or less. Where the droplets further comprise particles (e.g., beads or microcapsules), it will be appreciated that the sample liquid volume within the droplets may be less than about 90% of the above described volumes, less than about 80%, less than about 70%, less than about 60%, less than about 50%, less than about 40%, less than about 30%, less than about 20%, or less than about 10% the above described volumes (e.g., of a partitioning liquid), e.g., from 1% to 99%, from 5% to 95%, from 10% to 90%, from 20% to 80%, from 30% to 70%, or from 40% to 60%, e.g., from 1% to 5%, 5% to 10%, 10% to 15%, 15% to 20%, 20% to 25%, 25% to 30%, 30% to 35%, 35% to 40%, 40% to 45%, 45% to 50%, 50% to 55%, 55% to 60%, 60% to 65%, 65% to 70%, 70% to 75%, 75% to 80%, 80% to 85%, 85% to 90%, 90% to 95%, or 95% to 100% of the above described volumes. Any suitable number of droplets can be generated. For example, in a method described herein, a plurality of droplets may be generated that comprises at least about 1,000 droplets, at least about 5,000 droplets, at least about 10,000 droplets, at least about 50,000 droplets, at least about 100,000 droplets, at least about 500,000 droplets, at least about 1,000,000 droplets, at least about 5,000,000 droplets at least about 10,000,000 droplets, at least about 50,000,000 droplets, at least about 100,000,000 droplets, at least about 500,000,000 droplets, at least about 1,000,000,000 droplets, or more. Moreover, the plurality of droplets may comprise both unoccupied droplets (e.g., empty droplets) and occupied droplets.

The fluid to be dispersed into droplets may be transported from a reservoir to the droplet formation region. Alternatively, the fluid to be dispersed into droplets is formed in situ by combining two or more fluids in the device. For example, the fluid to be dispersed may be formed by combining one fluid containing one or more reagents with one or more other fluids containing one or more reagents. In these embodiments, the mixing of the fluid streams may result in a chemical reaction. For example, when a particle is employed, a fluid having reagents that disintegrates the particle may be combined with the particle, e.g., immediately upstream of the droplet generating region. In these embodiments, the particles may be cells, which can be combined with lysing reagents, such as surfactants. When particles, e.g., beads, are employed, the particles, e.g., beads, may be dissolved or chemically degraded, e.g., by a change in pH (acid or base), redox potential (e.g., addition of an oxidizing or reducing agent), enzymatic activity, change in salt or ion concentration, or other mechanism.

The first fluid is transported through the first channel at a flow rate sufficient to produce droplets in the droplet formation region. Faster flow rates of the first fluid generally increase the rate of droplet production; however, at a high enough rate, the first fluid will form a jet, which may not break up into droplets. Typically, the flow rate of the first fluid though the first channel may be between about 0.01 μL/min to about 100 μL/min, e.g., 0.1 to 50 μL/min, 0.1 to 10 μL/min, or 1 to 5 μL/min. In some instances, the flow rate of the first liquid may be between about 0.04 μL/min and about 40 μL/min. In some instances, the flow rate of the first liquid may be between about 0.01 μL/min and about 100 μL/min. Alternatively, the flow rate of the first liquid may be less than about 0.01 μL/min. Alternatively, the flow rate of the first liquid may be greater than about 40 μL/min, e.g., 45 μL/min, 50 μL/min, 55 μL/min, 60 μL/min, 65 μL/min, 70 μL/min, 75 μL/min, 80 μL/min, 85 μL/min, 90 μL/min, 95 μL/min, 100 μL/min, 110 μL/min, 120 μL/min, 130 μL/min, 140 μL/min, 150 μL/min, or greater. At lower flow rates, such as flow rates of about less than or equal to 10 μL/min, the droplet radius may not be dependent on the flow rate of first liquid. Alternatively or in addition, for any of the abovementioned flow rates, the droplet radius may be independent of the flow rate of the first liquid.

The typical droplet formation rate for a single channel in a device of the invention is between 0.1 Hz to 10,000 Hz, e.g., 1 to 1000 Hz or 1 to 500 Hz. The use of multiple first channels can increase the rate of droplet formation by increasing the number of locations of formation.

As discussed above, droplet formation may occur in the absence of externally driven movement of the continuous phase. In such embodiments, the continuous phase flows in response to displacement by the advancing stream of the first fluid or other forces. Channels may be present in the droplet formation region, e.g., including a shelf region, to allow more rapid transport of the continuous phase around the first fluid. This increase in transport of the continuous phase can increase the rate of droplet formation. Alternatively, the continuous phase may be actively transported. For example, the continuous phase may be actively transported into the droplet formation region, e.g., including a shelf region, to increase the rate of droplet formation; continuous phase may be actively transported to form a sheath flow around the first fluid as it exits the distal end; or the continuous phase may be actively transported to move droplets away from the point of formation.

Additional factors that affect the rate of droplet formation include the viscosity of the first fluid and of the continuous phase, where increasing the viscosity of either fluid reduces the rate of droplet formation. In certain embodiments, the viscosity of the first fluid and/or continuous is between 0.5 cP to 10 cP. Furthermore, lower interfacial tension results in slower droplet formation. In certain embodiments, the interfacial tension is between 0.1 and 100 mN/m, e.g., 1 to 100 mN/m or 2 mN/m to 60 mN/m. The depth of the shelf region can also be used to control the rate of droplet formation, with a shallower depth resulting in a faster rate of formation.

The methods may be used to produce droplets in range of 1 μm to 500 μm in diameter, e.g., 1 to 250 μm, 5 to 200 μm, 5 to 150 μm, or 12 to 125 μm. Factors that affect the size of the droplets include the rate of formation, the cross-sectional dimension of the distal end of the first channel, the depth of the shelf, and fluid properties and dynamic effects, such as the interfacial tension, viscosity, and flow rate.

The first liquid may be aqueous, and the second liquid may be an oil (or vice versa). Examples of oils include perfluorinated oils, mineral oil, and silicone oils. For example, a fluorinated oil may include a fluorosurfactant for stabilizing the resulting droplets, for example, inhibiting subsequent coalescence of the resulting droplets. Examples of particularly useful liquids and fluorosurfactants are described, for example, in U.S. Pat. No. 9,012,390, which is entirely incorporated herein by reference for all purposes. Specific examples include hydrofluoroethers, such as HFE 7500, 7300, 7200, or 7100. Suitable liquids are those described in US 2015/0224466 and U.S. 62/522,292, the liquids of which are hereby incorporated by reference. The continuous phase may also be a ferrofluid. In some cases multiple immiscible fluids may be employed, e.g., by using a spacing liquid that results in a droplet layer being between two immiscible liquids. Depending on the relative density of the droplets with the continuous phase, the spacing liquid may be more or less dense to position the droplets between two layers. In some cases, liquids include additional components such as a particle, e.g., a cell or a gel bead. As discussed above, the first fluid or continuous phase may include reagents for carrying out various reactions, such as nucleic acid amplification, lysis, or bead dissolution. The first liquid or continuous phase may include additional components that stabilize or otherwise affect the droplets or a component inside the droplet. Such additional components include surfactants, antioxidants, preservatives, buffering agents, antibiotic agents, salts, chaotropic agents, enzymes, nanoparticles, and sugars.

Once formed, droplets may be manipulating, e.g., transported, detected, sorted, held, incubated, reacted, or demulsified. Droplets may be manipulated in a reservoir or reentrained into a channel for manipulation. Reentrainment may occur by any mechanism, e.g., pressure, magnetic, electric, dielectrophoretic, optical, etc. Various generally applicable methods for reentrainment are described herein.

Devices of the present invention having a collection reservoir that has a first volume and a second volume may be used to produce droplets in a highly efficient manner by reducing the amount of second liquid, e.g., the continuous phase, that remains in the collection reservoir after a production run to form droplets. In other devices, the first volume of the collection reservoir has a volume that is about 1% of the volume of the second reservoir. Thus, when a production run for forming droplets is completed, the first volume of the collection reservoir may contain a relatively large volume of the second liquid remaining. In order to reduce the amount of second liquid that is removed from the device with the droplets, the collection reservoir may be pressurized, e.g., by the application of a positive pressure to the collection reservoir, to force a portion of the second liquid back into the device, leaving behind a population of droplets with reduced second liquid. This “push back” step, while removing excess second liquid, may also force a portion of the formed droplets back into the device, reducing yield and device efficiency.

In the present invention, the first volume of the collection reservoir may be smaller than, e.g., less than 1% of, the second volume of the collection reservoir. In this configuration, as the droplets are formed and collected in devices of the invention, the remaining excess second liquid after a production run is minimized, thus reducing or eliminating the need to pressurize the collection reservoir. In cases where the need to pressurize the collection reservoir is necessary, the amount of excess second liquid forced back into the device is reduced relative to other designs, further reducing or eliminating the number of droplets that may be inadvertently forced back into the device. This increases the overall yield of droplets and minimizes device downtime, thereby increasing efficiency.

Devices, systems, compositions, and methods of the invention may be used for various applications, such as, for example, processing a single analyte (e.g., bioanalytes, e.g., RNA, DNA, or protein) or multiple analytes (e.g., bioanalytes, e.g., DNA and RNA, DNA and protein, RNA and protein, or RNA, DNA and protein) from a single cell. For example, a biological particle (e.g., a cell or virus) can be formed in a droplet, and one or more analytes (e.g., bioanalytes) from the biological particle (e.g., cell) can be modified or detected (e.g., bound, labeled, or otherwise modified by an analyte detection moiety) for subsequent processing. The multiple analytes may be from the single cell. This process may enable, for example, proteomic, transcriptomic, and/or genomic analysis of the cell or population thereof (e.g., simultaneous proteomic, transcriptomic, and/or genomic analysis of the cell or population thereof). Methods of modifying analytes include providing a plurality of particles (e.g., beads) in a liquid carrier (e.g., an aqueous carrier); providing a sample containing an analyte (e.g., as part of a cell, or component or product thereof) in a sample liquid; and using the device to combine the liquids and form an analyte detection droplet containing one or more particles and one or more analytes (e.g., as part of one or more cells, or components or products thereof). Such sequestration of one or more particles with analyte (e.g., bioanalyte associated with a cell) in a droplet enables labeling of discrete portions of large, heterologous samples (e.g., single cells within a heterologous population). Once labeled or otherwise modified, droplets can be combined (e.g., by breaking an emulsion), and the resulting liquid can be analyzed to determine a variety of properties associated with each of numerous single cells.

In particular embodiments, the invention features methods of producing analyte detection droplets using a device having a particle channel (e.g., a first channel) and a sample channel (e.g., a second channel or a first side-channel that intersects a second channel) that intersect upstream of a droplet formation region. Particles having an analyte-detection moiety in a liquid carrier flow proximal-to-distal (e.g., towards the droplet formation region) through the particle channel (e.g., a first channel) and a sample liquid containing an analyte flows in the proximal-to-distal direction (e.g., towards the droplet formation region) through the sample channel (e.g., a second channel or a first side-channel that intersects a second channel) until the two liquids meet and combine at the intersection of the sample channel and the particle channel, upstream (and/or proximal to) the droplet formation region. The combination of the liquid carrier with the sample liquid results in an analyte detection liquid. In some embodiments, the two liquids are miscible (e.g., they both contain solutes in water or aqueous buffer). The two liquids may be mixed in a mixer as described herein. The combination of the two liquids can occur at a controlled relative rate, such that the analyte detection liquid has a desired volumetric ratio of particle liquid to sample liquid, a desired numeric ratio of particles to cells, or a combination thereof (e.g., one particle per cell per 50 pL). As the analyte detection liquid flows through the droplet formation region into a partitioning liquid (e.g., a liquid which is immiscible with the analyte detection liquid, such as an oil), analyte detection droplets form. These analyte detection droplets may continue to flow through one or more channels. Alternatively or in addition, the analyte detection droplets may accumulate (e.g., as a substantially stationary population) in a droplet collection region. In some cases, the accumulation of a population of droplets may occur by a gentle flow of a fluid within the droplet collection region, e.g., to move the formed droplets out of the path of the nascent droplets.

Devices useful for analyte detection may feature any combination of elements described herein. For example, various droplet formation regions can be employed in the design of a device for analyte detection. In some embodiments, analyte detection droplets are formed at a droplet formation region having a shelf region, where the analyte detection liquid expands in at least one dimension as it passes through the droplet formation region. Any shelf region described herein can be useful in the methods of analyte detection droplet formation provided herein. Additionally or alternatively, the droplet formation region may have a step at or distal to an inlet of the droplet formation region (e.g., within the droplet formation region or distal to the droplet formation region). In some embodiments, analyte detection droplets are formed without externally driven flow of a continuous phase (e.g., by one or more crossing flows of liquid at the droplet formation region). Alternatively, analyte detection droplets are formed in the presence of an externally driven flow of a continuous phase.

A device useful for droplet formation, e.g., analyte detection, may feature multiple droplet formation regions (e.g., in or out of (e.g., as independent, parallel circuits) fluid communication with one another. For example, such a device may have 2-100, 3-50, 4-40, 5-30, 6-24, 8-18, or 9-12, e.g., 2-6, 6-12, 12-18, 18-24, 24-36, 36-48, or 48-96, e.g., 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, or more droplet formation regions configured to produce analyte detection droplets).

Source reservoirs can store liquids prior to and during droplet formation. In some embodiments, a device useful in analyte detection droplet formation includes one or more particle reservoirs connected proximally to one or more particle channels. Particle suspensions can be stored in particle reservoirs (e.g., a first reservoir) prior to analyte detection droplet formation. Particle reservoirs can be configured to store particles containing an analyte detection moiety. For example, particle reservoirs can include, e.g., a coating to prevent adsorption or binding (e.g., specific or non-specific binding) of particles or analyte-detection moieties. Additionally or alternatively, particle reservoirs can be configured to minimize degradation of analyte detection moieties (e.g., by containing nuclease, e.g., DNAse or RNAse) or the particle matrix itself, accordingly.

Additionally or alternatively, a device includes one or more sample reservoirs connected proximally to one or more sample channels. Samples containing cells and/or other reagents useful in analyte detection and/or droplet formation can be stored in sample reservoirs prior to analyte detection droplet formation. Sample reservoirs can be configured to reduce degradation of sample components, e.g., by including nuclease (e.g., DNAse or RNAse).

Methods of the invention may include adding a sample and/or particles to the device, for example, (a) by pipetting a sample liquid, or a component or concentrate thereof, into a sample reservoir (e.g., a second reservoir) and/or (b) by pipetting a liquid carrier (e.g., an aqueous carrier) and/or particles into a particle reservoir (e.g., a first reservoir). In some embodiments, the method involves first adding (e.g., pipetting) the liquid carrier (e.g., an aqueous carrier) and/or particles into the particle reservoir prior to adding (e.g., pipetting) the sample liquid, or a component or concentrate thereof, into the sample reservoir. In some embodiments, the liquid carrier added to the particle reservoir includes lysing reagents. Alternatively, the methods of the invention include adding a liquid (e.g., a fourth liquid) containing lysing reagent(s) to a lysing reagent reservoir (e.g., a third reservoir).

The sample reservoir and/or particle reservoir may be incubated in conditions suitable to preserve or promote activity of their contents until the initiation or commencement of droplet formation.

Formation of bioanalyte detection droplets, as provided herein, can be used for various applications. In particular, by forming bioanalyte detection droplets using the methods, devices, systems, and kits herein, a user can perform standard downstream processing methods to barcode heterogeneous populations of cells or perform single-cell nucleic acid sequencing.

In methods of barcoding a population of cells, an aqueous sample having a population of cells is combined with bioanalyte detection particles having a nucleic acid primer sequence and a barcode in an aqueous carrier at an intersection of the sample channel and the particle channel to form a reaction liquid. In some embodiments, the bioanalyte detection particles are in a liquid carrier including lysing reagents. For example, the liquid carrier including bioanalyte detection particles and a liquid carrier may be used in a device or system including a first side-channel intersection with a second channel. In some embodiments, the lysing reagents are included in a lysing liquid. For example, a lysing liquid may be used in a device or system including a second channel, a third channel, and an intersection between them. The lysing reagent(s) (e.g., in a first liquid or in a fourth liquid) may be combined with a sample liquid (e.g., a third liquid) at a channel intersection (e.g., an intersection between a first side-channel and a second channel or an intersection between a first channel and a second channel). The combined liquids can be mixed in a mixer disposed downstream of the intersection.

Upon passing through the droplet formation region, the reaction liquid meets a partitioning liquid (e.g., a partitioning oil) under droplet-forming conditions to form a plurality of reaction droplets, each reaction droplet having one or more of the particles and one or more cells in the reaction liquid. The reaction droplets are incubated under conditions sufficient to allow for barcoding of the nucleic acid of the cells in the reaction droplets. In some embodiments, the conditions sufficient for barcoding are thermally optimized for nucleic acid replication, transcription, and/or amplification. For example, reaction droplets can be incubated at temperatures configured to enable reverse transcription of RNA produced by a cell in a droplet into DNA, using reverse transcriptase. Additionally or alternatively, reaction droplets may be cycled through a series of temperatures to promote amplification, e.g., as in a polymerase chain reaction (PCR). Accordingly, in some embodiments, one or more nucleotide amplification reagents (e.g., PCR reagents) are included in the reaction droplets (e.g., primers, nucleotides, and/or polymerase). Any one or more reagents for nucleic acid replication, transcription, and/or amplification can be provided to the reaction droplet by the aqueous sample, the liquid carrier, or both. In some embodiments, one or more of the reagents for nucleic acid replication, transcription, and/or amplification are in the aqueous sample.

Also provided herein are methods of single-cell nucleic acid sequencing, in which a heterologous population of cells can be characterized by their individual gene expression, e.g., relative to other cells of the population. Methods of barcoding cells discussed above and known in the art can be part of the methods of single-cell nucleic acid sequencing provided herein. After barcoding, nucleic acid transcripts that have been barcoded are sequenced, and sequences can be processed, analyzed, and stored according to known methods. In some embodiments, these methods enable the generation of a genome library containing gene expression data for any single cell within a heterologous population.

Alternatively, the ability to sequester a single cell in a reaction droplet provided by methods herein enables bioanalyte detection for applications beyond genome characterization. For example, a reaction droplet containing a single cell and variety of analyte detection moieties capable of binding different proteins can allow a single cell to be detectably labeled to provide relative protein expression data. In some embodiments, analyte detection moieties are antigen-binding molecules (e.g., antibodies or fragments thereof), wherein each antibody clone is detectably labeled (e.g., with a fluorescent marker having a distinct emission wavelength). Binding of antibodies to proteins can occur within the reaction droplet, and cells can be subsequently analyzed for bound antibodies according to known methods to generate a library of protein expression. Other methods known in the art can be employed to characterize cells within heterologous populations after detecting analytes using the methods provided herein. In one example, following the formation or droplets, subsequent operations that can be performed can include formation of amplification products, purification (e.g., via solid phase reversible immobilization (SPRI)), further processing (e.g., shearing, ligation of functional sequences, and subsequent amplification (e.g., via PCR)). These operations may occur in bulk (e.g., outside the droplet). An exemplary use for droplets formed using methods of the invention is in performing nucleic acid amplification, e.g., polymerase chain reaction (PCR), where the reagents necessary to carry out the amplification are contained within the first fluid. In the case where a droplet is a droplet in an emulsion, the emulsion can be broken and the contents of the droplet pooled for additional operations. Additional reagents that may be included in a droplet along with the barcode bearing bead may include oligonucleotides to block ribosomal RNA (rRNA) and nucleases to digest genomic DNA from cells. Alternatively, rRNA removal agents may be applied during additional processing operations. The configuration of the constructs generated by such a method can help minimize (or avoid) sequencing of poly-T sequence during sequencing and/or sequence the 5′ end of a polynucleotide sequence. The amplification products, for example first amplification products and/or second amplification products, may be subject to sequencing for sequence analysis. In some cases, amplification may be performed using the Partial Hairpin Amplification for Sequencing (PHASE) method.

The present disclosure also features methods of detecting the status, e.g., the presence or absence, of a fluid in a system. The methods may be employed in determining the absence, e.g., the depletion, of a fluid in a device, e.g., in a portion of the device, or the presence of a displacing fluid. This information may be used to determine the end of a run in a system, e.g., to prevent contamination of the system, and/or reduce excessive consumption or inappropriate dilution of fluids in the system. The methods may further be used to determine when to begin the flow of a second fluid, such as a different aqueous liquid, through a device or to provide for the introduction of fluids of different chemical compositions or containing different components.

The method includes allowing a volume of a first fluid contained in a first reservoir to flow in a flow path and detecting the status of the first fluid using one or more sensors. The determination of the status of the first fluid may be based on a reaching or crossing of a threshold condition, which may be required to endure for a set period of time, e.g., to avoid false positives, such as may be caused by transient gas bubbles. In particular embodiments, when the one or more sensors detect depletion of the first fluid, the flow of the first fluid may be stopped or additional fluid, e.g., additional first fluid may be added.

The fluid, e.g., the first fluid, may be an aqueous fluid, e.g., a buffer solution or aqueous sample solution, or a non-aqueous fluid, e.g., an oil or an organic solvent. In some cases, the fluid includes particles, e.g., beads or cells. In some instances, there may be a plurality of fluids employed, which may be the same or different. For example, the fluids in a subset of a plurality of reservoirs may contain one type of fluid, and the fluids in another subset of the plurality of reservoirs may contain a different type of fluid. As a non-limiting example, two fluids may be aqueous (e.g., the same aqueous fluid or different aqueous fluids), both fluids may be non-aqueous (e.g., the same non-aqueous fluid or different non-aqueous fluids), or one fluid is aqueous and the other is non-aqueous. This relationship is also true when three or more different fluids are present.

Various properties of a fluid, e.g., a first fluid, can be used to detect the status of the fluid in a device. For example, the one or more sensors may measure the flow of the fluid, the pressure of the fluid, the optical properties of the fluid, and/or the electrical properties of the fluid. Changes in any of these properties in the fluid as it flows may be detected by an appropriate sensor and are correlated with the volume of fluid as it flows along the flow path of the device. The status of the fluid can be determined by the reaching of a predetermined threshold value of a detected property (or a function of the measured value of the property, such as a derivative or integral). In some instances, the reaching of a predetermined threshold differential is from an initial or average value of the property of the fluid; alternatively, the reaching of the threshold is determined relative to a standard or reference system.

The threshold value used to determine when the status of a fluid is detected may be pre-determined, e.g., set from the operation of a reference system. Alternatively, the threshold value may be dynamic, e.g., changed based on feedback and/or machine learning algorithm. The reaching of the threshold value may be from a lower value to a higher value or from a higher value to a lower value. The threshold can indicate an increase or decrease in the flow rate or other property of the fluid and may be measured as an absolute or a relative value (e.g., compared to an initial or average value, such as a percent of the initial or average value). If the threshold indicates a percent change, it can indicate a percent change of about 10, 20, 30, 40, 50, 60, 70, 80, 90, or 100% or more.

In some embodiments, after the threshold value is reached, the flow of a fluid in the system is stopped (or additional fluid is added) within about 0.0001 seconds to 1 second, e.g., about 0.0001 seconds to about 0.001 seconds, about 0.0005 seconds to about 0.005 seconds, about 0.001 seconds to about 0.01 seconds, about 0.005 seconds to about 0.05 seconds, about 0.01 seconds to about 0.1 seconds, about 0.05 seconds to about 0.5 seconds, or about 0.1 seconds to about 01 seconds, e.g., about 0.0001 seconds, about 0.0002 seconds, about 0.0003 seconds, about 0.0004 seconds, about 0.0005 seconds, about 0.0006 seconds, about 0.0007 seconds, about 0.0008 seconds, about 0.0009 seconds, about 0.001 seconds, about 0.002 seconds, about 0.003 seconds, about 0.004 seconds, about 0.005 seconds, about 0.006 seconds, about 0.007 seconds, about 0.008 seconds, about 0.009 seconds, about 0.01 seconds, about 0.02 seconds, about 0.03 seconds, about 0.04 seconds, about 0.05 seconds, about 0.06 seconds, about 0.07 seconds, about 0.08 seconds, about 0.09 seconds, about 0.1 seconds, about 0.2 seconds, about 0.3 seconds, about 0.4 seconds, about 0.5 seconds, about 0.6 seconds, about 0.7 seconds, about 0.8 seconds, about 0.9 seconds, or about 1 second.

The threshold condition may also be employed to control the flow of a series of fluids. The series can be a series of different samples or aliquots of the same sample separated by a washing or spacing fluid. The series can be a series of two or more different fluids that result in a sequence of delivery of reagents or components, e.g., delivery of a sample followed by delivery of reagents for lysis, chemical or physical modification, detection, or amplification. The fluids may flow along the same or different flow paths. When different flow paths are employed, the paths will typically intersect, e.g., in a chamber or reservoir. The fluids may also be added sequentially to the same reservoir or be housed in separate reservoirs, e.g., that are in fluid communication with a common flow path. Thus, the method may include starting the flow of a second fluid when the status of the first fluid meets the threshold condition. The second fluid may be a liquid, such as an aqueous liquid, that has a different composition than the first fluid. As a non-limiting example, the first fluid may include a particle, e.g., a cell or a gel bead, or a sample, and the second fluid may be a wash fluid, e.g., a buffer, to flush the flow path of the first fluid after depletion of the first fluid. As another example, the second fluid may be a liquid that includes a reagent that reacts with a component of the first fluid. As a further example, the first fluid may include one type of particle, such as a cell, and the second fluid may include a different type of particle, such as a gel bead. The status of the second fluid may also be detected as it flows, and the flow of the second fluid may be stopped or additional fluid may be added when the status meets a threshold condition. For example, the flow of the first fluid may be re-initiated when the status of the second fluid meets the threshold condition. This process may be repeated as desired. In another example, the method includes the introduction of a third fluid after the status of the second fluid meets a threshold condition. For example, the second fluid may be a spacer fluid, e.g., air or another gas, such that a boundary exists between the first fluid and the third fluid. The spacer fluid may be introduced for a time sufficient to ensure a sufficient separation to reduce cross-contamination between the first fluid and the third fluid. The third fluid may be a liquid, such as an aqueous liquid, that has a different composition than the first liquid. For example, the first and third fluids may be different samples or the third fluid may include a reagent that modifies a component of the first fluid. The second fluid may also include a sample or reagent. Further fluids can be added as desired, e.g., to carry out a series of reactions or analyses. Generally, the second, third, or further fluids may be any type of fluid described herein, e.g., liquid, either aqueous or non-aqueous, or a gas. In some cases, the change in flow rate or other property detected by a sensor results from a transition of a first liquid to a second fluid, e.g., air or another liquid, e.g., an immiscible liquid.

In some embodiments, more than one sensor may be employed to detect the status of a fluid. For example, a plurality of sensors can detect the status of a fluid, e.g., measure an identical property, such as flow rate, e.g., for redundancy. In some cases, a plurality of sensors may measure different properties. For example, multiple properties of a liquid may be measured, e.g., where a determination of the status of a fluid requires at least one sensor to reach a threshold, at least two, at least three, or the entire plurality to reach a threshold.

The one or more sensors of a device or system of the invention may detect the status of a fluid in one or more locations in the system. This location may be a reservoir, e.g., a first reservoir or a collection reservoir, a channel, e.g., a first channel, or a droplet formation region. The location may be in the device or in the system external to the device, e.g., in a manifold. In some cases, the one or more sensors may be detecting the status of a fluid in a plurality of locations in the system simultaneously. As a non-limiting example, the one or more sensors may be configured to detect the status, such as the absence or depletion, of a fluid that is flowing from a plurality of first reservoirs, each holding the same fluid. If the one or more sensors detect the status of the fluid at more than one location, then the status of the fluid in the device may be determined based on the first sensor detecting a threshold value, a plurality less than all of the sensors detecting a threshold value, or all sensors detecting a threshold value. Multiple sensors may be placed in order in the flow path in the system, and the status of a fluid may be determined when a threshold is reached at two or more sensors in the order of flow (e.g., the most upstream sensor detects the threshold first, followed by detection at the next downstream sensor). If multiple sensors detect a threshold value, then a determination of status of a fluid may require that the measured values be within a tolerance of one another, e.g., within 10% or less of each other, e.g., 5%, 4%, 3%, 2%, or 1% or less of each other. Alternatively, multiple measured values for the threshold may be summed to yield a multi-sensor threshold determination.

Data from one or more sensors (or a determination of the status of a fluid) can be sent to a controller, e.g., a computer or other hardware, that is configured to control the flow of fluid in the system. In some cases, when depletion is detected, only the flow of the fluid whose absence is detected is stopped. Alternatively, when the presence of a displacing fluid is detected, only the flow of the displacing fluid is stopped. For example, fluid flow may be stopped when the presence of a displacing fluid, is detected, e.g., by a sharp step change in the flow rate is detected by one or more sensors. In this configuration, stopping the flow once the change in flow rate is detected by the one or more sensors ensures that all of the sample fluid is used for its intended purpose, e.g., forming droplets. In other cases, when depletion of a fluid is detected, the flow of more than one fluid is stopped, e.g., in the system as a whole. Alternatively or in addition to stopping flow, additional volumes of a fluid may be added where the depletion is detected. When the system includes parallel channel systems, detection of depletion in one channel system may or may not result in the stopping of flow or addition of fluid in the other channels systems. When the status of multiple different fluids is being measured simultaneously, flow may be stopped for each fluid individually when a threshold is met, or flow may be stopped in the system as a whole, e.g., when a threshold condition is met for one, two, three, or more, or all different fluids. Stopping the flow of a fluid may occur may any mechanism, including the stopping of pumping, the closing of one or more valves that allow fluid flow, or disconnection of the device from a pump or source of fluid.

When additional fluid is added, the flow of fluid may be restarted. The additional fluid may be the same type of fluid as that depleted or a different type of fluid. When a different type of fluid is added, a buffer, wash, or blank solution can be transported through the system prior to transporting the different type of fluid. The buffer, wash, or blank solution may wash away residue of the first fluid to avoid contamination of the added fluid. In some cases, when the flow of fluid is stopped, the flow of fluid is not restarted. In this configuration, no additional fluid is added.

In certain embodiments in which more than one fluid flows in the system, variations in the system, e.g., channel geometry, or differences in the fluids, e.g., in the temperature dependence of viscosity, may result in one fluid flowing faster than another. In such instances, more of the faster flowing fluid may be included to allow depletion of the fluids nearer to the same time. Similarly, when one fluid includes a limiting reagent, e.g., sample, one or more other fluids that are not limiting may be included in a volume sufficient to ensure that the limiting reagent depletes first.

### Methods of Device Manufacture

The microfluidic devices of the present disclosure may be fabricated in any of a variety of conventional ways. For example, in some cases the devices comprise layered structures, where a first layer includes a planar surface into which is disposed a series of channels or grooves that correspond to the channel network in the finished device. A second layer includes a planar surface on one side, and a series of reservoirs defined on the opposing surface, where the reservoirs communicate as passages through to the planar layer, such that when the planar surface of the second layer is mated with the planar surface of the first layer, the reservoirs defined in the second layer are positioned in liquid communication with the termini of the channels on the first layer. Alternatively, both the reservoirs and the connected channels may be fabricated into a single part, where the reservoirs are provided upon a first surface of the structure, with the apertures of the reservoirs extending through to the opposing surface of the structure. The channel network is fabricated as a series of grooves and features in this second surface. A thin laminating layer is then provided over the second surface to seal, and provide the final wall of the channel network, and the bottom surface of the reservoirs.

These layered structures may be fabricated in whole or in part from polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals, ceramics, and combinations thereof. Polymeric device components may be fabricated using any of a number of processes including soft lithography, embossing techniques, micromachining, e.g., laser machining, or in some aspects injection molding of the layer components that include the defined channels as well as other structures, e.g., reservoirs, integrated functional components, etc. In some aspects, the structure comprising the reservoirs and channels may be fabricated using, e.g., injection molding techniques to produce polymeric structures. In such cases, a laminating layer may be adhered to the molded structured part through readily available methods, including thermal lamination, solvent based lamination, sonic welding, or the like.

As will be appreciated, structures comprised of inorganic materials also may be fabricated using known techniques. For example, channels and other structures may be micro-machined into surfaces or etched into the surfaces using standard photolithographic techniques. In some aspects, the microfluidic devices or components thereof may be fabricated using three-dimensional printing techniques to fabricate the channel or other structures of the devices and/or their discrete components.

### Methods for Surface Modifications

The disclosure features methods for producing a microfluidic device that has a surface modification, e.g., a surface with a modified water contact angle. The methods may be employed to modify the surface of a device such that a liquid can “wet” the surface by altering the contact angle the liquid makes with the surface. An exemplary use of the methods of the invention is in creating a device having differentially coated surfaces to optimize droplet formation.

Devices to be modified with surface coating agents may be primed, e.g., pre-treated, before coating processes occur. In one embodiment, the device has a channel that is in fluid communication with a droplet formation region. In particular, the droplet formation region is configured to allow a liquid exiting the channel to expand in at least one dimension. A surface of the droplet formation region is contacted by at least one reagent that has an affinity for the primed surface to produce a surface having a first water contact angle of greater than about 90°, e.g., a hydrophobic or fluorophillic surface. In certain embodiments, the first contact angle is greater than the water contact angle of the primed surface. In other embodiments, the first contact angle is greater than the water contact angle of the channel surface. Thus, the method allows for the differential coating of surfaces within the microfluidic device.

A surface may be primed by depositing a metal oxide onto it. Example metal oxides useful for priming surfaces include, but are not limited to, Al₂O₃, TiO₂, SiO₂, or a combination thereof. Other metal oxides useful for surface modifications are known in the art. The metal oxide can be applied to the surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al₂O₃ can be prepared on a surface by depositing trimethylaluminum (TMA) and water.

In some cases, the coating agent may create a surface that has a water contact angle greater than 90°, e.g., hydrophobic or fluorophillic, or may create a surface with a water contact angle of less than 90°, e.g., hydrophilic. For example, a fluorophillic surface may be created by flowing fluorosilane (e.g., H₃FSi) through a primed device surface, e.g., a surface coated in a metal oxide. The priming of the surfaces of the device enhances the adhesion of the coating agents to the surface by providing appropriate surface functional groups. In some cases, the coating agent used to coat the primed surface may be a liquid reagent. For example, when a liquid coating agent is used to coat a surface, the coating agent may be directly introduced to the droplet formation region by a feed channel in fluid communication with the droplet formation region. In order to keep the coating agent localized to the droplet formation region, e.g., prevent ingress of the coating agent to another portion of the device, e.g., the channel, the portion of the device that is not to be coated can be substantially blocked by a substance that does not allow the coating agent to pass. For example, in order to prevent ingress of a liquid coating agent into the channel, the channel may be filled with a blocking liquid that is substantially immiscible with the coating agent. The blocking liquid may be actively transported through the portion of the device not to be coated, or the blocking liquid may be stationary. Alternatively, the channel may be filled with a pressurized gas such that the pressure prevents ingress of the coating agent into the channel. The coating agent may also be applied to the regions of interest external to the main device. For example, the device may incorporate an additional reservoir and at least one feed channel that connects to the region of interest such that no coating agent is passed through the device.

### EXAMPLES

### Example 1

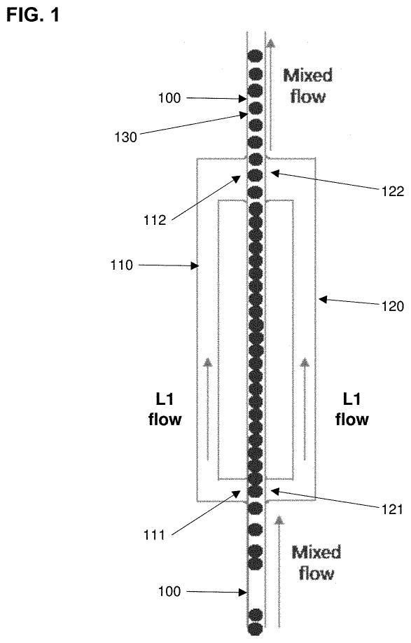

FIG. 1 illustrates a device for converting a stream of unevenly spaced particles (e.g., beads) into a stream of evenly spaced particles. The device includes first channel 100, first side-channel 110, and second side-channel 120. In the operating device, particles 130 propagate through channel 100 in the direction of an arrow labeled “Mixed flow.” Prior to proximal intersections 111 and 121, spacing between consecutive particles is non-uniform. At the proximal intersections, excess first liquid L1 escapes into side-channels 110 and 120. Inlets of side-channels 110 and 120 are sized to substantially prevent ingress of particles from first channel 100. The liquid that escapes into side-channels 110 and 120 rejoins first channel 100 at distal intersections 112 and 122. Upon rejoining first channel 100, liquid L1 separates consecutively packed particles 130, thereby providing evenly spaced particles 130.

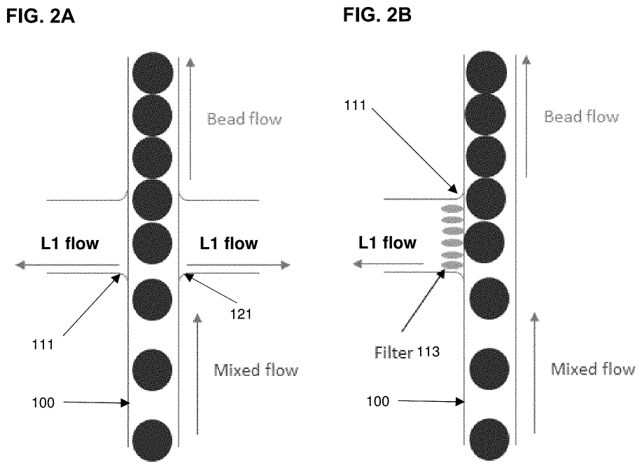

FIG. 2A and FIG. 2B are alternative configurations of proximal intersections of first channel 100 with first side-channel 110 (FIG. 2A and FIG. 2B) and second side-channel 120 (FIG. 2A).

FIG. 2A illustrates the direction of the excess liquid flow from first channel 100 into the side-channels at proximal intersections 111 and 121. In this configuration, the side-channels have a depth sized to substantially prevent particle ingress from first channel 100.

FIG. 2B illustrates the direction of the excess liquid flow from first channel 100 into the side-channel at proximal intersection 111. In this configuration, the side-channel includes filter 113 to substantially prevent particle ingress from first channel 100.

### Example 2

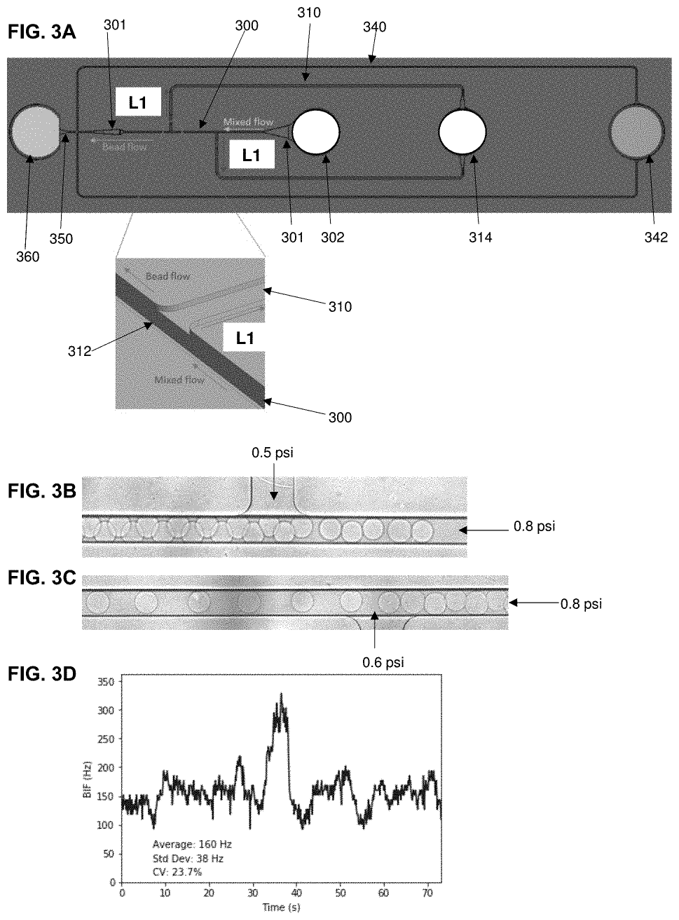

FIG. 3A illustrates an exemplary device of the invention. The device includes first channel 300 having two funnels 301, first reservoir 302, first side-channel 310 including first side-channel reservoir 314, two second channels 340 fluidically connected to second reservoir 342, droplet formation region 350, and droplet collection region 360. First channel 300 has a depth of 60 μm, and first side-channel 310 has a depth of 14 μm. This configuration may be used, e.g., with beads having a mean diameter of about 54 μm. This device is adapted to control pressure in first channel 300 through the use of first side-channel 310.

In use, beads and first liquid L1, preloaded into reservoir 302, are allowed to flow from reservoir 302 to droplet formation region 350. The bead spacing is controlled by way of side-channel 310, which includes side-channel reservoir 314. In use, side-channel reservoir 314 can be used for active control of the pressure in side-channel 310. Thus, the bead flow rate, spacing, and spacing uniformity may be adjusted as needed by controlling the pressure in reservoirs 302 and 314. Rectifiers 301 can provide additional control over bead spacing and spacing uniformity. Sample (e.g., a third liquid) may be loaded into reservoir 342 and allowed to flow to droplet formation region 350 through two second channels 340. At an intersection between first channel 300 and second channels 340, the bead stream is combined with the sample stream, and the combined beads, first liquid, and sample proceed to droplet formation region 350, where the combined stream contacts a second liquid in droplet collection region 360 to form droplets, preferably, droplets containing a single bead. Rectifiers 301 and side channel 310 thus can be used to control particle (e.g., bead) spacing to allow for the formation of droplets containing a single particle.

The inset shows an isometric view of distal intersection 312 with first-side channel 310 having a first side-channel depth that is smaller than the first depth and a first side-channel width that is greater than the first width. Droplet collection region 360 is in fluid communication with first reservoir 302, first side-channel reservoir 314, and second reservoir 342. In operation, beads flow with the first liquid L1 along first channel 300, and excess first liquid L1 is removed through first side-channel 310, and beads are sized to reduce or even substantially eliminate their ingress into first side-channel 310.

FIG. 3B shows an intersection between a first channel and a first side-channel in use. In this figure, the first liquid and beads flow along a first channel at a pressure of 0.8 psi, the first liquid pressure applied in the first side-channel is 0.5 psi. Accordingly, excess first liquid is removed from the space between consecutive beads, and these beads are then tightly packed in the first channel.

FIG. 3C shows an intersection between a first channel and a first side-channel in use. In this figure, the first liquid and beads flow along a first channel. The pressure applied to reservoir 302 is 0.8 psi, and the pressure applied to reservoir 314 is 0.6 psi. The beads are tightly packed in the first channel upstream of the channel intersection. The first liquid added to the first channel from the first side-channel is evenly distributed between consecutive beads, thereby providing a stream of evenly spaced beads.

FIG. 3D is a chart showing the frequency at which beads flow through a fixed region in the chip (Bead Injection Frequency, or BIF) as a function of time, during normal chip operation. The measurement was carried out by video analysis of a fixed region of the first channel, after the intersection between the first channel and first side-channel.

### Example 3

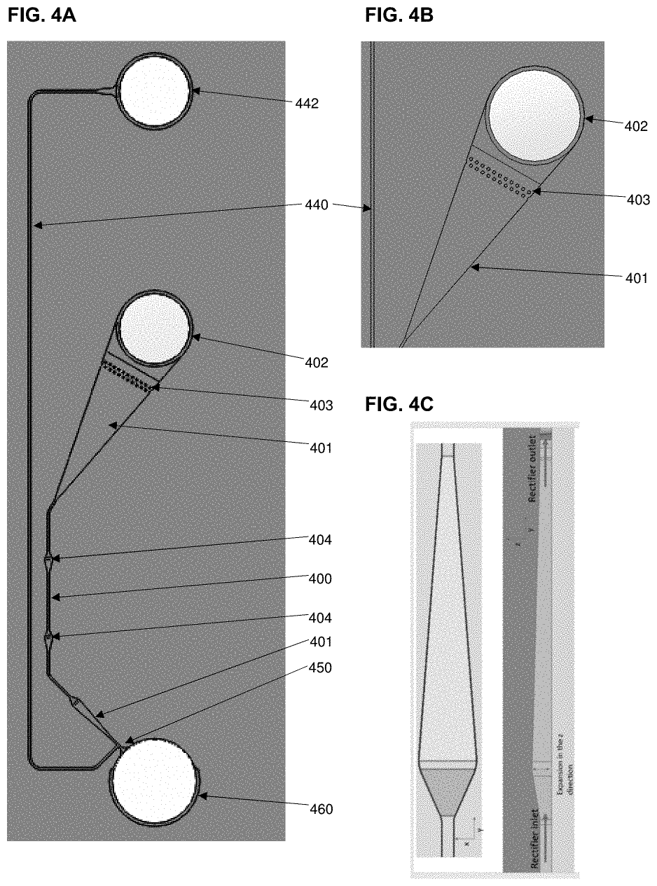

FIG. 4A illustrates an exemplary device of the invention. The device includes first channel 400 having two funnels 401 and two mini-rectifiers 404, first reservoir 402, second channel 440 fluidically connected to second reservoir 442, droplet formation region 450, and droplet collection region 460. The proximal funnel width is substantially equal to the width of first reservoir 402. Funnels 401 and mini-rectifiers 404 include pegs 403 as hurdles. There are two rows of pegs 403 in proximal funnel 401 as hurdles. Droplet collection region 460 is in fluid communication with first reservoir 402 and second reservoir 442. The spacing between pegs 403 is 100 μm.

In use, beads and a first liquid, preloaded into reservoir 402, are allowed to flow from reservoir 402 to droplet formation region 450. The bead flow rate and spacing may be adjusted as needed by controlling the pressure in reservoir 402. Rectifiers 401 and mini-rectifiers 404 can also provide control over bead spacing and spacing uniformity. Sample (e.g., a third liquid) may be loaded into reservoir 442 and allowed to flow to droplet formation region 450 through second channel 440. At an intersection between first channel 400 and second channel 440, the bead stream is combined with the sample stream, and the combined beads, first liquid, and sample proceed to droplet formation region 450, where the combined stream contacts a second liquid in droplet collection region 460 to form droplets, preferably, droplets containing a single bead. Rectifiers 401, mini-rectifiers 404, and hurdles 403 thus can be used to control particle (e.g., bead) spacing to allow for the formation of droplets containing a single particle.

FIG. 4B is an image focused on the combination of proximal funnel 401 and first reservoir 402 in the device of FIG. 4A. Proximal funnel 401 is fluidically connected to first reservoir 402 and includes two rows of pegs 403 as hurdles.

### Example 4

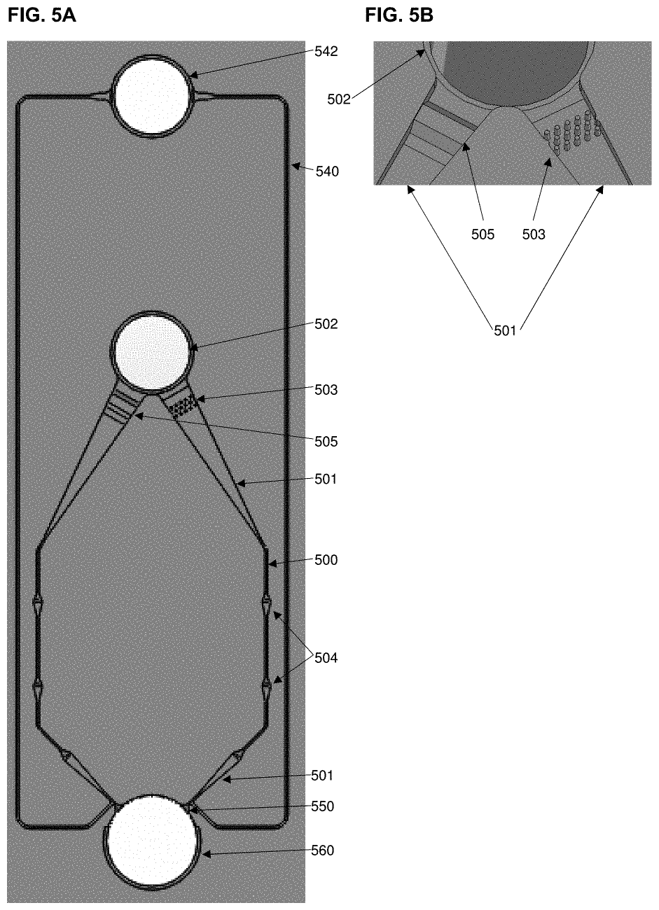

FIG. 5A illustrates an exemplary device of the invention. The device includes two first channels 500, each first channel having two funnels 501 and two mini-rectifiers 504; first reservoir 502; two second channels 540 fluidically connected to the same second reservoir 542; two droplet formation regions 550; and one droplet collection region 560. The proximal funnel 501 on the left includes one barrier 505 as a hurdle. The proximal funnel 501 on the right includes three rows of pegs 503 as hurdles. Droplet collection region 560 is in fluid communication with first reservoir 502 and second reservoir 542. Barrier 505 has a height of 30 μm, and pegs 503 are spaced at 100 μm intervals.

In use, beads and a first liquid, preloaded into reservoir 502, are allowed to flow from reservoir 502 to droplet formation regions 550. The bead flow rate and spacing may be adjusted as needed by controlling the pressure in reservoir 502. Rectifiers 501 and mini-rectifiers 504 can also provide control over bead spacing and spacing uniformity. Sample (e.g., a third liquid) may be loaded into reservoir 542 and allowed to flow to droplet formation regions 550 through second channels 540. At intersections between first channels 500 and second channels 540, the bead stream is combined with the sample stream, and the combined beads, first liquid, and sample proceed to droplet formation regions 550, where the combined streams contact a second liquid in droplet collection region 560 to form droplets, preferably, droplets containing a single bead. Rectifiers 501, mini-rectifiers 504, and hurdles 503 and 505 thus can be used to control particle (e.g., bead) spacing to allow for the formation of droplets containing a single particle.

FIG. 5B is an image focused on the combination of two proximal funnels 501 and first reservoir 502. Proximal funnel 501 on the left is fluidically connected to first reservoir 502 and includes one barrier 505 as a hurdle. Proximal funnel 501 on the right is fluidically connected to first reservoir 502 includes three rows of pegs 503 as hurdles.

### Example 5

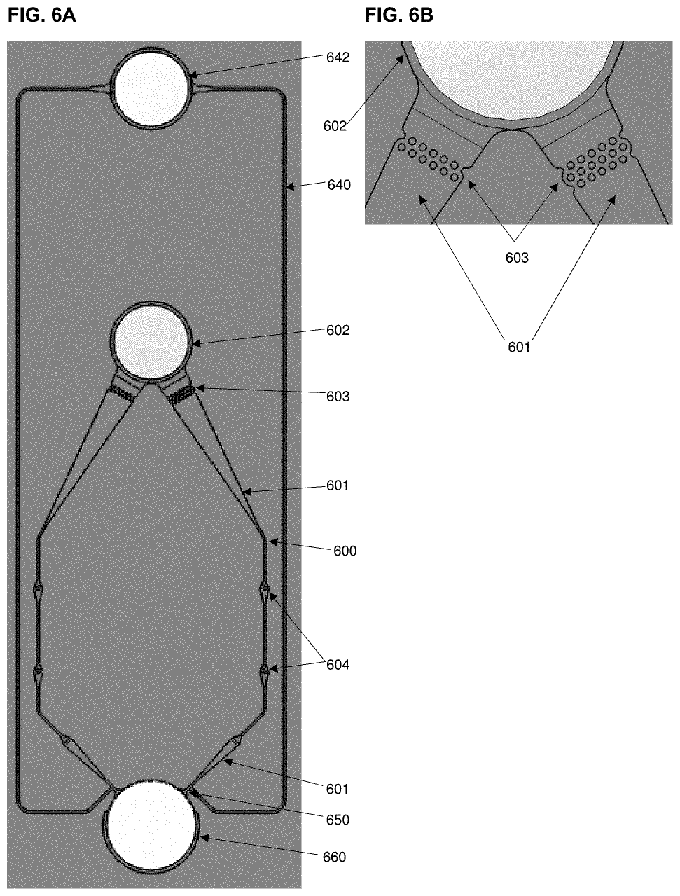

FIG. 6A is an image showing the top view of an exemplary device of the invention. The device includes two first channels 600, each first channel having two funnels 601 and two mini-rectifiers 604; first reservoir 602; two second channels 640 fluidically connected to the same second reservoir 642; two droplet formation regions 650; and one droplet collection region 660. Proximal funnel 601 on the left includes two rows of pegs 603 as hurdles. Proximal funnel 601 on the right includes three rows of pegs 603 as hurdles. Droplet collection region 660 is in fluid communication with first reservoir 602 and second reservoir 642. The spacing between pegs 603 is 65 μm.

In use, beads and a first liquid, preloaded into reservoir 602, are allowed to flow from reservoir 602 to droplet formation regions 650. The bead flow rate and spacing may be adjusted as needed by controlling the pressure in reservoir 602. Rectifiers 601 and mini-rectifiers 604 can also provide control over bead spacing and spacing uniformity. Sample (e.g., a third liquid) may be loaded into reservoir 642 and allowed to flow to droplet formation regions 650 through second channels 640. At intersections between first channels 600 and second channels 640, the bead stream is combined with the sample stream, and the combined beads, first liquid, and sample proceed to droplet formation regions 650, where the combined streams contact a second liquid in droplet collection region 660 to form droplets, preferably, droplets containing a single bead. Rectifiers 601, mini-rectifiers 604, and hurdles 603 thus can be used to control particle (e.g., bead) spacing to allow for the formation of droplets containing a single particle.

FIG. 6B is an image focused on the combination of proximal funnels 601 and first reservoir 602. Proximal funnel 601 on the left is fluidically connected to first reservoir 602 and includes two rows of pegs 603 as hurdles. Proximal funnel 601 on the right is fluidically connected to first reservoir 602 and includes three rows of pegs 603 as hurdles.

### Example 6

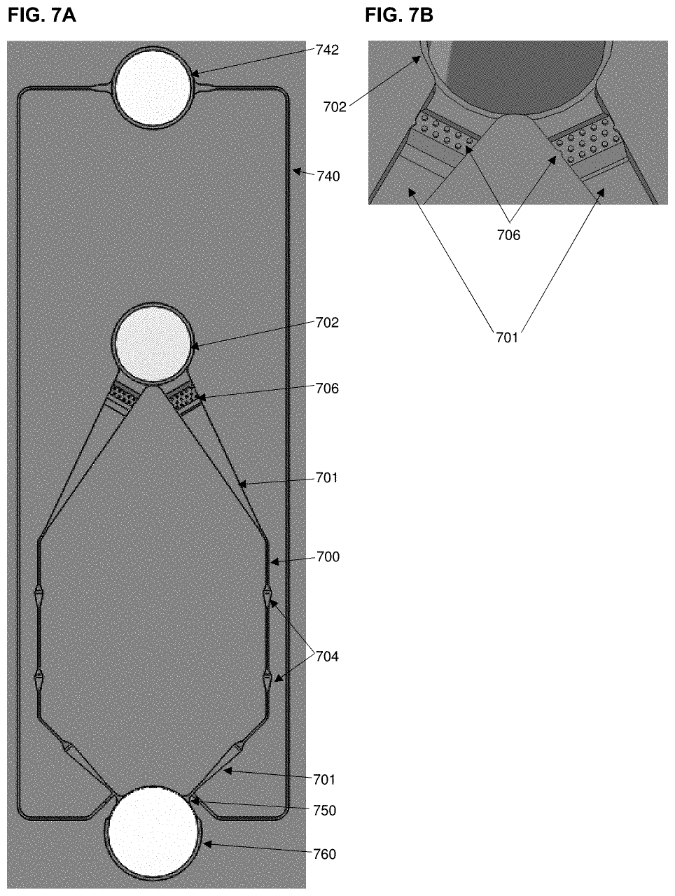

FIG. 7A is an image showing the top view of an exemplary device of the invention. The device includes two first channels 700, each first channel having two funnels 701 and two mini-rectifiers 704; first reservoir 702; two second channels 740 fluidically connected to the same second reservoir 742; two droplet formation regions 750; and one droplet collection region 760. Proximal funnel 701 on the left includes a barrier with two rows of pegs disposed on top of the barrier as hurdle 706. Proximal funnel 701 on the right includes a barrier with three rows of pegs disposed on top of the barrier as a hurdle 706. Droplet collection region 760 is in fluid communication with first reservoir 702 and second reservoir 742. Each hurdle 706 is a 30 μm-tall barrier with pegs spaced at 100 μm.

In use, beads and a first liquid, preloaded into reservoir 702, are allowed to flow from reservoir 702 to droplet formation regions 750. The bead flow rate and spacing may be adjusted as needed by controlling the pressure in reservoir 702. Rectifiers 701 and mini-rectifiers 704 can also provide control over bead spacing and spacing uniformity. Sample (e.g., a third liquid) may be loaded into reservoir 742 and allowed to flow to droplet formation regions 750 through second channels 740. At intersections between first channels 700 and second channels 740, the bead stream is combined with the sample stream, and the combined beads, first liquid, and sample proceed to droplet formation regions 750, where the combined streams contact a second liquid in droplet collection region 760 to form droplets, preferably, droplets containing a single bead. Rectifiers 701, mini-rectifiers 704, and hurdles 706 thus can be used to control particle (e.g., bead) spacing to allow for the formation of droplets containing a single particle.

FIG. 7B is an image focused on the combination of proximal funnels 701 and first reservoir 702. Proximal funnel 701 on the left is fluidically connected to first reservoir 702 and includes a barrier with two rows of pegs disposed on top of the barrier as hurdle 706. Proximal funnel 701 on the right is fluidically connected to first reservoir 702 includes a barrier with three rows of pegs disposed on top of the barrier as hurdle 706.

### Example 7

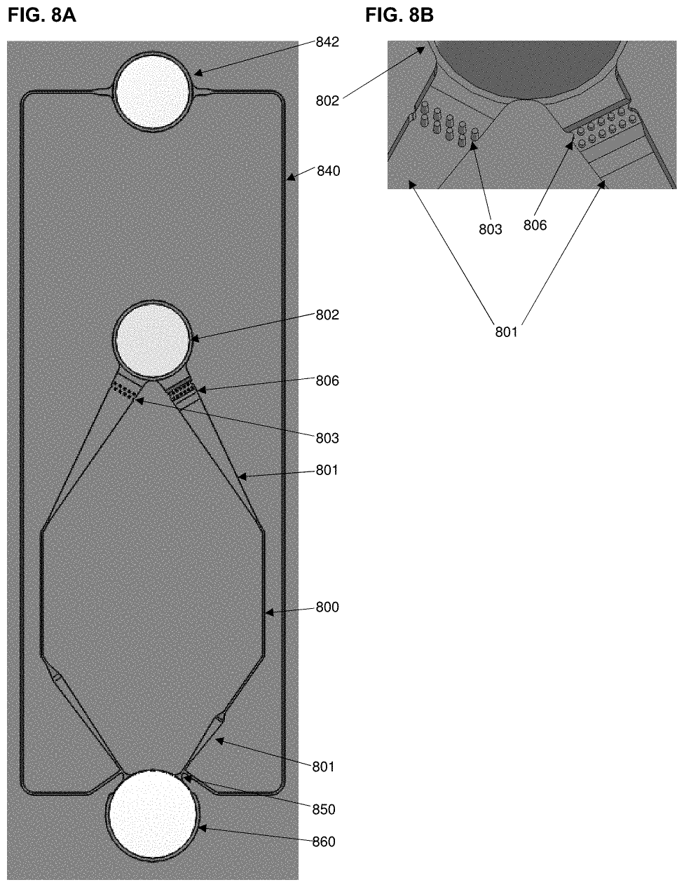

FIG. 8A is an image showing the top view of an exemplary device of the invention. The device includes two first channels 800, each first channel having two funnels 801; first reservoir 802; two second channels 840 fluidically connected to the same second reservoir 842; two droplet formation regions 850; and one droplet collection region 860. Proximal funnel 801 on the left includes two rows of pegs 803 as hurdles. Pegs 803 are spaced at 100 μm. Proximal funnel 801 on the right includes a barrier with two rows of pegs disposed on top of the barrier as a hurdle 806. Hurdle 806 is a 60 μm-tall barrier with pegs spaced at 65 μm. Distal funnel 801 on the left is elongated (2 mm in length). Droplet collection region 860 is in fluid communication with first reservoir 802 and second reservoir 842.

In use, beads and a first liquid, preloaded into reservoir 802, are allowed to flow from reservoir 802 to droplet formation regions 850. The bead flow rate and spacing may be adjusted as needed by controlling the pressure in reservoir 802. Rectifiers 801 can also provide control over bead spacing and spacing uniformity. Sample (e.g., a third liquid) may be loaded into reservoir 842 and allowed to flow to droplet formation regions 850 through second channels 840. At intersections between first channels 800 and second channels 840, the bead stream is combined with the sample stream, and the combined beads, first liquid, and sample proceed to droplet formation regions 850, where the combined streams contact a second liquid in droplet collection region 860 to form droplets, preferably, droplets containing a single bead. Rectifiers 801 and hurdles 803 and 806 thus can be used to control particle (e.g., bead) spacing to allow for the formation of droplets containing a single particle.

FIG. 8B is an image focused on the combination of proximal funnels 801 and first reservoir 802. Proximal funnel 801 on the left is fluidically connected to first reservoir 802 and includes two rows of pegs 803 as hurdles. Proximal funnel 801 on the right is fluidically connected to first reservoir 802 includes a barrier with two rows of pegs disposed on top of the barrier as hurdle 806.

### Example 8

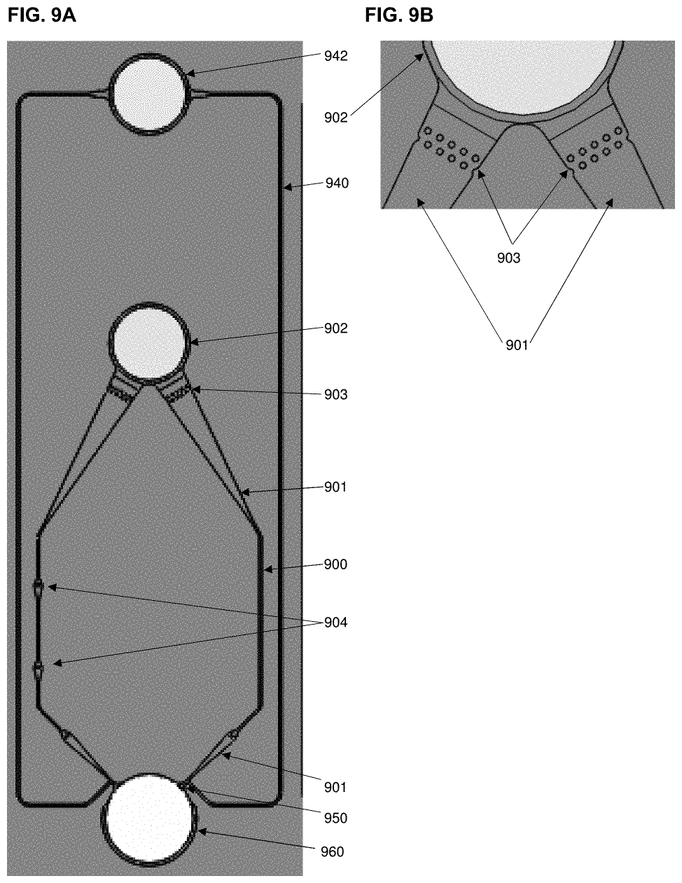

FIG. 9A is an image showing the top view of an exemplary device of the invention. The device includes two first channels 900, each first channel having two funnels 901, where first channel 900 on the left includes two mini-rectifiers 904, and first channel 900 on the right does not; first reservoir 902; two second channels 940 fluidically connected to the same second reservoir 942; two droplet formation regions 950; and one droplet collection region 960. First channel 900 on the left has dimensions of 65×60 μm, and first channel 900 on the right has dimensions of 70×65 μm. Each proximal funnel 901 includes a barrier with two rows of pegs 903 as hurdles. Droplet collection region 960 is in fluid communication with first reservoir 902 and second reservoir 942.

In use, beads and a first liquid, preloaded into reservoir 902, are allowed to flow from reservoir 902 to droplet formation regions 950. The bead flow rate and spacing may be adjusted as needed by controlling the pressure in reservoir 902. Rectifiers 901 alone or in combination with mini-rectifiers 904 can also provide control over bead spacing and spacing uniformity. Sample (e.g., a third liquid) may be loaded into reservoir 942 and allowed to flow to droplet formation regions 950 through second channels 940. At intersections between first channels 900 and second channels 940, the bead stream is combined with the sample stream, and the combined beads, first liquid, and sample proceed to droplet formation regions 950, where the combined streams contact a second liquid in droplet collection region 960 to form droplets, preferably, droplets containing a single bead. Rectifiers 901, mini-rectifiers 904, and hurdles 903 thus can be used to control particle (e.g., bead) spacing to allow for the formation of droplets containing a single particle.

FIG. 9B is an image focused on the combination of proximal funnels 901 and first reservoir 902. Each proximal funnel 901 on the left is fluidically connected to first reservoir 902 and includes two rows of pegs 903 as hurdles.

### Example 9

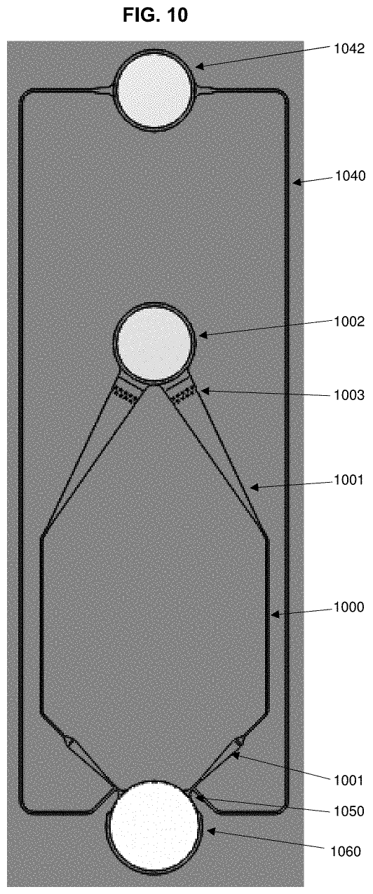

FIG. 10 illustrates an exemplary device of the invention. The device includes two first channels 1000, each first channel having two funnels 1001; first reservoir 1002; two second channels 1040 fluidically connected to the same second reservoir 1042; two droplet formation regions 1050; and one droplet collection region 1060. First channel 1000 on the left has dimensions of 65×110 μm, and first channel 1000 on the right has dimensions of 60×55 μm. Each proximal funnel 1001 includes two rows of pegs 1003 as hurdles. Droplet collection region 1060 is in fluid communication with first reservoir 1002 and second reservoir 1042.

In use, beads and a first liquid, preloaded into reservoir 1002, are allowed to flow from reservoir 1002 to droplet formation regions 1050. The bead flow rate and spacing may be adjusted as needed by controlling the pressure in reservoir 1002. Rectifiers 1001 can also provide control over bead spacing and spacing uniformity. Sample (e.g., a third liquid) may be loaded into reservoir 1042 and allowed to flow to droplet formation regions 1050 through second channels 1040. At intersections between first channels 1000 and second channels 1040, the bead stream is combined with the sample stream, and the combined beads, first liquid, and sample proceed to droplet formation regions 1050, where the combined streams contact a second liquid in droplet collection region 1060 to form droplets, preferably, droplets containing a single bead. Rectifiers 1001 and hurdles 1003 thus can be used to control particle (e.g., bead) spacing to allow for the formation of droplets containing a single particle.

### Example 10

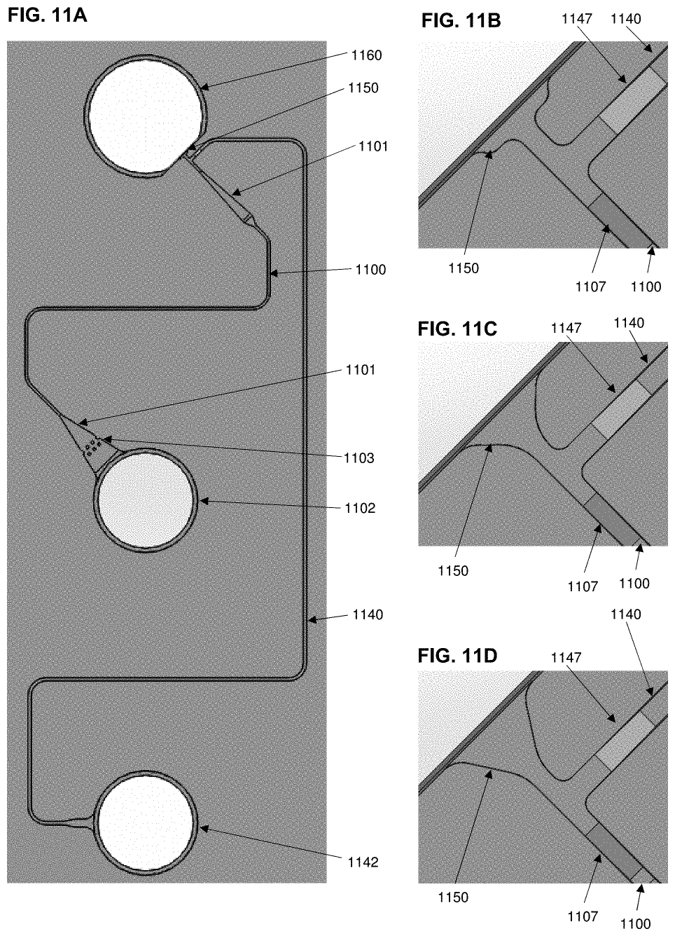

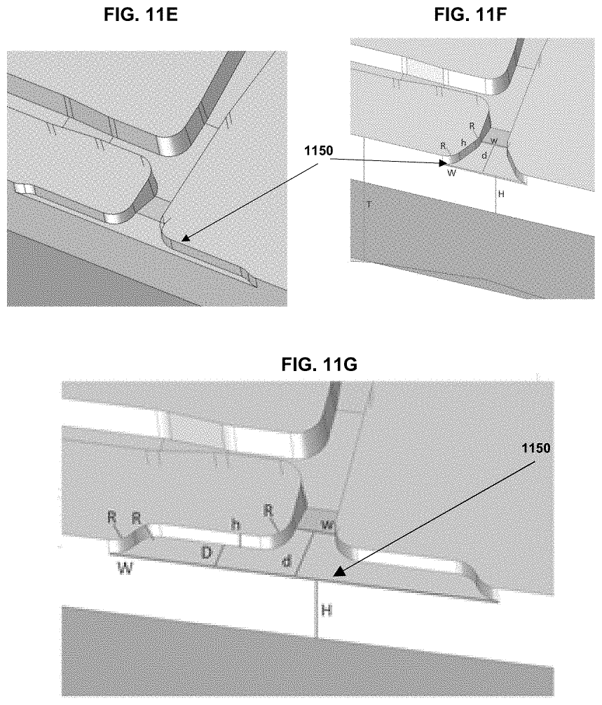

FIG. 11A is an image showing the top view of an exemplary device of the invention. The device includes first channel 1100 having two funnels 1101, first reservoir 1102, second channel 1140 fluidically connected to second reservoir 1142, droplet formation region 1150, and droplet collection region 1160. First channel 1100 on the left has dimensions of 55×50 μm, and first channel 1100 on the right has dimensions of 50×50 μm. Proximal funnel 1101 includes two rows of pegs 1103 as hurdles. Droplet collection region 1160 is in fluid communication with first reservoir 1102 and second reservoir 1142.

In use, beads and a first liquid, preloaded into reservoir 1102, are allowed to flow from reservoir 1102 to droplet formation region 1150. The bead flow rate and spacing may be adjusted as needed by controlling the pressure in reservoir 1102. Rectifiers 1101 can also provide control over bead spacing and spacing uniformity. Sample (e.g., a third liquid) may be loaded into reservoir 1142 and allowed to flow to droplet formation region 1150 through second channel 1140. At an intersection between first channel 1100 and second channel 1140, the bead stream is combined with the sample stream, and the combined beads, first liquid, and sample proceed to droplet formation region 1150, where the combined streams contact a second liquid in droplet collection region 1160 to form droplets, preferably, droplets containing a single bead. Rectifiers 1101 and hurdles 1103 thus can be used to control particle (e.g., bead) spacing to allow for the formation of droplets containing a single particle.

FIG. 11B, FIG. 11C, FIG. 11D, FIG. 11E, FIG. 11F, and FIG. 11G focus on droplet formation region 1150 and intersection between first channel 1100 and second channel 1140. In these figures, first channel 1100 includes channel portion 1107 where first depth is reduced in proximal-to-distal direction, second channel 1140 includes a channel portion 1147 where second depth is reduced in proximal-to-distal direction.

### Example 11

FIG. 13 is an image showing the top view of an exemplary device of the invention. The device includes first channel 1300 fluidically connected to first reservoir 1302, second channel 1340 including mixer 1380 and fluidically connected to second reservoir 1342, third channel 1370 fluidically connected to third reservoir 1372, droplet formation region 1350, and droplet collection region 1360. Third channel 1370 intersects second channel 1340, the distal end of which is fluidically connected to first channel 1300. Droplet collection region 1360 is in fluid communication with first reservoir 1302, second reservoir 1342, and third reservoir 1372.

In use, beads and a first liquid, preloaded into reservoir 1302, are allowed to flow from reservoir 1302 to droplet formation region 1350. The bead flow rate and spacing may be adjusted as needed by controlling the pressure in reservoir 1302. Channel 1300 may be modified upstream of the intersection between first channel 1300 and second channel 1340 to include one or more funnels to control bead spacing as needed. Sample (e.g., cells in a third liquid) may be loaded into reservoir 1342 and allowed to flow to droplet formation region 1350 through second channel 1340. Lysing reagents (e.g., a fourth liquid) may be loaded into reservoir 1372 and allowed to flow to droplet formation region 1350 through third channel 1370. At an intersection between second channel 1340 and third channel 1370, the sample stream is combined with the lysing reagent stream, and the combined liquids are mixed in mixer 1380. At an intersection between first channel 1300 and second channel 1340, the bead stream is combined with the mixed sample/lysing reagent stream, and the combined beads, sample, and lysing reagent proceed to droplet formation region 1350, where the combined streams contact a second liquid in droplet collection region 1360 to form droplets, preferably, droplets containing a single bead.

Mixer 1380 thus can be used to mix a sample (e.g., cells) and lysing reagents to avoid prolonged exposure of a sample portion to a localized high concentration of lysing reagents, which, absent mixing in a mixer, can result in sample (e.g., cell) lysis prior to droplet formation.

The channel/mixer configuration described in this Example is particularly advantageous, as it provides superior control over relative proportions of beads, cells, and lysing reagent. This is because each of the beads, cells, and lysing reagent proportions can be controlled independently through controlling pressures in reservoirs 1302, 1342, and 1372.

### Example 12

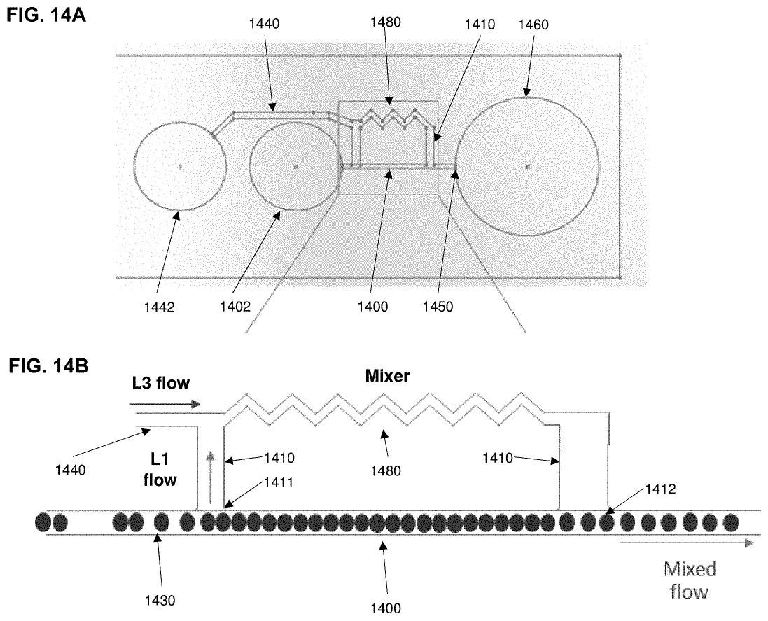

FIG. 14A is an image showing the top view of an exemplary device of the invention. The device includes first channel 1400 fluidically connected to first reservoir 1402, first side channel 1410 including mixer 1480, second channel 1440 fluidically connected to second reservoir 1442 and to first side-channel 1410, droplet formation region 1450, and droplet collection region 1460. Droplet collection region 1460 is in fluid communication with first reservoir 1402 and second reservoir 1442.

FIG. 14B focuses on a portion of the device of FIG. 14A in use. A mixture of first liquid L1 and beads 1430 is carried through first channel 1400 in the proximal-to-distal direction. Excess first liquid L1 is diverted from first channel 1400 at intersection 1411 into first side-channel 1410. Excess L1 is then combined with L3 at the intersection of first side-channel 1410 and second channel 1440. The combination of first liquid L1 and third liquid L3 then enters mixer 1480 and, after mixing, is combined with beads 1430/first liquid L1 at intersection 1412. As shown in FIG. 14B, beads 1430 are unevenly spaced in the proximal portion of first channel 1400 before intersection 1411. Between intersections 1411 and 1412 beads 1430 are tightly packed in first channel 1400. After intersection 1412, beads 1430 are substantially evenly spaced.

In use, beads and a first liquid containing lysing reagents, preloaded into reservoir 1402, are allowed to flow from reservoir 1402 to droplet formation region 1450. The bead flow rate and spacing may be adjusted as needed by controlling the pressure in reservoir 1402 and in first side-channel 1410. Channel 1400 may also be modified upstream of intersection 1412 to include one or more funnels to control bead spacing as needed. Sample (e.g., cells in a third liquid) may be loaded into reservoir 1442 and allowed to flow to droplet formation region 1450 through second channel 1440. At an intersection between first side-channel 1410 and second channel 1440, the sample stream is combined with the bead-free lysing reagent stream, and the combined liquids are mixed in mixer 1480. At intersection 1412, the bead stream is combined with the mixed sample/lysing reagent stream, and the combined beads, sample, and lysing reagent proceed to droplet formation region 1450, where the combined streams contact a second liquid in droplet collection region 1460 to form droplets, preferably, droplets containing a single bead.

Mixer 1480 thus can be used to mix a sample (e.g., cells) and lysing reagents to avoid prolonged exposure of a sample portion to a localized high concentration of lysing reagents, which, absent mixing in a mixer, can result in sample (e.g., cell) lysis prior to droplet formation.

The channel/mixer configuration described in this Example is particularly advantageous, as control over fewer fluid pressure parameters is required. In particular, the channel/mixer configuration described in this Example requires control over relative pressures in only two reservoirs, 1402 and 1442.

### Example 13

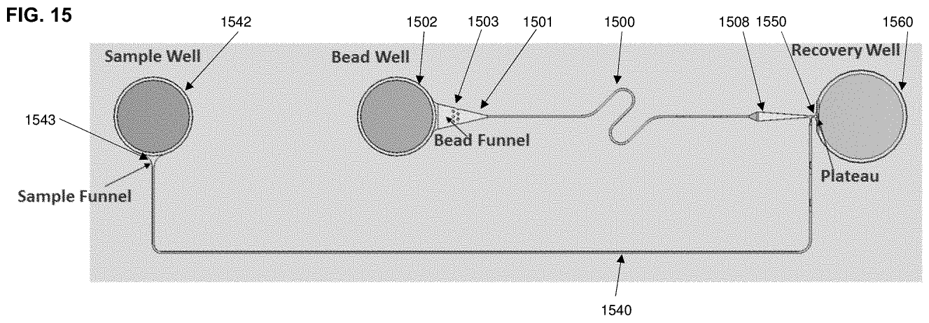

FIG. 15 illustrates an exemplary device of the invention. The device includes first channel 1500 fluidically connected to first reservoir 1502. First channel 1500 includes funnel 1501 disposed at its proximal end. Funnel 1501 at the proximal end of first channel 1500 includes pegs 1503. The device includes droplet collection region 1560 fluidically connected to droplet formation region 1550. The device also includes second reservoir 1542 fluidically connected to second channel 1540 that includes funnel 1543 at its proximal end. Second channel 1540 intersects channel 1500 between the first distal end and funnel 1508.

In use, beads and a first liquid containing lysing reagents, preloaded into reservoir 1502, are allowed to flow from reservoir 1502 to droplet formation region 1550. Sample (e.g., cells in a third liquid) may be loaded into reservoir 1542 and allowed to flow to droplet formation region 1550 through second channel 1540. At an intersection between first channel 1500 and second channel 1540, the sample stream is combined with the bead/lysing reagent stream, and the combined liquids proceed to droplet formation region 1550 to form droplets, preferably, droplets containing a single bead, for collection in droplet collection region 1560.

### Example 14

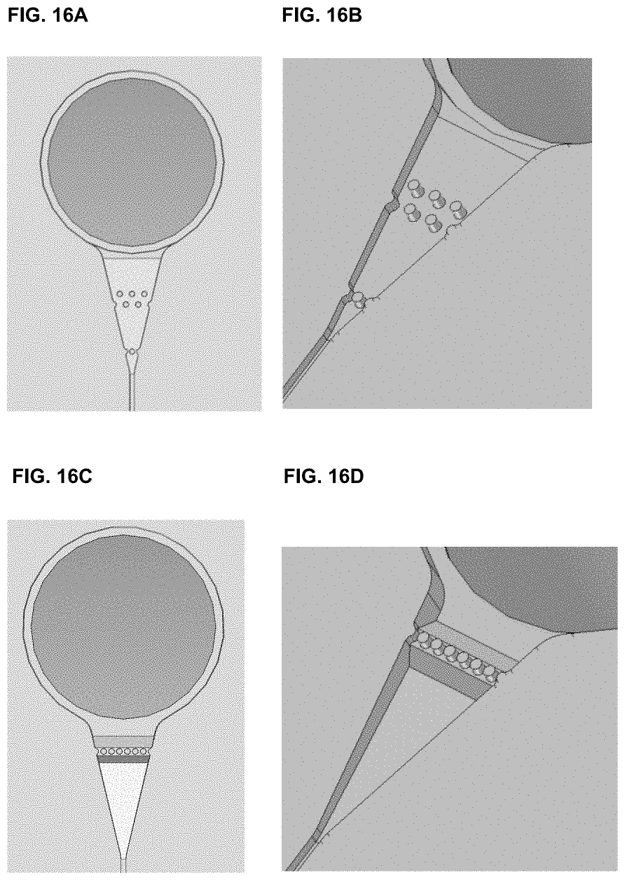

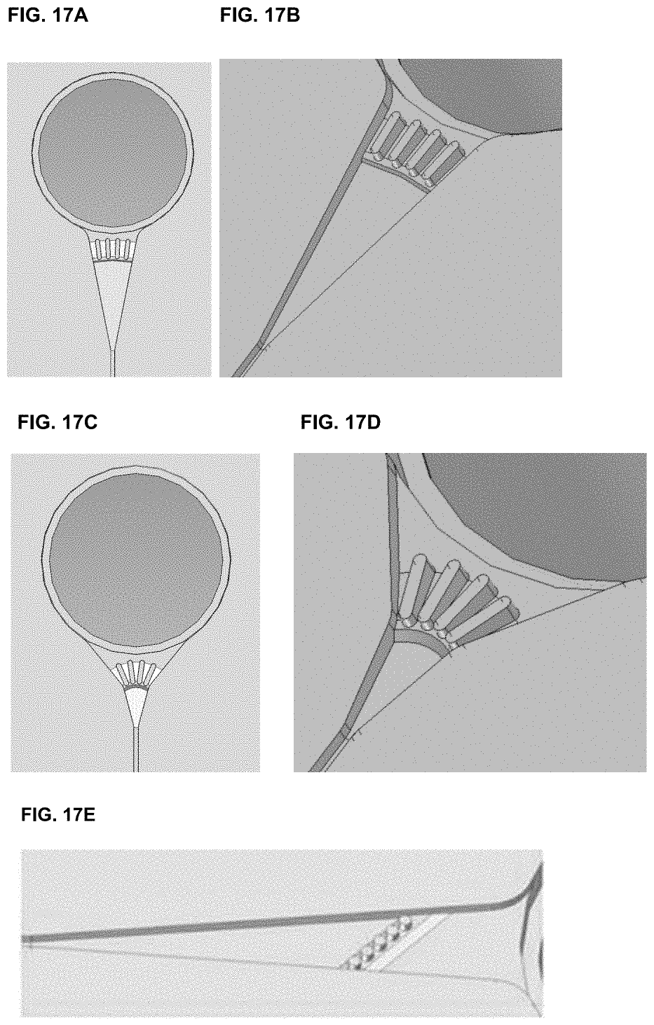

FIGS. 16A, 16B, 16C, 16D, 17A, 17B, 17C, and 17D show exemplary funnel configurations that may be included in any of the devices described herein (e.g., in a first channel).

FIG. 16A is a top view of an exemplary funnel that may be included, e.g., at the proximal end of a first channel. The funnel includes two rows of pegs as hurdles closer to the funnel inlet and a single row of pegs (in this instance, a peg) closer to the funnel outlet. FIG. 16B is a perspective view of an exemplary funnel shown in FIG. 16A.

FIG. 17A is a top view of an exemplary funnel that may be included, e.g., at the proximal end of a first channel. The funnel includes a barrier with one row of pegs disposed on top of the barrier as hurdle. FIG. 17B is a perspective view of an exemplary funnel shown in FIG. 17A.

FIG. 17C is a top view of an exemplary funnel that may be included, e.g., at the proximal end of a first channel. The funnel includes a barrier with one row of pegs disposed on top of the barrier as hurdle. The pegs have a peg length that is greater than the peg width. FIG. 17D is a perspective view of an exemplary funnel shown in FIG. 17C.

FIG. 17E is a perspective view of an exemplary funnel that may be included, e.g., at the proximal end of a first channel.

### Example 15

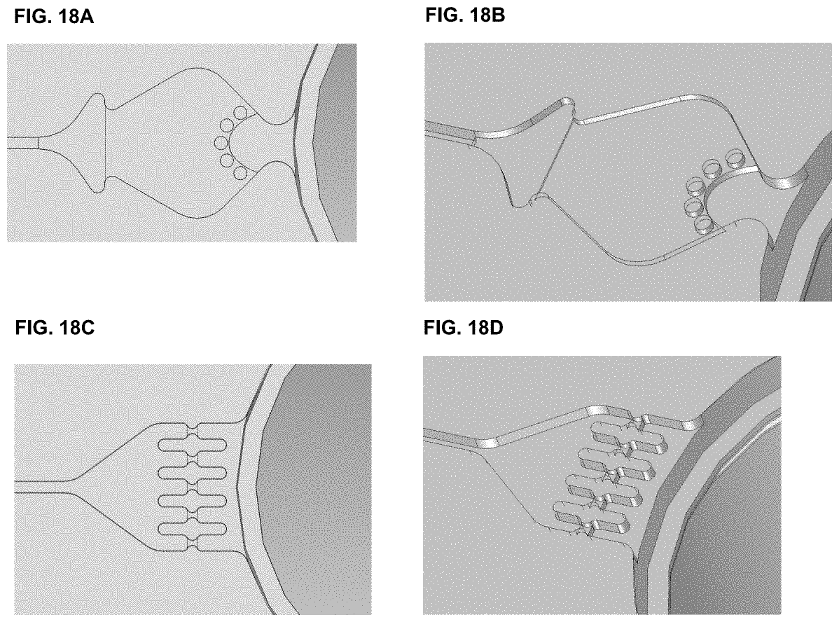

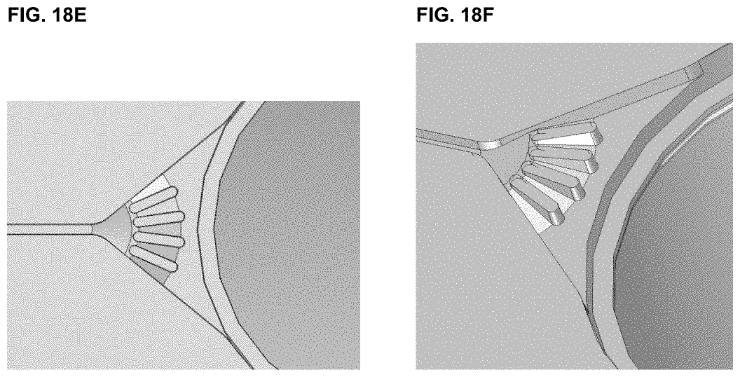

FIGS. 18A, 18B, 18C, 18D, 18E, and 18F show exemplary funnel configurations that may be included in any of the devices described herein (e.g., in a second channel).

FIG. 18A is a top view of an exemplary funnel that may be included, e.g., at the proximal end of a second channel. The funnel includes a barrier with one row of pegs disposed along a curve on top of the barrier as hurdle. FIG. 18B is a perspective view of an exemplary funnel shown in FIG. 18A.

FIG. 18C is a top view of an exemplary funnel that may be included, e.g., at the proximal end of a first channel. The funnel includes a barrier with one row of pegs disposed on top of the barrier as hurdle. The pegs have a peg length that is greater than the peg width. FIG. 18D is a perspective view of an exemplary funnel shown in FIG. 18C.

FIG. 18E is a top view of an exemplary funnel that may be included, e.g., at the proximal end of a first channel. The funnel includes a barrier with one row of pegs disposed along a curve. The pegs have a peg length that is greater than the peg width. The funnel also includes a ramp. FIG. 18F is a perspective view of an exemplary funnel shown in FIG. 18E.

### Example 16

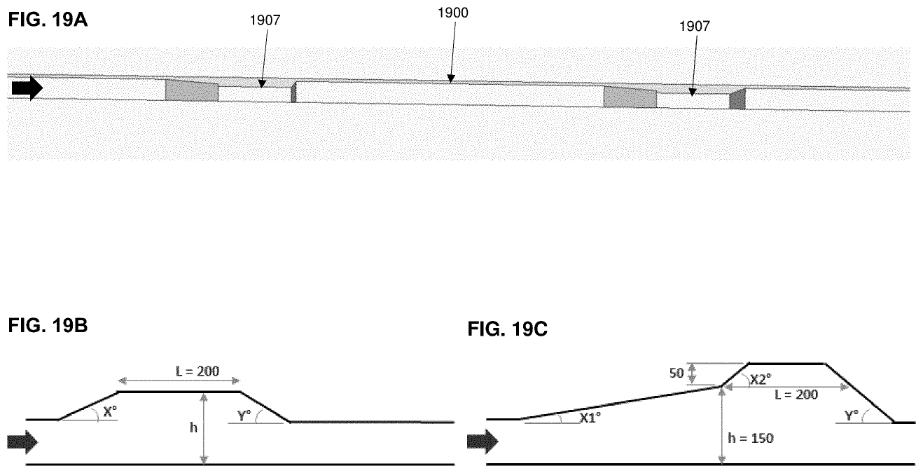

FIGS. 19A, 19B, and 19C show exemplary traps arranged in a channel. These traps can be included in any of the devices described herein (e.g., in a first channel, a second channel, a third channel, a first side-channel, or a second side-channel). FIG. 19A is a top view of an exemplary series of traps. In this figure, channel 1900 includes two traps 1907. The solid-fill arrow indicates the liquid flow direction through the channel including a series of traps. FIG. 19B is a side view cross section of a channel including a trap. The trap has a length (L) and depth (h). In operation, air bubbles that might be carried with a liquid can be lifted by the air buoyancy and thus are removed from the liquid flow. FIG. 19C is a side view cross section of a channel including a trap. The trap has a length (L) and depth (h+50). In operation, air bubbles that might be carried with a liquid can be lifted by the air buoyancy and thus are removed from the liquid flow.

### Example 17

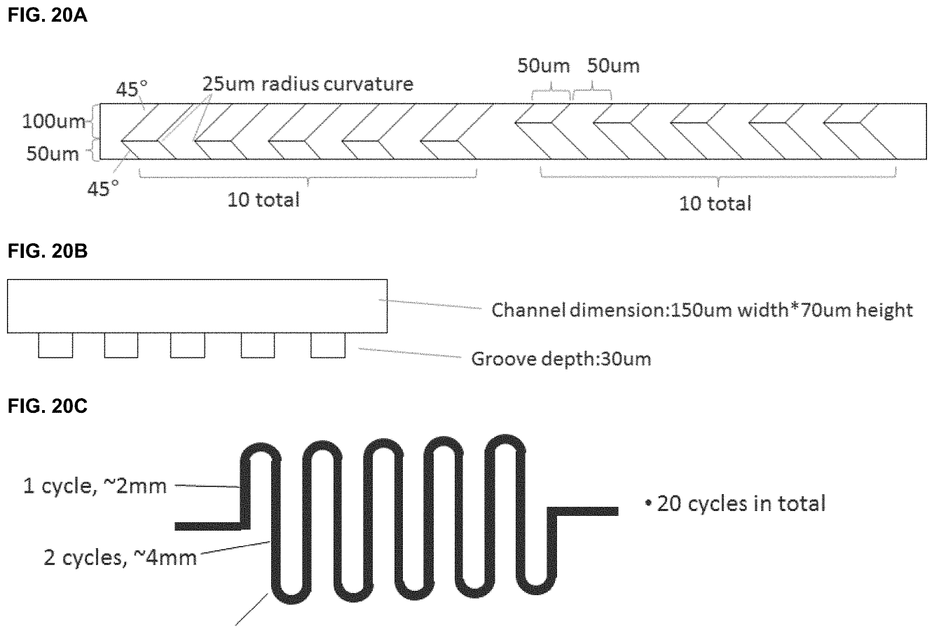

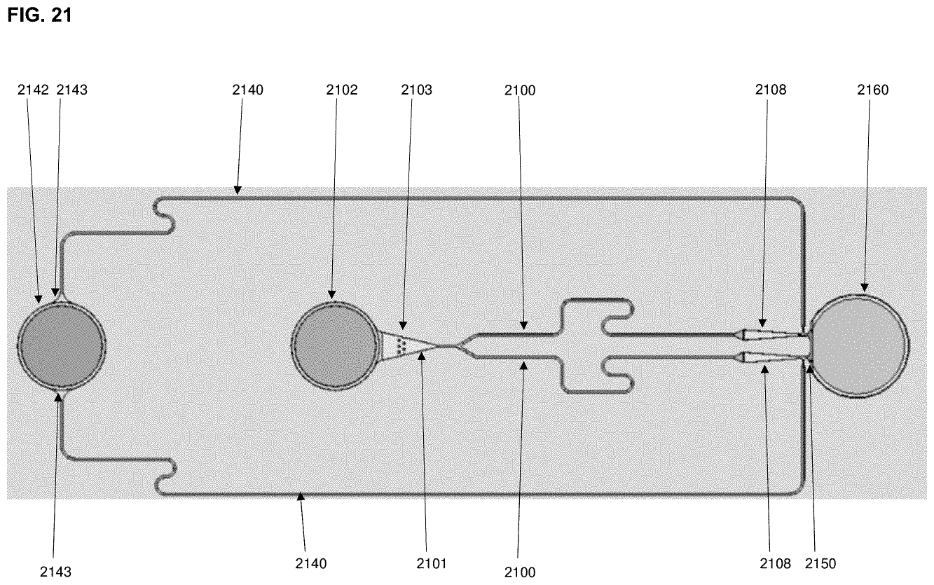

FIGS. 20A, 20B, and 20C show an exemplary herringbone mixer and its arrangement in a channel. These mixers can be included in any of the devices described herein (e.g., in a first channel or a second channel, preferably, after an intersection in which two or more liquids from different liquid sources mix). FIG. 20A is a top view of an exemplary herringbone mixer. This herringbone mixer may be used to provide a single mix cycle in a channel. The herringbone mixer includes and grooves extending transversely across the channel. In this drawing, um stands for microns. FIG. 20B is a side view cross section of an exemplary herringbone mixer portion shown in FIG. 20A. In this drawing, um stands for microns. FIG. 20C is a top view of an exemplary herringbone mixer including twenty mix cycles assembled from herringbone mixers shown in FIG. 20A.

### Example 18

FIG. 21 illustrates schematically an exemplary device of the invention. The device includes two first channels 2100, each first channel having a funnel 2108 and being in fluid communication with funnel 2101 and first reservoir 2102; two second channels 2140 in fluid communication with second reservoir 2142 and each having a funnel 2143; droplet formation region 2150; and droplet collection region 2160. The funnel 2101 includes two rows of pegs 2103 as a hurdle. Droplet collection region 2160 is in fluid communication with first reservoir 2102 and second reservoir 2142.

In use, beads and a first liquid, preloaded into reservoir 2102, are allowed to flow from reservoir 2102 to droplet formation region 2150. The bead flow rate and spacing may be adjusted as needed by controlling the pressure in reservoir 2102. Funnel 2101 can act as a rectifier and also provide control over bead spacing and spacing uniformity. Sample (e.g., a third liquid) may be loaded into reservoir 2142 and allowed to flow to droplet formation region 2150 through second channels 2140. At intersections between first channels 2100 and second channels 2140, the bead stream is combined with the sample stream, and the combined beads, first liquid, and sample proceed to droplet formation region 2150, where the combined streams contact a second liquid to form droplets, preferably, droplets containing a single bead. A single droplet formation region thus can process multiple liquid/particle streams into droplets.

### Example 19

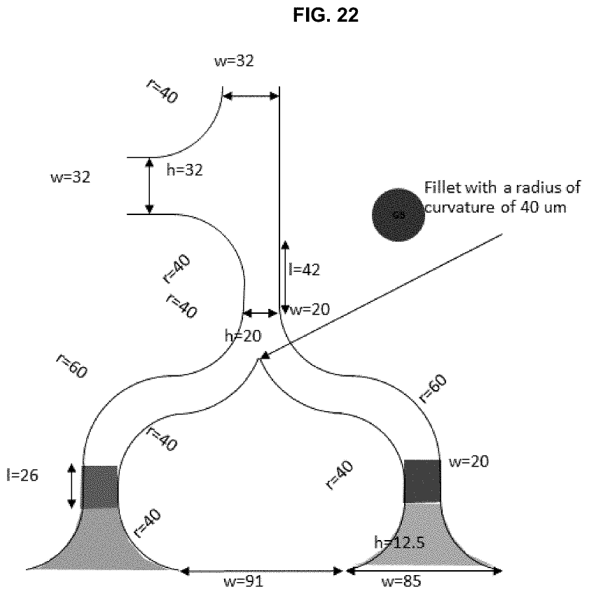

FIG. 22 illustrates schematically a portion of an exemplary device of the invention. The portion shown includes an intersection between a first channel and a second channel, a bifurcation in the first channel into two curved downstream first channels, each of which is fluidically connected to a droplet formation region (shown in light grey). The distal end of each downstream first channel includes a ramp (shown in dark grey) that decreases the depth of the downstream first channel.

In use, beads and a first liquid are allowed to flow towards the droplet formation regions through the first channel. Sample (e.g., a third liquid) may be allowed to flow to the droplet formation regions through the second channel. At the intersection between the first and second channels, the bead stream is combined with the sample stream, and the combined beads, first liquid, and sample proceed to the droplet formation regions through the first channel bifurcation and through the two downstream first channels. Without wishing to be bound by theory, it is believed that a particle entering one downstream first channel at the first channel bifurcation will cause fluid resistance behind it, thereby directing the subsequent particle to enter the other one of the two downstream first channels. Accordingly, a particle stream propagating through the first channel is expected to divide into two streams with particles entering the two downstream first channels in an alternating manner.

### Example 20

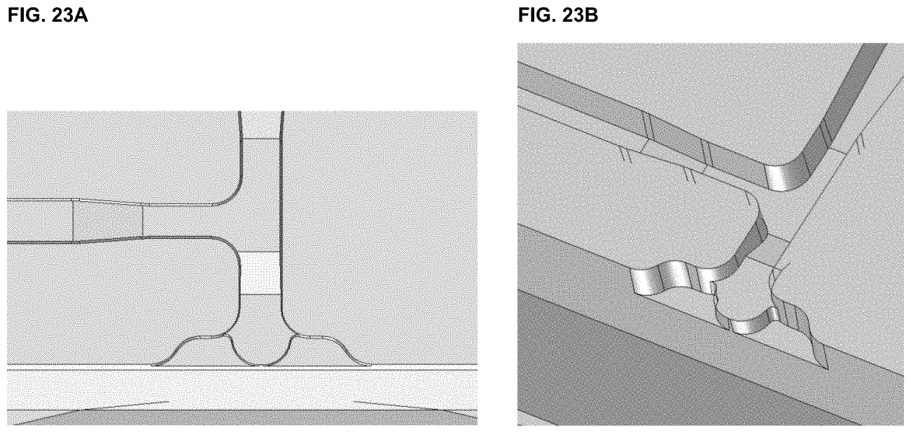

FIGS. 23A and 23B illustrate a portion of an exemplary device of the invention. The portion shown includes an intersection between a first channel and a second channel and a droplet formation region. The droplet formation region includes a shelf region with a protrusion from the first channel outlet towards the droplet collection region.

In use, beads and a first liquid are allowed to flow towards the droplet formation region through the first channel. Sample (e.g., a third liquid) may be allowed to flow to the droplet formation region through the second channel. At the intersection between the first and second channels, the bead stream is combined with the sample stream, and the combined beads, first liquid, and sample proceed to the droplet formation region. In the droplet formation region, upon droplet formation, the droplet detaches from the shelf region and is not pinned to the droplet formation region on either side of the shelf region.

### Example 21

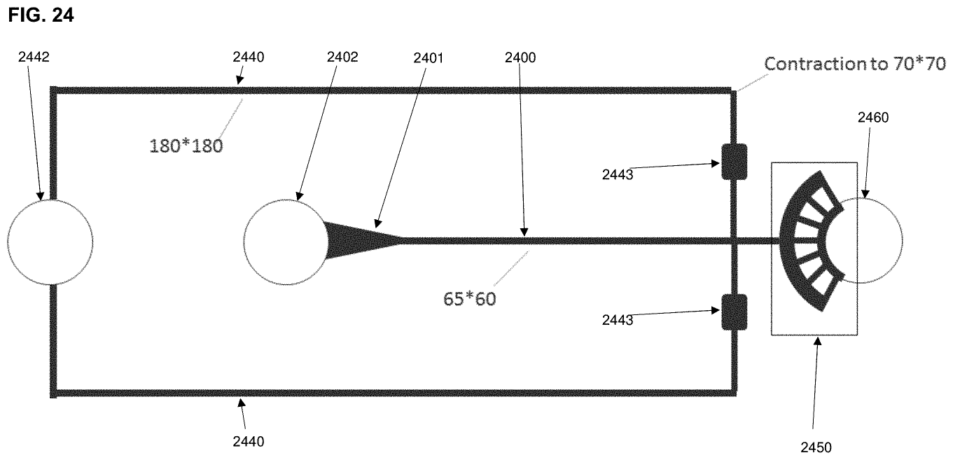

FIG. 24 illustrates schematically an exemplary device of the invention. The device includes first channel 2400 having funnel 2401; first reservoir 2402; two second channels 2440 in fluid communication with second reservoir 2442 and each having a funnel 2443; droplet formation region 2450; and droplet collection region 2460. Droplet collection region 2460 is in fluid communication with first reservoir 2402 and second reservoir 2442.

In use, beads and a first liquid, preloaded into reservoir 2402, are allowed to flow from reservoir 2402 to droplet formation region 2450. The bead flow rate and spacing may be adjusted as needed by controlling the pressure in reservoir 2402. Funnel 2401 may act as a rectifier and also provide control over bead spacing and spacing uniformity. Sample (e.g., a third liquid) may be loaded into reservoir 2442 and allowed to flow to droplet formation region 2450 through second channels 2440. Second channels 2440 include funnels 2443, which may serve as filters (e.g., by including hurdles) reducing the amount of debris from the sample carried to droplet formation region 2450. At the intersection between first channel 2400 and second channels 2440, the bead stream is combined with the sample stream, and the combined beads, first liquid, and sample proceed to droplet formation region 2450, where the combined streams contact a second liquid in droplet collection region 2460 to form droplets, preferably, droplets containing a single bead. The flow rate in the channels may be sufficiently high to produce, e.g., 500 droplets per second (droplets having 53.5 micron diameter) from droplet formation region 2450.

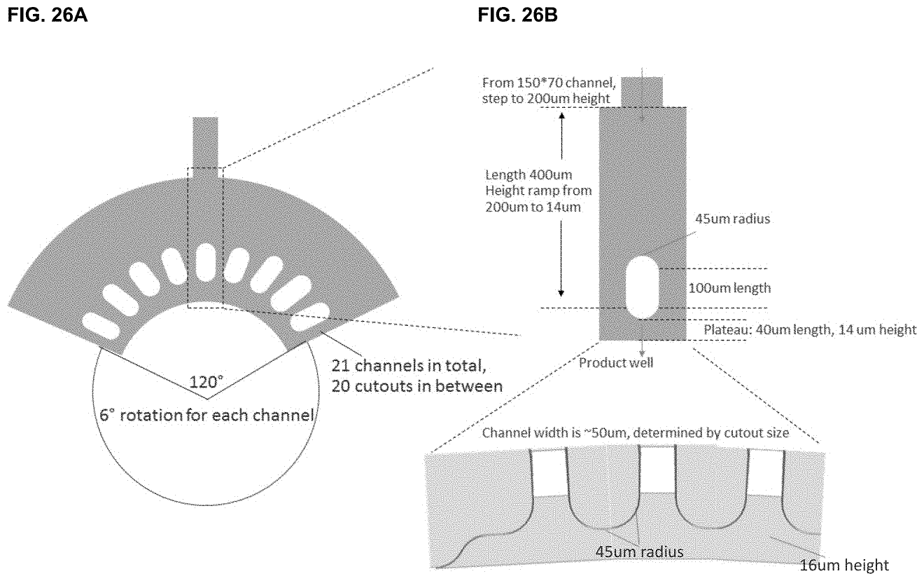

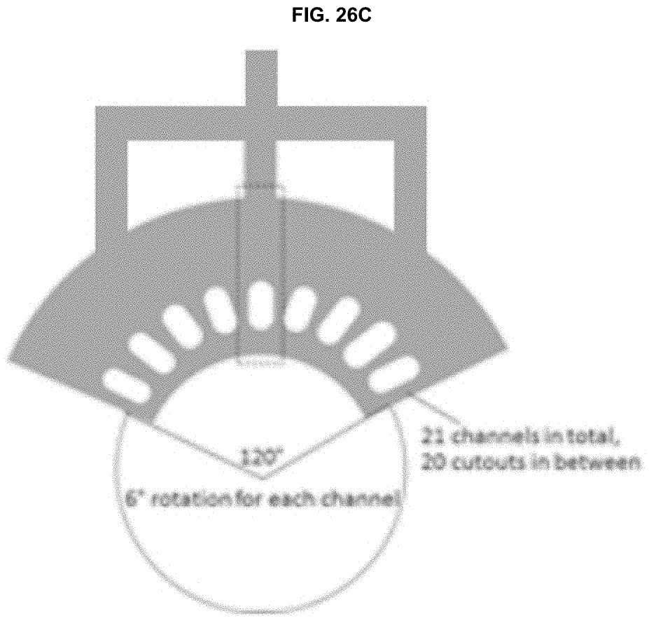

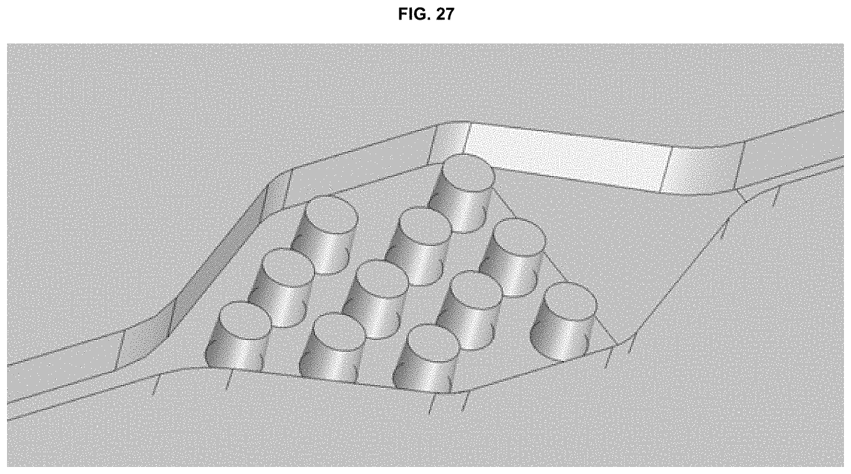

The details of droplet formation region 2450 are provided in FIGS. 27A and 27B. Exemplary details of funnels 2443 used as a filter are shown in FIG. 27. The device of FIG. 24 can alternatively include the droplet formation region and first channel configuration shown in FIG. 26C.

### Example 22

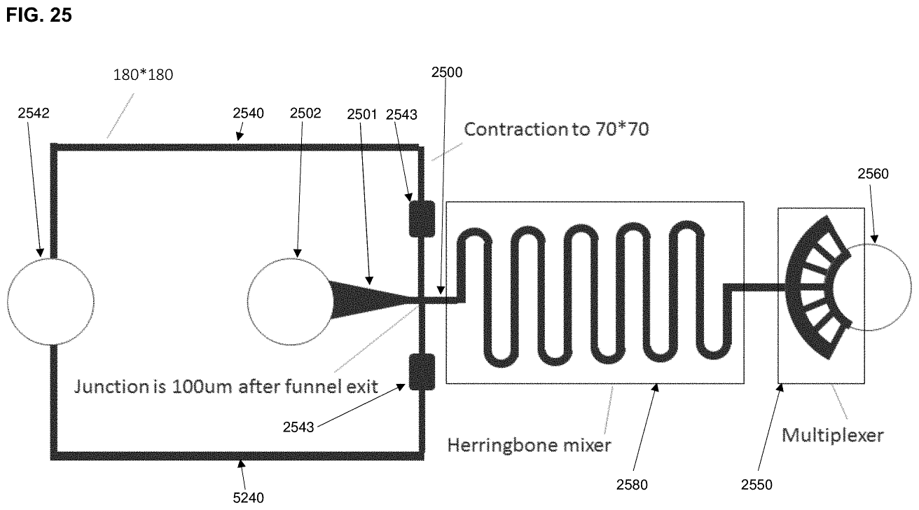

FIG. 25 illustrates schematically an exemplary device of the invention. The device includes first channel 2500 having funnel 2501 and mixer 2580; first reservoir 2502; two second channels 2540 in fluid communication with second reservoir 2542; droplet formation regions 2550; and droplet collection region 2560. Droplet collection region 2560 is in fluid communication with first reservoir 2502 and second reservoir 2542.

In use, beads and a first liquid, preloaded into reservoir 2502, are allowed to flow from reservoir 2502 to droplet formation region 2550. The bead flow rate and spacing may be adjusted as needed by controlling the pressure in reservoir 2502. Funnel 2501 can act as a rectifier and also provide control over bead spacing and spacing uniformity. Sample (e.g., a third liquid) may be loaded into reservoir 2542 and allowed to flow to droplet formation region 2550 through second channels 2540. Second channels 2540 include funnels 2543, which may serve as filters (e.g., by including hurdles) reducing the amount of debris from the sample carried to droplet formation region 2550. At the intersection between first channel 2500 and second channels 2540, the bead stream is combined with the sample stream, and the combined beads, first liquid, and sample proceed to mixer 2580 and then to droplet formation region 2550, where the combined streams contact a second liquid in droplet collection region 2560 to form droplets, preferably, droplets containing a single bead. Mixer 2580 facilitates mixing of the combined streams to improve droplet-to-droplet content uniformity. The flow rate in the channels may be sufficiently high to produce, e.g., 500 droplets per second (droplets having 53.5 micron diameter) from droplet formation region 2550.

The details of mixer 2580 are provided in FIGS. 20A, 20B, and 20C. The details of droplet formation region 2550 are provided in FIGS. 27A-27B. Exemplary details of funnels 2543 used as a filter are shown in FIG. 27. The device of FIG. 25 can alternatively include the droplet formation region and first channel configuration shown in FIG. 20C.

### Example 23

FIGS. 28A-28B show an example of a system 2800 for the detection of the status of a fluid. FIG. 28A shows the system 2800 before depletion of first fluid 2804 in a first reservoir 2850. FIG. 28B shows the system after depletion of the first fluid in the first reservoir. As shown in FIG. 28A, the first fluid is provided in the first reservoir, where a second fluid occupies the remaining volume. During regular operation, the first fluid 2804 is directed by a fluid flow unit 118 to flow along a fluid channel 2860. A sensor 2816 is provided to detect the status of the fluid flowing in the fluid channel. The fluid flow unit and/or the sensor may be operatively coupled to a controller 2820. As shown in FIG. 28B, the first fluid is depleted from the first reservoir, and the second fluid, such as air, now flows through the fluid channel. The sensor may measure the status of the first fluid/second fluid at one or more reference locations and/or at different points in time from the transition between the first fluid to the second fluid and send signals of the detected values to the controller. The controller and/or the sensor may process the sensor signals to determine whether a threshold value has been reached. Upon this determination, the controller may send one or more signals to the fluid flow unit to stop a flow in the channel and/or affect other alterations to the flow (e.g., load the depleted first reservoir with additional volumes of the first fluid or another fluid).

While FIGS. 28A-28B depict one fluid flow unit 2818, there may be a plurality of fluid flow units 2818, each in communication with the controller 2820 and/or with each other.

While FIGS. 28A-28B depict one sensor 2816, there may be a plurality of sensors which may or may not be in communication with each other, as described elsewhere herein.

While FIGS. 28A-28B depict one controller 2820 operatively coupled to both the fluid flow unit 2818 and the sensor 2816, separate controllers can be coupled to the fluid flow unit 2818 and the sensor 2816. The separate controllers may or may not be in communication with each other. In some instances, there may be a plurality of controllers (e.g., two controllers to a fluid flow unit 2818), wherein each controller may or may not be in communication with each other. The controller 2820 may send instructions to, and/or receive data from, the fluid flow unit 2818 and/or the sensor 2816 via wired connection and/or wireless connection (e.g., Wi-Fi, BLUETOOTH®, NFC, etc.).

### Example 24

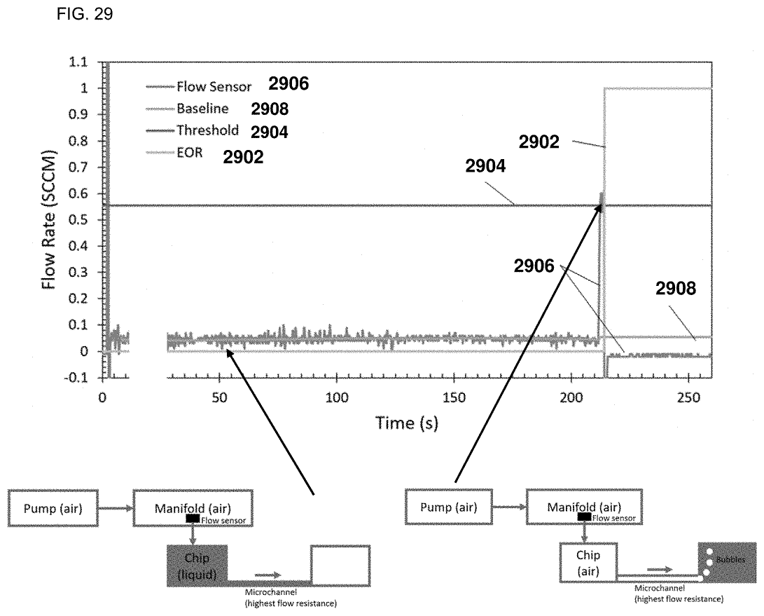

FIG. 29 shows an example of flow rate measurement results. Liquid was transported in a microfluidic device at about 0.05 standard cubic centimeters per minute (SCCM) until the liquid was depleted. A flow sensor measured the flow. The baseline measurement 2908 is indicated in FIG. 29. When the liquid depleted, the liquid in the device was displaced by air, resulting in an abrupt increase in the measured flow rate, as indicated by the flow sensor measurement 2906. This abrupt increase signaled the depletion of the liquid and thus the end of run. The end of run was determined once the flow rate exceeded a pre-determined threshold value 2904, indicated in FIG. 29. In this example, the threshold value was set at 0.55 SCCM. Also indicated in FIG. 29 is the end of run parameter 2902, which had a value of either 0 or 1. The end of run parameter was defined such that 0 indicated absence of end of run, or the liquid was still flowing through the device, and 1 indicated the presence of the end of run, or the liquid was no longer flowing through the device. In this example, end of run occurred about 2915 seconds after the start of measurement.

Further indicated in FIG. 29 are schematics of a system for detecting the end of run, with arrows from each schematic pointing to the region of the data presented in the flow rate vs. time graph. When the liquid was flowing from the reservoir and through the device, the flow sensor in the manifold detected the liquid flowing, and the flow rate measured by the sensor was at or near the baseline level. When the reservoir and channel were depleted of the liquid, the sensor registers a change in flow rate as air has completely displaced the liquid, thus triggering the end of run parameter to stop the pump.

### Example 25

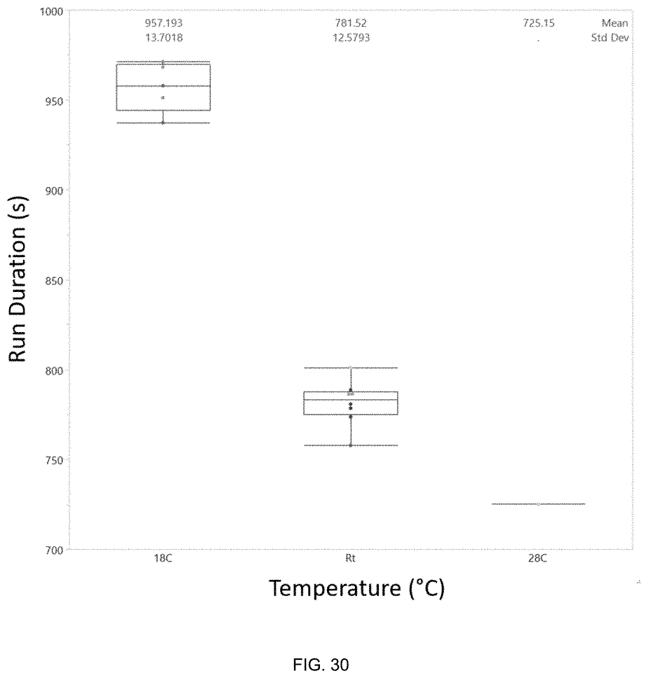

FIG. 30 shows a box-and-whisker plot of the run duration versus temperature at three different operating temperatures (18° C., room temperature (i.e., 23-25° C.), and 28° C.). The data plotted in FIG. 30 shows the difference in the amount of time necessary for a fixed volume of an input fluid to deplete from a reservoir, measured by detecting a step change in the flow rate for the input fluid. In FIG. 30, each individual data point corresponds to a different experimental run at that temperature. The variability, i.e., the whiskers of the boxes, are due to the variability of pipetting a volume of the input fluid and the fluidic resistance of the microchannel the input fluid flows in.

Examples 32-47 show various fluid flow paths including a droplet formation region that can be implemented in a device of the invention.

### Example 26

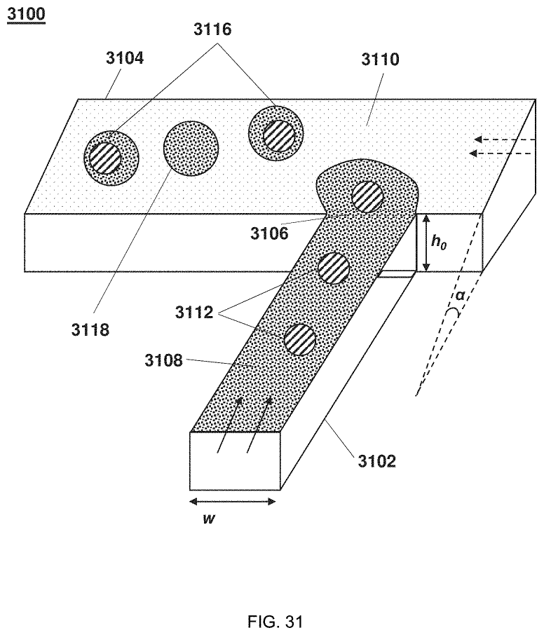

FIG. 31 shows an example of a microfluidic device for the controlled inclusion of particles, e.g., beads, into discrete droplets. A device 3100 can include a channel 3102 communicating at a fluidic connection 3106 (or intersection) with a reservoir 3104. The reservoir 3104 can be a chamber. Any reference to “reservoir,” as used herein, can also refer to a “chamber.” In operation, an aqueous liquid 3108 that includes suspended beads 3112 may be transported along the channel 3102 into the fluidic connection 3106 to meet a second liquid 3110 that is immiscible with the aqueous liquid 3108 in the reservoir 3104 to create droplets 3116, 3118 of the aqueous liquid 3108 flowing into the reservoir 3104. At the fluidic connection 3106 where the aqueous liquid 3108 and the second liquid 3110 meet, droplets can form based on factors such as the hydrodynamic forces at the fluidic connection 3106, flow rates of the two liquids 3108, 3110, liquid properties, and certain geometric parameters (e.g., w, h₀, α, etc.) of the device 3100. A plurality of droplets can be collected in the reservoir 3104 by continuously injecting the aqueous liquid 3108 from the channel 3102 through the fluidic connection 3106.

In some instances, the second liquid 3110 may not be subjected to and/or directed to any flow in or out of the reservoir 3104. For example, the second liquid 3110 may be substantially stationary in the reservoir 3104. In some instances, the second liquid 3110 may be subjected to flow within the reservoir 3104, but not in or out of the reservoir 3104, such as via application of pressure to the reservoir 3104 and/or as affected by the incoming flow of the aqueous liquid 3108 at the fluidic connection 3106. Alternatively, the second liquid 3110 may be subjected and/or directed to flow in or out of the reservoir 3104. For example, the reservoir 3104 can be a channel directing the second liquid 3110 from upstream to downstream, transporting the generated droplets. Alternatively, or in addition, the second liquid 3110 in reservoir 3104 may be used to sweep formed droplets away from the path of the nascent droplets.

While FIG. 31 illustrates the reservoir 3104 having a substantially linear inclination (e.g., creating the expansion angle, α) relative to the channel 3102, the inclination may be non-linear. The expansion angle may be an angle between the immediate tangent of a sloping inclination and the channel 3102. In an example, the reservoir 3104 may have a dome-like (e.g., hemispherical) shape. The reservoir 3104 may have any other shape.

### Example 27

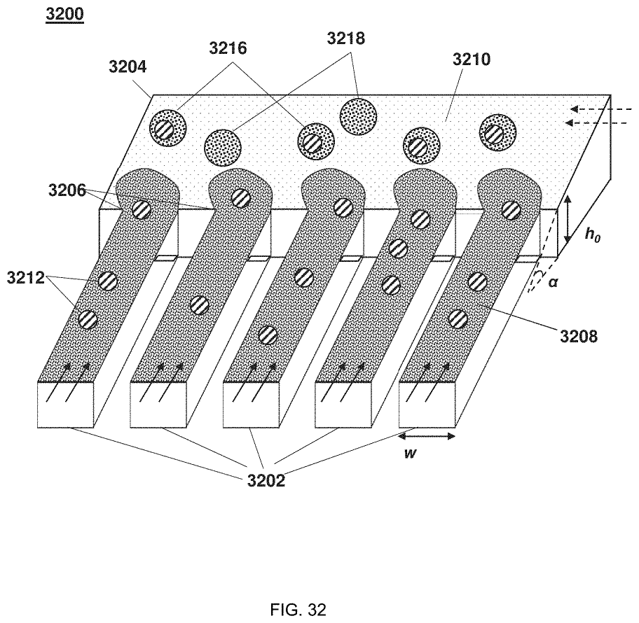

FIG. 32 shows an example of a microfluidic device for increased droplet formation throughput. A device 3200 can comprise a plurality of channels 3202 and a reservoir 3204. Each of the plurality of channels 3202 may be in fluid communication with the reservoir 3204. The device 3200 can comprise a plurality of fluidic connections 3206 between the plurality of channels 3202 and the reservoir 3204. Each fluidic connection can be a point of droplet formation. The channel 3102 from the device 3100 in FIG. 31 and any description to the components thereof may correspond to a given channel of the plurality of channels 3202 in device 3200 and any description to the corresponding components thereof. The reservoir 3104 from the device 3100 and any description to the components thereof may correspond to the reservoir 3204 from the device 3200 and any description to the corresponding components thereof.

Each channel of the plurality of channels 3202 may comprise an aqueous liquid 3208 that includes suspended particles, e.g., beads, 3212. The reservoir 3204 may comprise a second liquid 3210 that is immiscible with the aqueous liquid 3208. In some instances, the second liquid 3210 may not be subjected to and/or directed to any flow in or out of the reservoir 3204. For example, the second liquid 3210 may be substantially stationary in the reservoir 3204. Alternatively, or in addition, the formed droplets can be moved out of the path of nascent droplets using a gentle flow of the second liquid 3210 in the reservoir 3204. In some instances, the second liquid 3210 may be subjected to flow within the reservoir 3204, but not in or out of the reservoir 3204, such as via application of pressure to the reservoir 3204 and/or as affected by the incoming flow of the aqueous liquid 3208 at the fluidic connections. Alternatively, the second liquid 3210 may be subjected and/or directed to flow in or out of the reservoir 3204. For example, the reservoir 3204 can be a channel directing the second liquid 3210 from upstream to downstream, transporting the generated droplets. Alternatively, or in addition, the second liquid 3210 in reservoir 3204 may be used to sweep formed droplets away from the path of the nascent droplets.

In operation, the aqueous liquid 3208 that includes suspended particles, e.g., beads, 3212 may be transported along the plurality of channels 3202 into the plurality of fluidic connections 3206 to meet the second liquid 3210 in the reservoir 3204 to create droplets 3216, 3218. A droplet may form from each channel at each corresponding fluidic connection with the reservoir 3204. At the fluidic connection where the aqueous liquid 3208 and the second liquid 3210 meet, droplets can form based on factors such as the hydrodynamic forces at the fluidic connection, flow rates of the two liquids 3208, 3210, liquid properties, and certain geometric parameters (e.g., w, h₀, α, etc.) of the device 3200, as described elsewhere herein. A plurality of droplets can be collected in the reservoir 3204 by continuously injecting the aqueous liquid 3208 from the plurality of channels 3202 through the plurality of fluidic connections 3206. The geometric parameters, w, h₀, and α, may or may not be uniform for each of the channels in the plurality of channels 3202. For example, each channel may have the same or different widths at or near its respective fluidic connection with the reservoir 3204. For example, each channel may have the same or different height at or near its respective fluidic connection with the reservoir 3204. In another example, the reservoir 3204 may have the same or different expansion angle at the different fluidic connections with the plurality of channels 3202. When the geometric parameters are uniform, beneficially, droplet size may also be controlled to be uniform even with the increased throughput. In some instances, when it is desirable to have a different distribution of droplet sizes, the geometric parameters for the plurality of channels 3202 may be varied accordingly.

### Example 28

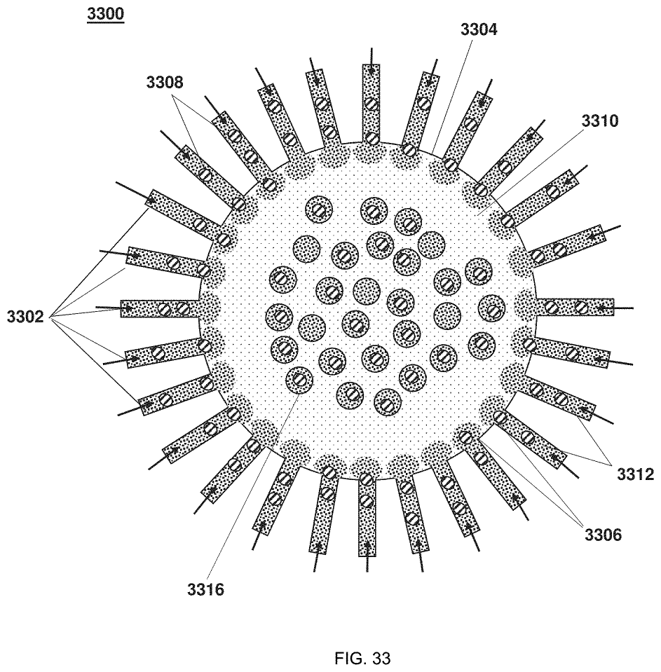

FIG. 33 shows another example of a microfluidic device for increased droplet formation throughput. A microfluidic device 3300 can comprise a plurality of channels 3302 arranged generally circularly around the perimeter of a reservoir 3304. Each of the plurality of channels 3302 may be in liquid communication with the reservoir 3304. The device 3300 can comprise a plurality of fluidic connections 3306 between the plurality of channels 3302 and the reservoir 3304. Each fluidic connection can be a point of droplet formation. The channel 3102 from the device 3100 in FIG. 31 and any description to the components thereof may correspond to a given channel of the plurality of channels 3302 in device 3300 and any description to the corresponding components thereof. The reservoir 3104 from the device 3100 and any description to the components thereof may correspond to the reservoir 3304 from the device 3300 and any description to the corresponding components thereof.

Each channel of the plurality of channels 3302 may comprise an aqueous liquid 3308 that includes suspended particles, e.g., beads, 3312. The reservoir 3304 may comprise a second liquid 3310 that is immiscible with the aqueous liquid 3308. In some instances, the second liquid 3310 may not be subjected to and/or directed to any flow in or out of the reservoir 3304. For example, the second liquid 3310 may be substantially stationary in the reservoir 3304. In some instances, the second liquid 3310 may be subjected to flow within the reservoir 3304, but not in or out of the reservoir 3304, such as via application of pressure to the reservoir 3304 and/or as affected by the incoming flow of the aqueous liquid 3308 at the fluidic connections. Alternatively, the second liquid 3310 may be subjected and/or directed to flow in or out of the reservoir 3304. For example, the reservoir 3304 can be a channel directing the second liquid 3310 from upstream to downstream, transporting the generated droplets. Alternatively, or in addition, the second liquid 3310 in reservoir 3304 may be used to sweep formed droplets away from the path of the nascent droplets.

In operation, the aqueous liquid 3308 that includes suspended particles, e.g., beads, 3312 may be transported along the plurality of channels 3302 into the plurality of fluidic connections 3306 to meet the second liquid 3310 in the reservoir 3304 to create a plurality of droplets 3316. A droplet may form from each channel at each corresponding fluidic connection with the reservoir 3304. At the fluidic connection where the aqueous liquid 3308 and the second liquid 3310 meet, droplets can form based on factors such as the hydrodynamic forces at the fluidic connection, flow rates of the two liquids 3308, 3310, liquid properties, and certain geometric parameters (e.g., widths and heights of the channels 3302, expansion angle of the reservoir 3304, etc.) of the channel 3300, as described elsewhere herein. A plurality of droplets can be collected in the reservoir 3304 by continuously injecting the aqueous liquid 3308 from the plurality of channels 3302 through the plurality of fluidic connections 3306.

### Example 29

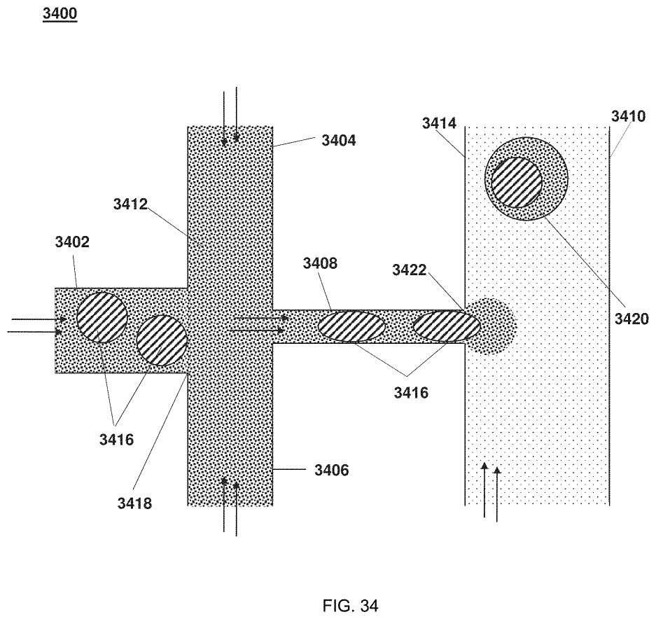

FIG. 34 shows another example of a microfluidic device for the introduction of beads into discrete droplets. A device 3400 can include a first channel 3402, a second channel 3404, a third channel 3406, a fourth channel 3408, and a reservoir 3410. The first channel 3402, second channel 3404, third channel 3406, and fourth channel 3408 can communicate at a first intersection 3418. The fourth channel 3408 and the reservoir 3410 can communicate at a fluidic connection 3422. In some instances, the fourth channel 3408 and components thereof can correspond to the channel 3102 in the device 3100 in FIG. 31 and components thereof. In some instances, the reservoir 3410 and components thereof can correspond to the reservoir 3104 in the device 3100 and components thereof.

In operation, an aqueous liquid 3412 that includes suspended particles, e.g., beads, 3416 may be transported along the first channel 3402 into the intersection 3418 at a first frequency to meet another source of the aqueous liquid 3412 flowing along the second channel 3404 and the third channel 3406 towards the intersection 3418 at a second frequency. In some instances, the aqueous liquid 3412 in the second channel 3404 and the third channel 3406 may comprise one or more reagents. At the intersection, the combined aqueous liquid 3412 carrying the suspended particles, e.g., beads, 3416 (and/or the reagents) can be directed into the fourth channel 3408. In some instances, a cross-section width or diameter of the fourth channel 3408 can be chosen to be less than a cross-section width or diameter of the particles, e.g., beads, 3416. In such cases, the particles, e.g., beads, 3416 can deform and travel along the fourth channel 3408 as deformed particles, e.g., beads, 3416 towards the fluidic connection 3422. At the fluidic connection 3422, the aqueous liquid 3412 can meet a second liquid 3414 that is immiscible with the aqueous liquid 3412 in the reservoir 3410 to create droplets 3420 of the aqueous liquid 3412 flowing into the reservoir 3410. Upon leaving the fourth channel 3408, the deformed particles, e.g., beads, 3416 may revert to their original shape in the droplets 3420. At the fluidic connection 3422 where the aqueous liquid 3412 and the second liquid 3414 meet, droplets can form based on factors such as the hydrodynamic forces at the fluidic connection 3422, flow rates of the two liquids 3412, 3414, liquid properties, and certain geometric parameters (e.g., w, h₀, α, etc.) of the channel, as described elsewhere herein. A plurality of droplets can be collected in the reservoir 3410 by continuously injecting the aqueous liquid 3412 from the fourth channel 3408 through the fluidic connection 3422.

A discrete droplet generated may include a particle, e.g., a bead, (e.g., as in droplets 3420). Alternatively, a discrete droplet generated may include more than one particle, e.g., bead. Alternatively, a discrete droplet generated may not include any particles, e.g., beads. In some instances, a discrete droplet generated may contain one or more biological particles, e.g., cells (not shown in FIG. 34).

In some instances, the second liquid 3414 may not be subjected to and/or directed to any flow in or out of the reservoir 3410. For example, the second liquid 3414 may be substantially stationary in the reservoir 3410. In some instances, the second liquid 3414 may be subjected to flow within the reservoir 3410, but not in or out of the reservoir 3410, such as via application of pressure to the reservoir 3410 and/or as affected by the incoming flow of the aqueous liquid 3412 at the fluidic connection 3422. In some instances, the second liquid 3414 may be gently stirred in the reservoir 3410. Alternatively, the second liquid 3414 may be subjected and/or directed to flow in or out of the reservoir 3410. For example, the reservoir 3410 can be a channel directing the second liquid 3414 from upstream to downstream, transporting the generated droplets. Alternatively, or in addition, the second liquid 3414 in reservoir 3410 may be used to sweep formed droplets away from the path of the nascent droplets.

### Example 30

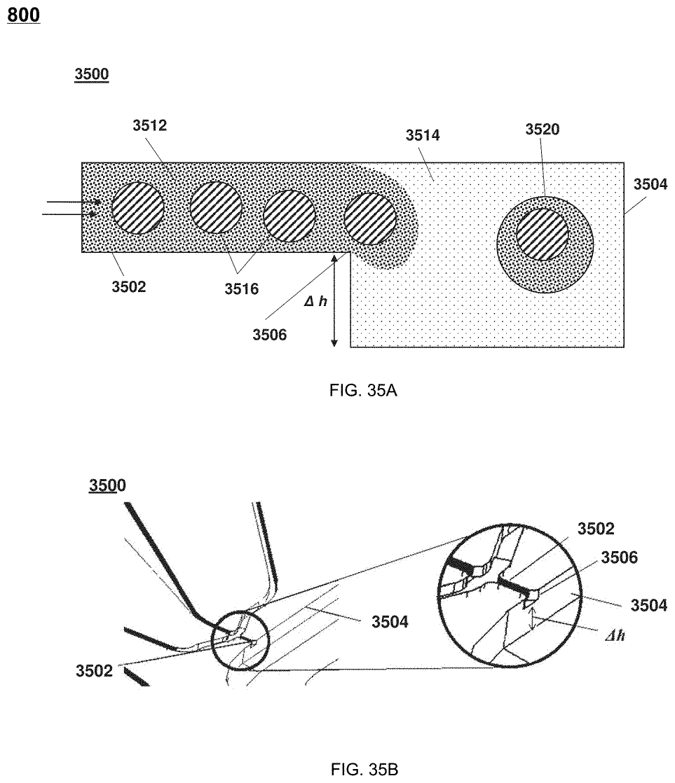

FIG. 35A shows a cross-section view of another example of a microfluidic device with a geometric feature for droplet formation. A device 3500 can include a channel 3502 communicating at a fluidic connection 3506 (or intersection) with a reservoir 3504. In some instances, the device 3500 and one or more of its components can correspond to the device 3100 and one or more of its components. FIG. 35B shows a perspective view of the device 3500 of FIG. 35A.

An aqueous liquid 3512 comprising a plurality of particles 3516 may be transported along the channel 3502 into the fluidic connection 3506 to meet a second liquid 3514 (e.g., oil, etc.) that is immiscible with the aqueous liquid 3512 in the reservoir 3504 to create droplets 3520 of the aqueous liquid 3512 flowing into the reservoir 3504. At the fluidic connection 3506 where the aqueous liquid 3512 and the second liquid 3514 meet, droplets can form based on factors such as the hydrodynamic forces at the fluidic connection 3506, relative flow rates of the two liquids 3512, 3514, liquid properties, and certain geometric parameters (e.g., dh, etc.) of the device 3500. A plurality of droplets can be collected in the reservoir 3504 by continuously injecting the aqueous liquid 3512 from the channel 3502 at the fluidic connection 3506.

While FIGS. 35A and 35B illustrate the height difference, Δh, being abrupt at the fluidic connection 3506 (e.g., a step increase), the height difference may increase gradually (e.g., from about 0 μm to a maximum height difference). Alternatively, the height difference may decrease gradually (e.g., taper) from a maximum height difference. A gradual increase or decrease in height difference, as used herein, may refer to a continuous incremental increase or decrease in height difference, wherein an angle between any one differential segment of a height profile and an immediately adjacent differential segment of the height profile is greater than 90°. For example, at the fluidic connection 3506, a bottom wall of the channel and a bottom wall of the reservoir can meet at an angle greater than 90°. Alternatively, or in addition, a top wall (e.g., ceiling) of the channel and a top wall (e.g., ceiling) of the reservoir can meet an angle greater than 90°. A gradual increase or decrease may be linear or non-linear (e.g., exponential, sinusoidal, etc.). Alternatively, or in addition, the height difference may variably increase and/or decrease linearly or non-linearly.

### Example 31

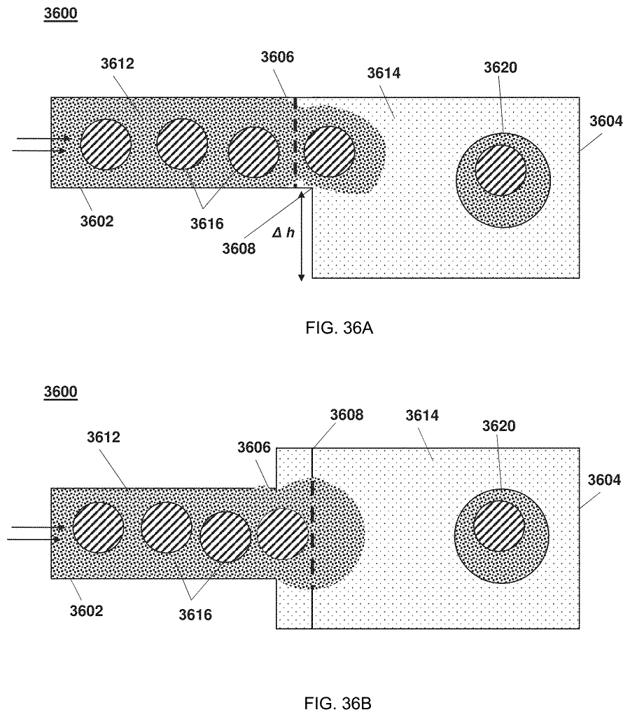

FIGS. 36A and 36B show a cross-section view and a top view, respectively, of another example of a microfluidic device with a geometric feature for droplet formation. A device 3600 can include a channel 3602 communicating at a fluidic connection 3606 (or intersection) with a reservoir 3604. In some instances, the device 3600 and one or more of its components can correspond to the device 3500 and one or more of its components.

An aqueous liquid 3612 comprising a plurality of particles 3616 may be transported along the channel 3602 into the fluidic connection 3606 to meet a second liquid 3614 (e.g., oil, etc.) that is immiscible with the aqueous liquid 3612 in the reservoir 3604 to create droplets 3620 of the aqueous liquid 3612 flowing into the reservoir 3604. At the fluidic connection 3606 where the aqueous liquid 3612 and the second liquid 3614 meet, droplets can form based on factors such as the hydrodynamic forces at the fluidic connection 3606, relative flow rates of the two liquids 3612, 3614, liquid properties, and certain geometric parameters (e.g., Δh, ledge, etc.) of the channel 3602. A plurality of droplets can be collected in the reservoir 3604 by continuously injecting the aqueous liquid 3612 from the channel 3602 at the fluidic connection 3606.

The aqueous liquid may comprise particles. The particles 3616 (e.g., beads) can be introduced into the channel 3602 from a separate channel (not shown in FIG. 36). In some instances, the particles 3616 can be introduced into the channel 3602 from a plurality of different channels, and the frequency controlled accordingly. In some instances, different particles may be introduced via separate channels. For example, a first separate channel can introduce beads and a second separate channel can introduce biological particles into the channel 3602. The first separate channel introducing the beads may be upstream or downstream of the second separate channel introducing the biological particles.

While FIGS. 36A and 36B illustrate one ledge (e.g., step) in the reservoir 3604, as can be appreciated, there may be a plurality of ledges in the reservoir 3604, for example, each having a different cross-section height. For example, where there is a plurality of ledges, the respective cross-section height can increase with each consecutive ledge. Alternatively, the respective cross-section height can decrease and/or increase in other patterns or profiles (e.g., increase then decrease then increase again, increase then increase then increase, etc.).

While FIGS. 36A and 36B illustrate the height difference, Δh, being abrupt at the ledge 3608 (e.g., a step increase), the height difference may increase gradually (e.g., from about 0 μm to a maximum height difference). In some instances, the height difference may decrease gradually (e.g., taper) from a maximum height difference. In some instances, the height difference may variably increase and/or decrease linearly or non-linearly. The same may apply to a height difference, if any, between the first cross-section and the second cross-section.

### Example 32

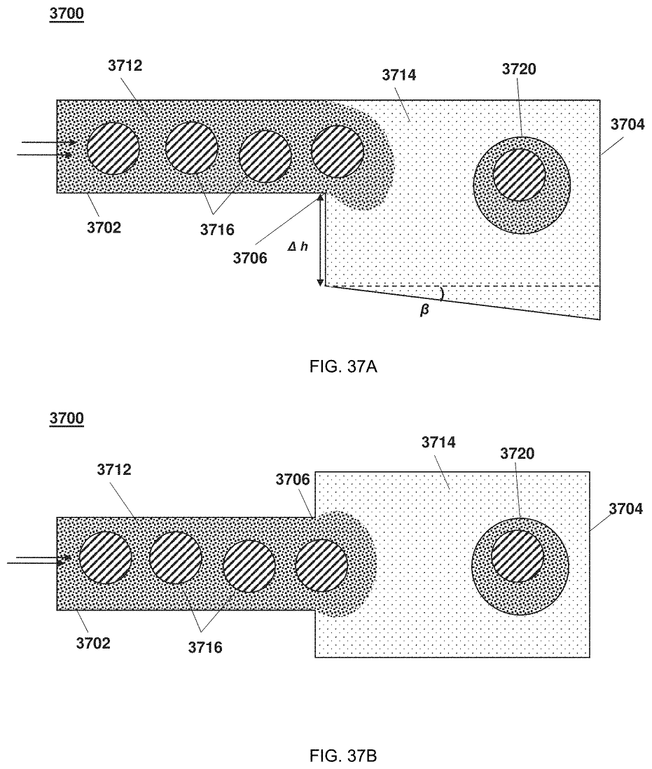

FIGS. 37A and 37B show a cross-section view and a top view, respectively, of another example of a microfluidic device with a geometric feature for droplet formation. A device 3700 can include a channel 3702 communicating at a fluidic connection 3706 (or intersection) with a reservoir 3704. In some instances, the device 3700 and one or more of its components can correspond to the device 3600 and one or more of its components.

An aqueous liquid 3712 comprising a plurality of particles 3716 may be transported along the channel 3702 into the fluidic connection 3706 to meet a second liquid 3714 (e.g., oil, etc.) that is immiscible with the aqueous liquid 3712 in the reservoir 3704 to create droplets 3720 of the aqueous liquid 3712 flowing into the reservoir 3704. At the fluidic connection 3706 where the aqueous liquid 3712 and the second liquid 3714 meet, droplets can form based on factors such as the hydrodynamic forces at the fluidic connection 3706, relative flow rates of the two liquids 3712, 3714, liquid properties, and certain geometric parameters (e.g., Δh, etc.) of the device 3700. A plurality of droplets can be collected in the reservoir 3704 by continuously injecting the aqueous liquid 3712 from the channel 3702 at the fluidic connection 3706.

In some instances, the second liquid 3714 may not be subjected to and/or directed to any flow in or out of the reservoir 3704. For example, the second liquid 3714 may be substantially stationary in the reservoir 3704. In some instances, the second liquid 3714 may be subjected to flow within the reservoir 3704, but not in or out of the reservoir 3704, such as via application of pressure to the reservoir 3704 and/or as affected by the incoming flow of the aqueous liquid 3712 at the fluidic connection 3706. Alternatively, the second liquid 3714 may be subjected and/or directed to flow in or out of the reservoir 3704. For example, the reservoir 3704 can be a channel directing the second liquid 3714 from upstream to downstream, transporting the generated droplets. Alternatively, or in addition, the second liquid 3714 in reservoir 3704 may be used to sweep formed droplets away from the path of the nascent droplets.

The device 3700 at or near the fluidic connection 3706 may have certain geometric features that at least partly determine the sizes and/or shapes of the droplets formed by the device 3700. The channel 3702 can have a first cross-section height, h₁, and the reservoir 3704 can have a second cross-section height, h₂. The first cross-section height, h₁, may be different from the second cross-section height h₂ such that at or near the fluidic connection 3706, there is a height difference of Δh. The second cross-section height, h₂, may be greater than the first cross-section height, h₁. The reservoir may thereafter gradually increase in cross-section height, for example, the more distant it is from the fluidic connection 3706. In some instances, the cross-section height of the reservoir may increase in accordance with expansion angle, β, at or near the fluidic connection 3706. The height difference, Δh, and/or expansion angle, β, can allow the tongue (portion of the aqueous liquid 3712 leaving channel 3702 at fluidic connection 3706 and entering the reservoir 3704 before droplet formation) to increase in depth and facilitate decrease in curvature of the intermediately formed droplet. For example, droplet size may decrease with increasing height difference and/or increasing expansion angle.

While FIGS. 37A and 37B illustrate the height difference, Δh, being abrupt at the fluidic connection 3706, the height difference may increase gradually (e.g., from about 0 μm to a maximum height difference). In some instances, the height difference may decrease gradually (e.g., taper) from a maximum height difference. In some instances, the height difference may variably increase and/or decrease linearly or non-linearly. While FIGS. 37A and 37B illustrate the expanding reservoir cross-section height as linear (e.g., constant expansion angle, β), the cross-section height may expand non-linearly. For example, the reservoir may be defined at least partially by a dome-like (e.g., hemispherical) shape having variable expansion angles. The cross-section height may expand in any shape.

### Example 33

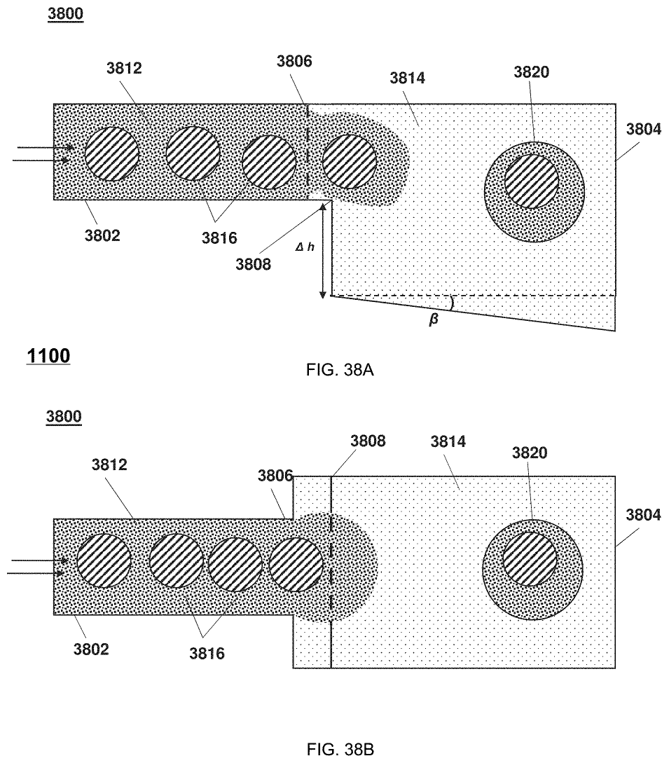

FIGS. 38A and 38B show a cross-section view and a top view, respectively, of another example of a microfluidic device with a geometric feature for droplet formation. A device 3800 can include a channel 3802 communicating at a fluidic connection 806 (or intersection) with a reservoir 3804. In some instances, the device 3800 and one or more of its components can correspond to the device 3700 and one or more of its components and/or correspond to the device 3600 and one or more of its components.

An aqueous liquid 3812 comprising a plurality of particles 816 may be transported along the channel 3802 into the fluidic connection 3806 to meet a second liquid 3814 (e.g., oil, etc.) that is immiscible with the aqueous liquid 3812 in the reservoir 3804 to create droplets 3820 of the aqueous liquid 3812 flowing into the reservoir 3804. At the fluidic connection 3806 where the aqueous liquid 3812 and the second liquid 3814 meet, droplets can form based on factors such as the hydrodynamic forces at the fluidic connection 3806, relative flow rates of the two liquids 3812, 3814, liquid properties, and certain geometric parameters (e.g., Δh, etc.) of the device 3800. A plurality of droplets can be collected in the reservoir 3804 by continuously injecting the aqueous liquid 3812 from the channel 3802 at the fluidic connection 3806.

A discrete droplet generated may comprise one or more particles of the plurality of particles 3816. As described elsewhere herein, a particle may be any particle, such as a bead, cell bead, gel bead, biological particle, macromolecular constituents of biological particle, or other particles. Alternatively, a discrete droplet generated may not include any particles.

In some instances, the second liquid 3814 may not be subjected to and/or directed to any flow in or out of the reservoir 3804. For example, the second liquid 3814 may be substantially stationary in the reservoir 3804. In some instances, the second liquid 3814 may be subjected to flow within the reservoir 3804, but not in or out of the reservoir 3804, such as via application of pressure to the reservoir 3804 and/or as affected by the incoming flow of the aqueous liquid 3812 at the fluidic connection 3806. Alternatively, the second liquid 3814 may be subjected and/or directed to flow in or out of the reservoir 3804. For example, the reservoir 804 can be a channel directing the second liquid 3814 from upstream to downstream, transporting the generated droplets. Alternatively, or in addition, the second liquid 3814 in reservoir 3804 may be used to sweep formed droplets away from the path of the nascent droplets.

While FIGS. 38A and 38B illustrate one ledge (e.g., step) in the reservoir 3804, as can be appreciated, there may be a plurality of ledges in the reservoir 3804, for example, each having a different cross-section height. For example, where there is a plurality of ledges, the respective cross-section height can increase with each consecutive ledge. Alternatively, the respective cross-section height can decrease and/or increase in other patterns or profiles (e.g., increase then decrease then increase again, increase then increase then increase, etc.).

While FIGS. 38A and 38B illustrate the height difference, dh, being abrupt at the ledge 3808, the height difference may increase gradually (e.g., from about 0 μm to a maximum height difference). In some instances, the height difference may decrease gradually (e.g., taper) from a maximum height difference. In some instances, the height difference may variably increase and/or decrease linearly or non-linearly. While FIGS. 38A and 38B illustrate the expanding reservoir cross-section height as linear (e.g., constant expansion angle), the cross-section height may expand non-linearly. For example, the reservoir may be defined at least partially by a dome-like (e.g., hemispherical) shape having variable expansion angles. The cross-section height may expand in any shape.

### Example 34

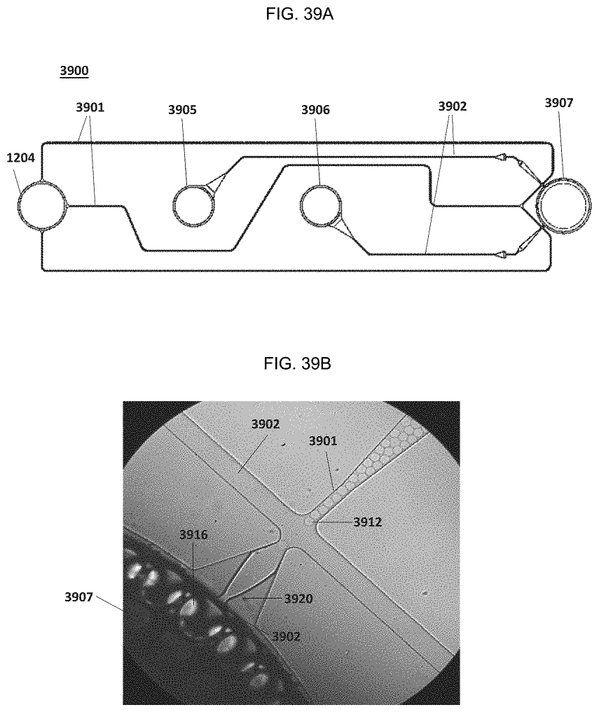

An example of a device according to the invention is shown in FIGS. 39A-39B. The device 3900 includes four fluid reservoirs, 3904, 3905, 3906, and 3907, respectively. Reservoir 3904 houses one liquid; reservoirs 3905 and 3906 house another liquid, and reservoir 3907 houses continuous phase in the step region 3908. This device 3900 include two first channels 3902 connected to reservoir 3905 and reservoir 3906 and connected to a shelf region 3920 adjacent a step region 3908. As shown, multiple channels 3901 from reservoir 3904 deliver additional liquid to the first channels 3902. The liquids from reservoir 3904 and reservoir 3905 or 3906 combine in the first channel 3902 forming the first liquid that is dispersed into the continuous phase as droplets. In certain embodiments, the liquid in reservoir 3905 and/or reservoir 3906 includes a particle, such as a gel bead. FIG. 39B shows a view of the first channel 3902 containing gel beads 3912 intersected by a second channel 3901 adjacent to a shelf region 3920 leading to a step region 3908, which contains multiple droplets 3916.

### Example 35

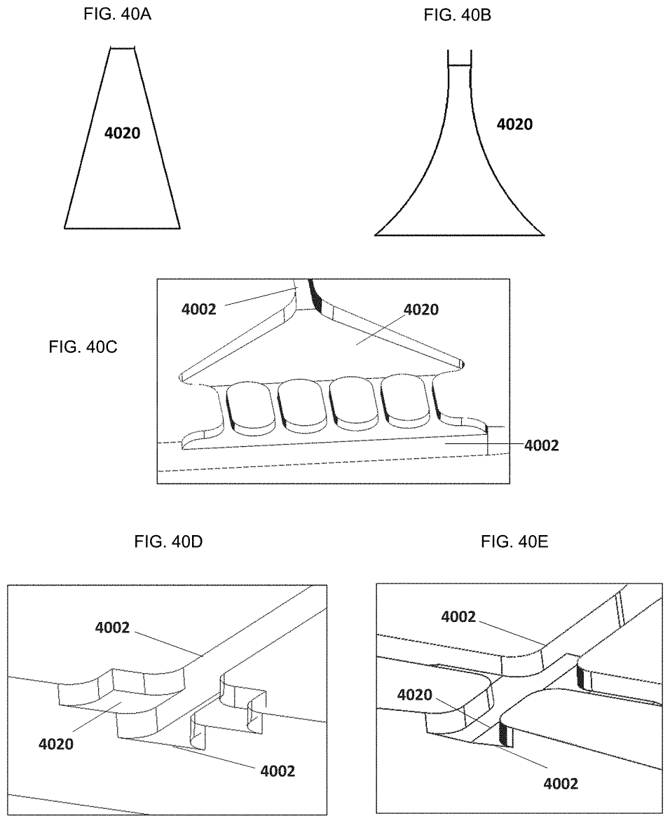

Variations on shelf regions 4020 are shown in FIGS. 40A-40E. As shown in FIGS. 40A-40B, the width of the shelf region 4020 can increase from the distal end of a first channel 4002 towards the step region 4008, linearly as in FIG. 40A or non-linearly as in FIG. 40B. As shown in FIG. 40C, multiple first channels 4002 can branch from a single feed channel 4002 and introduce fluid into interconnected shelf regions 4020. As shown in FIG. 40D, the depth of the first channel 4002 may be greater than the depth of the shelf region 4020 and cut a path through the shelf region 4020. As shown in FIG. 40E, the first channel 4002 and shelf region 4020 may contain a grooved bottom surface. This device 4000 also includes a second channel 4002 that intersects the first channel 4002 proximal to its distal end.

### Example 36

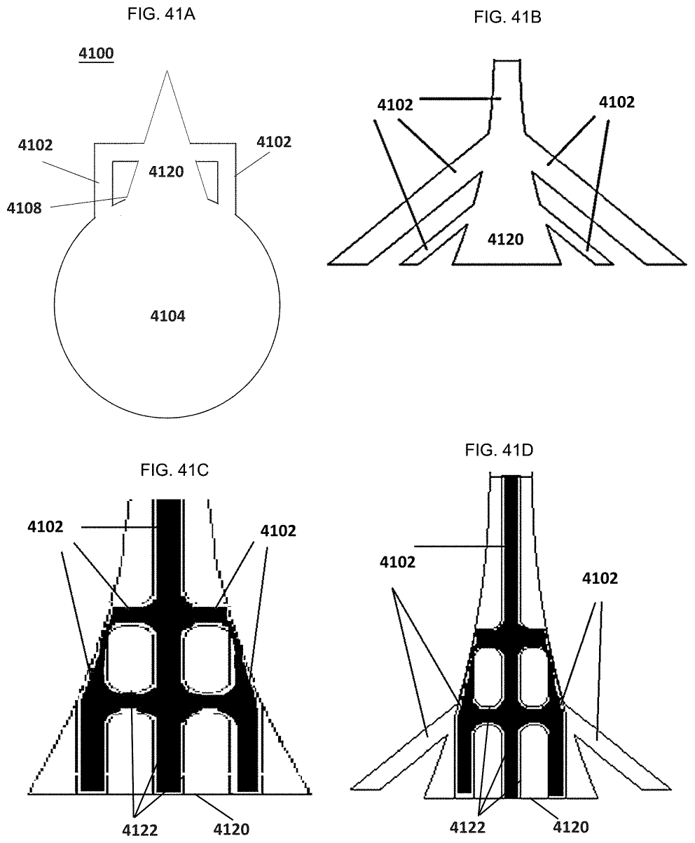

Continuous phase delivery channels 4102, shown in FIGS. 41A-41D, are variations on shelf regions 4120 including channels 4102 for delivery (passive or active) of continuous phase behind a nascent droplet. In one example in FIG. 41A, the device 4100 includes two channels 4102 that connect the reservoir 4104 of the step region 4108 to either side of the shelf region 4120. In another example in FIG. 41B, four channels 4102 provide continuous phase to the shelf region 4120. These channels 4102 can be connected to the reservoir 4104 of the step region 4108 or to a separate source of continuous phase. In a further example in FIG. 41C, the shelf region 4120 includes one or more channels 4102 (white) below the depth of the first channel 4102 (black) that connect to the reservoir 4104 of the step region 4108. The shelf region 4120 contains islands 4122 in black. In another example FIG. 41D, the shelf region 4120 of FIG. 41C includes two additional channels 4102 for delivery of continuous phase on either side of the shelf region 4120.

### Example 37

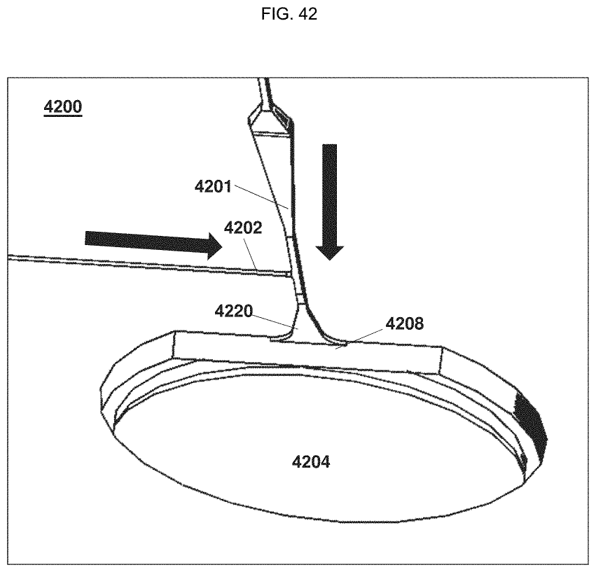

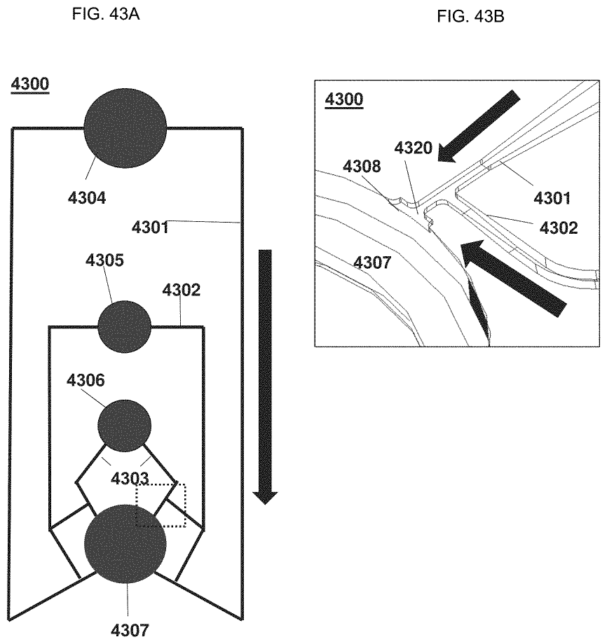

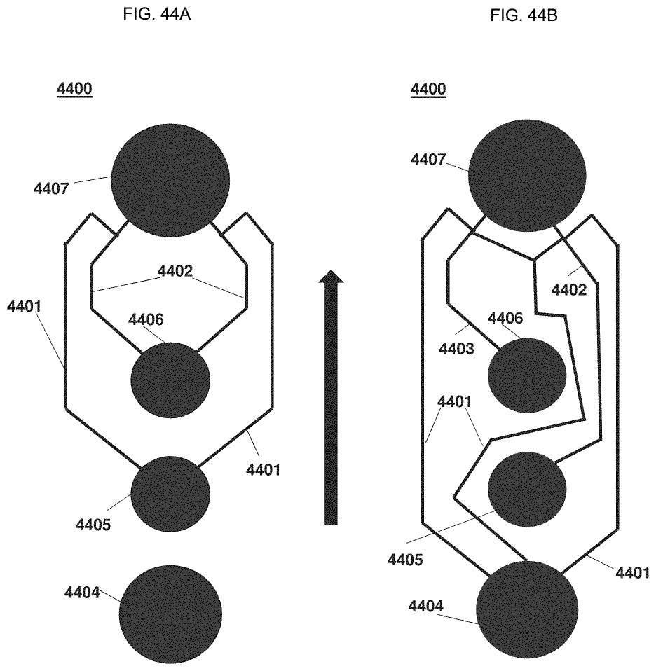

An embodiment of a device according to the invention is shown in FIG. 42. This device 4200 includes two channels 4201, 4202 that intersect upstream of a droplet formation region. The droplet formation region includes both a shelf region 4220 and a step region 4208 disposed between the distal end of the first channel 4201 and the step region 4208 that lead to a collection reservoir 4204. The black and white arrows show the flow of liquids through each of first channel 4201 and second channel 4202, respectively. In certain embodiments, the liquid flowing through the first channel 4201 or second channel 4202 includes a particle, such as a gel bead. As shown in the FIG. 42, the width of the shelf region 4220 can increase from the distal end of a first channel 4201 towards the step region 4208; in particular, the width of the shelf region 4220 in FIG. 42 increases non-linearly. In this embodiment, the shelf region extends from the edge of a reservoir to allow droplet formation away from the edge. Such a geometry allows droplets to move away from the droplet formation region due to differential density between the continuous and dispersed phase.

### Example 38

An embodiment of a device according to the invention for multiplexed droplet formation is shown in FIGS. 43A-43B. This device 4300 includes four fluid reservoirs, 4304, 4305, 4306, and 4307, and the overall direction of flow within the device 4300 is shown by the black arrow in FIG. 43A. Reservoir 4304 and reservoir 4306 house one liquid; reservoir 4305 houses another liquid, and reservoir 4307 houses continuous phase and is a collection reservoir. Fluid channels 4301, 4303 directly connect reservoir 4304 and reservoir 4306, respectively, to reservoir 4307; thus, there are four droplet formation region in this device 4300. Each droplet formation region has a shelf region 4320 and a step region 4308. This device 4300 further has two channels 4302 from the reservoir 4305 where each of these channels splits into two separate channels at their distal ends. Each of the branches of the split channel intersects the first channels 4301 or 4303 upstream of their connection to the collection reservoir 4307. As shown in the zoomed in view of the dotted line box in FIG. 43B, second channel 4302, with its flow indicated by the white arrow, has its distal end intersecting a channel 4303 from reservoir 4305, with the flow of the channel indicated by the black arrow, upstream of the droplet formation region. The liquid from reservoir 4304 and reservoir 4306, separately, are introduced into channels 4301, 4303 and flow towards the collection reservoir 4307. The liquid from the second reservoir 4305 combines with the fluid from reservoir 4304 or reservoir 4306, and the combined fluid is dispersed into the droplet formation region and to the continuous phase. In certain embodiments, the liquid flowing through the first channel 4301 or 4303 or second channel 4302 includes a particle, such as a gel bead.

### Example 39

Examples of devices according to the invention that include two droplet formation regions are shown in FIGS. 44A-44B. The device 1400 of FIG. 44A includes three reservoirs, 4405, 4406, and 4407, and the device 4400 of FIG. 44B includes four reservoirs, 4404, 4405, 4406, and 4407. For the device 4400 of FIG. 44A, reservoir 4405 houses a portion of the first fluid, reservoir 4406 houses a different portion of the first fluid, and reservoir 4407 houses continuous phase and is a collection reservoir. In the device 4400 of FIG. 44B, reservoir 4404 houses a portion of the first fluid, reservoir 4405 and reservoir 4406 house different portions of the first fluid, and reservoir 4407 houses continuous phase and is a collection reservoir. In both devices 4400, there are two droplet formation regions. For the device 4400 of FIG. 44A, the connections to the collection reservoir 4407 are from the reservoir 4406, and the distal ends of the channels 4401 from reservoir 4405 intersect the channels 4402 from reservoir 4406 upstream of the droplet formation region. The liquids from reservoir 4405 and reservoir 4406 combine in the channels 4402 from reservoir 4406, forming the first liquid that is dispersed into the continuous phase in the collection reservoir 4407 as droplets. In certain embodiments, the liquid in reservoir 4405 and/or reservoir 4406 includes a particle, such as a gel bead.

In the device 4400 of FIG. 44B, each of reservoir 4405 and reservoir 4406 are connected to the collection reservoir 4407. Reservoir 4404 has three channels 4401, two of which have distal ends that intersect each of the channels 4402, 4403 from reservoir 4404 and reservoir 4406, respectively, upstream of the droplet formation region. The third channel 4401 from reservoir 4404 splits into two separate distal ends, with one end intersecting the channel 4402 from reservoir 4405 and the other distal end intersecting the channel 4403 from reservoir 4406, both upstream of droplet formation regions. The liquid from reservoir 4404 combines with the liquids from reservoir 4405 and reservoir 4406 in the channels 4402 from reservoir 4405 and reservoir 4406, forming the first liquid that is dispersed into the continuous phase in the collection reservoir 4407 as droplets. In certain embodiments, the liquid in reservoir 4404, reservoir 4405, and/or reservoir 4406 includes a particle, such as a gel bead.

### Example 40

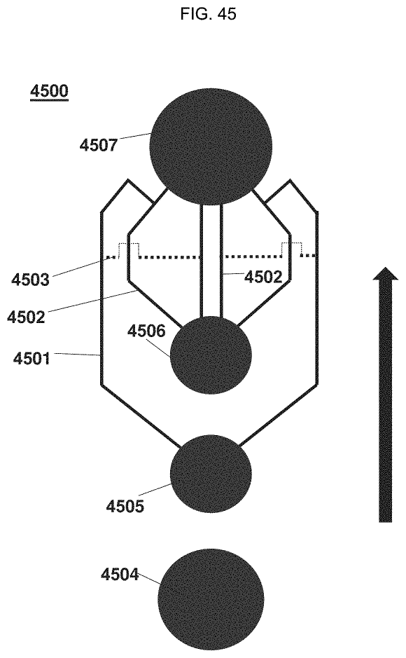

An embodiment of a device according to the invention that has four droplet formation regions is shown in FIG. 45. The device 4500 of FIG. 45 includes four reservoirs, 4504, 4505, 4506, and 4507; the reservoir labeled 4504 is unused in this embodiment. In the device 4500 of FIG. 45, reservoir 4505 houses a portion of the first fluid, reservoir 4506 houses a different portion of the first fluid, and reservoir 4507 houses continuous phase and is a collection reservoir. Reservoir 4506 has four channels 4502 that connect to the collection reservoir 4507 at four droplet formation regions. The channels 4502 from originating at reservoir 4506 include two outer channels 4502 and two inner channels 4502. Reservoir 4505 has two channels 4501 that intersect the two outer channels 4502 from reservoir 4506 upstream of the droplet formation regions. Channels 4501 and the inner channels 4502 are connected by two channels 4503 that traverse, but do not intersect, the fluid paths of the two outer channels 4502. These connecting channels 4503 from channels 4501 pass over the outer channels 4502 and intersect the inner channels 4502 upstream of the droplet formation regions. The liquids from reservoir 4505 and reservoir 4506 combine in the channels 4502, forming the first liquid that is dispersed into the continuous phase in the collection reservoir 4507 as droplets. In certain embodiments, the liquid in reservoir 4505 and/or reservoir 4506 includes a particle, such as a gel bead.

### Example 41

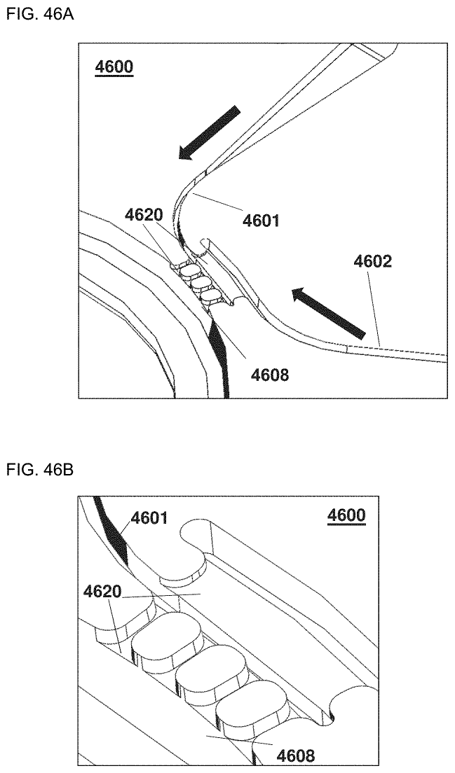

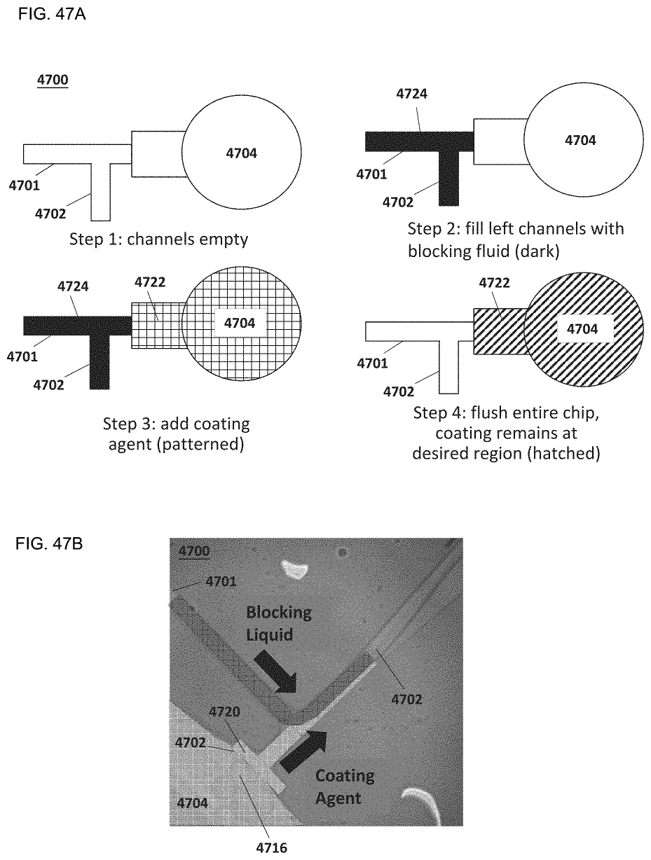

An embodiment of a device according to the invention that has a plurality of droplet formation regions is shown in FIGS. 46A-46B (FIG. 46B is a zoomed in view of FIG. 46A), with the droplet formation region including a shelf region 4620 and a step region 4608. This device 4600 includes two channels 4601, 4602 that meet at the shelf region 4620. As shown, after the two channels 4601, 4602 meet at the shelf region 4620, the combination of liquids is divided, in this example, by four shelf regions. In certain embodiments, the liquid with flow indicated by the black arrow includes a particle, such as a gel bead, and the liquid flow from the other channel, indicated by the white arrow, can move the particles into the shelf regions such that each particle can be introduced into a droplet.

### Example 42

An embodiment of a method of modifying the surface of a device using a coating agent is shown in FIGS. 47A-47B. In this example, the surface of the droplet formation region of the device 4700, e.g., the rectangular area connected to the circular shaped collection reservoir 4704, is coated with a coating agent 4722 to modify its surface properties. To localize the coating agent to only the regions of interest, the first channel 4701 and second channel 4702 of the device 4700 are filled with a blocking liquid 4724 (Step 2 of FIG. 47A) such that the coating agent 4722 cannot contact the channels 4701, 4702. The device 4700 is then filled with the coating agent 4722 to fill the droplet formation region and the collection reservoir 4704 (Step 3 of FIG. 47A). After the coating process is complete, the device 4700 is flushed (Step 4 of FIG. 47A) to remove both the blocking liquid 4724 from the channels and the coating agent 4722 from the droplet formation region and the collection reservoir 4704. This leaves behind a layer of the coating agent 4722 only in the regions where it is desired. This is further exemplified in the micrograph of FIG. 47B, the blocking liquid (dark gray) fills the first channel 4701 and second channel 4702, preventing ingress of the coating agent 4722 (white) into either the first channel 4701 or the second channel 4702 while completely coating the droplet formation region and the collection reservoir 4704. In this example, the first channel 4701 is also acting as a feed channel for the blocking liquid 4724, shown by the arrow for flow direction in FIG. 47B.

### Example 43

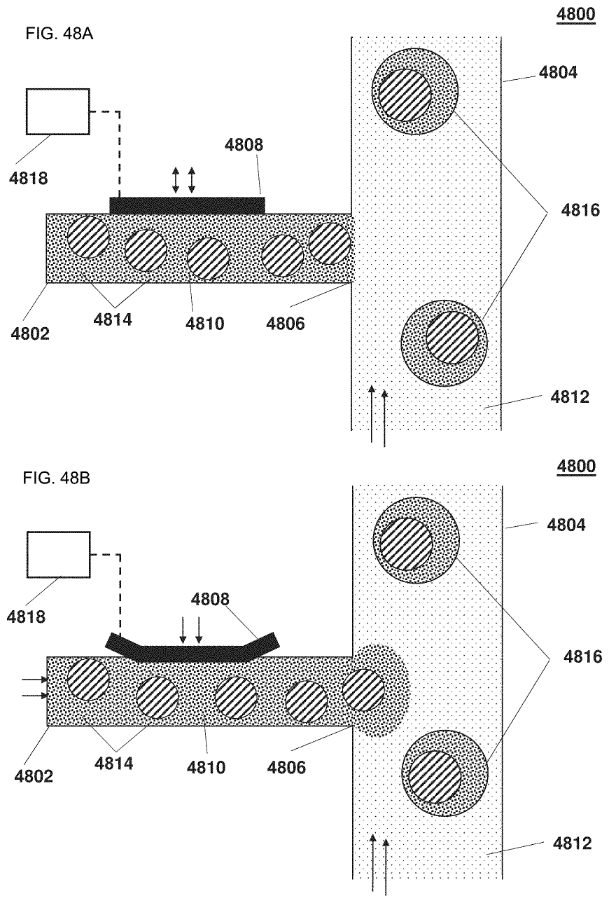

FIGS. 48A-48B show an embodiment of a device according to the invention that includes a piezoelectric element for droplet formation. A device 4800 includes a first channel 4802, a second channel 4804, and a piezoelectric element 4808. The first channel 4802 and the second channel 4804 are in fluid communication at a channel junction 4806. In some instances, the first channel 4802 and components thereof can correspond to the channel 3102 in the device 3100 in FIG. 31 and components thereof.

In this example, the first channel 4802 carries a first fluid 4810 (e.g., aqueous) and the second channel 4804 can carries second fluid 4812 (e.g., oil) that is immiscible with the first fluid 4810. The two fluids 4810, 4812 come in contact with one another at the junction 4806. In some instances, the first fluid 4810 in the first channel 4802 includes suspended particles 4814. The particles 4814 may be beads, biological particles, cells, cell beads, or any combination thereof (e.g., a combination of beads and cells or a combination of beads and cell beads, etc.). The piezoelectric element 4808 is operatively coupled to the first channel 4802 such that at least part of the first channel 4802 is capable of moving or deforming in response to movement of the piezoelectric element 4808. In some instances, the piezoelectric element 4808 is part of the first channel 4802, such as one or more walls of the first channel 4802. The piezoelectric element 4808 can be a piezoelectric plate. The piezoelectric element 4808 is responsive to electrical signals received from the controller 4818 and moves between at least a first state (as in FIG. 48A) and a second state (as in FIG. 48B). In the first state, the first fluid 4810 and the second fluid 4812 remain separated at or near the junction 4806 via an immiscible barrier. In the second state, the first fluid 4810 is directed towards the junction 4806 into the second fluid 4812 to create droplets 4816.

In some instances, the piezoelectric element 4808 is in the first state (shown in FIG. 48A) when no electrical charge, e.g., electric voltage, is applied. The first state can be an equilibrium state. When an electrical charge is applied to the piezoelectric element 4808, the piezoelectric element 4808 may bend backwards (not shown in FIG. 48A or 48B), pulling a part of the first channel 4802 outwards and drawing in more of the first fluid 4810 into the first channel 4802 such as from a reservoir of the first fluid 4810. When the electrical charge is altered, the piezoelectric element may bend in the other direction (e.g., inwards towards the contents of the channel 4802) (shown in FIG. 48B) pushing a part of the first channel 4802 inwards and propelling (e.g., at least partly via displacement) a volume of the first fluid 4810 into the second channel 4804, thereby generating a droplet of the first fluid 4810 in the second fluid 4812. After the droplet is propelled, the piezoelectric element 4808 may return to the first state (shown in FIG. 48A). The cycle can be repeated to generate more droplets. In some instances, each cycle may generate a plurality of droplets (e.g., a volume of the first fluid 4810 propelled breaks off as it enters the second fluid 4812 to form a plurality of discrete droplets). A plurality of droplets 4816 can be collected in the second channel 4804 for continued transportation to a different location (e.g., reservoir), direct harvesting, and/or storage.

### Example 44

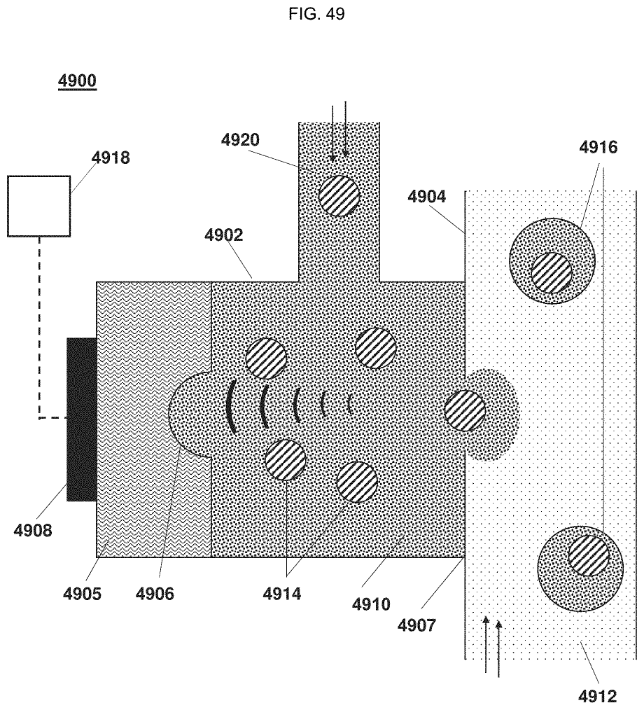

FIG. 49 shows an embodiment of a device according to the invention that uses a piezoelectric, e.g., a piezoacoustic element, for droplet formation. A device 4900 includes a first channel 4902, a second channel 4904, a piezoelectric element 4908, and a buffer substrate 4905. The first channel 4902 and the second channel 4904 communicate at a channel junction 4907. In some instances, the first channel 4902 and components thereof can correspond to the channel 3102 in the channel structure 3100 in FIG. 31 and components thereof.

The first channel 4902 carries a first fluid 4910 (e.g., aqueous), and the second channel 4904 carries a second fluid 4912 (e.g., oil) that is immiscible with the first fluid 4910. In some instances, the first fluid 4910 in the first channel 4902 includes suspended particles 4914. In some instances, the particles 4914, suspended in the first fluid 4910, are provided to the first channel 4902 from a third channel 4920, which is in fluid communication with the first channel 4902. The particles 4914 may be beads, biological particles, cells, cell beads, or any combination thereof (e.g., a combination of beads and cells or a combination of beads and cell beads, etc.). The piezoelectric element 4908 is operatively coupled to a buffer substrate 4905 (e.g., glass). The buffer substrate 4905 includes an acoustic lens 4906. In some instances, the acoustic lens 4906 is a substantially spherical cavity, e.g., a partially spherical cavity, e.g., hemispherical. In other instances, the acoustic lens 4906 is a different shape and/or includes one or more other objects for focusing acoustic waves. The buffer substrate 4905 and/or the acoustic lens 4906 can be in contact with the first fluid 4910 in the first channel 4902. Alternatively, the piezoelectric element 4908 is operatively coupled to a part (e.g., wall) of the first channel 4902 without an intermediary buffer substrate. The piezoelectric element 4908 is in electrical communication with a controller 4918. The piezoelectric element 4908 is responsive to a pulse of electric voltage driven at a particular frequent transmitted by the controller 4918. In some instances, the piezoelectric element 4908 and its properties can correspond to the piezoelectric element 4808 and its properties in FIGS. 48A-48B.

Before electric voltage is applied, the first fluid 4910 and the second fluid 4912 are separated at or near the junction 4907 via an immiscible barrier. When the electric voltage is applied to the piezoelectric element 4908, it generates acoustic waves that propagate in the buffer substrate 4905, from the first end to the second end. The acoustic lens 4906 at the second end of the buffer substrate 4905 focuses the acoustic waves towards the immiscible interface between the two fluids 4910, 4912. The acoustic lens 4906 may be located such that the immiscible interface is located at the focal plane of the converging beam of the acoustic waves. The pressure of the acoustic waves may cause a volume of the first fluid 4910 to be propelled into the second fluid 4912, thereby generating a droplet of the first fluid 4910 in the second fluid 4912. In some instances, each propelling may generate a plurality of droplets (e.g., a volume of the first fluid 4910 propelled breaks off as it enters the second fluid 4912 to form a plurality of discrete droplets). After ejection of the droplet, the immiscible interface can return to its original state. Subsequent bursts of electric voltage to the piezoelectric element 4908 can be repeated to generate more droplets 4916. A plurality of droplets 4916 can be collected in the second channel 4904 for continued transportation to a different location (e.g., reservoir), direct harvesting, and/or storage.

### Example 45

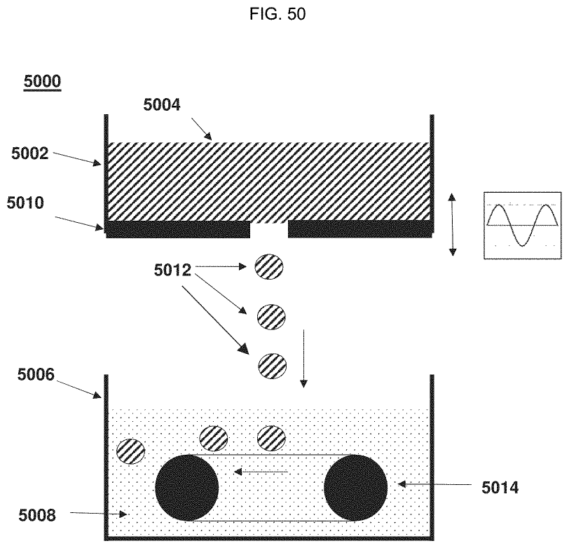

FIG. 50 shows an embodiment of a device according to the invention that includes a piezoelectric element for droplet formation. The device 5000 includes a reservoir 5002 for holding first fluid 5004 and a collection reservoir 5006 for holding second fluid 5008, such as an oil. In one wall of the reservoir 5002 is a piezoelectric element 5010 operatively coupled to an aperture.

Upon actuation of the piezoelectric element 5010, the first fluid 5004 exits the aperture and forms a droplet 5012 that is collected in collection reservoir 5006. Collection reservoir 5006 includes a mechanism 5014 for circulating second fluid 5008 and moving formed droplets 5012 through the second fluid 5008. The signal applied to the piezoelectric element 5010 may be a sinusoidal signal as indicated in the inset photo.

### Example 46

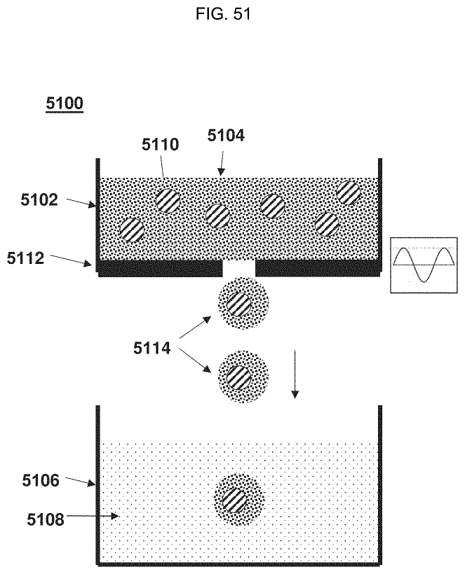

FIG. 51 shows an embodiment of a device according to the invention that includes a piezoelectric element for droplet formation. The device 5100 includes a reservoir 5102 for holding first fluid 5104 and a collection reservoir 5106 for holding second fluid 5108, such as an oil. The first fluid 5104 may contain particles 5110. In one wall of the reservoir 5102 is a piezoelectric element 5112 operatively couple to an aperture.

Upon operation of the piezoelectric element 5112 the first fluid 5104 and the particles 5110 exit the aperture and form a droplet 5114 containing the particle 5110. The droplet 5114 is collected in the second fluid 5108 held in the collection reservoir 5106. The second fluid 5108 may or may not be circulated. The signal applied to the piezoelectric element 5112 may be a sinusoidal signal as indicated in the inset photo.

### Example 47

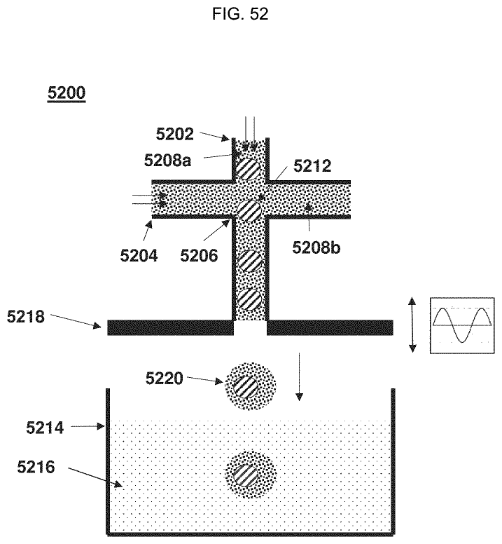

FIG. 52 shows an embodiment of a device according to the invention that includes a piezoelectric element for droplet formation. The device 5200 includes a first channel 5202 and a second channel 5204 that meet at junction 5206. The first channel 5202 carries a portion of first fluid 5208a, and the second channel 5204 carries another portion of first fluid 5208b. One of the portions of the first fluid 5208a or 5208b further includes a particle 5212. The device includes a collection reservoir 5214 for holding second fluid 5216, such as an oil. The distal end of the first channel includes a piezoelectric element 5218 operatively couple to an aperture.

The portion of first fluid 5208a flowing through the first channel 5202, e.g., carrying particles 5212, combines with the portion of the first fluid 5208b flowing through second channel 5204 to form the first fluid, and the first fluid continues to the distal end of the first channel 5202. Upon actuation of the piezoelectric element 5218 at the distal end of the first channel 5202, the first fluid and particles 5212 form a droplet 5220 containing a particle 5212. The droplet 5220 is collected in the second fluid 5216 in the collection reservoir 5214. The second fluid 5216 may or may not be circulated. The signal applied to the piezoelectric element 5218 may be a sinusoidal signal as indicated in the inset photo.

### Example 48

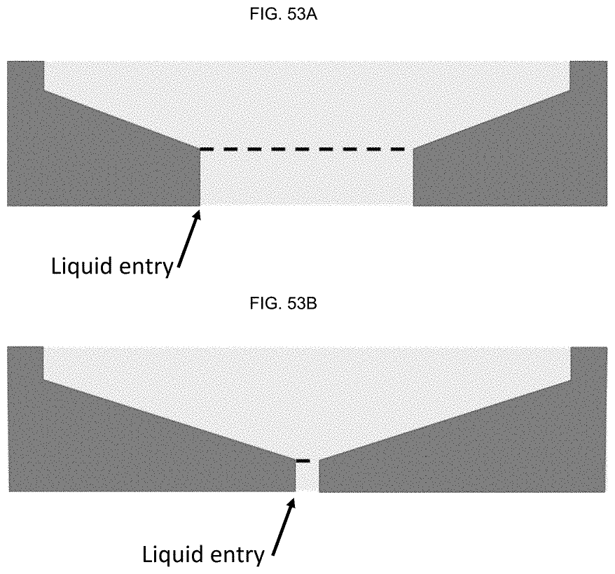

FIGS. 53A and 53B provide vertical cross-sectional views of collection reservoirs. FIG. 53A shows a collection reservoir with a relatively large first volume, and FIG. 53B shows a collection reservoir of the presently claimed invention. The dashed lines in FIGS. 53A-53B represent the division between the first volume of the collection reservoir and the second volume of the collection reservoir, with the area below the dashed line in each figure corresponding to the first volume and the area above the dashed line corresponding to the second volume. The black arrow in each of FIGS. 53A-53B indicates where a droplet enters the collection reservoir from the droplet formation region. In the collection reservoir depicted in FIG. 53A, the first volume of the collection reservoir is larger than the first volume of the collection reservoir of the embodiment depicted in FIG. 53B.

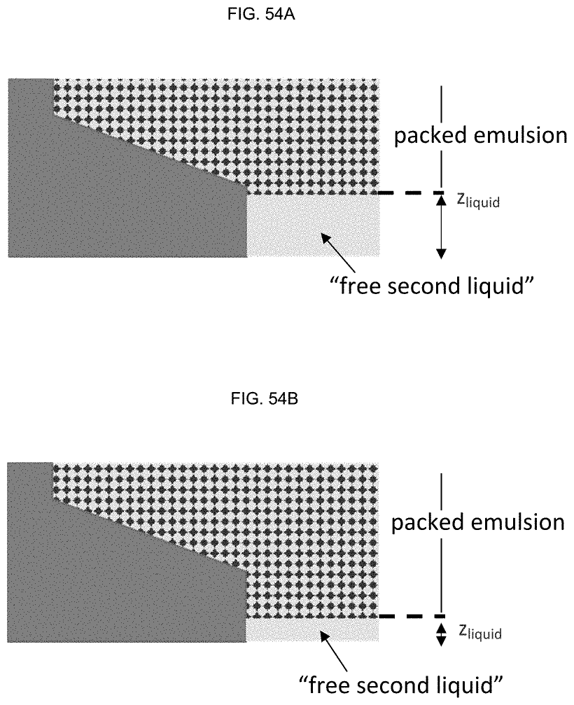

FIGS. 54A and 54B show vertical cross-sections of the collection reservoir depicted in FIG. 53A with the collection reservoir filled with the second liquid as droplets (black diamonds) are formed and completely fill the second volume of the collection reservoir (FIG. 54A) and as additional droplets enter the collection reservoir and begin to fill first volume (FIG. 54B). As the droplets are formed and enter the collection reservoir by passing from the first volume into the second volume, the available volume of the collection reservoir is reduced. This reduction in volume is shown in FIGS. 54A-54B as the height of the second liquid in the z-direction, e.g., the vertical direction, (z_{liquid}) with the available second liquid labeled as “free second liquid.” The droplets that are formed fill the collection reservoir up to the second volume (resulting in a first level of z_{liquid}) and as more droplets are formed, begin to fill the first volume of the collection reservoir, resulting in a decrease in z_{liquid}. When z_{liquid} falls below a threshold, e.g., critical, level, the continued formation of droplets is impeded by the droplets that have already been collected in the collection reservoir. After this point, the droplets that are formed may no longer be monodisperse and/or may have a poor fill ratio, e.g., the number of droplets containing a particle or other desired content to the number of droplets that do not contain a particle or other desired content.

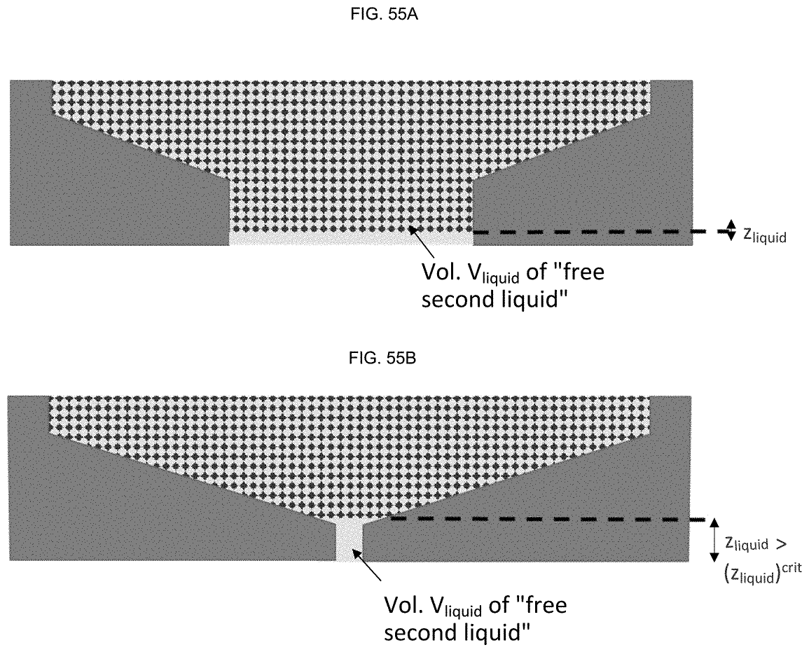

FIGS. 55A-55B show vertical cross-sections of the collection reservoirs depicted in FIGS. 53A-53B filled with the second liquid (gray) and droplets (black diamonds). In the collection reservoir shown in FIG. 55A, the droplets have filled the second volume of the collection reservoir and have partially filled the first volume of the collection reservoir, reducing z_{liquid} to a level below the interface of the first and second volumes of the collection reservoir. The level of z_{liquid} corresponds to a volume of residual second liquid (V_{liquid}) in the collection reservoir. In the embodiment of the collection reservoir shown in FIG. 55B, the droplets have filled the second volume of the collection reservoir up to the interface of the first and second volumes but have not filled the first volume of the collection reservoir. As indicated in FIG. 55B, the level of second liquid in the collection reservoir, z_{liquid}, is greater than the threshold level, e.g., critical ((z_{liquid})^{crit} as labeled in FIG. 55B), of second liquid necessary for unimpeded droplet formation, even though the volume of second liquid (V_{liquid}) remaining in the collection reservoir is substantially identical to that of the collection reservoir depicted in FIG. 55A. Thus, for substantially the same volume of remaining second liquid in the collection reservoir, the higher z_{liquid} of the embodiment of the collection reservoir shown in FIG. 55B allows for unimpeded droplet formation even with a minimal volume of second liquid.

### Example 49

Droplets formed in devices of the present invention are removed from the collection reservoir by the end user. In this example, after a production run of droplet formation, the collection reservoir containing the droplets and any remaining second liquid is pressurized to force a portion of the remaining second liquid back into the device, leaving behind the droplets for removal with a minimal amount of second liquid remaining as excess.

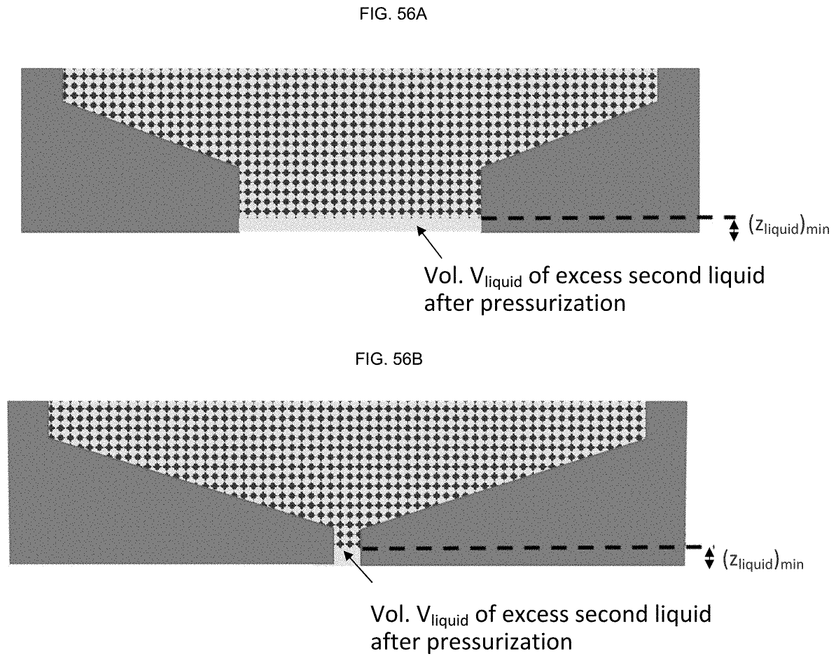

FIGS. 56A-56B show vertical cross-sections of the embodiments of collection reservoirs shown in FIGS. 53A-53B that have been pressurized to remove a portion of the remaining second liquid after droplets are formed. In the collection reservoir shown in FIG. 56A, after pressurization, the first volume of the collection reservoir contains a minimum level of excess second liquid, (z_{liquid})ₘᵢₙ. In FIG. 56A, the amount of remaining excess liquid after pressurization is larger than that in FIG. 57B.

In the embodiment of FIG. 56B, where the first volume of the collection reservoir is substantially smaller than, e.g., less than 1% of, the second volume, the threshold (z_{liquid})ₘᵢₙ level is reached at a lower volume of second liquid after pressurization of the collection reservoir, and in certain instances, the volume of excess second liquid in the collection reservoir may be low enough after a droplet production run such that the pressurization of the collection reservoir may not be required. In instances where pressurization of the collection reservoir is necessary, as shown in FIG. 56B, the remaining volume of excess second liquid is decreased relative to the collection reservoir shown in FIG. 56A. This reduction of excess second liquid results in increased droplet collection efficiency.

### Example 50

FIG. 57A shows an embodiment of a device or system according to the invention that includes a temperature sensor and a pressure sensor. The droplets are formed by entering into a formation region at the intersection between two liquids. The temperature sensor monitors the temperature and the pressure sensor monitors the pressure. Based on the temperature, the device or system can provide feedback to adjust the pressure to produce droplets of a uniform generation parameter (e.g., flow rate, droplet generation frequency, and ratio of droplets including a specified number of particles compared to droplets not including the specified number of particles).

### Example 51

FIG. 57B shows an embodiment of a device or system according to the invention that includes a temperature sensor, a plurality of pressure sensors, and two flow rate controllers. The droplets are formed by entering into a formation region at the intersection between two liquids. The temperature sensor monitors the temperature and the pressure sensors monitors the pressure. The flow rate controllers adjust the flow rate of the liquids. Based on the temperature, the device or system can provide feedback to adjust the pressure and/or flow rate to produce droplets of a uniform generation parameter (e.g., flow rate, droplet generation frequency, and ratio of droplets including a specified number of particles compared to droplets not including the specified number of particles).

### Example 52

A microscope and high-speed camera recorded the generation of each droplet during a run. Using image analysis software that detects when droplets are generated and when gel beads arrive at the point of generation, the occupancy of each droplet generated in a run was determined from the recordings. The occupancy in FIG. 58A refers to the percentage of droplets that contained a single gel bead at three different temperatures (cold, room, hot). The remainder of the population contained either no gel beads or more than one gel beads. The gel bead in emulsion (GEM) droplet generation frequency shown in FIG. 58B was determined through image analysis-based counting of the number of droplets generated in 0.5 second intervals over the entire run at three different temperatures (cold, room, hot). To acquire occupancy and GEM generation frequency data at different temperatures, runs were conducted in a temperature control chamber.

### Example 53

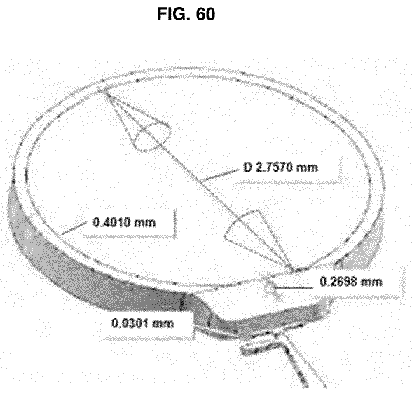

FIG. 60 shows a mold for a device of the invention in which a droplet collection region, i.e., reservoir, has a recess between the shelf and step and the main volume of the collection region.

### Example 54

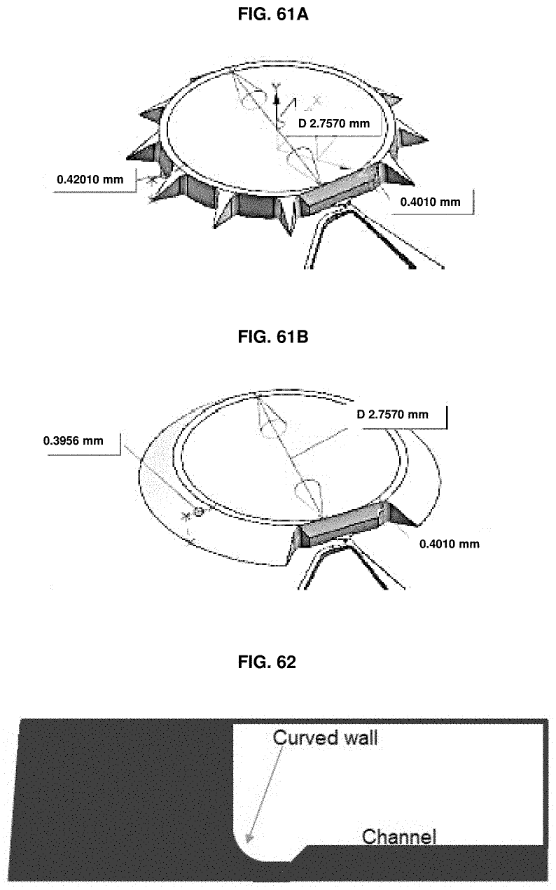

FIGS. 61A-61B show molds for devices of the invention in which multiple peripherally protruding volumes (61A) or a single, contiguous peripherally protruding volume (61B) is arranged at the periphery of the collection region, i.e., reservoir.

### Example 55

FIG. 62 shows a cross-section of a device of the invention in which the shelf and step regions connect via a curved wall.

### Example 56

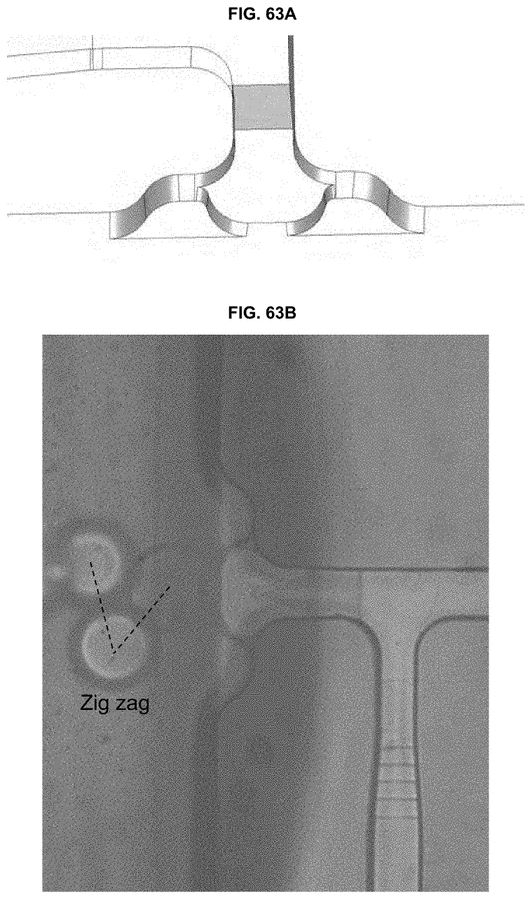

FIG. 63A shows a device of the invention in which the shelf region includes a central portion and two peripheral portions. The depth of the central portion is less than the depth of the peripheral portions. FIG. 63B shows droplet formation in this device, where droplets form in a zig-zag pattern.

### Example 57

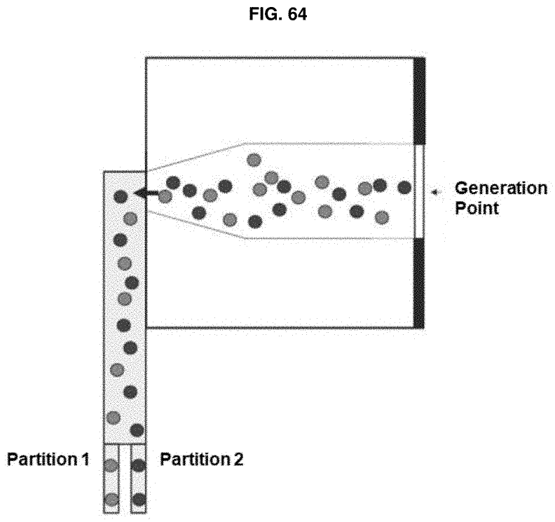

FIG. 64 shows a general embodiment of a device according to the invention that includes reentrainment channels. The droplets are formed in the droplet formation region (generation point) and move in a large reservoir. The droplets are then funneled into a narrower channel where the droplets line up in single file for further manipulation, e.g., holding, reaction, incubation, detection, or sorting.

### Example 58

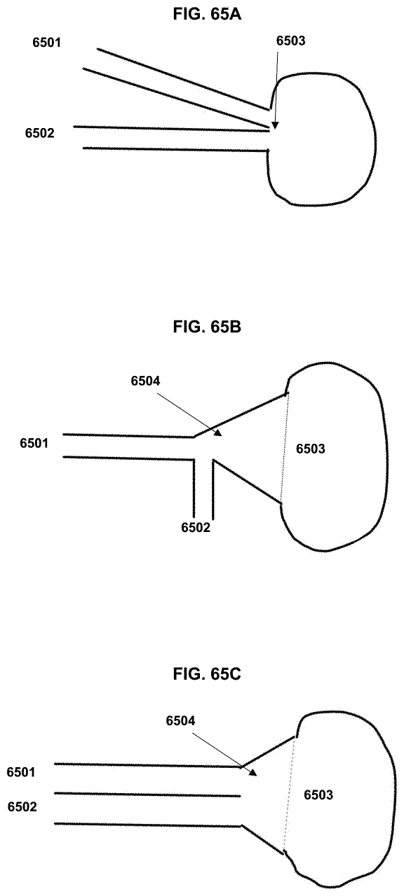

FIGS. 65A-65C show embodiments of a device according to the disclosure that includes a first channel (6501) and a second channel (6502) that do not intersect. The channels are arranged to allow combination of fluids flowing therefrom at a step region (6503) or a shelf region (6504) fluidically connected to a step region (6503).

### Example 59

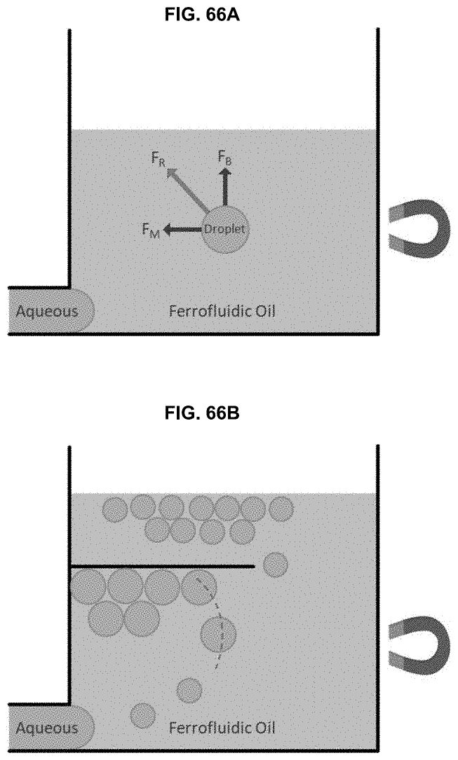

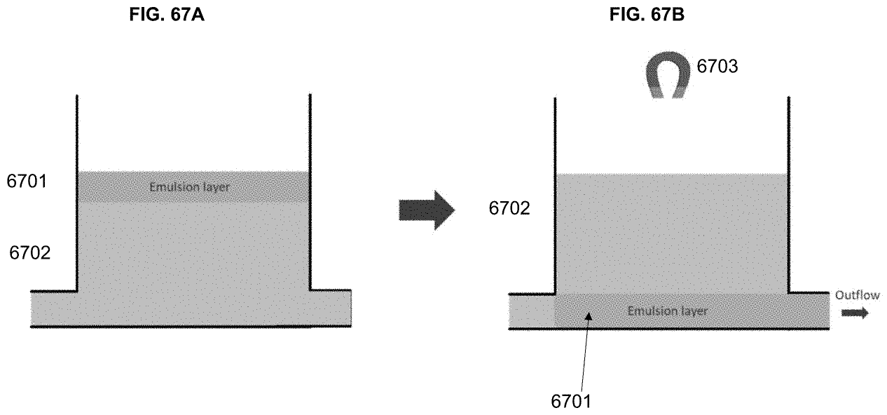

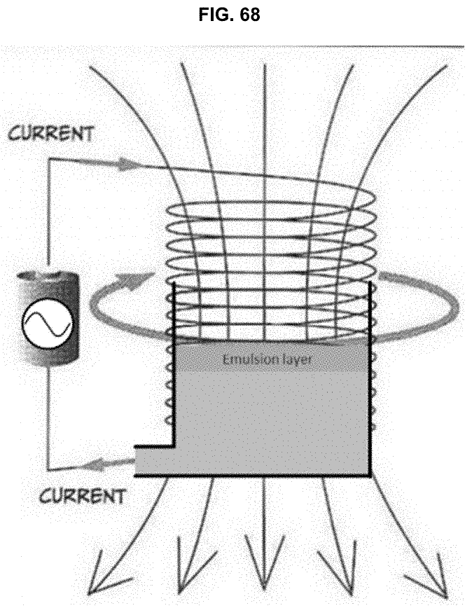

FIGS. 66A-66B, FIGS. 67A-67B, and FIG. 68 show embodiments of a system according to the disclosure that includes droplets in a ferrofluid. FIG. 66A shows the buoyant force (F_{B}) on the droplet, the force caused by the magnetic actuator (F_{M}), and the resultant force (F_{R}), the sum of F_{B} and F_{M}. FIG. 66B shows the system separating droplets based on size using the F_{R}. The force exerted on the larger droplets is greater than that of the force exerted on the smaller droplets, effectively separating the droplets based on size. FIG. 67A shows an emulsion layer (6701) at the top of a ferrofluid (6702), while FIG. 67B shows the magnetic actuator (6703) directing the emulsion layer (6701) below the ferrofluid (6702) for reentrainment. FIG. 68 shows an embodiment of the invention where the magnetic actuator creates a current thereby heating the ferrofluid and the emulsion.

### Example 60

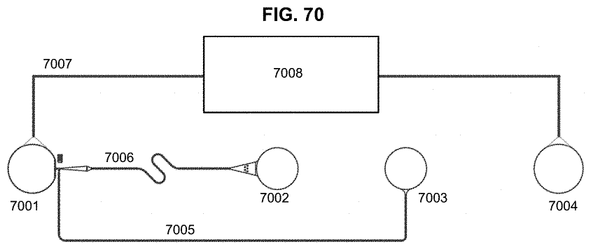

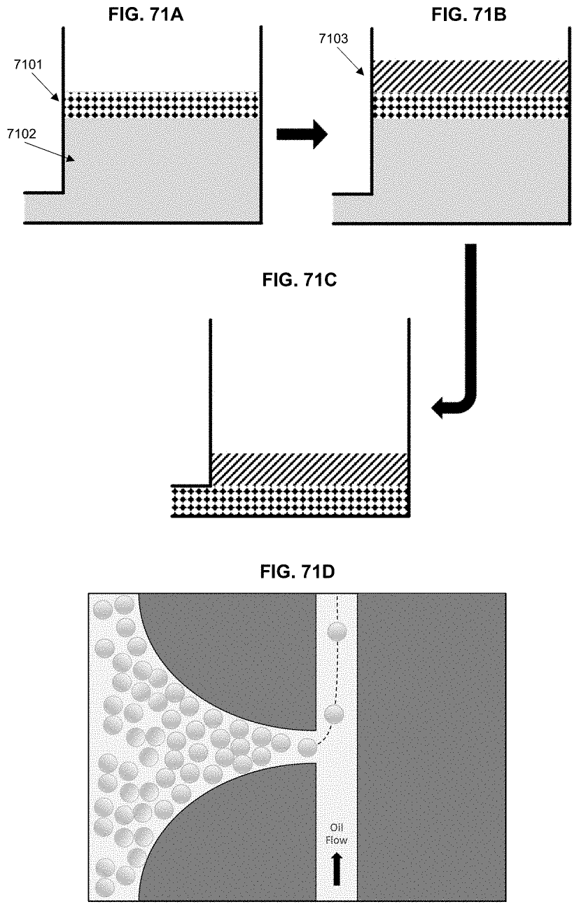

FIG. 70 and FIGS. 71A-71D are schematic drawings of an embodiment of a device of the disclosure for reentrainment of droplets or particles. FIG. 70 shows droplets or particles within reservoir (7001) can be reentrained into a reentrainment channel (7007) by application of pressure between reservoirs 7001 and 7004. Liquids from reservoir 7002 and reservoir 7003 flow through channels 7005 and 7006, combine, and form droplets in reservoir 7001. During this step, pressure may prevent flow between reservoirs 7001 and 7004. Reentrainment channel 7007 connects to a unit operation element 7008, which is connected to reservoir 7004. FIGS. 71A-71D are schematic drawings of an embodiment of a device of the disclosure for reentrainment of droplets. FIG. 71A shows an emulsion layer (7101) at the top of a partitioning oil (7102) within a reservoir. FIG. 71B shows a spacing liquid (e.g., mineral oil) (7103) added on top of the emulsion layer. FIG. 71C shows the emulsion layer reentrainment into a reentrainment channel. The spacing liquid allows for the emulsion layer to be reentrained without introducing air into the channel. FIG. 71D is a close up view of droplets in a reentrainment channel including an oil flow to meter droplets and dilute concentrated droplets prior to detection.

### Example 61

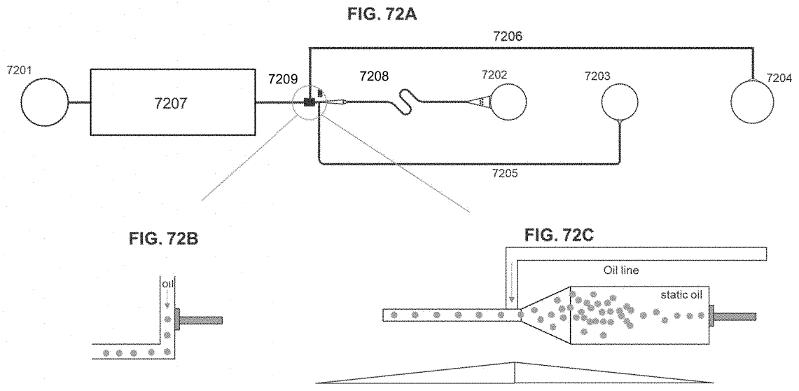

FIGS. 72A-72C are schematic drawings of an embodiment of a device of the disclosure for unit operations or inline detection of droplets or particles. Liquids from reservoirs 7202 and 7303 flow via channels 7208 and 7205 to produce droplets at step region 7209. Oil flowing continuously from reservoir 7204 reentrains the droplets and directs them to unit operation element 7207 toward reservoir 7201. FIG. 72B shows oil from a channel (7206) directly sweeping the droplets after droplet generation. FIG. 72C shows oil from a channel aiding in reentrainment of droplets after production and holding in a droplet collection region. The upper portion of FIG. 72C is a top view of an embodiment of step region 7209, and the lower portion of FIG. 72C is a profile view of the depth first increasing and then decreasing in the direction away from step region 7209 and toward unit operation element 7207.

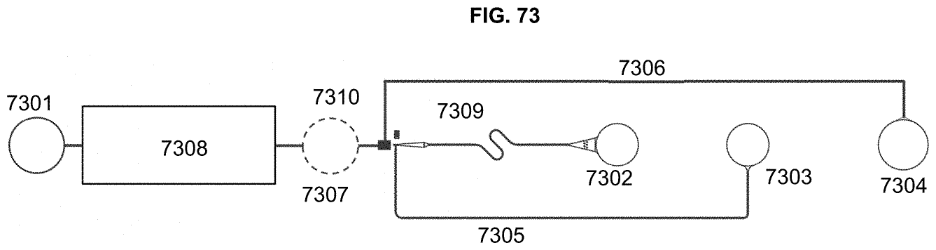

FIG. 73 is a schematic drawing of an embodiment of a device of the disclosure for unit operations or inline detection of droplets or particles having a pressure control region (7207). Liquids flow from reservoirs 7302 and 7303 via channels 7305 and 7309 (which includes a delay line) to step region 7310. Oil flowing from reservoir 7304 reentrains droplets and directs them unit operation element 7308 towards reservoir 7301. A pressure inlet 7307 may be employed to regulate pressure.

### ORDERED EMBODIMENTS

The following sections describe various embodiments of the invention.

### Embodiment A

1. A device for producing droplets, the device comprising:
a) a first channel having a first depth, a first width, a first proximal end, and a first distal end;
b) a first side-channel having a first side-channel depth, a first side-channel width, a first side-channel proximal end, and a first side-channel distal end,
   wherein the first side-channel proximal end comprises one or more first side-channel inlets, and the first side-channel distal end comprises one or more first side-channel outlets,
   wherein the first side-channel proximal end is fluidically connected to the first channel at a first proximal intersection between the first proximal end and the first distal end, and the first side-channel distal end is fluidically connected to the first channel at a first distal intersection between the first proximal intersection and the first distal end, and
   wherein the first side-channel optionally comprises a first side-channel reservoir configured for holding a liquid; and
c) a droplet formation region having at least one outlet and at least one inlet in fluid communication with the first channel;
   wherein the device is configured to produce droplets.
   2. The device of embodiment 1, wherein each of the one or more first side-channel outlets has at least one dimension smaller than the smaller of the first depth and the first width.
   3. The device of embodiment 1 or 2, wherein each of the one or more first side-channel inlets has at least one dimension smaller than the smaller of the first depth and the first width.
   4. The device of any one of embodiments 1 to 3, further comprising a second side-channel having a second side-channel depth, a second side-channel width, a second side-channel proximal end, and a second side-channel distal end,
wherein the second side-channel proximal end comprises one or more second side-channel inlets, and the second side-channel distal end comprises one or more second side-channel outlets,
wherein the second side-channel proximal end is fluidically connected to the first channel at a second proximal intersection between the first proximal end and the first distal end, and the second side-channel distal end is fluidically connected to the first channel at a second distal intersection between the second proximal intersection and the first distal end, and
wherein the second side-channel optionally comprises a reservoir configured for holding a liquid.
   5. The device of embodiment 4, wherein the first proximal intersection is substantially opposite the second proximal intersection.
   6. The device of embodiment 4 or 5, wherein the first distal intersection is substantially opposite the second distal intersection.
   7. The device of any one of embodiments 4 to 6, wherein the second side-channel comprises the second side-channel reservoir.
   8. The device of any one of embodiments 4 to 7, wherein the second side-channel reservoir is same as the first side-channel reservoir.
   9. The device of any one of embodiments 1 to 8, wherein the first side-channel comprises a first side-channel reservoir.
   10. The device of any one of embodiments 1 to 9, further comprising a first reservoir configured for holding a liquid, wherein the first reservoir is in fluid communication with the first channel.
   11. The device of embodiment 10, wherein the first proximal end is fluidically connected to the first reservoir.
   12. The device of any one of embodiments 1 to 11, further comprising one or more funnels, each funnel having a funnel proximal end, a funnel distal end, a funnel width, and a funnel depth, and wherein each funnel proximal end comprises a funnel inlet, and each funnel distal end comprises a funnel outlet.
   13. The device of embodiment 12, wherein the first channel comprises at least one funnel.
   14. The device of embodiment 12 or 13, wherein at least one funnel is disposed between the first proximal end and the first proximal intersection.
   15. The device of any one of embodiments 12 to 14, wherein at least one funnel is disposed between the first distal end and the first distal intersection.
   16. The device of any one of embodiments 12 to 15, wherein at least one funnel is disposed between the first distal intersection and the first proximal intersection.
   17. The device of embodiment 12, wherein, for one funnel, the funnel proximal end is fluidically connected to the first reservoir.
   18. The device of embodiment 17, wherein the funnel width of the one funnel is substantially equal to the width of the first reservoir.
   19. The device of any one of embodiments 12 to 18, wherein at least one funnel has at least one dimension that decreases in the direction from the funnel proximal end to the funnel distal end.
   20. The device of any one of embodiments 12 to 19, wherein at least one funnel has at least one dimension that decreases in the direction from the funnel distal end to the funnel proximal end.
   21. The device of any one of embodiments 12 to 20, wherein the funnel has a funnel length, the funnel outlet has a funnel outlet depth and a funnel outlet width, and the funnel inlet has a funnel inlet depth and a funnel inlet width, wherein the funnel length is at least 20 times greater than the smaller of the funnel outlet depth, the funnel outlet width, the funnel inlet depth, and the funnel inlet width.
   22. The device of any one of embodiments 12 to 21, wherein at least one funnel comprises one or more hurdles.
   23. The device of embodiment 22, wherein the one or more hurdles are pegs and/or barriers.
   24. The device of embodiment 23, wherein the one or more hurdles are pegs or a combination of a barrier and pegs.
   25. The device of embodiment 23 or 24, wherein the pegs have a peg length and a peg width, and the peg length is greater than the peg width.
   26. The device of any one of embodiments 23 to 25, wherein at least one hurdle is disposed closer to the funnel outlet than to the funnel inlet.
   27. The device of any one of embodiments 23 to 26, wherein at least one hurdle is disposed closer to the funnel inlet than to the funnel outlet.
   28. The device of any one of embodiments 1 to 27, wherein the first side-channel comprises a mixer.
   29. The device of embodiment 28, wherein the mixer is a passive mixer.
   30. The device of embodiment 28 or 29, wherein the mixer is a chaotic advection mixer.
   31. The device of any one of embodiments 1 to 30, wherein the first side-channel depth is half of the first depth or less.
   32. The device of embodiment 31, wherein the first side-channel depth is a quarter of the first depth or less.
   33. The device of any one of embodiments 1 to 32, further comprising a second channel having a second depth, a second width, a second proximal end, and a second distal end, wherein the second channel is in fluid communication with the first channel.
   34. The device of embodiment 33, wherein the second channel is fluidically connected to the first channel between the first distal end and the first distal intersection.
   35. The device of embodiment 33 or 34, wherein the first side-channel comprises a mixer, and the second channel is fluidically connected to the first side-channel between the mixer and the first side-channel proximal end.
   36. The device of any one of embodiments 33 to 35, wherein the second channel comprises a trap having a trap depth and configured to entrap air bubbles.
   37. The device of embodiment 36, wherein the trap depth is greater than the second depth.
   38. The device of any one of embodiments 33 to 37, wherein the second channel further comprises one or more funnels, each funnel having a funnel proximal end, a funnel distal end, a funnel width, and a funnel depth, and wherein each funnel proximal end comprises a funnel inlet, and each funnel distal end comprises a funnel outlet; wherein the one or more funnels are disposed between the second proximal end and the second distal end.
   39. The device of embodiment 38, wherein at least one funnel has at least one dimension that decreases in the direction from the funnel proximal end to the funnel distal end.
   40. The device of embodiment 38 or 39, wherein at least one funnel has at least one dimension that decreases in the direction from the funnel distal end to the funnel proximal end.
   41. The device of any one of embodiments 38 to 40, wherein the funnel has a funnel length, the funnel outlet has a funnel outlet depth and a funnel outlet width, and the funnel inlet has a funnel inlet depth and a funnel inlet width, wherein the funnel length is at least 20 times greater than the smaller of the funnel outlet depth, the funnel outlet width, the funnel inlet depth, and the funnel inlet width.
   42. The device of any one of embodiments 38 to 41, wherein the funnel width is defined by two opposing, curved walls.
   43. The device of any one of embodiments 38 to 42, wherein at least one funnel comprises one or more hurdles.
   44. The device of embodiment 43, wherein the one or more hurdles are pegs and/or barriers.
   45. The device of embodiment 44, wherein the one or more hurdles are pegs or a combination of a barrier and pegs.
   46. The device of embodiment 44 or 45, wherein the pegs have a peg length and a peg width, and the peg length is greater than the peg width.
   47. The device of any one of embodiments 40 to 46, wherein the hurdles are disposed along a curve.
   48. The device of any one of embodiments 43 to 47, wherein at least one hurdle is disposed closer to the funnel inlet than to the funnel outlet.
   49. The device of any one of embodiments 43 to 48, wherein at least one hurdle is disposed closer to the funnel outlet than to the funnel inlet.
   50. The device of any one of embodiments 38 to 49, wherein at least one funnel comprises a ramp configured to reduce the funnel depth from the funnel inlet to the funnel outlet.
   51. A device for producing droplets, the device comprising:
a) a first channel having a first depth, a first width, a first proximal end, and a first distal end, wherein the first channel comprises one or more funnels, each funnel having a funnel proximal end, a funnel distal end, a funnel width, and a funnel depth, and wherein each funnel proximal end comprises a funnel inlet, and each funnel distal end comprises a funnel outlet; and
b) a droplet formation region having at least one outlet and at least one inlet in fluid communication with the first channel, wherein the droplet formation region
   (i) is configured to allow a liquid to expand in at least one dimension, or
   (ii) comprises a step region having a step depth;
      wherein the device is configured to produce droplets.
      52. The device of embodiment 51, further comprising a first reservoir configured for holding a liquid, wherein the first reservoir is in fluid communication with the first channel.
      53. The device of embodiment 52, wherein the first proximal end is fluidically connected to the first reservoir.
      54. The device of embodiment 52 or 53, wherein, for one funnel, the funnel proximal end is fluidically connected to the first reservoir.
      55. The device of embodiment 54, wherein the funnel width of the one funnel is substantially equal to the width of the first reservoir.
      56. The device of any one of embodiments 51 to 55, wherein at least one funnel has at least one dimension that decreases in the direction from the funnel proximal end to the funnel distal end.
      57. The device of any one of embodiments 51 to 56, wherein at least one funnel has at least one dimension that decreases in the direction from the funnel distal end to the funnel proximal end.
      58. The device of any one of embodiments 51 to 57, wherein at least one funnel comprises one or more hurdles.
      59. The device of embodiment 58, wherein the one or more hurdles are pegs and/or barriers.
      60. The device of embodiment 59, wherein the one or more hurdles are pegs or a combination of a barrier and pegs.
      61. The device of embodiment 59 or 60, wherein the pegs have a peg length and a peg width, and the peg length is greater than the peg width.
      62. The device of any one of embodiments 58 to 61, wherein at least one hurdle is disposed closer to the funnel outlet than to the funnel inlet.
      63. The device of any one of embodiments 58 to 62, wherein at least one hurdle is disposed closed to the funnel inlet than to the funnel outlet.
      64. The device of any one of embodiments 51 to 63, wherein the funnel has a funnel length, the funnel outlet has a funnel outlet depth and a funnel outlet width, and the funnel inlet has a funnel inlet depth and a funnel inlet width, wherein the funnel length is at least 20 times greater than the smaller of the funnel outlet depth, the funnel outlet width, the funnel inlet depth, and the funnel inlet width.
      65. The device of any one of embodiments 51 to 64, further comprising a second channel having a second depth, a second width, a second proximal end, and a second distal end, wherein the second channel is fluidically connected to the first channel at a channel intersection between the first proximal end and the first distal end.
      66. The device of embodiment 65, wherein at least one funnel is disposed between the first proximal end and the channel intersection.
      67. The device of embodiment 65 or 66, wherein at least one funnel is disposed between the first distal end and the channel intersection.
      68. The device of any one of embodiments 65 to 67, wherein the second channel comprises a mixer disposed between the second proximal end and the channel intersection.
      69. A device for producing droplets, the device comprising:
a) a first channel having a first depth, a first width, a first proximal end, and a first distal end;
b) a second channel having a second depth, a second width, a second proximal end, and a second distal end, wherein the second channel is fluidically connected to the first channel at a channel intersection between the first proximal end and the first distal end, and the second channel comprises a mixer disposed between the second proximal end and the channel intersection; and
c) a droplet formation region having at least one outlet and at least one inlet in fluid communication with the first channel;
   wherein the device is configured to produce droplets.
   70. The device of embodiment 69, further comprising a first reservoir configured for holding a liquid, wherein the first reservoir is in fluid communication with the first channel.
   71. The device of embodiment 69 or 70, wherein the first proximal end is fluidically connected to the first reservoir.
   72. The device of any one of embodiments 68 to 71, wherein the mixer is a passive mixer.
   73. The device of any one of embodiments 68 to 71, wherein the mixer is a chaotic advection mixer.
   74. The device of any one of embodiments 65 to 74, wherein the second channel further comprises one or more funnels, each funnel having a funnel proximal end, a funnel distal end, a funnel width, and a funnel depth, and wherein each funnel proximal end comprises a funnel inlet, and each funnel distal end comprises a funnel outlet; wherein the one or more funnels are disposed between the second proximal end and the second distal end.
   75. A device for producing droplets, the device comprising:
a) a first channel having a first depth, a first width, a first proximal end, and a first distal end;
b) a second channel having a second depth, a second width, a second proximal end, and a second distal end, wherein the second channel is fluidically connected to the first channel at a channel intersection between the first proximal end and the first distal end, and the second channel comprises one or more funnels, each funnel having a funnel proximal end, a funnel distal end, a funnel width, and a funnel depth, and wherein each funnel proximal end comprises a funnel inlet, and each funnel distal end comprises a funnel outlet; and
c) a droplet formation region having at least one outlet and at least one inlet in fluid communication with the first channel;
   wherein the first channel, the second channel, and the droplet formation region are configured to produce droplets.
   76. The device of embodiment 74 or 75, wherein at least one funnel has at least one dimension that decreases in the direction from the funnel proximal end to the funnel distal end.
   77. The device of embodiment 74 or 75, wherein at least one funnel has at least one dimension that decreases in the direction from the funnel distal end to the funnel proximal end.
   78. The device of any one of embodiments 74 to 77, wherein the funnel has a funnel length, the funnel outlet has a funnel outlet depth and a funnel outlet width, and the funnel inlet has a funnel inlet depth and a funnel inlet width, wherein the funnel length is at least 20 times greater than the smaller of the funnel outlet depth, the funnel outlet width, the funnel inlet depth, and the funnel inlet width.
   79. The device of any one of embodiments 74 to 78, wherein the funnel width is defined by two opposing, curved walls.
   79. The device of any one of embodiments 74 to 78, wherein at least one funnel comprises one or more hurdles.
   80. The device of embodiment 79, wherein the one or more hurdles are pegs and/or barriers.
   81. The device of embodiment 80, wherein the one or more hurdles are pegs or a combination of a barrier and pegs.
   82. The device of embodiment 80 or 81, wherein the pegs have a peg length and a peg width, and the peg length is greater than the peg width.
   83. The device of any one of embodiments 79 to 82, wherein the hurdles are disposed along a curve.
   84. The device of any one of embodiments 79 to 83, wherein at least one hurdle is disposed closer to the funnel inlet than to the funnel outlet.
   85. The device of any one of embodiments 79 to 84, wherein at least one hurdle is disposed closer to the funnel outlet than to the funnel inlet.
   86. The device of any one of embodiments 79 to 85, wherein at least one funnel comprises a ramp configured to reduce the funnel depth from the funnel inlet to the funnel outlet.
   87. The device of any one of embodiments 65 to 86, wherein the second channel comprises a trap having a trap depth and configured to entrap air bubbles.
   88. A device for producing droplets, the device comprising:
a) a first channel having a first depth, a first width, a first proximal end, and a first distal end;
b) a second channel having a second depth, a second width, a second proximal end, and a second distal end, wherein the second channel is fluidically connected to the first channel at a channel intersection between the first proximal end and the first distal end;
c) a droplet formation region having at least one outlet and at least one inlet in fluid communication with the first channel; and
   wherein at least one of the first channel and the second channel comprises at least one trap, each trap having a trap depth, wherein each trap is configured to entrap air bubbles, and wherein the device is configured to produce droplets;
   wherein the first channel, the second channel, and the droplet formation region are configured to produce droplets.
   89. The device of embodiment 88, wherein the second channel comprises at least one trap.
   90. The device of embodiment 89, wherein the trap is disposed between the second proximal end and the channel intersection.
   91. The device of any one of embodiments 87 to 90, wherein trap depth is greater than the second depth.
   92. The device of any one of embodiments 87 to 91, wherein the second channel comprises a mixer, and at least one trap is disposed between the second proximal end and the mixer.
   93. The device of any one of embodiments 87 to 91, wherein the second channel comprises a mixer, and at least one trap is disposed between the second distal end and the mixer.
   94. The device of any one of embodiments 65 to 93, further comprising a second reservoir configured for holding a liquid, wherein the second reservoir is in fluid communication with the first channel.
   95. The device of embodiment 94, wherein the second reservoir is fluidically connected to the second channel.
   96. The device of embodiment 94 or 95, further comprising a third reservoir configured for holding a liquid, wherein the third reservoir is in fluid communication with the first channel.
   97. The device of embodiment 96, further comprising a third channel having a third depth, third width, third proximal end, and third distal end, wherein the third channel is fluidically connected to the second channel and the third reservoir.
   98. The device of embodiment 96 or 97, wherein the third channel comprises at least one trap.
   99. The device of embodiment 98, wherein the trap depth is greater than the third depth.
   100. The device of any one of embodiments 1 to 99, wherein the first channel comprises at least one trap.
   101. The device of embodiment 100, wherein the trap is disposed between the first proximal end and the channel intersection.
   102. The device of embodiment 100 or 101, wherein the trap depth is greater than the first depth.
   103. The device of any one of embodiments 1 to 102, wherein the droplet formation region is configured to allow a liquid to expand in at least one dimension.
   104. The device of any one of embodiments 1 to 103, wherein the droplet formation region comprises a shelf region having a droplet formation region depth and a droplet formation region width.
   105. The device of any one of embodiments 1 to 104, wherein the droplet formation region comprises a step region having a step depth.
   106. The device of any one of embodiments 1 to 105, further comprising a collection region configured to collect droplets produced in the droplet formation region.
   107. The device of any one of embodiments 1 to 106, wherein the device is configured to produce a population of droplets that are substantially stationary in the collection region.
   108. The device of any one of embodiments 1 to 59, wherein the droplets comprise particles.
   109. The device of any one of embodiments 1 to 60, wherein the device is configured to produce droplets comprising a single particle.
   110. A system for producing droplets, the system comprising:
   a) a device comprising:
i) a first channel having a first depth, a first width, a first proximal end, and a first distal end, the first channel comprising a first liquid and particles;
ii) a first side-channel having a first side-channel proximal end and a first side-channel distal end,
   wherein the first side-channel proximal end comprises one or more first side-channel inlets, and the first side-channel distal end comprises one or more first side-channel outlets,
   wherein the first side-channel proximal end is fluidically connected to the first channel at a first proximal intersection between the first proximal end and the first distal end, and the first side-channel distal end is fluidically connected to the first channel at a first distal intersection between the first proximal intersection and the first distal end, and
   wherein the first side-channel optionally comprises a first side-channel reservoir configured for holding a liquid; and
iii) a droplet formation region having at least one outlet and at least one inlet in fluid communication with the first channel;
   b) a first liquid disposed in the first channel and the first side-channel;
   c) a second liquid disposed in the droplet formation region, wherein the first liquid and the second liquid are immiscible; and
   d) particles disposed in the first channel;
   wherein the system is configured to produce droplets of a first liquid in a second liquid, the droplets comprising the particles.
   111. The system of embodiment 110, wherein the device is of embodiment 2 or 3.
   112. The system of embodiment 110 or 111, wherein the first side-channel is substantially free of the particles.
   113. The system of any one of embodiments 110 to 112, wherein the device is of any one of embodiments 4 to 9, and wherein the second side-channel comprises the first liquid.
   114. The system of embodiment 113, wherein the second side-channel is substantially free of the particles.
   115. The system of any one of embodiments 110 to 114, wherein the device is of embodiment 10 or 11, and wherein the first reservoir comprises the first liquid and particles.
   116. The system of any one of embodiments 110 to 115, wherein the device is of any one of embodiments 12 to 32.
   117. The system of any one of embodiments 110 to 116, wherein the device is of any one of embodiments 33 to 50, and wherein the second channel comprises a third liquid, and wherein the droplets produced by the device further comprise the third liquid.
   118. The system of any one of embodiments 110 to 117, wherein the first side-channel depth is half of the first depth or less.
   119. The system of embodiment 118, wherein the first side-channel depth is a quarter of the first depth or less.
   120. The system of any one of embodiments 110 to 119, wherein the first side-channel is sized to substantially prevent ingress of particles from the first channel
   121. A system for producing droplets, the system comprising:
   a) a device comprising:
i) a first channel having a first depth, a first width, a first proximal end, a first distal end, wherein the first channel comprises one or more funnels, each funnel having a funnel proximal end, a funnel distal end, a funnel width, and a funnel depth, and wherein each funnel proximal end comprises a funnel inlet, and each funnel distal end comprises a funnel outlet; and
ii) a droplet formation region having at least one outlet and at least one inlet in fluid communication with the first channel, wherein the droplet formation region
   (i) is configured to allow a liquid to expand in at least one dimension, or
   (ii) comprises a step region having a step depth;
      b) a first liquid disposed in the first channel;
      c) a second liquid disposed in the droplet formation region, wherein the first liquid and the second liquid are immiscible; and
      d) particles disposed in the first channel;
      wherein the system is configured to produce droplets of a first liquid in a second liquid, the droplets comprising the particles.
      122. The system of embodiment 121, wherein the device is of any one of embodiments 51 to 55, and wherein the first reservoir comprises the first liquid and the particles.
      123. The system of embodiment 121 or 122, wherein the device is of any one of embodiments 56 to 64.
      124. The system of any one of embodiments 121 to 123, wherein the device is of any one of embodiments 65 to 68, wherein the system further comprises a third liquid disposed in the second channel, and the droplets further comprise the third liquid.
      125. The system of any one of embodiments 110 to 124, wherein the system is configured to produce droplets comprising a single particle.
      126. A system for producing droplets, the system comprising:
      a) a device comprising:
i) a first channel having a first depth, a first width, a first proximal end, and a first distal end;
ii) a second channel having a second depth, a second width, a second proximal end, and a second distal end, wherein the second channel is fluidically connected to the first channel at a channel intersection between the first proximal end and the first distal end, and the second channel comprises a mixer disposed between the second proximal end and the channel intersection; and
iii) a droplet formation region having at least one outlet and at least one inlet in fluid communication with the first channel;
   b) a first liquid disposed in the first channel;
   c) a second liquid disposed in the droplet formation region, wherein the first liquid and the second liquid are immiscible;
   d) a third liquid disposed in the second channel;
   wherein the system is configured to produce droplets of the first and third liquids in the second liquid.
   127. The system of embodiment 126, wherein the device is of embodiment 70 or 71, and wherein the first reservoir comprises the first liquid.
   128. The system of embodiment 126 or 127, wherein the mixer is a passive mixer.
   129. The system of any one of embodiments 126 to 128, wherein the mixer is a chaotic advection mixer.
   130. The system of any one of embodiments 126 to 129, further comprising particles, wherein the particles are disposed in the first channel and, when present, the first reservoir.
   131. The system of any one of embodiments 124 and 126 to 130, the device further comprises a second reservoir configured for holding a liquid, wherein the second reservoir is in fluid communication with the first channel.
   132. The system of embodiment 131, wherein the third liquid is disposed in the second reservoir.
   133. The system of embodiment 131 or 132, wherein the second reservoir is fluidically connected to the second channel.
   134. The system of any one of embodiments 130 to 133, wherein the system further comprises a fourth liquid, and the device further comprises a third reservoir configured for holding a liquid, wherein the third reservoir is in fluid communication with the first channel, and the fourth liquid is disposed in the third reservoir.
   135. The system of embodiment 134, wherein the device further comprises a third channel having a third depth, third width, third proximal end, and third distal end, wherein the third channel is fluidically connected to the second channel and the third reservoir, and wherein the fourth liquid is disposed in the second and third channels.
   136. The system of any one of embodiments 123 and 125 to 134, wherein the mixer is configured to mix the liquids.
   137. A system for producing droplets, the system comprising:
   a) a device comprising:
i) a first channel having a first depth, a first width, a first proximal end, and a first distal end;
ii) a second channel having a second depth, a second width, a second proximal end, and a second distal end, wherein the second channel is fluidically connected to the first channel at a channel intersection between the first proximal end and the first distal end, and the second channel comprises one or more funnels, each funnel having a funnel proximal end, a funnel distal end, a funnel width, and a funnel depth, and wherein each funnel proximal end comprises a funnel inlet, and each funnel distal end comprises a funnel outlet; and
iii) a droplet formation region having at least one outlet and at least one inlet in fluid communication with the first channel;
   b) a first liquid disposed in the first channel;
   c) a second liquid disposed in the droplet formation region, wherein the first liquid and the second liquid are immiscible;
   d) a third liquid disposed in the second channel;
   wherein the system is configured to produce droplets of the first and third liquids in the second liquid.
   138. The system of embodiment 137, wherein the device is of any one of embodiments 76 to 87.
   139. A system for producing droplets, the system comprising:
   a) a device comprising:
i) a first channel having a first depth, a first width, a first proximal end, and a first distal end;
ii) a second channel having a second depth, a second width, a second proximal end, and a second distal end, wherein the second channel is fluidically connected to the first channel at a channel intersection between the first proximal end and the first distal end;
iii) a droplet formation region having at least one outlet and at least one inlet in fluid communication with the first channel; and
wherein at least one of the first channel and the second channel comprises at least one trap, each trap having a trap depth, wherein each trap is configured to entrap air bubbles, and wherein the device is configured to produce droplets;
wherein the first channel, the second channel, and the droplet formation region are configured to produce droplets;
   b) a first liquid disposed in the first channel;
   c) a second liquid disposed in the droplet formation region, wherein the first liquid and the second liquid are immiscible; and
   d) a third liquid disposed in the second channel;
   wherein the system is configured to produce droplets of the first and third liquids in the second liquid.
   140. The system of embodiment 139, wherein the device is of any one of embodiments 89 to 93.
   141. The system of any one of embodiments 110 to 140, wherein the droplet formation region is configured to allow a liquid to expand in at least one dimension.
   142. The system of any one of embodiments 110 to 141, wherein the droplet formation region comprises a shelf region having a droplet formation region depth and a droplet formation region width.
   143. The system of any one of embodiments 110 to 142, wherein the droplet formation region comprises a step region having a step depth.
   144. The system of any one of embodiments 110 to 143, further comprising a collection region configured to collect droplets produced in the droplet formation region.
   145. The system of any one of embodiments 110 to 144, wherein the device is configured to produce a population of droplets that are substantially stationary in the collection region.
   146. The system of any one of embodiments 110 to 145, wherein the droplets comprise particles.
   147. The system of any one of embodiments 110 to 146, wherein the device is configured to produce droplets comprising a single particle.
   148. A method of producing droplets comprising a first liquid and a particle, the method comprising:
   a) providing the system of any one of embodiments 110 to 125 and 137 to 147;
and
   b) allowing the first liquid to flow from the first channel to the droplet formation region to produce droplets of the first liquid and a particle in the second liquid.
   149. A method of producing droplets in a second liquid, the droplets comprising a first liquid and a third liquid premixed with another liquid, the method comprising:
   a) providing the system of any one of embodiments 126 to 136; and
   b) allowing the first liquid to flow from the first channel to the droplet formation region to produce droplets in the second liquid, the droplets comprising the first liquid and the third liquid premixed with another liquid.
   150. The method of embodiment 149, wherein the another liquid is the first liquid.
   151. The method of embodiment 149 or 150, wherein the system is of embodiment 134, and the another liquid is the fourth liquid.
   152. The method of any one of embodiments 148 to 151, wherein the droplet formation region is configured to allow a liquid to expand in at least one dimension.
   153. The method of any one of embodiments 148 to 152, wherein the droplet formation region comprises a shelf region having a droplet formation region depth and a droplet formation region width.
   154. The method of any one of embodiments 148 to 153, wherein the droplet formation region comprises a step region having a step depth.
   155. The method of any one of embodiments 148 to 154, further comprising a collection region configured to collect droplets produced in the droplet formation region.

### Embodiment B

1. A device for producing droplets, the device comprising:
(i) one or more first channels, each first channel having independently a first depth, a first width, a first proximal end, and a first distal end, the first distal end comprising a first channel outlet;
(ii) one or more second channels, each second channel having independently a second depth, a second width, a second proximal end, and a second distal end, wherein each second channel intersects one of the first channels between the first proximal and first distal ends;
(iii) a droplet collection region; and
(iv) a droplet formation region comprising a shelf region, wherein the droplet formation region is in fluid communication with the first channel outlets and the droplet collection region, and
   (a) wherein the width of the droplet formation region is at least five times greater than the combined widths of the first channel outlets, or
   (b) wherein the droplet formation region comprises a protrusion from the first channel outlet towards the droplet collection region;
      wherein the first channels, the second channels, the droplet formation region, and the droplet collection region are configured to produce droplets.
      2. The device of embodiment 1, wherein the droplet formation region comprises a row of pegs disposed along the width of the shelf region.
      3. The device of embodiment 2, wherein the width of each peg is smaller than the width of a single first channel outlet by 50% or less.
      4. The device of embodiment 2 or 3, wherein the width of each peg is greater than the width of a single first channel outlet by 100% or less.
      5. The device of any one of embodiments 2 to 4, wherein the length of each peg is at least equal to the width of the peg.
      6. The device of any one of embodiments 2 to 5, wherein the length of each peg is greater than the width of the peg by 200% or less.
      7. The device of any one of embodiments 2 to 6, wherein the row of pegs comprises at least 10 pegs for each first channel outlet.
      8. The device of any one of embodiments 2 to 7, wherein the row of pegs comprises 30 or fewer pegs for each first channel outlet.
      9. The device of any one of embodiments 2 to 8, wherein the pegs are spaced at a distance that is smaller than the width of a single first channel outlet by 50% or less.
      10. The device of any one of embodiments 2 to 9, wherein the pegs are spaced at a distance that is equal to or smaller than the width of a single first channel outlet.
      11. The device of any one of embodiments 1 to 10, wherein the length of the shelf region is greater than the width of one first channel outlet by at least 100%.
      12. The device of any one of embodiments 1 to 11, wherein the length of the shelf region is greater than the width of a single first channel outlet by 1000% or less.
      13. The device of any one of embodiments 1 to 12, wherein the depth of the shelf region increases in the direction from the first channel outlet to the droplet collection region.
      14. The device of any one of embodiments 1 to 13, wherein the droplet formation region occupies at least 25% of the perimeter of the droplet collection region.
      15. The device of embodiment 1, wherein the droplet formation region comprises a shelf region protruding from the first channel outlet towards the droplet collection region.
      16. The device of embodiment 15, wherein the shelf region has a shelf region width that is less than twice the width of the first channel outlet.
      17. The device of embodiment 15 or 16, wherein the droplet formation region comprises a step region, and the shelf region protrudes into the step region.
      18. A device for producing droplets, the device comprising:
(i) one or more first channels, each first channel having independently a first depth, a first width, a first proximal end, and a first distal end, the first distal end comprising a first channel outlet;
(ii) one or more second channels, each second channel having independently a second depth, a second width, a second proximal end, and a second distal end, wherein each second channel intersects one of the first channels between the first proximal and first distal ends;
(iii) a droplet collection region; and
(iv) one or more droplet formation regions in fluid communication with the first channel outlets and the droplet collection region;
   wherein at least one of the one or more first channels bifurcates into two downstream first channels after the intersection between the first channel and the second channel, and the downstream first channels are fluidically connected to the one or more droplet formation regions; and
   wherein the first channels, the downstream first channels, the second channels, the droplet formation region, and the droplet collection region are configured to produce droplets.
   19. The device of embodiment 18, wherein the two downstream first channels are curved.
   20. The device of any one of embodiments 1 to 19, wherein at least one of the second channels comprises a funnel.
   21. The device of any one of embodiments 1 to 20, wherein the funnel is disposed between the second proximal end and the intersection between the first channel and the second channel.
   22. The device of any one of embodiments 1 to 21, wherein the first channel comprises a mixer.
   23. The device of embodiment 22, wherein the mixer is disposed between the first distal end and the intersection between the first channel and the second channel.
   24. The device of embodiment 22 or 23, wherein the mixer is a herringbone mixer.
   25. A system for producing droplets, the system comprising:
   (a) a device comprising:
(i) one or more first channels, each first channel having independently a first depth, a first width, a first proximal end, and a first distal end, the first distal end comprising a first channel outlet;
(ii) one or more second channels, each second channel having independently a second depth, a second width, a second proximal end, and a second distal end, wherein each second channel intersects one of the first channels between the first proximal and first distal ends;
(iii) a droplet collection region; and
(iv) a droplet formation region comprising a shelf region, wherein the droplet formation region is in fluid communication with the first channel outlets and the droplet collection region, and
   wherein the width of the droplet formation region is at least five times greater than the combined widths of the first channel outlets, or
   wherein the droplet formation region comprises a protrusion from the first channel outlet towards the droplet collection region;
      (b) a first liquid disposed in the first channel;
      (c) a second liquid disposed in the droplet collection region; and
      (d) a third liquid disposed in the second channel;
      wherein the first liquid and the second liquid are immiscible;
      wherein the first liquid and the third liquid are miscible; and
      wherein the system is configured to produce droplets of the first and third liquids in the second liquid.
      26. The system of embodiment 25, wherein the device is of any one of embodiments 2 to 17.
      27. A system for producing droplets, the system comprising:
      (a) a device comprising:
(i) one or more first channels, each first channel having independently a first depth, a first width, a first proximal end, and a first distal end, the first distal end comprising a first channel outlet;
(ii) one or more second channels, each second channel having independently a second depth, a second width, a second proximal end, and a second distal end, wherein each second channel intersects one of the first channels between the first proximal and first distal ends;
(iii) a droplet collection region; and
(iv) one or more droplet formation regions in fluid communication with the first channel outlets and the droplet collection region;
wherein at least one of the one or more first channels bifurcates into two downstream first channels after the intersection between the first channel and the second channel, and the downstream first channels are fluidically connected to the one or more droplet formation regions;
   (b) a first liquid disposed in the first channel;
   (c) a second liquid disposed in the droplet collection region; and
   (d) a third liquid disposed in the second channel;
   wherein the first liquid and the second liquid are immiscible;
   wherein the first liquid and the third liquid are miscible; and
   wherein the system is configured to produce droplets of the first and third liquids in the second liquid.
   28. The system of embodiment 27, wherein the device is of embodiment 19.
   29. The system of any one of embodiments 25 to 28, wherein the device is of any one of embodiments 20 to 24.
   30. The system of any one of embodiments 25 to 29, further comprising a plurality of particles disposed in the first channel.
   31. A method of producing droplets in a second liquid, the droplets comprising a first liquid and a third liquid, the method comprising:
   (a) providing the system of any one of embodiments 25 to 30; and
   (b) allowing the first liquid to flow from the first channel to the droplet formation region to produce droplets in the second liquid, the droplets comprising the first liquid and the third liquid.

### Embodiment C

1. A system for detecting the status of a fluid, comprising:
a) a device, comprising a flow path comprising a first channel having a first proximal end and a first distal end;
b) a first reservoir in fluid communication with the first proximal end;
c) a collection reservoir in fluid communication with the first distal end; and
d) one or more sensors configured to measure the status of the fluid as it flows in the system.
   2. The system of embodiment 1, wherein the status is the presence or absence of the fluid in a portion of the device.
   3. The system of embodiment 2, wherein the status is depletion of the fluid in the portion of the device.
   4. The system of embodiment 1, wherein the one or more sensors are integrated into the device.
   5. The system of embodiment 1, wherein the one or more sensors are external to the device.
   6. The system of any one of embodiments 1-5, wherein the one or more sensors are disposed at an interface of the first reservoir and the first distal end.
   7. The system of any one of embodiments 1-5, wherein the one or more sensors are disposed between the first proximal end and the first distal end.
   8. The system of any one of embodiments 1-7, further comprising a controller configured to collect, process, and/or transmit data collected by the one or more sensors.
   9. The system of any one of embodiments 1-8, wherein the one or more sensors comprise a flow sensor, a pressure sensor, an optical sensor, or an electrical sensor.
   10. The system of embodiment 9, wherein the flow sensor is a rotameter, a mass gas flow meter, a spring and piston flow meter, a positive displacement flow meter, a vortex meter, a differential pressure sensor, a magnetic flow meter, an ultrasonic flow meter, a turbine flow meter, a paddlewheel sensor, or an electromagnetic flow sensor.
   11. The system of embodiment 9, wherein the pressure sensor is an inductive, resistive, piezoelectric, or capacitive transducer.
   12. The system of embodiment 9, wherein the optical sensor comprises a light source and a light detector.
   13. The system of any one of embodiments 1-12, wherein the status of the fluid in the device is determined by measuring the pressure, flow rate, viscosity, conductivity, or optical density of the fluid as it flows along the flow path.
   14. The system of any one of embodiments 1-13, wherein the status of the fluid in the device is determined by measuring the pressure, flow rate, viscosity, conductivity, or optical density of a second fluid as it displaces the fluid in a portion of the device.
   15. A method for detecting the status of a fluid comprising:
a) providing the system of any one of embodiments 1-14
b) allowing a volume of a first fluid contained in the first reservoir to flow in the flow path;
c) detecting the status of the first fluid as it flows using the one or more sensors; and
d) stopping the flow of the first fluid or adding additional fluid to the first reservoir when the status of the first fluid flowing in the flow path meets a threshold condition.
   16. The method of embodiment 15, wherein the status is the presence or absence of the fluid in a portion of the device.
   17. The method of embodiment 15, wherein the status is depletion of the fluid in the portion of the device.
   18. The method of embodiment 15, wherein step (c) comprises measuring the pressure, flow rate, viscosity, conductivity, optical density of the fluid as it flows along the flow path.
   19. The method of embodiment 15, wherein step (c) comprises measuring the pressure, flow rate, viscosity, conductivity, or optical density of a second fluid as it displaces the fluid in the device.
   20. The method of embodiment 15, wherein the threshold condition results from displacement of the first fluid by a second fluid.
   21. The method of embodiment 15, wherein the first fluid is a liquid.
   22. The method of embodiment 21, wherein the liquid is aqueous.
   23. The method of embodiment 20, wherein the second fluid is air.
   24. The method of embodiment 15, wherein the flow of the first fluid in the flow path is stopped within 0.0001 second to 1 second of when the status meets the threshold condition.
   25. The method of any one of embodiments 15-24, further comprising allowing a volume of a second fluid to flow in the flow path when the status meets the threshold condition.
   26. The method of embodiment 25 wherein the second fluid is a liquid.
   27. The method of embodiment 25, wherein the second fluid is a gas.
   28. The method of any one of embodiments 25-27, further comprising detecting the status of the second fluid as it flows using the one or more sensors; and stopping the flow of the second fluid when the status of the second fluid flowing in the flow path meets a threshold condition.
   29. The method of embodiment 28, further comprising allowing a second volume of the first fluid to flow in the flow path when the status of the second fluid flowing in the flow path meets its threshold condition.
   30. The method of embodiment 28, further comprising allowing a volume of a third fluid to flow in the flow path when the status of the second fluid flowing in the flow path meets its threshold condition.

### Embodiment D

1. A device for producing droplets of a first liquid in a second liquid, the device comprising:
a) a first channel having a first depth, a first width, a first proximal end, and a first distal end;
b) a droplet formation region in fluid communication with the first channel; and
c) a collection reservoir in fluid communication with the droplet formation region and configured to collect droplets formed in the droplet formation region, wherein the collection reservoir comprises a first volume and a second volume, wherein the first volume has at least one cross-sectional dimension that is smaller than a corresponding cross-sectional dimension of the second volume, the first volume has a volume that is less than 1% of the volume of the second volume, and a droplet in the first volume does not contact the second volume,
wherein the first channel and droplet formation region are configured to produce droplets of the first liquid in the second liquid.
2. The device of embodiment 1, wherein the first volume has a volume that is less than 0.5% of the volume of the second volume.
3. The device of embodiment 1, wherein the first volume has a volume that is less than 0.1% of the volume of the second volume.
4. The device of embodiment 1, wherein the first volume has a volume between 0.01 μL to 10 μL.
5. The device of embodiment 1, wherein the second volume has a volume between 100 μL to 10,000 μL.
6. The device of embodiment 1, further comprising a second channel having a second depth, a second width, a second proximal end, and a second distal end, wherein the second channel intersects the first channel between the first proximal and first distal ends.
7. The device of embodiment 1, wherein the droplet formation region comprises a shelf region having a third depth, a third width, at least one inlet, and at least one outlet, wherein the shelf region is configured to allow the first liquid to expand in at least one dimension.
8. The device of embodiment 1, wherein the droplet formation region further comprises a step region having a fourth depth.
9. The device of embodiment 1, wherein the device is configured to produce a droplets that are substantially stationary in the collection reservoir.
10. The device of embodiment 1, wherein the first liquid comprises particles.
11. The device of embodiment 1, wherein the first channel and the droplet formation region are configured to produce droplets including a single particle.
12. The device of embodiment 7, wherein the third width increases from the inlet of the shelf region to the outlet of the shelf region.
13. The device of embodiment 1, further comprising a first reservoir in fluid communication with the first proximal end.
14. The device of embodiment 6, further comprising a second reservoir in fluid communication with the second proximal end.
15. The device of embodiment 7, further comprising a third channel having a third proximal end and a third distal end, wherein the third proximal end is in fluid communication with the shelf region, and wherein the third distal end is in fluid communication with the step region.
16. The device of embodiment 1, further comprising at least one additional first channel (a), droplet formation region (b), and collection reservoir (c).
17. A method of producing droplets of a first liquid in a second liquid comprising:
a) providing a device comprising:
i) a first channel having a first depth, a first width, a first proximal end, and a first distal end;
ii) a droplet formation region in fluid communication with the first channel; and
iii) a collection reservoir configured to collect droplets formed in the droplet formation region,
wherein the collection reservoir has a first volume and a second volume, wherein the first volume has at least one cross-sectional dimension that is smaller than a corresponding cross-sectional dimension of the second volume; wherein the first volume has a volume of less than 1% of the second volume; wherein the collection reservoir comprises the second liquid; and wherein the first liquid is substantially immiscible with the second liquid;
b) allowing the first liquid to flow from the first channel to the droplet formation region to produce droplets of the first liquid in the second liquid;
c) collecting the droplets in the collection reservoir, wherein the droplets pass through the first volume into the second volume; and
d) removing the droplets from the collection reservoir.
18. The method of embodiment 17, wherein the removal of droplets does not comprise pressurization of the collection reservoir.
19. The method of embodiment 17, wherein the first volume has a volume that is less than 0.5% of the volume of the second volume.
20. The method of embodiment 17, wherein the first volume has a volume that is less than 0.3% of the volume of the second volume.
21. The method of embodiment 17, wherein the first volume has a volume that is less than 0.1% of the volume of the second volume.
22. The method of embodiment 17, wherein the first volume has a volume between 0.01 μL to 10 μL.
23. The method of embodiment 17, wherein the second volume has a volume between 100 μL to 10,000 μL.
24. The method of embodiment 17, wherein the device further comprises a second channel having a second depth, a second width, a second proximal end, and a second distal end, wherein the second channel intersects the first channel between the first proximal and first distal ends.
25. The method of embodiment 17, wherein the droplet formation region comprises a shelf region having a third depth, a third width, at least one inlet, and at least one outlet, wherein the shelf region of the device is configured to allow the first liquid to expand in at least one dimension.
26. The method of embodiment 17, wherein the droplet formation region further comprises a step region having a fourth depth.
27. The method of embodiment 17, wherein the device is configured to produce a droplets.

### Embodiment E

1. A method of producing droplets comprising:
(a) bringing a first liquid in contact with a second liquid immiscible with the first liquid at a specified droplet generation parameter to produce droplets in a device;
(b) monitoring a temperature of the device; and
(c) adjusting a pressure of the first liquid or the second liquid based on the temperature to substantially maintain the specified droplet generation parameter.
2. The method of embodiment 1, wherein the droplet generation parameter is selected from the group consisting of flow rate, droplet generation frequency, and ratio of droplets comprising a specified number of particles compared to droplets not comprising the specified number of particles.
3. The method of embodiment 1, wherein the droplet comprises a particle.
4. The method of embodiment 3, wherein the particle comprises a biological particle, a bead, or a combination thereof.
5. The method of embodiment 4, wherein the biological particle comprises a cell or one or more constituents of a cell.
6. The method of embodiment 2, wherein the method maintains a substantially constant ratio of droplets comprising a specified number of particles as compared to droplets not comprising the specified number of particles.
7. The method of embodiment 2, wherein the method maintains a substantially constant ratio of droplets comprising a particle as compared to droplets not comprising a particle.
8. The method of embodiment 1, wherein adjusting the pressure of the first liquid or the second liquid comprises increasing the pressure.
9. The method of embodiment 1, wherein adjusting the pressure of the first liquid or the second liquid comprises decreasing the pressure.
10. The method of embodiment 1, wherein the pressure of the first liquid or the second liquid is adjusted based on a viscosity calculated based on the temperature of the device.
11. The method of embodiment 1, wherein the device comprises:
(i) a first channel having a first depth, a first width, a first proximal end, and a first distal end; and
(ii) a second channel having a second depth, a second width, a second proximal end, and a second distal end, wherein the second channel intersects the first channel between the first proximal and first distal ends; and
(iii) a droplet formation region, wherein the droplet formation region comprises a shelf region having a third depth and a third width, and a step region having a fourth depth, wherein the shelf region is configured to allow the first liquid to expand in at least one dimension and has at least one inlet and at least one outlet, wherein the shelf region is disposed between the first distal end and the step region, wherein the first channel and droplet formation region are configured to produce droplets of the first liquid in the second liquid; and
(iv) a droplet collection region, in fluid communication with the droplet formation region.
   12. The method of embodiment 9, wherein the first liquid comprises a plurality of particles, the particles comprising an analyte detection moiety, and the second liquid comprises an analyte.
   13. The method of embodiment 10, wherein the first channel comprises the first liquid and the second channel comprises the second liquid.
   14. The method of embodiment 11, further comprising allowing the particles in the first liquid to flow proximal-to-distal through the first channel, and allowing the second liquid to flow proximal-to-distal through the second channel, wherein the second liquid combines with the first liquid to form an analyte detection liquid at the intersection, wherein the analyte detection liquid meets a partitioning liquid at the droplet formation region under droplet forming conditions, thereby forming a plurality of analyte detection droplets comprising one or more of the particles in the analyte detection liquid.
   15. The method of embodiment 9, wherein the first channel is one of a plurality of first channels and the second channel is one of a plurality of second channels, and wherein the device further comprises a first reservoir connected proximally to the plurality of first channels and a second reservoir connected proximally to the plurality of second channels.
   16. The method of embodiment 12, wherein the first liquid and the second liquid are aqueous liquids and the partitioning liquid is immiscible with the first liquid and the second liquid.
   17. The method of embodiment 10, wherein the analyte is a bioanalyte.
   18. The method of embodiment 15, wherein the bioanalyte is selected from the group consisting of a nucleic acid, an intracellular protein, a glycan, and a surface protein.
   19. The method of embodiment 10, wherein the analyte detection moiety comprises a nucleic acid or an antigen-binding protein.
   20. The method of embodiment 10, wherein the second liquid comprises a cell or fragment or product thereof.
   21. The method of embodiment 12, wherein the plurality of analyte detection droplets accumulate as a population in the droplet collection region.
   22. A system for producing droplets comprising:
(a) a device comprising a droplet formation region for producing droplets of a first liquid immiscible in a second liquid at a specified droplet generation parameter;
(b) a temperature sensor for monitoring a temperature of the device;
(c) a pressure sensor for monitoring a pressure of the device; and
(d) a controller configured to adjust a flow rate of the first liquid or the second liquid.
   23. The system of embodiment 22, wherein the droplet generation parameter is selected from the group consisting of flow rate, droplet generation frequency, and ratio of droplets comprising a specified number of particles compared to droplets not comprising the specified number of particles
   24. The system of embodiment 22, wherein the device comprises:
(i) a first channel having a first depth, a first width, a first proximal end, and a first distal end;
(ii) a second channel having a second depth, a second width, a second proximal end, and a second distal end, wherein the second channel intersects the first channel between the first proximal and first distal ends;
(iii) the droplet formation region, wherein the droplet formation region comprises a shelf region having a third depth and a third width, and a step region having a fourth depth, wherein the shelf region is configured to allow the first liquid to expand in at least one dimension and has at least one inlet and at least one outlet, wherein the shelf region is disposed between the first distal end and the step region, wherein the first channel and droplet formation region are configured to produce droplets of the first liquid in the second liquid; and
(iv) a droplet collection region, in fluid communication with the droplet formation region.
   25. The system of embodiment 24, wherein the first channel is one of a plurality of first channels and the second channel is one of a plurality of second channels, and wherein the device further comprises a first reservoir connected proximally to the plurality of first channels and a second reservoir connected proximally to the plurality of second channels.
   26. The system of embodiment 22, further comprising a holder configured to hold the device in operative connection with the pressure sensor, the temperature sensor, and the controller.
   27. The system of embodiment 26, wherein the temperature sensor is positioned between the holder and the device.
   28. The system of embodiment 26, wherein the temperature sensor is embedded within the holder.

### Embodiment F

1. A device for producing droplets, the device comprising:
(a) a first channel having a first channel depth, a first channel width, a first proximal end, and a first distal end;
(b) a shelf region having a shelf width and a shelf depth, wherein the shelf region is in fluid communication with the first distal end; and
and
(c) a droplet collection region having a droplet collection region width and a droplet collection region depth, the droplet collection region comprising a recess having a recess depth and a recess width, wherein the recess is fluidically connected to the shelf region, the recess depth is greater than the shelf depth, and the recess width is greater than the shelf width;
   wherein the first channel and the shelf region are configured to produce droplets.
   2. The device of embodiment 1, wherein the recess width is 100% of the droplet formation region to 1000% of the droplet collection region width.
   3. The device of embodiment 1 or 2, wherein the recess width increases distally from the shelf region.
   4. The device of any one of embodiments 1 to 3, wherein the recess depth increases distally from the shelf region.
   5. The device of any one of embodiments 1 to 4, wherein the shelf width is greater than the first channel width by at least 10%.
   6. The device of any one of embodiments 1 to 5, wherein the shelf region width is greater than the first channel width by 100000% or less.
   7. The device of any one of embodiments 1 to 6, wherein the droplet collection region comprises one or more peripherally protruding volumes.
   8. A device for producing droplets, the device comprising:
(a) a first channel having a first channel depth, a first channel width, a first proximal end, and a first distal end;
(b) a shelf region having a shelf width and a shelf depth, wherein the shelf region is in fluid communication with the first channel; and
and
(c) a droplet collection region having a droplet collection region width and a droplet collection region depth, the droplet correction region comprising one or more peripherally protruding volumes;
   wherein the first channel and the shelf region are configured to produce droplets.
   9. The device of embodiment 7 or 8, wherein the one or more peripherally protruding volumes extend away from the periphery of the droplet collection region.
   10. The device of embodiment 9, wherein the one or more peripherally protruding volumes extend away from the periphery of the droplet collection region by at least 10% of the droplet collection region width.
   11. The device of any one of embodiments 1 to 10, wherein the device further comprises a step region having a step region depth and being in fluid communication with the shelf region, where the shelf region is disposed between the step region and the first distal end.
   12. The device of embodiment 11, wherein the step region and shelf region connect via a curved wall.
   13. A device for producing droplets, the device comprising:
a) a first channel having a first channel depth, a first channel width, a first proximal end, and a first distal end;
(b) a shelf region and a step region, the shelf region having a shelf width and a shelf depth, and the step region having the step depth, wherein the shelf region is in fluid communication with the first distal end, and wherein the step region and shelf region connect via a curved wall,
   wherein the first channel and the droplet formation region are configured to produce droplets.
   14. The device of embodiment 13, wherein the curved wall has a curvature length of 0.0001% to 10000% of the length of the shelf region.
   15. A device for producing droplets comprising:
a) a first channel having a first channel depth, a first channel width, a first proximal end, and a first distal end;
(b) a shelf region and a step region, the shelf region having a shelf width, the shelf region having a central portion aligned with the first distal end having a first shelf depth and two peripheral portions on either side of the central portion, each independently having a second shelf depth, wherein the first shelf depth is less than the second shelf depths, and the step region having a step depth, wherein the shelf region is in fluid communication with the first distal end and disposed between the first distal end and the step region,
   wherein the first channel and the shelf and step regions are configured to produce droplets.
   16. A device for producing droplets comprising:
a) a first channel having a first channel depth, a first channel width, a first proximal end, and a first distal end;
(b) a shelf region and a step region, the shelf region having a shelf width and a shelf depth, and the step region having the step depth, wherein the shelf region is in fluid communication with the first distal end, and wherein the long axis of the shelf region is oriented perpendicular to the long axis of the first channel,
   wherein the first channel and the shelf region are configured to produce droplets.
   17. The device of any one of embodiments 1 to 16, wherein the step region depth is greater than the shelf region depth and the first channel depth.
   18. The device of any one of embodiments 1 to 17, wherein the first channel further comprises a funnel.
   19. The device of any one of embodiments 1 to 18, further comprising a second channel having a second depth, a second width, a second proximal end, and a second distal end, wherein:
a) the second channel intersecting the first channels between the first proximal and first distal ends; or
b) the second distal end is in fluid communication with the shelf region, and the second channel does not intersect the first channel.
   20. The device of embodiment 19, wherein the second channel comprises a funnel.
   21. The device of embodiment 19 or 20, wherein the funnel is disposed between the second proximal end and the intersection between the first channel and the second channel.
   22. The device of embodiment 20 or 21, wherein the second channel comprises a funnel fluidically connected to the second proximal end.
   23. The device of any one of embodiments 19 to 22, wherein the first channel comprises a funnel disposed between the first proximal end and the intersection between the first channel and the second channel.
   24. The device of any one of embodiments 19 to 23, wherein the first channel comprises a funnel disposed between the first distal end and the intersection between the first channel and the second channel.
   25. The device of any one of embodiments 18 to 24, wherein the first channel comprises a funnel fluidically connected to the first proximal end.
   26. The device of any one of embodiments 18 to 25, wherein the funnel comprises a row of pegs comprising a first end and a second end disposed along the width of the funnel.
   27. The device of embodiment 26, wherein the row of pegs is disposed along a diagonal across the funnel width.
   28. The device of embodiment 26 or 27, wherein the first end is disposed nearer to the proximal end than the second end.
   29. The device of any one of embodiments 1 to 28, wherein the first channel comprises a mixer.
   30. The device of embodiment 29, wherein the mixer is disposed between the first distal end and the intersection between the first channel and the second channel, when present.
   31. The device of embodiment 20 or 21, wherein the mixer is a herringbone mixer.
   32. A system for producing droplets, the system comprising:
   (a) a device comprising:
(i) a first channel having a first channel depth, a first channel width, a first proximal end, and a first distal end;
(ii) a shelf region having a shelf width and a shelf depth, wherein the shelf region is in fluid communication with the first distal end;
(iii) a droplet collection region having a droplet collection region width and a droplet collection region depth, the droplet collection region comprising a recess having a recess depth and a recess width, wherein the recess is fluidically connected to the shelf region, the recess depth is greater than the shelf depth, and the recess width is greater than the shelf width;
   (b) a first liquid disposed in the first channel;
   (c) a second liquid disposed in the droplet collection region; and
   wherein the first liquid and the second liquid are immiscible;
   wherein the system is configured to produce droplets of the first liquid in the second liquid.
   33. The system of embodiment 32, wherein the device is of any one of embodiments 2 to 12.
   34. A system for producing droplets, the system comprising:
   (a) a device comprising:
(i) a first channel having a first channel depth, a first channel width, a first proximal end, and a first distal end;
(ii) a shelf region having a shelf width and a shelf depth, wherein the shelf region is in fluid communication with the first distal end; and
and
(iii) a droplet collection region having a droplet collection region width and a droplet collection region depth, the droplet correction region comprising one or more peripherally protruding volumes;
   (b) a first liquid disposed in the first channel;
   (c) a second liquid disposed in the droplet collection region; and
   wherein the first liquid and the second liquid are immiscible;
   wherein the system is configured to produce droplets of the first liquid in the second liquid.
   35. The system of embodiment 34, wherein the device is of any one of embodiments 9 to 12.
   36. A system for producing droplets, the system comprising:
(a) a device comprising:
   (i) a first channel having a first channel depth, a first channel width, a first proximal end, and a first distal end;
   (ii) a shelf region and a step region, the shelf region having a shelf width and a shelf depth, and the step region having the step depth, wherein the shelf region is in fluid communication with the first distal end, and wherein the step region comprises a smooth curved wall extending away from the shelf region,
      (b) a first liquid disposed in the first channel;
      (c) a second liquid disposed in the droplet collection region; and
      wherein the first liquid and the second liquid are immiscible;
      wherein the system is configured to produce droplets of the first liquid in the second liquid.
      37. The system of embodiment 36, wherein the device is of embodiment 14 or 17.
      38. A system for producing droplets, the system comprising:
      (a) a device comprising:
(i) a first channel having a first channel depth, a first channel width, a first proximal end, and a first distal end;
(ii) a shelf region and a step region, the shelf region having a shelf width and a shelf depth, and the step region having the step depth, wherein the shelf region is in fluid communication with the first distal end, and wherein the long axis of the shelf region is oriented perpendicular to the long axis of the first channel,
   wherein the first channel and the shelf region are configured to produce droplets.
   (b) a first liquid disposed in the first channel;
   (c) a second liquid disposed in the droplet collection region; and
   wherein the first liquid and the second liquid are immiscible;
   wherein the system is configured to produce droplets of the first liquid in the second liquid.
   39. The system of any one of embodiments 32 to 38, wherein the first channel further comprises a funnel.
   40. The system of any one of embodiments 32 to 39, further comprising a second channel having a second depth, a second width, a second proximal end, and a second distal end, the second channel intersecting the first channels between the first proximal and first distal ends; wherein the second channel comprises a third liquid, and the system is configured to produce droplets of the first and third liquids in the second liquid.
   41. The system of embodiment 40, wherein the second channel comprises a funnel.
   42. The system of embodiment 40 or 41, wherein the funnel is disposed between the second proximal end and the intersection between the first channel and the second channel.
   43. The system of embodiment 41 or 42, wherein the second channel comprises a funnel fluidically connected to the second proximal end.
   44. The system of any one of embodiments 40 to 43, wherein the first channel comprises a funnel disposed between the first proximal end and the intersection between the first channel and the second channel.
   45. The system of any one of embodiments 40 to 44, wherein the first channel comprises a funnel disposed between the first distal end and the intersection between the first channel and the second channel.
   46. The system of any one of embodiments 39 to 45, wherein the first channel comprises a funnel fluidically connected to the first proximal end.
   47. The system of any one of embodiments 39 to 46, wherein the funnel comprises a row of pegs comprising a first end and a second end disposed along the width of the funnel.
   48. The system of embodiment 47, wherein the row of pegs is disposed along a diagonal across the funnel width.
   49. The system of embodiment 47 or 48, wherein the first end is disposed nearer to the proximal end than the second end.
   50. The system of any one of embodiments 32 to 49, wherein the first channel comprises a mixer.
   51. The system of embodiment 50, wherein the mixer is disposed between the first distal end and the intersection between the first channel and the second channel, when present.
   52. The system of embodiment 50 or 51, wherein the mixer is a herringbone mixer.
   53. The system of any one of embodiments 32 to 52, further comprising a plurality of particles disposed in the first channel.
   54. A method of producing droplets in a second liquid, the method comprising:
   (a) providing the system of any one of embodiments 32 to 53; and
   (b) allowing the liquids to flow from the channel(s) to the droplet formation region to produce droplets in the second liquid, the droplets comprising the liquids from the channel(s).

### Embodiment G

1. A device for producing droplets, the device comprising:
a) a first channel having a first depth, a first width, a first proximal end, and a first distal end;
b) a second channel having a second depth, a second width, a second proximal end, and a second distal end; and
d) a step region having a wall having a fourth depth, wherein the fourth depth is greater than the first depth,
   wherein a first liquid flowing from the first distal end and a third liquid flowing from the second distal end combine and form droplets in a second, immiscible liquid at the step region and wherein the first and second channels do not intersect.
   2. The device of embodiment 1, further comprising a shelf region being in fluid communication with the first distal end and the second distal end and having a third depth and a third width, wherein the third width is greater than the first width and wherein the shelf region is fluidically connected to the step region, and disposed between the first distal end and the step region.
   3. The device of embodiment 2, wherein the third width increases from the first distal end to the step region.
   4. The device of embodiment 2, wherein the third width is greater than the first and second widths.
   5. The device of embodiment 2, wherein the third depth is less than the first, second, and/or fourth depths.
   6. The device of embodiment 1, further comprising a first reservoir in fluid communication with the first proximal end.
   7. The device of embodiment 1, further comprising a second reservoir in fluid communication with the second proximal end.
   8. The device of embodiment 1, further comprising a collection reservoir in fluid communication with the step region to collect droplets formed in the droplet formation region.
   9. A system for producing droplets, the system comprising:
a) a device for producing droplets, the device comprising:
   i) a first channel having a first depth, a first width, a first proximal end, and a first distal end;
   ii) a second channel having a second depth, a second width, a second proximal end, and a second distal end;
   iii) a step region having a wall having a fourth depth, wherein the fourth depth is greater than the first depth;
   iv) a first reservoir in fluid communication with the first proximal end, wherein the first reservoir comprises a first liquid; and
   v) a second reservoir in fluid communication with the second proximal end, wherein the second reservoir comprises a third liquid, wherein the first and third liquids are miscible with each other and wherein the first and third liquids combine at the distal end of the first channel and second channel,
b) a second liquid contained in the step region, wherein the first liquid and the second liquid are immiscible with each other,
   wherein the combined first and third liquids, flowing from the first distal end to the step region, form droplets of the first and third liquids dispersed in the second liquid and wherein the first and second channels do not intersect.
   10. The system of embodiment 9, wherein the device further comprises a shelf region being in fluid communication with the first distal end and the second distal end and having a third depth and a third width, wherein the third width is greater than the first width and wherein the shelf region is fluidically connected to the step region and disposed between the first distal end and the step region.
   11. The system of embodiment 10, wherein the third width is greater than the first and second widths.
   12. The system of embodiment 9, wherein the first liquid comprises particles.
   13. The system of embodiment 9, wherein the third liquid comprises an analyte.
   14. The system of embodiment 10, wherein the third width increases from the first distal end to the step region.
   15. The system of embodiment 9, further comprising a collection reservoir in fluid communication with the step region to collect droplets formed in the droplet formation region.
   16. The system of embodiment 9, further comprising a controller operatively coupled to the first channel and the second channel to transport the first liquid in the first reservoir, the third liquid in the second reservoir to the step region.
   17. The system of any one of embodiments 9-16, wherein the first and third liquids may combine at the step region or a shelf region if present.
   18. A method of producing droplets of a first liquid in a second liquid comprising:
a) providing a device of any one of claims 1-8 or a system of any one of claims 9-17;
b) allowing the first liquid to flow from the first channel and the third liquid to flow from the second channel to the shelf region to produce droplets of the combination of the first and third liquids in the second liquid.
   19. The method of claim 18, further comprising collecting the droplets in a collection reservoir in fluid communication with the step region; and
optionally removing the droplets from the collection reservoir.

### Embodiment H

1. A device for producing droplets, the device comprising:
a) a first channel having a first depth, a first width, a first proximal end, and a first distal end;
b) a second channel having a second depth, a second width, a second proximal end, and a second distal end, wherein the second channel intersects the first channel between the first proximal and first distal ends and wherein the intersection has a depth greater than the first depth;
c) a shelf region in fluid communication with the first distal end and having a third depth and a third width, wherein the third width is greater than the first width; and
d) a step region having a wall having a fourth depth, wherein the fourth depth is greater than the third depth, wherein the shelf region is fluidically connected to the step region, and the shelf region is disposed between the first distal end and the step region,
wherein a first liquid flowing from the first distal end and a third liquid flowing from the second distal end combine and form droplets in a second, immiscible liquid at the step region.
   2. The device of embodiment 1, wherein the intersection depth is greater than the third depth.
   3. The device of embodiment 1, wherein the third width increases from the first distal end to the step region.
   4. The device of embodiment 1, further comprising a first reservoir in fluid communication with the first proximal end.
   5. The device of embodiment 1, further comprising a second reservoir in fluid communication with the second proximal end.
   6. The device of embodiment 2, further comprising a collection reservoir in fluid communication with the step region to collect droplets produced by the device.
   7. A system for producing droplets, the system comprising:
a) a device for producing droplets, the device comprising:
   i) a first channel having a first depth, a first width, a first proximal end, and a first distal end;
   ii) a second channel having a second depth, a second width, a second proximal end, and a second distal end, wherein the second channel intersects the first channel between the first proximal and first distal ends and wherein the intersection has a depth greater than the first depth;
   iii) a shelf region in fluid communication with the first distal end and having a third depth and a third width, wherein the third width is greater than the first width; and
   iv) a step region having a wall having a fourth depth, wherein the fourth depth is greater than the third depth, wherein the shelf region is fluidically connected to the step region, and the shelf region is disposed between the first distal end and the step region,
   v) a first reservoir in fluid communication with the first proximal end, wherein the first reservoir comprises a first liquid; and
   vi) a second reservoir in fluid communication with the second proximal end, wherein the second reservoir comprises a third liquid, wherein the first and third liquids are miscible with each other and wherein the first and third liquids combine at the intersection of the first channel and second channel,
b) a second liquid contained in the droplet formation region, wherein the first liquid and the second liquid are immiscible with each other, and
   wherein the combined first and third liquids, flowing from the first distal end to the droplet formation region, form droplets of the first and third liquids dispersed in the second liquid, and wherein the fourth depth is sized for droplets produced in the droplet formation region to be transported therefrom by buoyancy.
   8. The system of embodiment 7, wherein the first liquid comprises particles.
   9. The system of embodiment 7, wherein the third liquid comprises an analyte.
   10. The system of embodiment 7, wherein the intersection depth is greater than the third depth.
   11. The system of embodiment 7, wherein the third width increases from the first distal end to the step region.
   12. The system of embodiment 7, further comprising a collection reservoir in fluid communication with the step region to collect droplets formed by the device.
   13. The system of embodiment 7, further comprising a controller operatively coupled to the first channel and the second channel to transport the first liquid in the first reservoir, the third liquid in the second reservoir to the intersection, and the combined first and third liquids from the intersection to the droplet formation region.
   14. A method of producing droplets of a first liquid in a second liquid comprising:
a) providing a device comprising:
   i) a first channel having a first depth, a first width, a first proximal end, and a first distal end;
   ii) a second channel having a second depth, a second width, a second proximal end, and a second distal end, wherein the second channel intersects the first channel between the first proximal and first distal ends and wherein the intersection has a depth greater than the first depth;
   iii) a shelf region in fluid communication with the first distal end and having a third depth and a third width, wherein the third width is greater than the first width; and
   iv) a step region having a wall having a fourth depth, wherein the fourth depth is greater than the third depth, wherein the shelf region is fluidically connected to the step region, and the shelf region is disposed between the first distal end and the step region,
   wherein a first liquid flowing from the first distal end and a third liquid flowing from the second distal end combine and form droplets in a second, immiscible liquid at the step region;
b) allowing the first liquid to flow from the first channel the third liquid to flow from the second channel to the shelf region to produce droplets of the combination of the first and third liquids in the second liquid;
c) collecting the droplets in a collection reservoir; and optionally
d) removing the droplets from the collection reservoir.
   15. A method of producing droplets of a first liquid in a second liquid, the method comprising:
a) providing the system of embodiment 7; and
b) allowing the first liquid to flow in the first channel and the third liquid to flow from the second channel to the shelf region to produce droplets of the combination of the first and third liquids in the second liquid.

### Embodiment I

1. A system for producing droplets, the system comprising:
a) a device for producing droplets, the device comprising:
   i) a first channel having a first depth, a first width, a first proximal end, and a first distal end; and
   ii) a reservoir comprising a step region comprising a wall having a fourth depth, wherein the fourth depth is greater than the first depth, wherein the first distal end is in fluid communication with the wall;
b) a ferrofluid contained in the reservoir, wherein the first liquid and the ferrofluid are immiscible with each other; and
c) a magnetic actuator in operative connection with the device;
   wherein the first liquid, flowing from the first distal end to the step region, forms droplets of the first liquid dispersed in the ferrofluid.
   2. The system of embodiment 1, wherein the device further comprises a shelf region being in fluid communication with the first distal end and having a third depth and a third width, wherein the third width is greater than the first width and wherein the shelf region is fluidically connected to the step region and disposed between the first distal end and the step region.
   3. The system of embodiment 2, wherein the device further comprises a second channel, having a second depth, a second width, a second proximal end, and a second distal end, wherein:
a) the second channel intersects the first channel between the first proximal and first distal end; or
b) the second distal end is in fluid communication with the step region, and the second channel does not intersect the first channel.
   4. The system of embodiment 3, wherein the first liquid comprises particles.
   5. The system of embodiment 3, wherein the third liquid comprises an analyte.
   6. The system of embodiment 3, wherein the third width increases from the first distal end to the step region.
   7. A method of producing droplets, the method comprising:
a) providing the system of any one of embodiments 1-7; and
b) producing droplets of the first liquid in the ferrofluid.
   8. The method of embodiment 7, further comprising manipulating the droplets by actuating the magnetic actuator.
   9. The method of embodiment 8, wherein the droplets are separated by altering the magnetic field.
   10. The system of embodiment 9, wherein the droplets are separated based on droplet size.
   11. The system of embodiment 8, wherein the droplets are heated by altering the magnetic field.
   12. The system of embodiment 8, wherein the droplets are directed above or below the ferrofluid by the magnetic field.

### Embodiment J

1. A device for producing droplets of a first liquid in a second liquid comprising:
a) a first channel having a first proximal end, a first distal end, a first width, and a first depth;
b) a droplet formation region having a width or depth greater than the first width or first depth and being in fluid communication with the first distal end; and
c) a reentrainment channel having a proximal end and a distal end, wherein the proximal end is in fluid communication with the droplet formation region.
2. The device of claim 1, further comprising a second channel have a second proximal end, a second distal end, a second width, and a second depth, wherein either the second channel intersects the first channel between the first proximal and first distal ends or the second distal end is in fluid communication with the droplet formation region.
3. The device of claim 1 or 2, wherein the droplet formation region comprises a shelf region having a third width and third depth, wherein the third width is greater than the first width.
4. The device of claim 3, wherein the droplet formation region further comprises a step region comprising a wall having a fourth depth, wherein the step region is in fluid communication with the shelf region and the shelf region is disposed between the first distal end and the step region.
5. The device of claim 1 or 2, wherein the droplet formation region comprises a step region comprising a wall having a fourth depth, wherein the step region is in fluid communication with the first distal end.
6. The device of any one of claims 1-5, wherein the droplet formation region is contiguous with a reservoir, wherein the proximal end of the reentrainment channel is at the top or the bottom of the reservoir.
7. The device of any one of claims 1-6, further comprising a magnetic actuator disposed to apply a magnetic force to direct droplets to the reentrainment channel.
8. The device of any one of claims 1-7, further comprising a controller operably coupled to flow fluid in the reentrainment channel.
9. A system for producing droplets of a first liquid in a second liquid comprising:
a) a device comprising
i) a first channel having a first proximal end, a first distal end, a first width, and a first depth;
ii) a droplet formation region having a width or depth greater than the first width or first depth and being in fluid communication with the first distal end; and
iii) a reentrainment channel having a proximal end and a distal end, wherein the proximal end is in fluid communication with the droplet formation region; and
   b) a second liquid in the droplet formation region.
   10. The system of claim 9, wherein the droplet formation region is contiguous with a reservoir, wherein the proximal end of the reentrainment channel is at the top or the bottom of the reservoir.
   11. The system of claim 9, wherein the second liquid comprises a ferrofluid and the system further comprises a magnetic actuator disposed to apply a magnetic force to direct droplets to the reentrainment channel.
   12. The system of claim 10, wherein the reservoir comprises the second liquid and a spacing liquid, wherein the density of the droplets is between that of the second and spacing liquids.
   13. The system of claim 9, wherein the device further comprises a second channel have a second proximal end, a second distal end, a second width, and a second depth, wherein either the second channel intersects the first channel between the first proximal and first distal ends or the second distal end is in fluid communication with the droplet formation region.
   14. The system of claim 9, wherein the droplet formation region comprises a shelf region having a third width and third depth, wherein the third width is greater than the first width.
   15. The system of claim 14, wherein the droplet formation region further comprises a step region comprising a wall having a fourth depth, wherein the step region is in fluid communication with the shelf region and the shelf region is disposed between the first distal end and the step region.
   16. The system of claim 9, wherein the droplet formation region comprises a step region comprising a wall having a fourth depth, wherein the step region is in fluid communication with the first distal end.
   17. The system of claim 9, further comprising a controller operably coupled to flow fluid in the reentrainment channel.
   18. A method of manipulating droplets of a first liquid in a second liquid comprising:
   a) providing a device of any of claims 1-8 or a system of any one of claim 9-17;
   b) producing droplets in the droplet formation region;
   c) directing the droplets into the reentrainment channel.
   19. The method of claim 18, wherein the second liquid comprises a ferrofluid and the droplets are directed by application of a magnetic field to the ferrofluid.
   20. The method of claim 18, wherein the droplet formation region is contiguous with a reservoir, wherein the proximal end of the reentrainment channel is at the top or the bottom of the reservoir.
   21. The method of claim 20, wherein the reservoir comprises the second liquid and spacing liquid, wherein the density of the droplets is between that of the second and spacing liquids, and wherein the droplets are directed to the reentrainment channel by pressure.
   22. The method of claim 21, further comprising flowing a liquid in the reentrainment channel.

### Other Embodiments

Various modifications and variations of the described invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention that are obvious to those skilled in the art are intended to be within the scope of the invention.

Other embodiments are in the claims.

1. A method of producing droplets comprising:
(a) bringing a first liquid in contact with a second liquid immiscible with the first liquid at a specified droplet generation parameter to produce droplets in a device;
(b) monitoring a temperature of the device; and
(c) adjusting a pressure of the first liquid or the second liquid based on the temperature to substantially maintain the specified droplet generation parameter.

2. The method of claim 1, wherein the droplet generation parameter is selected from the group consisting of flow rate, droplet generation frequency, and ratio of droplets comprising a specified number of particles compared to droplets not comprising the specified number of particles.

3. The method of claim 1, wherein the droplet comprises a particle.

4. The method of claim 3, wherein the particle comprises a biological particle, a bead, or a combination thereof.

5. The method of claim 4, wherein the biological particle comprises a cell or one or more constituents of a cell.

6. The method of claim 2, wherein the method maintains a substantially constant ratio of droplets comprising a specified number of particles as compared to droplets not comprising the specified number of particles.

7. The method of claim 2, wherein the method maintains a substantially constant ratio of droplets comprising a particle as compared to droplets not comprising a particle.

8. (canceled)

9. The method of claim 1, wherein adjusting the pressure of the first liquid or the second liquid comprises decreasing the pressure, or wherein adjusting the pressure of the first liquid or the second liquid comprises increasing the pressure or wherein the pressure of the first liquid or the second liquid is adjusted based on a viscosity calculated based on the temperature of the device.

10. (canceled)

11. The method of claim 1, wherein the device comprises:
(i) a first channel having a first depth, a first width, a first proximal end, and a first distal end; and
(ii) a second channel having a second depth, a second width, a second proximal end, and a second distal end, wherein the second channel intersects the first channel between the first proximal and first distal ends; and
(iii) a droplet formation region, wherein the first channel and droplet formation region are configured to produce droplets of the first liquid in the second liquid; and
(iv) a droplet collection region, in fluid communication with the droplet formation region.

12. The method of claim 9, wherein the first liquid comprises a plurality of particles, the particles comprising an analyte detection moiety, and the second liquid comprises an analyte.

13. The method of claim 9, wherein the first channel comprises the first liquid and the second channel comprises the second liquid.

14. The method of claim 11, further comprising allowing the particles in the first liquid to flow proximal-to-distal through the first channel, and allowing the second liquid to flow proximal-to-distal through the second channel, wherein the second liquid combines with the first liquid to form an analyte detection liquid at the intersection, wherein the analyte detection liquid meets a partitioning liquid at the droplet formation region under droplet forming conditions, thereby forming a plurality of analyte detection droplets comprising one or more of the particles in the analyte detection liquid.

15. The method of claim 9, wherein the first channel is one of a plurality of first channels and the second channel is one of a plurality of second channels, and wherein the device further comprises a first reservoir connected proximally to the plurality of first channels and a second reservoir connected proximally to the plurality of second channels.

16. The method of claim 12, wherein the first liquid and the second liquid are aqueous liquids and the partitioning liquid is immiscible with the first liquid and the second liquid.

17. (canceled)

18. (canceled)

19. (canceled)

20. (canceled)

21. (canceled)

22. A system for producing droplets comprising:
(a) a device comprising a droplet formation region for producing droplets of a first liquid immiscible in a second liquid at a specified droplet generation parameter;
(b) a temperature sensor for monitoring a temperature of the device;
(c) a pressure sensor for monitoring a pressure of the device; and
(d) a controller configured to adjust a flow rate of the first liquid or the second liquid.

23. The system of claim 22, wherein the droplet generation parameter is selected from the group consisting of flow rate, droplet generation frequency, and ratio of droplets comprising a specified number of particles compared to droplets not comprising the specified number of particles

24. The system of claim 22, wherein the device comprises:
(i) a first channel having a first depth, a first width, a first proximal end, and a first distal end;
(ii) a second channel having a second depth, a second width, a second proximal end, and a second distal end, wherein the second channel intersects the first channel between the first proximal and first distal ends;
(iii) the droplet formation region, wherein the first channel and droplet formation region are configured to produce droplets of the first liquid in the second liquid; and
(iv) a droplet collection region, in fluid communication with the droplet formation region.

25. The system of claim 24, wherein the first channel is one of a plurality of first channels and the second channel is one of a plurality of second channels, and wherein the device further comprises a first reservoir connected proximally to the plurality of first channels and a second reservoir connected proximally to the plurality of second channels.

26. The system of claim 22, further comprising a holder configured to hold the device in operative connection with the pressure sensor, the temperature sensor, and the controller.

27. The system of claim 26, wherein the temperature sensor is positioned between the holder and the device or wherein the temperature sensor is embedded within the holder.

28. (canceled)
